(19) United States
(12) Patent Application Publication
(10) Pub. No.: US 2022/0338502 A1
(43) Pub. Date: Oct. 27, 2022

(54) EDIBLE SILK AND METHODS OF MAKING AND USING THEREOF

(71) Applicant: Evolved by Nature, Inc., Arlington, MA (US)

(72) Inventors: Gregory H. ALTMAN, Providence, RI (US); Marius COSTACHE, Lexington, MA (US); Carlos J. BOSQUES, Arlington, MA (US); Corey CHAMBERLAIN, Arlington, MA (US)

(21) Appl. No.: 17/762,238

(22) PCT Filed: Sep. 19, 2020
(86) PCT No.: PCT/US20/51697

§ 371 Date: Mar. 21, 2022

Related U.S. Application Data
(60) Provisional application No. 62/903,431, filed on Sep. 20, 2019.

(51) Int. Cl. A23J 1/00; A23J 3/32; A23B 7/16; A23C 19/10; A23L 2/66; A23L 2/02

(52) U.S. Cl. CPC A23J 1/00; A23J 3/32; A23B 7/16; A23C 19/10; A23L 2/66; A23L 2/02; A23V 2002/00

(57) ABSTRACT

This disclosure provides novel silk fibroin protein based additives for foods or beverage products, and foodstuffs mixed or coated with pure silk fibroin-based proteins or protein fragments, and methods of making thereof.

### CROSS-REFERENCE TO RELATED APPLICATIONS

This application is an International Patent Application which claims the benefit of U.S. Provisional Patent Application No. 62/903,431, filed Sep. 20, 2019, which is hereby incorporated by reference in its entirety.

### FIELD

The disclosure relates to novel silk fibroin protein based additives and/or ingredients for foods or beverage products, and specifically the preservation of perishable goods by providing an edible coating formed of novel aqueous coating compositions containing silk fibroin-based proteins or protein fragments, and methods of making thereof.

### BACKGROUND

Consumer demands for both higher quality and longer shelf-life foods have stimulated edible film research. The environmental movement has promoted increased concern about reducing disposable packaging amounts and increasing packaging recyclability, further contributing to the recent surge in edible coating and film research. Edible films and coatings are capable of offering solutions to these concerns by regulating the mass transfer of water, oxygen, carbon dioxide, lipid, flavor, and aroma movement in food systems. Edible coatings function by direct adherence to food products; whereas, edible films act as stand-alone sheets of material used as wrappings.

This disclosure provides the application of aqueous solutions of silk fibroin fragments as novel edible coating material with improve film forming properties, food additive, or food ingredient.

### SUMMARY

This disclosure provides food or beverage products containing silk fibroin-based additives, and methods of making thereof.

In an embodiment, this disclosure provides a silk food or beverage product comprising an edible material and silk fibroin fragments having: (i) an average weight average molecular weight selected from the group consisting of between about 1 kDa and about 5 kDa, between about 5 kDa and about 10 kDa, between about 6 kDa and about 17 kDa, between about 10 kDa and about 15 kDa, between about 15 kDa and about 20 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa; and (ii) a polydispersity between 1.0 and about 5.0.

In some embodiments, the polydispersity is between 1 and about 1.5. In some embodiments, the polydispersity is between about 1.5 and about 3.0. In some embodiments, the polydispersity is between is between about 1.5 and about 2.0. In some embodiments, the polydispersity is between is between about 2.0 and about 2.5. In some embodiments, the polydispersity is between is between about 2.5 and about 3.0.

In some embodiments, the silk fibroin fragments are present in the silk food or beverage product at about 0.001 wt. % to about 10.0 wt. % by the total weight of the silk food or beverage product. In some embodiments, the silk fibroin fragments are present in the silk food or beverage product at about 0.001 wt. % to about 5.0 wt. % by the total weight of the silk food or beverage product. In some embodiments, the silk fibroin fragments are present in the silk food or beverage product at about 0.001 wt. % to about 1.0 wt. % by the total weight of the silk food or beverage product. In some embodiments, the silk food or beverage product further comprising about 0.001% wt. % to about 10 wt. % sericin by the total weight of the silk fibroin fragments.

In some embodiments, the silk fibroin fragments do not spontaneously or gradually gelate and do not visibly change in color or turbidity when in an aqueous solution for at least 10 days prior to formulation into the silk food or beverage product.

In some embodiments, the silk fibroin fragments have a shelf stability at room temperature of at least 1 week, at least 2 weeks, at least 3 weeks, at least 4 weeks, at least 6 week, at least 8 weeks, at least 10 weeks, at least 12 weeks, at least 16 weeks, at least 20 weeks, at least 24 weeks, at least 36 weeks, or at least 52 weeks. In some embodiments, the edible material has a shelf stability at room temperature of less than 1 hour, less than 3 hours, less than 6 hours, less than 12 hours, less than 24 hours, less than 3 days, less than 1 week, less than 2 weeks, less than 3 weeks, less than 4 weeks, less than 8 weeks, less than 12 weeks, less than 24 weeks, or less than 52 weeks. In some embodiments, the silk food or beverage product has a shelf stability at room temperature of at least 1 hour, at least 3 hours, at least 6 hours, at least 12 hours, at least 24 hours, at least 3 days, at least 1 week, at least 2 weeks, at least 3 weeks, at least 4 weeks, at least 8 weeks, at least 12 weeks, at least 24 weeks, or at least 52 weeks.

In some embodiments, the silk food or beverage product is a beverage. In some embodiments, the beverage is selected from the group consisting of a ready-to-drink beverage, a milk or milk analog beverage, a weight management beverage, a protein shake, and a meal replacement drink. In some embodiments, the beverage is cold-pressed juice.

In some embodiments, the edible material is selected from the group consisting of skim milk, whole milk, cream, dried milk powder, non-fat dry milk powder, caseinate, soy protein concentrate, soy protein isolate, whey protein concentrate, whey protein isolate, chocolate, cocoa powder, coffee, and combinations thereof.

In some embodiments, the silk food or beverage product further comprises an ingredient selected from the group consisting of a sweetening agent, an emulsifying agent, a thickening agent, a stabilizer, a lipid material, a preservative, an antioxidant, a flavoring agent, a coloring agent, a vitamin, a mineral, and combinations thereof.

In some embodiments, the silk food or beverage product is selected from the group consisting of a silk food bar, a nutritional supplement, a cereal-based product, a meat or meat analog product, deli-meat, and a dairy or dairy analog product.

In some embodiments, the silk food or beverage product is selected from the group consisting of lettuce, chicken, milk, beer, fish, berries, corn, avocado, banana, tomato, peach, potato, bean, kale, broccoli, mushroom, asparagus, hummus, grain, egg, cooked vegetable, raw vegetable, parsley, and yogurt.

In some embodiments, the silk fibroin fragments are mixed throughout the edible material. In some embodiments, the silk fibroin fragments form, at least in part, a coating on a surface of the edible material. In some embodiments, the coating is transparent. In some embodiments, the coating is water-soluble.

In some embodiments, the coating further comprises an additive. In some embodiments, the additive is selected from the group consisting of: anti-microbe agents, antibacterial agents and antifungal agents, enzyme inhibitors, ethylene-capturing/binding molecules, ethylene-binding domains of ethylene receptors, ethylene-absorbing substances, aluminosilicates, zeolites, silk fibroin-based aerogels, oxidizing agents, potassium permanganate, ethylene receptor antagonists, porphyrins, hormones, hormone receptor agonists and antagonists thereof, nutraceutical agents, dietary supplements, vitamins, antioxidants, fatty acids, flavorings and other compounds added to improve taste, sugars, perfumes or fragrances, colorings, dyes, and any combination thereof.

In some embodiments, the coating does not contain an added plasticizing agent.

In an embodiment, this disclosure provides a method for preserving an foodstuff, comprising: contacting the foodstuff with a silk fibroin protein fragment coating composition, wherein said coating composition comprising silk fibroin fragments having: (i) an average weight average molecular weight selected from the group consisting of between about 1 kDa and about 5 kDa, between about 5 kDa and about 10 kDa, between about 6 kDa and about 17 kDa, between about 10 kDa and about 15 kDa, between about 15 kDa and about 20 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa; and (ii) a polydispersity between 1.0 and about 5.0, wherein a silk fibroin protein fragment coating layer is formed on at least a portion of the foodstuff; and wherein the foodstuff is preserved as compared to an foodstuff without the coating.

In some embodiments, dip-coating, spray-coating, powder-coating, wrapping, sealing, covering, layering, or any combination thereof forms the coating. In some embodiments, the coating has at least two layers. In some embodiments, the coating has more than two layers.

In some embodiments, the method of preserving the foodstuff further comprising a step of annealing, crosslinking, or a combination thereof.

In an embodiment, this disclosure provides a silk food or beverage product comprising a foodstuff and silk fibroin fragments, the silk fibroin fragments having an average weight average molecular weight selected from between about 1 kDa and about 5 kDa, between about 5 kDa and about 10 kDa, between about 6 kDa and about 17 kDa, between about 10 kDa and about 15 kDa, between about 15 kDa and about 20 kDa, between about 14 kDa and about 30 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 54 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa, and a polydispersity between 1 and about 5.

In some embodiments, the polydispersity is between 1 and about 1.5. In some embodiments, the polydispersity is between about 1.5 and about 3.0. In some embodiments, the polydispersity is between about 1.5 and about 2.0. In some embodiments, the polydispersity is between about 2.0 and about 2.5. In some embodiments, the polydispersity is between about 2.5 and about 3.0. In some embodiments, the silk fibroin fragments are present in the silk food or beverage product at about 0.001 wt. % to about 10.0 wt. % relative to the total weight of the silk food or beverage product. In some embodiments, the silk fibroin fragments are present in the silk food or beverage product at about 0.001 wt. % to about 5.0 wt. % relative to the total weight of the silk food or beverage product. In some embodiments, the silk fibroin fragments are present in the silk food or beverage product at about 0.001 wt. % to about 1.0 wt. % relative to the total weight of the silk food or beverage product. In some embodiments, the silk food or beverage product further comprises about 0.001% wt. % to about 10 wt. % sericin relative to the total weight of the silk fibroin fragments. In some embodiments, the silk food or beverage product further comprises about 0.001% wt. % to about 10 wt. % sericin relative to the total weight of the silk food or beverage product.

In some embodiments, the silk fibroin fragments do not spontaneously or gradually gelate and do not visibly change in color or turbidity when in an aqueous solution for at least 10 days prior to formulation into the silk food or beverage product. In some embodiments, the silk fibroin fragments have a shelf stability of at least 1 week, at least 2 weeks, at least 3 weeks, at least 4 weeks, at least 6 week, at least 8 weeks, at least 10 weeks, at least 12 weeks, at least 16 weeks, at least 20 weeks, at least 24 weeks, at least 36 weeks, or at least 52 weeks. In some embodiments, the silk fibroin fragments have a shelf stability of at least 1 week, at least 2 weeks, at least 3 weeks, at least 4 weeks, at least 6 week, at least 8 weeks, at least 10 weeks, at least 12 weeks, at least 16 weeks, at least 20 weeks, at least 24 weeks, at least 36 weeks, or at least 52 weeks when in an aqueous solution prior to formulation into the silk food or beverage product. In some embodiments, the foodstuff has a shelf stability of at least 1 hour, at least 3 hours, at least 6 hours, at least 12 hours, at least 24 hours, at least 3 days, at least 1 week, at least 2 weeks, at least 3 weeks, at least 4 weeks, at least 8 weeks, at least 12 weeks, at least 24 weeks, or at least 52 weeks. In some embodiments, the silk food or beverage product has a shelf stability of at least 1 hour, at least 3 hours, at least 6 hours, at least 12 hours, at least 24 hours, at least 3 days, at least 1 week, at least 2 weeks, at least 3 weeks, at least 4 weeks, at least 8 weeks, at least 12 weeks, at least 24 weeks, or at least 52 weeks. In some embodiments, the silk food or beverage product has a shelf stability longer than the shelf stability of the corresponding foodstuff not formulated into the silk food or beverage product. In some embodiments, shelf stability is measured at room temperature. In some embodiments, shelf stability is measured at about −18° C., about −17° C., about −16° C., about −15° C., about −14° C., about −13° C., about −12° C., about −11° C., about −10 ° C., about −9° C., about −8° C., about −7° C., about −6° C., about −5° C., about −4° C., about −3° C., about −2° C., about −1° C., about 0° C., about 1° C., about 2° C., about 3° C., about 4° C., about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., about 20° C., about 21° C., about 22° C., about 23° C., about 24° C., or about 25° C.

In some embodiments, the silk food or beverage product is a beverage. In some embodiments, the beverage is selected from a ready-to-drink beverage, a milk or milk analog beverage, a weight management beverage, a protein shake, and a meal replacement drink. In some embodiments, the beverage is cold-pressed juice. In some embodiments, the foodstuff is selected from skim milk, whole milk, cream, dried milk powder, non-fat dry milk powder, caseinate, soy protein concentrate, soy protein isolate, whey protein concentrate, whey protein isolate, chocolate, cocoa powder, coffee, and combinations thereof. In some embodiments, the silk food or beverage product further comprises an ingredient selected from a sweetening agent, an emulsifying agent, a thickening agent, a stabilizer, a lipid material, a preservative, an antioxidant, a flavoring agent, a coloring agent, a vitamin, a mineral, and combinations thereof. In some embodiments, the silk food or beverage product is selected from a food bar, a nutritional supplement, a cereal-based product, a meat or meat analog product, a deli-meat, and a dairy or dairy analog product. In some embodiments, the silk food or beverage product is at least in part selected from the group consisting of lettuce, chicken, milk, beer, fish, berries, corn, avocado, banana, tomato, peach, potato, bean, kale, broccoli, mushroom, asparagus, hummus, grain, egg, cooked vegetable, raw vegetable, parsley, cheese, and yogurt.

In some embodiments, the silk fibroin fragments are substantially mixed with the foodstuff. In some embodiments, the silk fibroin fragments form, at least in part, a coating on a surface of the foodstuff. In some embodiments, the coating is transparent. In some embodiments, the coating is edible. In some embodiments, the coating is water-soluble. In some embodiments, the coating further comprises an additive. In some embodiments, the additive is selected from anti-microbe agents, antibacterial agents and antifungal agents, enzyme inhibitors, ethylene-capturing/binding molecules, ethylene-binding domains of ethylene receptors, ethylene-absorbing substances, aluminosilicates, zeolites, silk fibroin-based aerogels, oxidizing agents, potassium permanganate, ethylene receptor antagonists, porphyrins, hormones, hormone receptor agonists and antagonists thereof, nutraceutical agents, dietary supplements, vitamins, antioxidants, fatty acids, flavorings and other compounds added to improve taste, sugars, perfumes or fragrances, colorings, dyes, and any combination thereof. In some embodiments, the coating does not contain an added plasticizing agent.

In an embodiment, this disclosure provides a method for preserving a foodstuff, the method comprising contacting the foodstuff with a silk fibroin protein fragment (SPF) coating composition comprising silk fibroin fragments having an average weight average molecular weight selected from between about 1 kDa and about 5 kDa, between about 5 kDa and about 10 kDa, between about 6 kDa and about 17 kDa, between about 10 kDa and about 15 kDa, between about 15 kDa and about 20 kDa, between about 14 kDa and about 30 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 54 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa, and a polydispersity between 1 and about 5, wherein a silk fibroin protein fragment coating layer is formed on at least a portion of the foodstuff.

In some embodiments, the foodstuff is preserved as compared to a foodstuff without the coating. In some embodiments, the contacting comprises di-coating, spray-coating, powder-coating, wrapping, sealing, covering, layering, or any combination thereof. In some embodiments, the contacting is repeated at least 2 times. In some embodiments, the method further comprises a step of annealing, crosslinking, or a combination thereof.

### BRIEF DESCRIPTION OF THE DRAWINGS

FIG. 1 is a flow chart showing various embodiments for producing silk fibroin protein fragments (SPFs) of the present disclosure.

FIG. 2 is a flow chart showing various parameters that can be modified during the process of producing a silk protein fragment solution of the present disclosure during the extraction and the dissolution steps.

FIG. 3 illustrates the freshness preservation effects under ambient storage conditions by silk fibroin protein fragment based coating on the perishable goods (e.g., strawberry) as compared with strawberry without coating.

FIG. 4 illustrates the weight loss effects under ambient storage conditions by silk fibroin protein fragment based coating on the perishable goods (e.g., strawberry) over a period of 7 day as compared with strawberry without coating (control).

FIGS. 5A-5D illustrate the effects food decay under ambient storage conditions by silk fibroin protein fragment based coating on the perishable goods (e.g., strawberry) over a period of 7 days as compared with strawberry without coating (control) at 0 day and 7th day; FIG. 5A: control at t=0 days; FIG. 5B: high annealed at t=0 days; FIG. 5C: control at t=7 days; FIG. 5D: high annealed at t=7 days.

FIGS. 6A-6D illustrate the effects food decay under ambient storage conditions by silk fibroin protein fragment based coating on the perishable goods (e.g., strawberry) over a period of 7 days as compared with strawberry without coating (control) at 0 day and 7th day; FIG. 6A: control at t=0 days; FIG. 6B: high dip coated at t=0 days; FIG. 6C: control at t=7 days; FIG. 6D: high dip coated at t=7 days.

FIGS. 7A-7D illustrate the effects of food decay at 4° C. by silk fibroin protein fragment based coating on perishable goods (e.g., cheese) over a period of 21 days compared with cheese without coating (control) at day 21; FIG. 7A: control at t=21 days; FIG. 7B: low molecular silk at t=21 days; FIG. 7C: medium molecular weight silk at t=21 days; FIG. 7D: water at t=21 days.

FIGS. 8A-8D illustrate the effects of food decay at 25° C. by silk fibroin protein fragment based coating on perishable goods (e.g., cheese) over a period of 21 days compared with cheese without coating (control) at day 21; FIG. 8A: control at t=21 days; FIG. 8B: low molecular silk at t=21 days; FIG. 8C: medium molecular weight silk at t=21 days; FIG. 8D: water at t=21 days.

### DETAILED DESCRIPTION

Dried foods, low moisture baked products and intermediate and high moisture foods all exhibit potential for improvement with edible coatings and films. Dried foods (e.g., dried vegetables and dried meats) and low moisture baked products (e.g., crackers, cookies and cereals) are particularly susceptible to moisture uptake from the atmosphere. Such changes can result in loss of sensory acceptability of the food product, as well as a reduced shelf life. Many dried and baked products are also susceptible to oxidation, lipid migration and volatile flavor loss. Intermediate moisture foods, such as raisins and dates, often become unacceptable due to moisture loss over time. High moisture food components typically lose moisture to lower moisture components and is particularly problematic. Oxidation and flavor loss are also problematic to high moisture food systems. The respiration rates of whole fruits and vegetables often dictate their shelf lives. Minimally processed fruits and vegetables are often subject to unacceptable levels of oxidative browning.

Individual food products within the broad food categories discussed above require different barrier properties in order to optimize product quality and shelf life. Edible films and coatings are capable of solving the barrier problems of these and a variety of other food systems. See (Azad et al., Edible Coating for Preservation of Perishable Foods: A Review, J. Ready to Eat Foods, 2015, vol. 2, pp. 81-88).

Silk fibroin is an attractive natural fibrous polymer produced by silkworm Bombyx mori. Beside as material for clothing, silk fibroin has been widely applied to cosmetics, medicine, food and chemical industry. The aqueous silk solutions represents a good starting material for the preparation of different kinds of fibroin-based materials, e.g., film, gel, powder, and membranes. Besides its promising applications, native silk fibroin films have poor mechanical film properties and they are quite hard and brittle in dry state.

Silk is a natural polymer produced by a variety of insects and spiders. Silk produced by Bombyx mori (silkworm) comprises a filament core protein, silk fibroin, and a glue-like coating consisting of a nonfilamentous protein, sericin. Silk fibroin protein of silkworm (thereafter SPF) is a FDA approved, edible, non-toxic, and relative inexpensive silkworm cocoon derived protein.

Silk fibroin protein has found applications in food and beverage products, e.g. silk fibroin based foodstuffs including silk protein biscuits, candy silk, silk protein jelly, etc., but so far, no such foods or drinks are on the market.

Edible coating is an environmentally friendly technology that can be applied to many food products to control moisture transfer, gas exchange or oxidation process. Edible coating can provide additional protective coating to food products, can give the same effect as modified atmosphere storage in modifying internal gas composition, and it can incorporate several ingredients into the polymer matrix. Edible coating on the fresh fruits can provide an alternative to modified atmosphere storage by reducing quality changes and quantity losses through modification and control of the internal atmosphere of the individual fruits.

Coating fruits and vegetables with a wax material is a conventional freshness preservation technic to create a selective barrier to the exchange of gases and the loss of moisture. Both natural wax (e.g. carnauba, shellac) and petroleum-based waxed are used.

Proteins are known to form films with good mechanical properties, but with poor permeability, whereas lipids form brittle films but with improved permeability.

However, edible coatings were not successful in all cases. There is a continued need to develop novel edible coatings for fruits and vegetables.

Further, there is a need to develop novel food and beverage products utilizing the advantageous properties associated with the silk fibroin protein and processing technology for manufacturing of silk fibroin protein based additives for food and beverage products.

Provided herein are silk food or beverage products comprising silk fibroin protein fragments (SPF), and methods of producing SPF-containing and SPF-coated food or beverage products. The present disclosure provides SPF-based edible coatings suitable for coating perishable products, such as fresh fruits. Among other things, the present disclosure encompasses silk fibroin protein-based (i.e., silk polypeptide-based) coating materials and related methods that do not require the use of added plasticizers.

Coatings prepared in accordance with the present disclosure show superior ability to preserve perishable materials (e.g., increase shelf-life/shelf stability, preserve taste or flavor, preserve color, and prevent or reduce decomposition), such as fresh fruits, as compared to known edible coatings. Furthermore, such coatings allow functional versatility in that additional agent(s) can be incorporated to further control the process of preservation of the perishable items or for other purposes. Yet further, certain characteristics (e.g., brittleness) of such coatings may be modulated without requiring additional additives, thereby providing tunability, depending on its application.The SPF can be prepared as a solution generated from raw pure intact silk fibroin protein material; the SPF solution can be processed in order to remove any sericin and achieve the desired weight average molecular weight (MW) and polydispersity of the fragment mixture for use in mixing with or coating food or beverage products.

In some embodiments, the pure silk fibroin-based protein fragments in the solution are substantially devoid of sericin, have an average weight average molecular weight ranging from about 6 kDa to about 16 kDa, and have a polydispersity ranging from about 1.5 and about 3.0. In an embodiment, the pure silk fibroin-based protein fragments in the solution are substantially devoid of sericin, have an average weight average molecular weight ranging from about 17 kDa to about 38 kDa, and have a polydispersity ranging from about 1.5 and about 3.0. In an embodiment, the pure silk fibroin-based protein fragments in the solution are substantially devoid of sericin, have an average weight average molecular weight ranging from about 39 kDa to about 80 kDa, and have a polydispersity ranging from about 1.5 and about 3.0.

In some embodiments, the solutions may be used to generate articles, such as silk gels of varying gel and liquid consistencies by varying water content/concentration, or sold as a raw ingredient into the consumer market.

Food coatings have been extensively studied and widely employed in the food industry. Perhaps the most common example is the use of wax to coat fruits and vegetables. Waxes are organic compounds that characteristically consist of long alkyl chains. Natural waxes are typically esters of fatty acids and long chain alcohols. Synthetic waxes are long-chain hydrocarbons lacking functional groups. The hydrophobicity of wax makes it an attractive moisture barrier for keeping fruits and vegetables fresh. Wax suitable for food coating is, however, also brittle and is typically used in conjunction with a plasticizing agent (i.e., plasticizer). For instance, wax may be mixed with a SPF (e.g., chitosan, gelatin) that acts as a plasticizer.

Other SPFs that have been employed as coating materials include, but are not limited to, various proteins, such as collagen, gelatin, corn zein, wheat gluten, casein and whey. Both collagen and gelatin are very hydrophilic and therefore do not provide an effective moisture barrier. Corn zein, on the other hand, is a highly hydrophobic protein and due to its abundance has been exploited in the food industry for a number of applications. However, as a coating material, because of its brittleness, it typically requires the use of added plasticizer. In addition, zein proteins do not remain transparent in that they turn white upon contact with water (e.g., moisture), which in some applications is not desirable. Wheat gluten also requires a plasticizer to be used as coating materials. Casein and whey may also be used for the production of edible film materials, but generally, these are used as composite films. Moreover, addition of plasticizing agents is typically required. In contrast to these SPF-based coatings commercially exploited to date, SPF-based coatings described herein provide superior material features with desirable functional attributes. For example, such coatings (i) may be used to form a barrier between a perishable item and its environment; (ii) may be used as a carrier for an agent; (iii) may be used as an enhancer of at least one property of the perishable item, or any combination thereof. In any one of these functional parameters, the SPF-based coatings described herein exhibit superior performance as compared to commercially available coatings described in prior art.

### Definitions

As used in the preceding sections and throughout the rest of this specification, unless defined otherwise, all technical and scientific terms used herein have the same meaning as is commonly understood by one skilled in the art to which this disclosure belongs. All patents and publications referred to herein are incorporated by reference in their entireties.

All percentages, parts and ratios are based upon the total weight of the food or beverage compositions of the present disclosure, unless otherwise specified. All such weights as they pertain to listed ingredients are based on the active level and, therefore, do not include solvents or by-products that may be included in commercially available materials, unless otherwise specified. The term “weight percent” may be denoted as “wt. %” or % w/w herein.

As used herein, the term “a”, “an”, or “the” generally is construed to cover both the singular and the plural forms.

As used herein, the term “about” generally refers to a particular numeric value that is within an acceptable error range as determined by one of ordinary skill in the art, which will depend in part on how the numeric value is measured or determined, i.e., the limitations of the measurement system. For example, “about” can mean a range of ±20%, ±10%, or ±5% of a given numeric value.

As used herein, the term “dermatologically acceptable carrier” means a carrier suitable for use in contact with mammalian keratinous tissue without causing any adverse effects such as undue toxicity, incompatibility, instability, allergic response, for example. A dermatologically acceptable carrier may include, without limitations, water, liquid or solid emollients, humectants, solvents, and the like.

As used herein, the term “biocompatibility” refers to the compositions that are compatible with living tissue or a living system by not being toxic, injurious, or physiologically reactive and not causing immunological rejection. Such biocompatibility can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely.

As used herein, the term “edible coating” refers to thin layers of film applied to the surface of foodstuff in addition to or as a replacement for natural protective waxy coating, and to provide a barrier to moisture, oxygen and solute movement for the food. An ideal edible coating is one that can extend storage life of fresh fruits and vegetables without causing anaerobiosis and reduces decay without affecting their quality.

As used herein, the term “edible material” can refer to a substance that is non-toxic to mammals including humans, when ingested. As used herein, “edible material” and foodstuff' are used interchangeably. In certain embodiments, the term “edible material” can refer to perishable foods, including, but not limited to, fruits, meat, cooked vegetable, raw vegetable, lettuce, chicken, milk, beer, fish, berries, corn, avocado, banana, tomato, peach, potato, bean, kale, broccoli, mushroom, asparagus, hummus, grain, egg, parsley, yogurt, and the like. In certain embodiments, “edible material comprises oral edible material (e.g., edible material taken into the system through the oral cavity) and includes typical foodstuffs, as well as pharmaceutical preparations. These are, for example, beverages, including soft drinks, carbonated beverages, ready-to-mix beverages and the like, infused foods, fruits, vegetables, sauces, condiments, salad dressings, juices, syrups, desserts, including puddings, gelatin and frozen desserts, like ice creams, sherbets and icings, confections, chewing gum, intermediate moisture foods (e.g. dog food, and cat food), animal food in general, including pet food; medicaments, toothpaste, mouthwashes and the like.

In some embodiments, the edible material and/or foodstuff is targeted to ingestion by a human. In some embodiments, the edible item is edible for a human. In some embodiments, the edible material and/or foodstuff is targeted to ingestion by an animal. In some embodiments, the edible item is edible for an animal. Sometimes, an animal is a pet, laboratory animal, farm animal or wild animal. In some instances, the human is a healthy human. In some examples, the human is a human that is not healthy. In some embodiments, the edible material and/or foodstuff is targeted to ingestion by vertebrates, mollusks, arthropods, annelids or sponges. In some embodiments, the edible item is edible for vertebrates, mollusks, arthropods, annelids or sponges. Sometimes, the animal is a bird, mammal, amphibian, reptile or fish. Sometimes, the vertebrate is a bird, mammal, amphibian, reptile or fish. In some instances, the mammal is a primate, ape, dog, cat, rodent, rabbit or ferret. In some instances, the rodent is a gerbil, hamster, chinchilla, fancy rat, or guinea pig. In some instances, the bird is a canary, parakeet or parrots. In some examples, the reptile is a turtles, lizard or snake. In some embodiments, the fish is a tropical fish. In some instances, the amphibian is a frog. In some embodiments, the arthropod is a tarantula or hermit crab.

As used herein, the term “food additive” refers to any substance the intended use of which results directly or indirectly in becoming a component or otherwise affecting the characteristics of any food. Direct food additives are those that are added to a food for a specific purpose in that food. For example, xanthan gum, used in salad dressings, chocolate milk, bakery fillings, puddings and other foods to add texture, is a direct additive. Food additives many include preservatives, colorants, flavors and spices, flavor enhancers, fat replacers, nutrients, emulsifiers, stabilizers and thickeners, binders, texturizers, and film forming agent.

As used herein, the term “hydrophilic-lipophilic balance” (HLB) of a surfactant is a measure of the degree to which it is hydrophilic or hydrophobic, as determined by calculating values for the different regions of the molecule, as described by Griffin's method HLB=20*Mh/M, where Mh is the molecular mass of the hydrophilic portion of the surfactant, and M is the molecular mass of the entire surfactant molecule, giving a result on a scale of 0 to 20. A HLB value of 0 corresponds to a completely lipophilic molecule, and a value of 20 corresponds to a completely hydrophilic molecule. The HLB value can be used to predict the surfactant properties of a molecule: HLB<10: Lipid-soluble (water-insoluble), HLB>10: Water-soluble (lipid-insoluble), HLB=1-3: anti-foaming agent, 3-6: W/O (water-in-oil) emulsifier, 7-9: wetting and spreading agent, 8-16: O/W (oil-in-water) emulsifier, 13-16: detergent, 16-18: solubilizer or hydrotrope.

As used herein, “hypoallergenic” is a property of the silk fibroin proteins that they are relatively unlikely to cause an allergic reaction. Such hypoallergenicity can be evidenced by participants topically applying compositions of the present disclosure on their skin for an extended period of time.

As used herein, the term “nutrient” refers to any substance that is used in foodstuff to replace vitamins and minerals lost in processing (enrichment), add nutrients that may be lacking in the diet (fortification). Most commonly used nutrient in foodstuff include amino acids (L-tryptophan, L-lysine, L-leucine, L-methionine).

As used herein, the term “perishable goods” refer to items that are susceptible to at least one type of damage (e.g., reduced quality), which typically involves changes in one or more parameters, such as water content, color, general appearance, taste or flavor, texture (e.g., visual texture such as smoothness and structural texture such as crispness), structural integrity, smell, bacterial or fungal growth, etc. Non-limiting examples of perishable items may include but are not limited to: foodstuffs, such as fresh produce (e.g., fruits and vegetables), meat products (e.g., processed meat and raw meat products), grains, nuts, seeds, spores, dairy products (e.g., cheese), beverages (e.g., spirits, wine, juices), processed food (e.g., snacks), tablets and capsules, such as gel-caps, plants and flowers, and the like.

A s used herein, “average weight average molecular weight” refers to an average of two or more values of weight average molecular weight of silk fibroin or fragments thereof of the same compositions, the two or more values determined by two or more separate experimental readings.

As used herein, the term polymer “polydispersity (PD)” is generally used as a measure of the broadness of a molecular weight distribution of a polymer, and is defined by the formula polydispersity

$$P D = \frac{M w}{M n} .$$

As used herein, the term “preservatives” refers to chemical substance used to prevent food spoilage from bacteria, molds, fungi, or yeast (antimicrobials); slow or prevent changes in color, flavor, or texture and delay rancidity (antioxidants); maintain freshness. Example of preservatives include ascorbic acid, citric acid, sodium benzoate, BHA, BHT, EDTA, tocopherols (Vitamin E). Examples of foodstuff made with preservatives include beverages, baked goods, cured meats, fresh fruits and vegetables.

As used herein, the food additive “stabilizers and thickeners, binders, texturizers” refers to any substance used in foodstuff to produce uniform texture and improve mouth feel. Examples may include gelatin, pectin, guar gum, carrageenan, xanthan gum, whey.

As used herein, the terms “silk fibroin peptide,” “silk fibroin protein fragment,” and “silk fibroin fragment” are used interchangeably. Molecular weight or number of amino acids units are defined when molecular size becomes an important parameter.

As used herein, the terms “silk fibroin peptide,” “silk fibroin protein fragment,” and “silk fibroin fragment” are used interchangeably. Molecular weight or number of amino acids units are defined when molecular size becomes an important parameter.

As used herein, the term “substantially homogeneous” may refer to silk fibroin-based protein fragments that are distributed in a normal distribution about an identified molecular weight. As used herein, the term “substantially homogeneous” may refer to an even distribution of a component or an additive, for example, silk fibroin fragments, dermatologically acceptable carrier, etc., throughout a composition of the present disclosure.

As used herein, the term “substantially free of inorganic residuals” means that the composition (e.g., SPF solution intended for use as an additive in a food or beverage product, or as a coating on a surface of an edible material and/or foodstuff) exhibits residuals of 0.1% (w/w) or less. In an embodiment, substantially free of inorganic residuals refers to a composition that exhibits residuals of 0.05% (w/w) or less. In an embodiment, substantially free of inorganic residuals refers to a composition that exhibits residuals of 0.01% (w/w) or less. In an embodiment, the amount of inorganic residuals is between 0 ppm (“non-detectable” or “ND”) and 1000 ppm. In an embodiment, the amount of inorganic residuals is ND to about 500 ppm. In an embodiment, the amount of inorganic residuals is ND to about 400 ppm. In an embodiment, the amount of inorganic residuals is ND to about 300 ppm. In an embodiment, the amount of inorganic residuals is ND to about 200 ppm. In an embodiment, the amount of inorganic residuals is ND to about 100 ppm. In an embodiment, the amount of inorganic residuals is between 10 ppm and 1000 ppm.

As used herein, the term “substantially free of organic residuals” means that the composition (e.g., SPF solution intended for use as an additive in a food product, or as a coating on a surface of an edible material and/or foodstuff) exhibits residuals of 0.1% (w/w) or less. In an embodiment, substantially free of organic residuals refers to a composition that exhibits residuals of 0.05% (w/w) or less. In an embodiment, substantially free of organic residuals refers to a composition that exhibits residuals of 0.01% (w/w) or less. In an embodiment, the amount of organic residuals is between 0 ppm (“non-detectable” or “ND”) and 1000 ppm. In an embodiment, the amount of organic residuals is ND to about 500 ppm. In an embodiment, the amount of organic residuals is ND to about 400 ppm. In an embodiment, the amount of organic residuals is ND to about 300 ppm. In an embodiment, the amount of organic residuals is ND to about 200 ppm. In an embodiment, the amount of organic residuals is ND to about 100 ppm. In an embodiment, the amount of organic residuals is between 10 ppm and 1000 ppm.

As used herein, the term “substantially homogeneous” may refer to silk fibroin-based protein fragments that are distributed in a normal distribution about an identified molecular weight. As used herein, the term “substantially homogeneous” may refer to an even distribution of a component or an additive, for example, silk fibroin fragments, dermatologically acceptable carrier, etc., throughout a composition of the present disclosure.

### SPF Definitions and Properties

As used herein, “silk protein fragments” (SPF) include, without limitation, one or more of: “silk fibroin fragments” as defined herein; “recombinant silk fragments” as defined herein; “spider silk fragments” as defined herein; “silk fibroin-like protein fragments” as defined herein; “chemically modified silk fragments” as defined herein; and/or “sericin or sericin fragments” as defined herein. SPF may have any molecular weight values or ranges described herein, and any polydispersity values or ranges described herein. As used herein, in some embodiments the term “silk protein fragment” also refers to a silk protein that comprises or consists of at least two identical repetitive units which each independently selected from naturally-occurring silk polypeptides or of variations thereof, amino acid sequences of naturally-occurring silk polypeptides, or of combinations of both.

### SPF Molecular Weight and Polydispersity

In an embodiment, a composition of the present disclosure includes SPF having an average weight average molecular weight selected from between about 1 to about 5 kDa. In an embodiment, a composition of the present disclosure includes SPF having an average weight average molecular weight selected from between about 5 to about 10 kDa. In an embodiment, a composition of the present disclosure includes SPF having an average weight average molecular weight selected from between about 10 to about 15 kDa. In an embodiment, a composition of the present disclosure includes SPF having an average weight average molecular weight selected from between about 15 to about 20 kDa. In an embodiment, a composition of the present disclosure includes SPF having an average weight average molecular weight selected from between about 14 to about 30 kDa. In an embodiment, a composition of the present disclosure includes SPF having an average weight average molecular weight selected from between about 20 to about 25 kDa. In an embodiment, a composition of the present disclosure includes SPF having an average weight average molecular weight selected from between about 25 to about 30 kDa. In an embodiment, a composition of the present disclosure includes SPF having an average weight average molecular weight selected from between about 30 to about 35 kDa. In an embodiment, a composition of the present disclosure includes SPF having an average weight average molecular weight selected from between about 35 to about 40 kDa. In an embodiment, a composition of the present disclosure includes SPF having an average weight average molecular weight selected from between about 39 to about 54 kDa. In an embodiment, a composition of the present disclosure includes SPF having an average weight average molecular weight selected from between about 40 to about 45 kDa. In an embodiment, a composition of the present disclosure includes SPF having an average weight average molecular weight selected from between about 45 to about 50 kDa. In an embodiment, a composition of the present disclosure includes SPF having an average weight average molecular weight selected from between about 50 to about 55 kDa. In an embodiment, a composition of the present disclosure includes SPF having an average weight average molecular weight selected from between about 55 to about 60 kDa. In an embodiment, a composition of the present disclosure includes SPF having an average weight average molecular weight selected from between about 60 to about 65 kDa. In an embodiment, a composition of the present disclosure includes SPF having an average weight average molecular weight selected from between about 65 to about 70 kDa. In an embodiment, a composition of the present disclosure includes SPF having an average weight average molecular weight selected from between about 70 to about 75 kDa. In an embodiment, a composition of the present disclosure includes SPF having an average weight average molecular weight selected from between about 75 to about 80 kDa. In an embodiment, a composition of the present disclosure includes SPF having an average weight average molecular weight selected from between about 80 to about 85 kDa. In an embodiment, a composition of the present disclosure includes SPF having an average weight average molecular weight selected from between about 85 to about 90 kDa. In an embodiment, a composition of the present disclosure includes SPF having an average weight average molecular weight selected from between about 90 to about 95 kDa. In an embodiment, a composition of the present disclosure includes SPF having an average weight average molecular weight selected from between about 95 to about 100 kDa. In an embodiment, a composition of the present disclosure includes SPF having an average weight average molecular weight selected from between about 100 to about 105 kDa. In an embodiment, a composition of the present disclosure includes SPF having an average weight average molecular weight selected from between about 105 to about 110 kDa. In an embodiment, a composition of the present disclosure includes SPF having an average weight average molecular weight selected from between about 110 to about 115 kDa. In an embodiment, a composition of the present disclosure includes SPF having an average weight average molecular weight selected from between about 115 to about 120 kDa. In an embodiment, a composition of the present disclosure includes SPF having an average weight average molecular weight selected from between about 120 to about 125 kDa. In an embodiment, a composition of the present disclosure includes SPF having an average weight average molecular weight selected from between about 125 to about 130 kDa. In an embodiment, a composition of the present disclosure includes SPF having an average weight average molecular weight selected from between about 130 to about 135 kDa. In an embodiment, a composition of the present disclosure includes SPF having an average weight average molecular weight selected from between about 135 to about 140 kDa. In an embodiment, a composition of the present disclosure includes SPF having an average weight average molecular weight selected from between about 140 to about 145 kDa. In an embodiment, a composition of the present disclosure includes SPF having an average weight average molecular weight selected from between about 145 to about 150 kDa. In an embodiment, a composition of the present disclosure includes SPF having an average weight average molecular weight selected from between about 150 to about 155 kDa. In an embodiment, a composition of the present disclosure includes SPF having an average weight average molecular weight selected from between about 155 to about 160 kDa. In an embodiment, a composition of the present disclosure includes SPF having an average weight average molecular weight selected from between about 160 to about 165 kDa. In an embodiment, a composition of the present disclosure includes SPF having an average weight average molecular weight selected from between about 165 to about 170 kDa. In an embodiment, a composition of the present disclosure includes SPF having an average weight average molecular weight selected from between about 170 to about 175 kDa. In an embodiment, a composition of the present disclosure includes SPF having an average weight average molecular weight selected from between about 175 to about 180 kDa. In an embodiment, a composition of the present disclosure includes SPF having an average weight average molecular weight selected from between about 180 to about 185 kDa. In an embodiment, a composition of the present disclosure includes SPF having an average weight average molecular weight selected from between about 185 to about 190 kDa. In an embodiment, a composition of the present disclosure includes SPF having an average weight average molecular weight selected from between about 190 to about 195 kDa. In an embodiment, a composition of the present disclosure includes SPF having an average weight average molecular weight selected from between about 195 to about 200 kDa. In an embodiment, a composition of the present disclosure includes SPF having an average weight average molecular weight selected from between about 200 to about 205 kDa. In an embodiment, a composition of the present disclosure includes SPF having an average weight average molecular weight selected from between about 205 to about 210 kDa. In an embodiment, a composition of the present disclosure includes SPF having an average weight average molecular weight selected from between about 210 to about 215 kDa. In an embodiment, a composition of the present disclosure includes SPF having an average weight average molecular weight selected from between about 215 to about 220 kDa. In an embodiment, a composition of the present disclosure includes SPF having an average weight average molecular weight selected from between about 220 to about 225 kDa. In an embodiment, a composition of the present disclosure includes SPF having an average weight average molecular weight selected from between about 225 to about 230 kDa. In an embodiment, a composition of the present disclosure includes SPF having an average weight average molecular weight selected from between about 230 to about 235 kDa. In an embodiment, a composition of the present disclosure includes SPF having an average weight average molecular weight selected from between about 235 to about 240 kDa. In an embodiment, a composition of the present disclosure includes SPF having an average weight average molecular weight selected from between about 240 to about 245 kDa. In an embodiment, a composition of the present disclosure includes SPF having an average weight average molecular weight selected from between about 245 to about 250 kDa. In an embodiment, a composition of the present disclosure includes SPF having an average weight average molecular weight selected from between about 250 to about 255 kDa. In an embodiment, a composition of the present disclosure includes SPF having an average weight average molecular weight selected from between about 255 to about 260 kDa. In an embodiment, a composition of the present disclosure includes SPF having an average weight average molecular weight selected from between about 260 to about 265 kDa. In an embodiment, a composition of the present disclosure includes SPF having an average weight average molecular weight selected from between about 265 to about 270 kDa. In an embodiment, a composition of the present disclosure includes SPF having an average weight average molecular weight selected from between about 270 to about 275 kDa. In an embodiment, a composition of the present disclosure includes SPF having an average weight average molecular weight selected from between about 275 to about 280 kDa. In an embodiment, a composition of the present disclosure includes SPF having an average weight average molecular weight selected from between about 280 to about 285 kDa. In an embodiment, a composition of the present disclosure includes SPF having an average weight average molecular weight selected from between about 285 to about 290 kDa. In an embodiment, a composition of the present disclosure includes SPF having an average weight average molecular weight selected from between about 290 to about 295 kDa. In an embodiment, a composition of the present disclosure includes SPF having an average weight average molecular weight selected from between about 295 to about 300 kDa. In an embodiment, a composition of the present disclosure includes SPF having an average weight average molecular weight selected from between about 300 to about 305 kDa. In an embodiment, a composition of the present disclosure includes SPF having an average weight average molecular weight selected from between about 305 to about 310 kDa. In an embodiment, a composition of the present disclosure includes SPF having an average weight average molecular weight selected from between about 310 to about 315 kDa. In an embodiment, a composition of the present disclosure includes SPF having an average weight average molecular weight selected from between about 315 to about 320 kDa. In an embodiment, a composition of the present disclosure includes SPF having an average weight average molecular weight selected from between about 320 to about 325 kDa. In an embodiment, a composition of the present disclosure includes SPF having an average weight average molecular weight selected from between about 325 to about 330 kDa. In an embodiment, a composition of the present disclosure includes SPF having an average weight average molecular weight selected from between about 330 to about 335 kDa. In an embodiment, a composition of the present disclosure includes SPF having an average weight average molecular weight selected from between about 335 to about 340 kDa. In an embodiment, a composition of the present disclosure includes SPF having an average weight average molecular weight selected from between about 340 to about 345 kDa. In an embodiment, a composition of the present disclosure includes SPF having an average weight average molecular weight selected from between about 345 to about 350 kDa.

In some embodiments, compositions of the present disclosure include SPF compositions selected from compositions #1001 to #2450, having weight average molecular weights selected from about 1 kDa to about 145 kDa, and a polydispersity selected from between 1 and about 5 (including, without limitation, a polydispersity of 1), between 1 and about 1.5 (including, without limitation, a polydispersity of 1), between about 1.5 and about 2, between about 1.5 and about 3, between about 2 and about 2.5, between about 2.5 and about 3, between about 3 and about 3.5, between about 3.5 and about 4, between about 4 and about 4.5, and between about 4.5 and about 5:

| MW | | PDI (about) | | | | | | | | | |
|---|---|---|---|---|---|---|---|---|---|---|---|
| (about) | | 1-5 | 1-1.5 | 1.5-2 | 1.5-3 | 2-2.5 | 2.5-3 | 3-3.5 | 3.5-4 | 4-4.5 | 4.5-5 |
| 1 | kDa | 1001 | 1002 | 1003 | 1004 | 1005 | 1006 | 1007 | 1008 | 1009 | 1010 |
| 2 | kDa | 1011 | 1012 | 1013 | 1014 | 1015 | 1016 | 1017 | 1018 | 1019 | 1020 |
| 3 | kDa | 1021 | 1022 | 1023 | 1024 | 1025 | 1026 | 1027 | 1028 | 1029 | 1030 |
| 4 | kDa | 1031 | 1032 | 1033 | 1034 | 1035 | 1036 | 1037 | 1038 | 1039 | 1040 |
| 5 | kDa | 1041 | 1042 | 1043 | 1044 | 1045 | 1046 | 1047 | 1048 | 1049 | 1050 |
| 6 | kDa | 1051 | 1052 | 1053 | 1054 | 1055 | 1056 | 1057 | 1058 | 1059 | 1060 |
| 7 | kDa | 1061 | 1062 | 1063 | 1064 | 1065 | 1066 | 1067 | 1068 | 1069 | 1070 |
| 8 | kDa | 1071 | 1072 | 1073 | 1074 | 1075 | 1076 | 1077 | 1078 | 1079 | 1080 |
| 9 | kDa | 1081 | 1082 | 1083 | 1084 | 1085 | 1086 | 1087 | 1088 | 1089 | 1090 |
| 10 | kDa | 1091 | 1092 | 1093 | 1094 | 1095 | 1096 | 1097 | 1098 | 1099 | 1100 |
| 11 | kDa | 1101 | 1102 | 1103 | 1104 | 1105 | 1106 | 1107 | 1108 | 1109 | 1110 |
| 12 | kDa | 1111 | 1112 | 1113 | 1114 | 1115 | 1116 | 1117 | 1118 | 1119 | 1120 |
| 13 | kDa | 1121 | 1122 | 1123 | 1124 | 1125 | 1126 | 1127 | 1128 | 1129 | 1130 |
| 14 | kDa | 1131 | 1132 | 1133 | 1134 | 1135 | 1136 | 1137 | 1138 | 1139 | 1140 |
| 15 | kDa | 1141 | 1142 | 1143 | 1144 | 1145 | 1146 | 1147 | 1148 | 1149 | 1150 |
| 16 | kDa | 1151 | 1152 | 1153 | 1154 | 1155 | 1156 | 1157 | 1158 | 1159 | 1160 |
| 17 | kDa | 1161 | 1162 | 1163 | 1164 | 1165 | 1166 | 1167 | 1168 | 1169 | 1170 |
| 18 | kDa | 1171 | 1172 | 1173 | 1174 | 1175 | 1176 | 1177 | 1178 | 1179 | 1180 |
| 19 | kDa | 1181 | 1182 | 1183 | 1184 | 1185 | 1186 | 1187 | 1188 | 1189 | 1190 |
| 20 | kDa | 1191 | 1192 | 1193 | 1194 | 1195 | 1196 | 1197 | 1198 | 1199 | 1200 |
| 21 | kDa | 1201 | 1202 | 1203 | 1204 | 1205 | 1206 | 1207 | 1208 | 1209 | 1210 |
| 22 | kDa | 1211 | 1212 | 1213 | 1214 | 1215 | 1216 | 1217 | 1218 | 1219 | 1220 |
| 23 | kDa | 1221 | 1222 | 1223 | 1224 | 1225 | 1226 | 1227 | 1228 | 1229 | 1230 |
| 24 | kDa | 1231 | 1232 | 1233 | 1234 | 1235 | 1236 | 1237 | 1238 | 1239 | 1240 |
| 25 | kDa | 1241 | 1242 | 1243 | 1244 | 1245 | 1246 | 1247 | 1248 | 1249 | 1250 |
| 26 | kDa | 1251 | 1252 | 1253 | 1254 | 1255 | 1256 | 1257 | 1258 | 1259 | 1260 |
| 27 | kDa | 1261 | 1262 | 1263 | 1264 | 1265 | 1266 | 1267 | 1268 | 1269 | 1270 |
| 28 | kDa | 1271 | 1272 | 1273 | 1274 | 1275 | 1276 | 1277 | 1278 | 1279 | 1280 |
| 29 | kDa | 1281 | 1282 | 1283 | 1284 | 1285 | 1286 | 1287 | 1288 | 1289 | 1290 |
| 30 | kDa | 1291 | 1292 | 1293 | 1294 | 1295 | 1296 | 1297 | 1298 | 1299 | 1300 |
| 31 | kDa | 1301 | 1302 | 1303 | 1304 | 1305 | 1306 | 1307 | 1308 | 1309 | 1310 |
| 32 | kDa | 1311 | 1312 | 1313 | 1314 | 1315 | 1316 | 1317 | 1318 | 1319 | 1320 |
| 33 | kDa | 1321 | 1322 | 1323 | 1324 | 1325 | 1326 | 1327 | 1328 | 1329 | 1330 |
| 34 | kDa | 1331 | 1332 | 1333 | 1334 | 1335 | 1336 | 1337 | 1338 | 1339 | 1340 |
| 35 | kDa | 1341 | 1342 | 1343 | 1344 | 1345 | 1346 | 1347 | 1348 | 1349 | 1350 |
| 36 | kDa | 1351 | 1352 | 1353 | 1354 | 1355 | 1356 | 1357 | 1358 | 1359 | 1360 |
| 37 | kDa | 1361 | 1362 | 1363 | 1364 | 1365 | 1366 | 1367 | 1368 | 1369 | 1370 |
| 38 | kDa | 1371 | 1372 | 1373 | 1374 | 1375 | 1376 | 1377 | 1378 | 1379 | 1380 |
| 39 | kDa | 1381 | 1382 | 1383 | 1384 | 1385 | 1386 | 1387 | 1388 | 1389 | 1390 |
| 40 | kDa | 1391 | 1392 | 1393 | 1394 | 1395 | 1396 | 1397 | 1398 | 1399 | 1400 |
| 41 | kDa | 1401 | 1402 | 1403 | 1404 | 1405 | 1406 | 1407 | 1408 | 1409 | 1410 |
| 42 | kDa | 1411 | 1412 | 1413 | 1414 | 1415 | 1416 | 1417 | 1418 | 1419 | 1420 |
| 43 | kDa | 1421 | 1422 | 1423 | 1424 | 1425 | 1426 | 1427 | 1428 | 1429 | 1430 |
| 44 | kDa | 1431 | 1432 | 1433 | 1434 | 1435 | 1436 | 1437 | 1438 | 1439 | 1440 |
| 45 | kDa | 1441 | 1442 | 1443 | 1444 | 1445 | 1446 | 1447 | 1448 | 1449 | 1450 |
| 46 | kDa | 1451 | 1452 | 1453 | 1454 | 1455 | 1456 | 1457 | 1458 | 1459 | 1460 |
| 47 | kDa | 1461 | 1462 | 1463 | 1464 | 1465 | 1466 | 1467 | 1468 | 1469 | 1470 |
| 48 | kDa | 1471 | 1472 | 1473 | 1474 | 1475 | 1476 | 1477 | 1478 | 1479 | 1480 |
| 49 | kDa | 1481 | 1482 | 1483 | 1484 | 1485 | 1486 | 1487 | 1488 | 1489 | 1490 |
| 50 | kDa | 1491 | 1492 | 1493 | 1494 | 1495 | 1496 | 1497 | 1498 | 1499 | 1500 |
| 51 | kDa | 1501 | 1502 | 1503 | 1504 | 1505 | 1506 | 1507 | 1508 | 1509 | 1510 |
| 52 | kDa | 1511 | 1512 | 1513 | 1514 | 1515 | 1516 | 1517 | 1518 | 1519 | 1520 |
| 53 | kDa | 1521 | 1522 | 1523 | 1524 | 1525 | 1526 | 1527 | 1528 | 1529 | 1530 |
| 54 | kDa | 1531 | 1532 | 1533 | 1534 | 1535 | 1536 | 1537 | 1538 | 1539 | 1540 |
| 55 | kDa | 1541 | 1542 | 1543 | 1544 | 1545 | 1546 | 1547 | 1548 | 1549 | 1550 |
| 56 | kDa | 1551 | 1552 | 1553 | 1554 | 1555 | 1556 | 1557 | 1558 | 1559 | 1560 |
| 57 | kDa | 1561 | 1562 | 1563 | 1564 | 1565 | 1566 | 1567 | 1568 | 1569 | 1570 |
| 58 | kDa | 1571 | 1572 | 1573 | 1574 | 1575 | 1576 | 1577 | 1578 | 1579 | 1580 |
| 59 | kDa | 1581 | 1582 | 1583 | 1584 | 1585 | 1586 | 1587 | 1588 | 1589 | 1590 |
| 60 | kDa | 1591 | 1592 | 1593 | 1594 | 1595 | 1596 | 1597 | 1598 | 1599 | 1600 |
| 61 | kDa | 1601 | 1602 | 1603 | 1604 | 1605 | 1606 | 1607 | 1608 | 1609 | 1610 |
| 62 | kDa | 1611 | 1612 | 1613 | 1614 | 1615 | 1616 | 1617 | 1618 | 1619 | 1620 |
| 63 | kDa | 1621 | 1622 | 1623 | 1624 | 1625 | 1626 | 1627 | 1628 | 1629 | 1630 |
| 64 | kDa | 1631 | 1632 | 1633 | 1634 | 1635 | 1636 | 1637 | 1638 | 1639 | 1640 |
| 65 | kDa | 1641 | 1642 | 1643 | 1644 | 1645 | 1646 | 1647 | 1648 | 1649 | 1650 |
| 66 | kDa | 1651 | 1652 | 1653 | 1654 | 1655 | 1656 | 1657 | 1658 | 1659 | 1660 |
| 67 | kDa | 1661 | 1662 | 1663 | 1664 | 1665 | 1666 | 1667 | 1668 | 1669 | 1670 |
| 68 | kDa | 1671 | 1672 | 1673 | 1674 | 1675 | 1676 | 1677 | 1678 | 1679 | 1680 |
| 69 | kDa | 1681 | 1682 | 1683 | 1684 | 1685 | 1686 | 1687 | 1688 | 1689 | 1690 |
| 70 | kDa | 1691 | 1692 | 1693 | 1694 | 1695 | 1696 | 1697 | 1698 | 1699 | 1700 |
| 71 | kDa | 1701 | 1702 | 1703 | 1704 | 1705 | 1706 | 1707 | 1708 | 1709 | 1710 |
| 72 | kDa | 1711 | 1712 | 1713 | 1714 | 1715 | 1716 | 1717 | 1718 | 1719 | 1720 |
| 73 | kDa | 1721 | 1722 | 1723 | 1724 | 1725 | 1726 | 1727 | 1728 | 1729 | 1730 |
| 74 | kDa | 1731 | 1732 | 1733 | 1734 | 1735 | 1736 | 1737 | 1738 | 1739 | 1740 |
| 75 | kDa | 1741 | 1742 | 1743 | 1744 | 1745 | 1746 | 1747 | 1748 | 1749 | 1750 |
| 76 | kDa | 1751 | 1752 | 1753 | 1754 | 1755 | 1756 | 1757 | 1758 | 1759 | 1760 |
| 77 | kDa | 1761 | 1762 | 1763 | 1764 | 1765 | 1766 | 1767 | 1768 | 1769 | 1770 |
| 78 | kDa | 1771 | 1772 | 1773 | 1774 | 1775 | 1776 | 1777 | 1778 | 1779 | 1780 |
| 79 | kDa | 1781 | 1782 | 1783 | 1784 | 1785 | 1786 | 1787 | 1788 | 1789 | 1790 |
| 80 | kDa | 1791 | 1792 | 1793 | 1794 | 1795 | 1796 | 1797 | 1798 | 1799 | 1800 |
| 81 | kDa | 1801 | 1802 | 1803 | 1804 | 1805 | 1806 | 1807 | 1808 | 1809 | 1810 |
| 82 | kDa | 1811 | 1812 | 1813 | 1814 | 1815 | 1816 | 1817 | 1818 | 1819 | 1820 |
| 83 | kDa | 1821 | 1822 | 1823 | 1824 | 1825 | 1826 | 1827 | 1828 | 1829 | 1830 |
| 84 | kDa | 1831 | 1832 | 1833 | 1834 | 1835 | 1836 | 1837 | 1838 | 1839 | 1840 |
| 85 | kDa | 1841 | 1842 | 1843 | 1844 | 1845 | 1846 | 1847 | 1848 | 1849 | 1850 |
| 86 | kDa | 1851 | 1852 | 1853 | 1854 | 1855 | 1856 | 1857 | 1858 | 1859 | 1860 |
| 87 | kDa | 1861 | 1862 | 1863 | 1864 | 1865 | 1866 | 1867 | 1868 | 1869 | 1870 |
| 88 | kDa | 1871 | 1872 | 1873 | 1874 | 1875 | 1876 | 1877 | 1878 | 1879 | 1880 |
| 89 | kDa | 1881 | 1882 | 1883 | 1884 | 1885 | 1886 | 1887 | 1888 | 1889 | 1890 |
| 90 | kDa | 1891 | 1892 | 1893 | 1894 | 1895 | 1896 | 1897 | 1898 | 1899 | 1900 |
| 91 | kDa | 1901 | 1902 | 1903 | 1904 | 1905 | 1906 | 1907 | 1908 | 1909 | 1910 |
| 92 | kDa | 1911 | 1912 | 1913 | 1914 | 1915 | 1916 | 1917 | 1918 | 1919 | 1920 |
| 93 | kDa | 1921 | 1922 | 1923 | 1924 | 1925 | 1926 | 1927 | 1928 | 1929 | 1930 |
| 94 | kDa | 1931 | 1932 | 1933 | 1934 | 1935 | 1936 | 1937 | 1938 | 1939 | 1940 |
| 95 | kDa | 1941 | 1942 | 1943 | 1944 | 1945 | 1946 | 1947 | 1948 | 1949 | 1950 |
| 96 | kDa | 1951 | 1952 | 1953 | 1954 | 1955 | 1956 | 1957 | 1958 | 1959 | 1960 |
| 97 | kDa | 1961 | 1962 | 1963 | 1964 | 1965 | 1966 | 1967 | 1968 | 1969 | 1970 |
| 98 | kDa | 1971 | 1972 | 1973 | 1974 | 1975 | 1976 | 1977 | 1978 | 1979 | 1980 |
| 99 | kDa | 1981 | 1982 | 1983 | 1984 | 1985 | 1986 | 1987 | 1988 | 1989 | 1990 |
| 100 | kDa | 1991 | 1992 | 1993 | 1994 | 1995 | 1996 | 1997 | 1998 | 1999 | 2000 |
| 101 | kDa | 2001 | 2002 | 2003 | 2004 | 2005 | 2006 | 2007 | 2008 | 2009 | 2010 |
| 102 | kDa | 2011 | 2012 | 2013 | 2014 | 2015 | 2016 | 2017 | 2018 | 2019 | 2020 |
| 103 | kDa | 2021 | 2022 | 2023 | 2024 | 2025 | 2026 | 2027 | 2028 | 2029 | 2030 |
| 104 | kDa | 2031 | 2032 | 2033 | 2034 | 2035 | 2036 | 2037 | 2038 | 2039 | 2040 |
| 105 | kDa | 2041 | 2042 | 2043 | 2044 | 2045 | 2046 | 2047 | 2048 | 2049 | 2050 |
| 106 | kDa | 2051 | 2052 | 2053 | 2054 | 2055 | 2056 | 2057 | 2058 | 2059 | 2060 |
| 107 | kDa | 2061 | 2062 | 2063 | 2064 | 2065 | 2066 | 2067 | 2068 | 2069 | 2070 |
| 108 | kDa | 2071 | 2072 | 2073 | 2074 | 2075 | 2076 | 2077 | 2078 | 2079 | 2080 |
| 109 | kDa | 2081 | 2082 | 2083 | 2084 | 2085 | 2086 | 2087 | 2088 | 2089 | 2090 |
| 110 | kDa | 2091 | 2092 | 2093 | 2094 | 2095 | 2096 | 2097 | 2098 | 2099 | 2100 |
| 111 | kDa | 2101 | 2102 | 2103 | 2104 | 2105 | 2106 | 2107 | 2108 | 2109 | 2110 |
| 112 | kDa | 2111 | 2112 | 2113 | 2114 | 2115 | 2116 | 2117 | 2118 | 2119 | 2120 |
| 113 | kDa | 2121 | 2122 | 2123 | 2124 | 2125 | 2126 | 2127 | 2128 | 2129 | 2130 |
| 114 | kDa | 2131 | 2132 | 2133 | 2134 | 2135 | 2136 | 2137 | 2138 | 2139 | 2140 |
| 115 | kDa | 2141 | 2142 | 2143 | 2144 | 2145 | 2146 | 2147 | 2148 | 2149 | 2150 |
| 116 | kDa | 2151 | 2152 | 2153 | 2154 | 2155 | 2156 | 2157 | 2158 | 2159 | 2160 |
| 117 | kDa | 2161 | 2162 | 2163 | 2164 | 2165 | 2166 | 2167 | 2168 | 2169 | 2170 |
| 118 | kDa | 2171 | 2172 | 2173 | 2174 | 2175 | 2176 | 2177 | 2178 | 2179 | 2180 |
| 119 | kDa | 2181 | 2182 | 2183 | 2184 | 2185 | 2186 | 2187 | 2188 | 2189 | 2190 |
| 120 | kDa | 2191 | 2192 | 2193 | 2194 | 2195 | 2196 | 2197 | 2198 | 2199 | 2200 |
| 121 | kDa | 2201 | 2202 | 2203 | 2204 | 2205 | 2206 | 2207 | 2208 | 2209 | 2210 |
| 122 | kDa | 2211 | 2212 | 2213 | 2214 | 2215 | 2216 | 2217 | 2218 | 2219 | 2220 |
| 123 | kDa | 2221 | 2222 | 2223 | 2224 | 2225 | 2226 | 2227 | 2228 | 2229 | 2230 |
| 124 | kDa | 2231 | 2232 | 2233 | 2234 | 2235 | 2236 | 2237 | 2238 | 2239 | 2240 |
| 125 | kDa | 2241 | 2242 | 2243 | 2244 | 2245 | 2246 | 2247 | 2248 | 2249 | 2250 |
| 126 | kDa | 2251 | 2252 | 2253 | 2254 | 2255 | 2256 | 2257 | 2258 | 2259 | 2260 |
| 127 | kDa | 2261 | 2262 | 2263 | 2264 | 2265 | 2266 | 2267 | 2268 | 2269 | 2270 |
| 128 | kDa | 2271 | 2272 | 2273 | 2274 | 2275 | 2276 | 2277 | 2278 | 2279 | 2280 |
| 129 | kDa | 2281 | 2282 | 2283 | 2284 | 2285 | 2286 | 2287 | 2288 | 2289 | 2290 |
| 130 | kDa | 2291 | 2292 | 2293 | 2294 | 2295 | 2296 | 2297 | 2298 | 2299 | 2300 |
| 131 | kDa | 2301 | 2302 | 2303 | 2304 | 2305 | 2306 | 2307 | 2308 | 2309 | 2310 |
| 132 | kDa | 2311 | 2312 | 2313 | 2314 | 2315 | 2316 | 2317 | 2318 | 2319 | 2320 |
| 133 | kDa | 2321 | 2322 | 2323 | 2324 | 2325 | 2326 | 2327 | 2328 | 2329 | 2330 |
| 134 | kDa | 2331 | 2332 | 2333 | 2334 | 2335 | 2336 | 2337 | 2338 | 2339 | 2340 |
| 135 | kDa | 2341 | 2342 | 2343 | 2344 | 2345 | 2346 | 2347 | 2348 | 2349 | 2350 |
| 136 | kDa | 2351 | 2352 | 2353 | 2354 | 2355 | 2356 | 2357 | 2358 | 2359 | 2360 |
| 137 | kDa | 2361 | 2362 | 2363 | 2364 | 2365 | 2366 | 2367 | 2368 | 2369 | 2370 |
| 138 | kDa | 2371 | 2372 | 2373 | 2374 | 2375 | 2376 | 2377 | 2378 | 2379 | 2380 |
| 139 | kDa | 2381 | 2382 | 2383 | 2384 | 2385 | 2386 | 2387 | 2388 | 2389 | 2390 |
| 140 | kDa | 2391 | 2392 | 2393 | 2394 | 2395 | 2396 | 2397 | 2398 | 2399 | 2400 |
| 141 | kDa | 2401 | 2402 | 2403 | 2404 | 2405 | 2406 | 2407 | 2408 | 2409 | 2410 |
| 142 | kDa | 2411 | 2412 | 2413 | 2414 | 2415 | 2416 | 2417 | 2418 | 2419 | 2420 |
| 143 | kDa | 2421 | 2422 | 2423 | 2424 | 2425 | 2426 | 2427 | 2428 | 2429 | 2430 |
| 144 | kDa | 2431 | 2432 | 2433 | 2434 | 2435 | 2436 | 2437 | 2438 | 2439 | 2440 |
| 145 | kDa | 2441 | 2442 | 2443 | 2444 | 2445 | 2446 | 2447 | 2448 | 2449 | 2450 |

As used herein, “low molecular weight,” “low MW,” or “low-MW” SPF may include SPF having a weight average molecular weight, or average weight average molecular weight selected from between about 5 kDa to about 38 kDa, about 14 kDa to about 30 kDa, or about 6 kDa to about 17 kDa. In some embodiments, a target low molecular weight for certain SPF may be weight average molecular weight of about 5 kDa, about 6 kDa, about 7 kDa, about 8 kDa, about 9 kDa, about 10 kDa, about 11 kDa, about 12 kDa, about 13 kDa, about 14 kDa, about 15 kDa, about 16 kDa, about 17 kDa, about 18 kDa, about 19 kDa, about 20 kDa, about 21 kDa, about 22 kDa, about 23 kDa, about 24 kDa, about 25 kDa, about 26 kDa, about 27 kDa, about 28 kDa, about 29 kDa, about 30 kDa, about 31 kDa, about 32 kDa, about 33 kDa, about 34 kDa, about 35 kDa, about 36 kDa, about 37 kDa, or about 38 kDa.

As used herein, “medium molecular weight,” “medium MW,” or “mid-MW” SPF may include SPF having a weight average molecular weight, or average weight average molecular weight selected from between about 31 kDa to about 55 kDa, or about 39 kDa to about 54 kDa. In some embodiments, a target medium molecular weight for certain SPF may be weight average molecular weight of about 31 kDa, about 32 kDa, about 33 kDa, about 34 kDa, about 35 kDa, about 36 kDa, about 37 kDa, about 38 kDa, about 39 kDa, about 40 kDa, about 41 kDa, about 42 kDa, about 43 kDa, about 44 kDa, about 45 kDa, about 46 kDa, about 47 kDa, about 48 kDa, about 49 kDa, about 50 kDa, about 51 kDa, about 52 kDa, about 53 kDa, about 54 kDa, or about 55 kDa.

As used herein, “high molecular weight,” “high MW,” or “high-MW” SPF may include SPF having a weight average molecular weight, or average weight average molecular weight selected from between about 55 kDa to about 150 kDa. In some embodiments, a target high molecular weight for certain SPF may be about 55 kDa, about 56 kDa, about 57 kDa, about 58 kDa, about 59 kDa, about 60 kDa, about 61 kDa, about 62 kDa, about 63 kDa, about 64 kDa, about 65 kDa, about 66 kDa, about 67 kDa, about 68 kDa, about 69 kDa, about 70 kDa, about 71 kDa, about 72 kDa, about 73 kDa, about 74 kDa, about 75 kDa, about 76 kDa, about 77 kDa, about 78 kDa, about 79 kDa, or about 80 kDa.

In some embodiments, the molecular weights described herein (e.g., low molecular weight silk, medium molecular weight silk, high molecular weight silk) may be converted to the approximate number of amino acids contained within the respective SPF, as would be understood by a person having ordinary skill in the art. For example, the average weight of an amino acid may be about 110 daltons (i.e., 110 g/mol). Therefore, in some embodiments, dividing the molecular weight of a linear protein by 110 daltons may be used to approximate the number of amino acid residues contained therein.

In an embodiment, SPF in a composition of the present disclosure have a polydispersity selected from between 1 to about 5.0, including, without limitation, a polydispersity of 1. In an embodiment, SPF in a composition of the present disclosure have a polydispersity selected from between about 1.5 to about 3.0. In an embodiment, SPF in a composition of the present disclosure have a polydispersity selected from between 1 to about 1.5, including, without limitation, a polydispersity of 1. In an embodiment, SPF in a composition of the present disclosure have a polydispersity selected from between about 1.5 to about 2.0. In an embodiment, SPF in a composition of the present disclosure have a polydispersity selected from between about 2.0 to about 2.5. In an embodiment, SPF in a composition of the present disclosure have a polydispersity selected from between about 2.5 to about 3.0. In an embodiment, SPF in a composition of the present disclosure have a polydispersity selected from between about 3.0 to about 3.5. In an embodiment, SPF in a composition of the present disclosure have a polydispersity selected from between about 3.5 to about 4.0. In an embodiment, SPF in a composition of the present disclosure have a polydispersity selected from between about 4.0 to about 4.5. In an embodiment, SPF in a composition of the present disclosure have a polydispersity selected from between about 4.5 to about 5.0.

In an embodiment, SPF in a composition of the present disclosure have a polydispersity of 1. In an embodiment, SPF in a composition of the present disclosure have a polydispersity of about 1.1. In an embodiment, SPF in a composition of the present disclosure have a polydispersity of about 1.2. In an embodiment, SPF in a composition of the present disclosure have a polydispersity of about 1.3. In an embodiment, SPF in a composition of the present disclosure have a polydispersity of about 1.4. In an embodiment, SPF in a composition of the present disclosure have a polydispersity of about 1.5. In an embodiment, SPF in a composition of the present disclosure have a polydispersity of about 1.6. In an embodiment, SPF in a composition of the present disclosure have a polydispersity of about 1.7. In an embodiment, SPF in a composition of the present disclosure have a polydispersity of about 1.8. In an embodiment, SPF in a composition of the present disclosure have a polydispersity of about 1.9. In an embodiment, SPF in a composition of the present disclosure have a polydispersity of about 2.0. In an embodiment, SPF in a composition of the present disclosure have a polydispersity of about 2.1. In an embodiment, SPF in a composition of the present disclosure have a polydispersity of about 2.2. In an embodiment, SPF in a composition of the present disclosure have a polydispersity of about 2.3. In an embodiment, SPF in a composition of the present disclosure have a polydispersity of about 2.4. In an embodiment, SPF in a composition of the present disclosure have a polydispersity of about 2.5. In an embodiment, SPF in a composition of the present disclosure have a polydispersity of about 2.6. In an embodiment, SPF in a composition of the present disclosure have a polydispersity of about 2.7. In an embodiment, SPF in a composition of the present disclosure have a polydispersity of about 2.8. In an embodiment, SPF in a composition of the present disclosure have a polydispersity of about 2.9. In an embodiment, SPF in a composition of the present disclosure have a polydispersity of about 3.0. In an embodiment, SPF in a composition of the present disclosure have a polydispersity of about 3.1. In an embodiment, SPF in a composition of the present disclosure have a polydispersity of about 3.2. In an embodiment, SPF in a composition of the present disclosure have a polydispersity of about 3.3. In an embodiment, SPF in a composition of the present disclosure have a polydispersity of about 3.4. In an embodiment, SPF in a composition of the present disclosure have a polydispersity of about 3.5. In an embodiment, SPF in a composition of the present disclosure have a polydispersity of about 3.6. In an embodiment, SPF in a composition of the present disclosure have a polydispersity of about 3.7. In an embodiment, SPF in a composition of the present disclosure have a polydispersity of about 3.8. In an embodiment, SPF in a composition of the present disclosure have a polydispersity of about 3.9. In an embodiment, SPF in a composition of the present disclosure have a polydispersity of about 4.0. In an embodiment, SPF in a composition of the present disclosure have a polydispersity of about 4.1. In an embodiment, SPF in a composition of the present disclosure have a polydispersity of about 4.2. In an embodiment, SPF in a composition of the present disclosure have a polydispersity of about 4.3. In an embodiment, SPF in a composition of the present disclosure have a polydispersity of about 4.4. In an embodiment, SPF in a composition of the present disclosure have a polydispersity of about 4.5. In an embodiment, SPF in a composition of the present disclosure have a polydispersity of about 4.6. In an embodiment, SPF in a composition of the present disclosure have a polydispersity of about 4.7. In an embodiment, SPF in a composition of the present disclosure have a polydispersity of about 4.8. In an embodiment, SPF in a composition of the present disclosure have a polydispersity of about 4.9. In an embodiment, SPF in a composition of the present disclosure have a polydispersity of about 5.0.

In some embodiments, in compositions described herein having combinations of low, medium, and/or high molecular weight SPF, such low, medium, and/or high molecular weight SPF may have the same or different polydispersities.

### Silk Fibroin Fragments

Methods of making silk fibroin or silk fibroin protein fragments and their applications in various fields are known and are described for example in U.S. Patent Application Publication Nos. 20200188269, 20200188268, 20190336431, 20190380944, 20190070089, 20190070088, 20160022563, 20160022562, 20160022561, 20160022560, 20160022559, 20160193130, 20150094269, 20150093340, 20190211498, 20190309467, 20190003113, 20160281294, and 20160222579, and U.S. Patent Nos. 9,187,538, 9,511,012, 9,517,191, 9,522,107, 9,522,108, 9,545,369, 10,166,177, 10,610,478, 10,588,843, and 10,287,728, all of which are incorporated herein in their entireties. Raw silk from silkworm Bombyx mori is composed of two primary proteins: silk fibroin (approximately 75%) and sericin (approximately 25%). Silk fibroin is a fibrous protein with a semi-crystalline structure that provides stiffness and strength. As used herein, the term “silk fibroin” means the fibers of the cocoon of Bombyx mori having a weight average molecular weight of about 370,000 Da. The crude silkworm fiber consists of a double thread of fibroin. The adhesive substance holding these double fibers together is sericin. The silk fibroin is composed of a heavy chain having a weight average molecular weight of about 350,000 Da (H chain), and a light chain having a weight average molecular weight about 25,000 Da (L chain). Silk fibroin is an amphiphilic polymer with large hydrophobic domains occupying the major component of the polymer, which has a high molecular weight. The hydrophobic regions are interrupted by small hydrophilic spacers, and the N- and C-termini of the chains are also highly hydrophilic. The hydrophobic domains of the H-chain contain a repetitive hexapeptide sequence of Gly-Ala-Gly-Ala-Gly-Ser and repeats of Gly-Ala/Ser/Tyr dipeptides, which can form stable anti-parallel-sheet crystallites. The amino acid sequence of the L-chain is non-repetitive, so the L-chain is more hydrophilic and relatively elastic. The hydrophilic (Tyr, Ser) and hydrophobic (Gly, Ala) chain segments in silk fibroin molecules are arranged alternatively such that allows self-assembling of silk fibroin molecules.

Provided herein are methods for producing pure and highly scalable silk fibroin-protein fragment mixture solutions that may be used across multiple industries for a variety of applications. Without wishing to be bound by any particular theory, it is believed that these methods are equally applicable to fragmentation of any SPF described herein, including without limitation recombinant silk proteins, and fragmentation of silk-like or fibroin-like proteins.

As used herein, the term “fibroin” includes silk worm fibroin and insect or spider silk protein. In an embodiment, fibroin is obtained from Bombyx mori. Raw silk from Bombyx mori is composed of two primary proteins: silk fibroin (approximately 75%) and sericin (approximately 25%). Silk fibroin is a fibrous protein with a semi-crystalline structure that provides stiffness and strength. As used herein, the term “silk fibroin” means the fibers of the cocoon of Bombyx mori having a weight average molecular weight of about 370,000 Da. Conversion of these insoluble silk fibroin fibrils into water-soluble silk fibroin protein fragments requires the addition of a concentrated neutral salt (e.g., 8-10 M lithium bromide), which interferes with inter- and intramolecular ionic and hydrogen bonding that would otherwise render the fibroin protein insoluble in water. Methods of making silk fibroin protein fragments, and/or compositions thereof, are known and are described for example in U.S. Patent Application Publication Nos. 20200188269, 20200188268, 20190336431, 20190380944, 20190070089, 20190070088, 20160022563, 20160022562, 20160022561, 20160022560, 20160022559, 20160193130, 20150094269, 20150093340, 20190211498, 20190309467, 20190003113, 20160281294, and 20160222579, and U.S. Pat. Nos. 9,187,538, 9,511,012, 9,517,191, 9,522,107, 9,522,108, 9,545,369, 10,166,177, 10,610,478, 10,588,843, 10,287,728, and 10,301,768, all of which are incorporated by reference herein in their entireties.

The raw silk cocoons from the silkworm Bombyx mori was cut into pieces. The pieces silk cocoons were processed in an aqueous solution of Na₂CO₃ at about 100° C. for about 60 minutes to remove sericin (degumming). The volume of the water used equals about 0.4× raw silk weight and the amount of Na₂CO₃ is about 0.848× the weight of the raw silk cocoon pieces. The resulting degummed silk cocoon pieces were rinsed with deionized water three times at about 60° C. (20 minutes per rinse). The volume of rinse water for each cycle was 0.2 L×the weight of the raw silk cocoon pieces. The excess water from the degummed silk cocoon pieces was removed. After the DI water washing step, the wet degummed silk cocoon pieces were dried at room temperature. The degummed silk cocoon pieces were mixed with a LiBr solution, and the mixture was heated to about 100° C. The warmed mixture was placed in a dry oven and was heated at about 100° C. for about 60 minutes to achieve complete dissolution of the native silk protein. The resulting silk fibroin solution was filtered and dialyzed using Tangential Flow Filtration (TFF) and a 10 kDa membrane against deionized water for 72 hours. The resulting silk fibroin aqueous solution has a concentration of about 8.5 wt. %. Then, 8.5% silk solution was diluted with water to result in a 1.0% w/v silk solution. TFF can then be used to further concentrate the pure silk solution to a concentration of 20.0% w/w silk to water.

Dialyzing the silk through a series of water changes is a manual and time intensive process, which could be accelerated by changing certain parameters, for example diluting the silk solution prior to dialysis. The dialysis process could be scaled for manufacturing by using semi-automated equipment, for example a tangential flow filtration system.

In some embodiments, the silk solutions are prepared under various preparation condition parameters such as: 90° C. 30 min, 90° C. 60 min, 100° C. 30 min, and 100° C. 60 min. Briefly, 9.3 M LiBr was prepared and allowed to sit at room temperature for at least 30 minutes. 5 mL of LiBr solution was added to 1.25 g of silk and placed in the 60° C. oven. Samples from each set were removed at 4, 6, 8, 12, 24, 168 and 192 hours.

In some embodiments, the silk solutions are prepared under various preparation condition parameters such as: 90° C. 30 min, 90° C. 60 min, 100° C. 30 min, and 100° C. 60 min. Briefly, 9.3 M LiBr solution was heated to one of four temperatures: 60° C., 80° C., 100° C. or boiling. 5 mL of hot LiBr solution was added to 1.25 g of silk and placed in the 60° C. oven. Samples from each set were removed at 1, 4 and 6 hours.

In some embodiments, the silk solutions are prepared under various preparation condition parameters such as: Four different silk extraction combinations were used: 90° C. 30 min, 90° C. 60 min, 100° C. 30 min, and 100° C. 60 min. Briefly, 9.3 M LiBr solution was heated to one of four temperatures: 60° C., 80° C., 100° C. or boiling. 5 mL of hot LiBr solution was added to 1.25 g of silk and placed in the oven at the same temperature of the LiBr. Samples from each set were removed at 1, 4 and 6 hours. 1 mL of each sample was added to 7.5 mL of 9.3 M LiBr and refrigerated for viscosity testing.

In some embodiments, SPF are obtained by dissolving raw unscoured, partially scoured, or scoured silkworm fibers with a neutral lithium bromide salt. The raw silkworm silks are processed under selected temperature and other conditions in order to remove any sericin and achieve the desired weight average molecular weight (Mw) and polydispersity (PD) of the fragment mixture. Selection of process parameters may be altered to achieve distinct final silk protein fragment characteristics depending upon the intended use. The resulting final fragment solution is silk fibroin protein fragments and water with parts per million (ppm) to non-detectable levels of process contaminants, levels acceptable in the pharmaceutical, medical and consumer eye care markets. The concentration, size and polydispersity of SPF may further be altered depending upon the desired use and performance requirements.

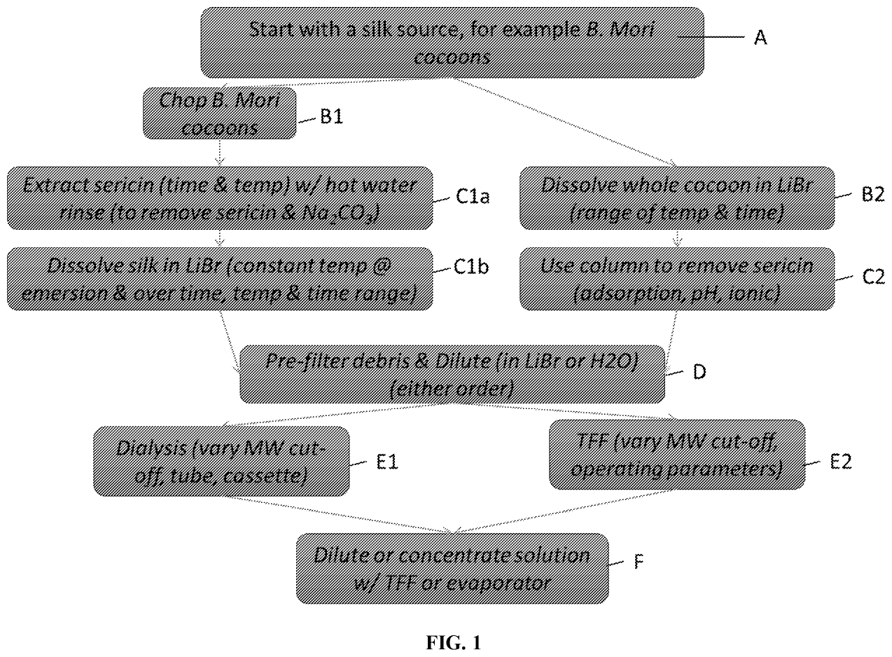

FIG. 1 is a flow chart showing various embodiments for producing pure silk fibroin protein fragments (SPFs) of the present disclosure. It should be understood that not all of the steps illustrated are necessarily required to fabricate all silk solutions of the present disclosure. As illustrated in FIG. 1, step A, cocoons (heat-treated or non-heat-treated), silk fibers, silk powder, spider silk or recombinant spider silk can be used as the silk source. If starting from raw silk cocoons from Bombyx mori, the cocoons can be cut into small pieces, for example pieces of approximately equal size, step B1. The raw silk is then extracted and rinsed to remove any sericin, step C1a. This results in substantially sericin free raw silk. In an embodiment, water is heated to a temperature between 84° C. and 100° C. (ideally boiling) and then Na₂CO₃ (sodium carbonate) is added to the boiling water until the Na₂CO₃ is completely dissolved. The raw silk is added to the boiling water/Na₂CO₃ (100° C.) and submerged for approximately 15-90 minutes, where boiling for a longer time results in smaller silk protein fragments. In an embodiment, the water volume equals about 0.4× raw silk weight and the Na₂CO₃ volume equals about 0.848× raw silk weight. In an embodiment, the water volume equals 0.1× raw silk weight and the Na₂CO₃ volume is maintained at 2.12 g/L.

Subsequently, the water dissolved Na₂CO₃ solution is drained and excess water/Na₂CO₃ is removed from the silk fibroin fibers (e.g., ring out the fibroin extract by hand, spin cycle using a machine, etc.). The resulting silk fibroin extract is rinsed with warm to hot water to remove any remaining adsorbed sericin or contaminate, typically at a temperature range of about 40° C. to about 80° C., changing the volume of water at least once (repeated for as many times as required). The resulting silk fibroin extract is a substantially sericin-depleted silk fibroin. In an embodiment, the resulting silk fibroin extract is rinsed with water at a temperature of about 60° C. In an embodiment, the volume of rinse water for each cycle equals 0.1 L to 0.2 L×raw silk weight. It may be advantageous to agitate, turn or circulate the rinse water to maximize the rinse effect. After rinsing, excess water is removed from the extracted silk fibroin fibers (e.g., ring out fibroin extract by hand or using a machine). Alternatively, methods known to one skilled in the art such as pressure, temperature, or other reagents or combinations thereof may be used for the purpose of sericin extraction. Alternatively, the silk gland (100% sericin free silk protein) can be removed directly from a worm. This would result in liquid silk protein, without any alteration of the protein structure, free of sericin.

The extracted fibroin fibers are then allowed to dry completely. Once dry, the extracted silk fibroin is dissolved using a solvent added to the silk fibroin at a temperature between ambient and boiling, step C1b. In an embodiment, the solvent is a solution of Lithium bromide (LiBr) (boiling for LiBr is 140° C.). Alternatively, the extracted fibroin fibers are not dried but wet and placed in the solvent; solvent concentration can then be varied to achieve similar concentrations as to when adding dried silk to the solvent. The final concentration of LiBr solvent can range from 0.1 M to 9.3 M. Complete dissolution of the extracted fibroin fibers can be achieved by varying the treatment time and temperature along with the concentration of dissolving solvent. Other solvents may be used including, but not limited to, phosphate phosphoric acid, calcium nitrate, calcium chloride solution or other concentrated aqueous solutions of inorganic salts. To ensure complete dissolution, the silk fibers should be fully immersed within the already heated solvent solution and then maintained at a temperature ranging from about 60° C. to about 140° C. for 1-168 hrs. In an embodiment, the silk fibers should be fully immersed within the solvent solution and then placed into a dry oven at a temperature of about 100° C. for about 1 hour.

The temperature at which the silk fibroin extract is added to the LiBr solution (or vice versa) has an effect on the time required to completely dissolve the fibroin and on the resulting molecular weight and polydispersity of the final SPF mixture solution. In an embodiment, silk solvent solution concentration is less than or equal to 20% w/v. In addition, agitation during introduction or dissolution may be used to facilitate dissolution at varying temperatures and concentrations. The temperature of the LiBr solution will provide control over the silk protein fragment mixture molecular weight and polydispersity created. In an embodiment, a higher temperature will more quickly dissolve the silk offering enhanced process scalability and mass production of silk solution. In an embodiment, using a LiBr solution heated to a temperature from 80° C. to 140° C. reduces the time required in an oven in order to achieve full dissolution. Varying time and temperature at or above 60° C. of the dissolution solvent will alter and control the MW and polydispersity of the SPF mixture solutions formed from the original molecular weight of the native silk fibroin protein.

Alternatively, whole cocoons may be placed directly into a solvent, such as LiBr, bypassing extraction, step B2. This requires subsequent filtration of silk worm particles from the silk and solvent solution and sericin removal using methods know in the art for separating hydrophobic and hydrophilic proteins such as a column separation and/or chromatography, ion exchange, chemical precipitation with salt and/or pH, and or enzymatic digestion and filtration or extraction, all methods are common examples and without limitation for standard protein separation methods, step C2. Non-heat treated cocoons with the silkworm removed, may alternatively be placed into a solvent such as LiBr, bypassing extraction. The methods described above may be used for sericin separation, with the advantage that non-heat treated cocoons will contain significantly less worm debris.

Dialysis may be used to remove the dissolution solvent from the resulting dissolved fibroin protein fragment solution by dialyzing the solution against a volume of water, step E1. Pre-filtration prior to dialysis is helpful to remove any debris (i.e., silk worm remnants) from the silk and LiBr solution, step D. In one example, a 3 μm or 5 μm filter is used with a flow-rate of 200-300 mL/min to filter a 0.1% to 1.0% silk-LiBr solution prior to dialysis and potential concentration if desired. A method disclosed herein, as described above, is to use time and/or temperature to decrease the concentration from 9.3 M LiBr to a range from 0.1 M to 9.3 M to facilitate filtration and downstream dialysis, particularly when considering creating a scalable process method. Alternatively, without the use of additional time or temperate, a 9.3 M LiBr-silk protein fragment solution may be diluted with water to facilitate debris filtration and dialysis. The result of dissolution at the desired time and temperate filtration is a translucent particle-free room temperature shelf-stable silk protein fragment-LiBr solution of a known MW and polydispersity. It is advantageous to change the dialysis water regularly until the solvent has been removed (e.g., change water after 1 hour, 4 hours, and then every 12 hours for a total of 6 water changes). The total number of water volume changes may be varied based on the resulting concentration of solvent used for silk protein dissolution and fragmentation. After dialysis, the final silk solution maybe further filtered to remove any remaining debris (i.e., silk worm remnants).

Alternatively, Tangential Flow Filtration (TFF), which is a rapid and efficient method for the separation and purification of biomolecules, may be used to remove the solvent from the resulting dissolved fibroin solution, step E2. TFF offers a highly pure aqueous silk protein fragment solution and enables scalability of the process in order to produce large volumes of the solution in a controlled and repeatable manner. The silk and LiBr solution may be diluted prior to TFF (20% down to 0.1% silk in either water or LiBr). Pre-filtration as described above prior to TFF processing may maintain filter efficiency and potentially avoids the creation of silk gel boundary layers on the filter's surface as the result of the presence of debris particles. Pre-filtration prior to TFF is also helpful to remove any remaining debris (i.e., silk worm remnants) from the silk and LiBr solution that may cause spontaneous or long-term gelation of the resulting water only solution, step D. TFF, recirculating or single pass, may be used for the creation of water-silk protein fragment solutions ranging from 0.1% silk to 30.0% silk (more preferably, 0.1%-6.0% silk). Different cutoff size TFF membranes may be required based upon the desired concentration, molecular weight and polydispersity of the silk protein fragment mixture in solution. Membranes ranging from 1-100 kDa may be necessary for varying molecular weight silk solutions created for example by varying the length of extraction boil time or the time and temperate in dissolution solvent (e.g., LiBr). In an embodiment, a TFF 5 or 10 kDa membrane is used to purify the silk protein fragment mixture solution and to create the final desired silk-to-water ratio. As well, TFF single pass, TFF, and other methods known in the art, such as a falling film evaporator, may be used to concentrate the solution following removal of the dissolution solvent (e.g., LiBr) (with resulting desired concentration ranging from 0.1% to 30% silk). This can be used as an alternative to standard HFIP concentration methods known in the art to create a water-based solution. A larger pore membrane could also be utilized to filter out small silk protein fragments and to create a solution of higher molecular weight silk with and/or without tighter polydispersity values.

An assay for LiBr and Na₂CO₃ detection can be performed using an HPLC system equipped with evaporative light scattering detector (ELSD). The calculation was performed by linear regression of the resulting peak areas for the analyte plotted against concentration. More than one sample of a number of formulations of the present disclosure was used for sample preparation and analysis. Generally, four samples of different formulations were weighed directly in a 10 mL volumetric flask. The samples were suspended in 5 mL of 20 mM ammonium formate (pH 3.0) and kept at 2-8° C. for 2 hours with occasional shaking to extract analytes from the film. After 2 hours the solution was diluted with 20 mM ammonium formate (pH 3.0). The sample solution from the volumetric flask was transferred into HPLC vials and injected into the HPLC-ELSD system for the estimation of sodium carbonate and lithium bromide.

The analytical method developed for the quantitation of Na₂CO₃ and LiBr in silk protein formulations was found to be linear in the range 10-165 μg/mL, with RSD for injection precision as 2% and 1% for area and 0.38% and 0.19% for retention time for sodium carbonate and lithium bromide respectively. The analytical method can be applied for the quantitative determination of sodium carbonate and lithium bromide in silk protein formulations.

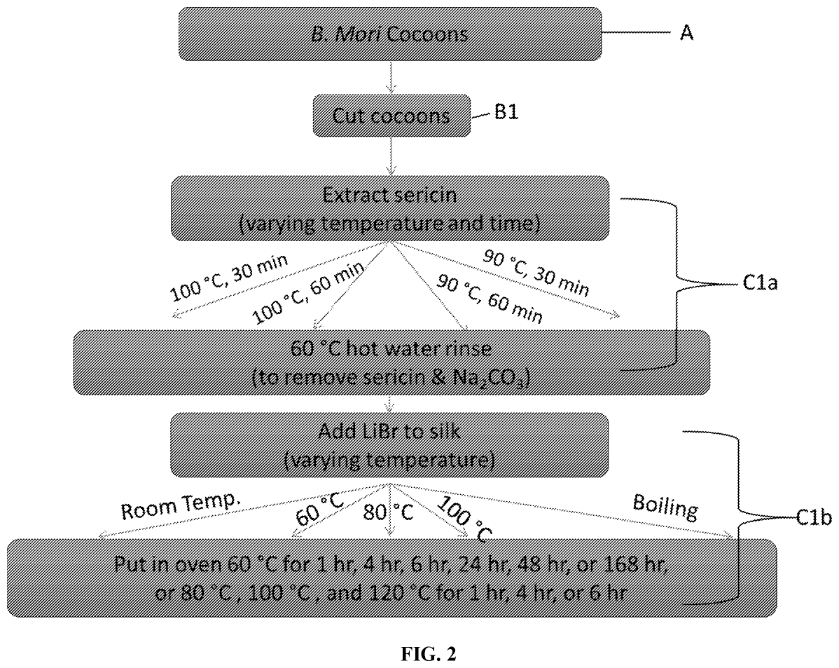

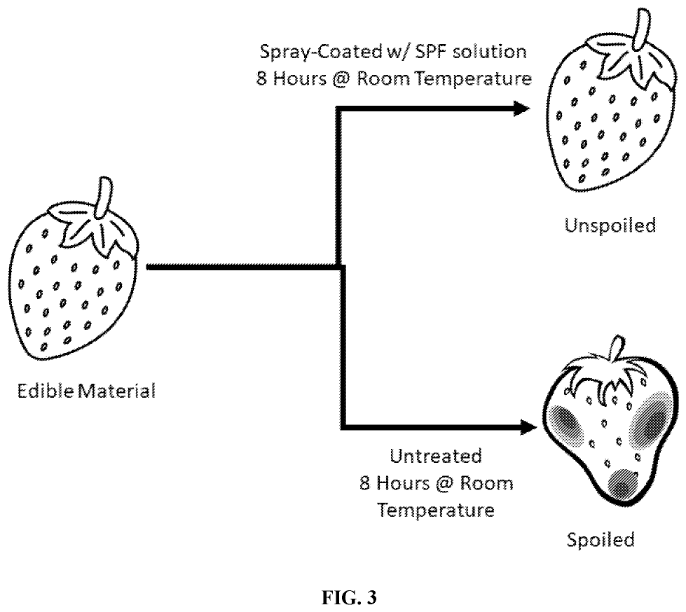

FIG. 2 is a flow chart showing various parameters that can be modified during the process of producing a silk protein fragment solution of the present disclosure during the extraction and the dissolution steps. Select method parameters may be altered to achieve distinct final solution characteristics depending upon the intended use, e.g., molecular weight and polydispersity. It should be understood that not all of the steps illustrated are necessarily required to fabricate all silk solutions of the present disclosure.

In an embodiment, silk protein fragment solutions useful for a wide variety of applications are prepared according to the following steps: forming pieces of silk cocoons from the Bombyx mori silkworm; extracting the pieces at about 100° C. in a Na₂CO₃ water solution for about 60 minutes, wherein a volume of the water equals about 0.4× raw silk weight and the amount of Na₂CO₃ is about 0.848× the weight of the pieces to form a silk fibroin extract; triple rinsing the silk fibroin extract at about 60° C. for about 20 minutes per rinse in a volume of rinse water, wherein the rinse water for each cycle equals about 0.2L× the weight of the pieces; removing excess water from the silk fibroin extract; drying the silk fibroin extract; dissolving the dry silk fibroin extract in a LiBr solution, wherein the LiBr solution is first heated to about 100° C. to create a silk and LiBr solution and maintained; placing the silk and LiBr solution in a dry oven at about 100° C. for about 60 minutes to achieve complete dissolution and further fragmentation of the native silk protein structure into mixture with desired molecular weight and polydispersity; filtering the solution to remove any remaining debris from the silkworm; diluting the solution with water to result in a 1.0 wt. % silk solution; and removing solvent from the solution using Tangential Flow Filtration (TFF). In an embodiment, a 10 kDa membrane is utilized to purify the silk solution and create the final desired silk-to-water ratio. TFF can then be used to further concentrate the silk solution to a concentration of 2.0 wt. % silk in water.

Without wishing to be bound by any particular theory, varying extraction (i.e., time and temperature), LiBr (i.e., temperature of LiBr solution when added to silk fibroin extract or vice versa) and dissolution (i.e., time and temperature) parameters results in solvent and silk solutions with different viscosities, homogeneities, and colors. Also without wishing to be bound by any particular theory, increasing the temperature for extraction, lengthening the extraction time, using a higher temperature LiBr solution at emersion and over time when dissolving the silk and increasing the time at temperature (e.g., in an oven as shown here, or an alternative heat source) all resulted in less viscous and more homogeneous solvent and silk solutions.

The extraction step could be completed in a larger vessel, for example an industrial washing machine where temperatures at or in between 60° C. to 100° C. can be maintained. The rinsing step could also be completed in the industrial washing machine, eliminating the manual rinse cycles. Dissolution of the silk in LiBr solution could occur in a vessel other than a convection oven, for example a stirred tank reactor. Dialyzing the silk through a series of water changes is a manual and time intensive process, which could be accelerated by changing certain parameters, for example diluting the silk solution prior to dialysis. The dialysis process could be scaled for manufacturing by using semi-automated equipment, for example a tangential flow filtration system.

Varying extraction (i.e., time and temperature), LiBr (i.e., temperature of LiBr solution when added to silk fibroin extract or vice versa) and dissolution (i.e., time and temperature) parameters results in solvent and silk solutions with different viscosities, homogeneities, and colors. Increasing the temperature for extraction, lengthening the extraction time, using a higher temperature LiBr solution at emersion and over time when dissolving the silk and increasing the time at temperature (e.g., in an oven as shown here, or an alternative heat source) all resulted in less viscous and more homogeneous solvent and silk solutions. While almost all parameters resulted in a viable silk solution, methods that allow complete dissolution to be achieved in fewer than 4 to 6 hours are preferred for process scalability.

In an embodiment, solutions of silk fibroin protein fragments having a weight average selected from between about 6 kDa to about 17 kDa are prepared according to following steps: degumming a silk source by adding the silk source to a boiling (100° C.) aqueous solution of sodium carbonate for a treatment time of between about 30 minutes to about 60 minutes; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 60° C. to about 140° C.; maintaining the solution of silk fibroin-lithium bromide in an oven having a temperature of about 140° C. for a period of at most 1 hour; removing the lithium bromide from the silk fibroin extract; and producing an aqueous solution of silk protein fragments, the aqueous solution comprising: fragments having a weight average molecular weight selected from between about 6 kDa to about 17 kDa, and a polydispersity of between 1 and about 5, or between about 1.5 and about 3.0. The method may further comprise drying the silk fibroin extract prior to the dissolving step. The aqueous solution of silk fibroin protein fragments may comprise lithium bromide residuals of less than 300 ppm as measured using a high-performance liquid chromatography lithium bromide assay. The aqueous solution of silk fibroin protein fragments may comprise sodium carbonate residuals of less than 100 ppm as measured using a high-performance liquid chromatography sodium carbonate assay. The aqueous solution of silk fibroin protein fragments may be lyophilized. In some embodiments, the silk fibroin protein fragment solution may be further processed into various forms including gel, powder, and nanofiber.

In an embodiment, solutions of silk fibroin protein fragments having a weight average molecular weight selected from between about 17 kDa to about 39 kDa are prepared according to the following steps: adding a silk source to a boiling (100° C.) aqueous solution of sodium carbonate for a treatment time of between about 30 minutes to about 60 minutes so as to result in degumming; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 80° C. to about 140° C.; maintaining the solution of silk fibroin-lithium bromide in a dry oven having a temperature in the range between about 60° C. to about 100° C. for a period of at most 1 hour; removing the lithium bromide from the silk fibroin extract; and producing an aqueous solution of silk fibroin protein fragments, wherein the aqueous solution of silk fibroin protein fragments comprises lithium bromide residuals of between about 10 ppm and about 300 ppm, wherein the aqueous solution of silk protein fragments comprises sodium carbonate residuals of between about 10 ppm and about 100 ppm, wherein the aqueous solution of silk fibroin protein fragments comprises fragments having a weight average molecular weight selected from between about 17 kDa to about 39 kDa, and a polydispersity of between 1 and about 5, or between about 1.5 and about 3.0. The method may further comprise drying the silk fibroin extract prior to the dissolving step. The aqueous solution of silk fibroin protein fragments may comprise lithium bromide residuals of less than 300 ppm as measured using a high- performance liquid chromatography lithium bromide assay. The aqueous solution of silk fibroin protein fragments may comprise sodium carbonate residuals of less than 100 ppm as measured using a high-performance liquid chromatography sodium carbonate assay.

In some embodiments, a method for preparing an aqueous solution of silk fibroin protein fragments having an average weight average molecular weight selected from between about 6 kDa to about 17 kDa includes the steps of: degumming a silk source by adding the silk source to a boiling (100° C.) aqueous solution of sodium carbonate for a treatment time of between about 30 minutes to about 60 minutes; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 60° C. to about 140° C.; maintaining the solution of silk fibroin-lithium bromide in an oven having a temperature of about 140° C. for a period of at least 1 hour; removing the lithium bromide from the silk fibroin extract; and producing an aqueous solution of silk protein fragments, the aqueous solution comprising: fragments having an average weight average molecular weight selected from between about 6 kDa to about 17 kDa, and a polydispersity of between 1 and about 5, or between about 1.5 and about 3.0. The method may further comprise drying the silk fibroin extract prior to the dissolving step. The aqueous solution of pure silk fibroin protein fragments may comprise lithium bromide residuals of less than 300 ppm as measured using a high-performance liquid chromatography lithium bromide assay. The aqueous solution of pure silk fibroin protein fragments may comprise sodium carbonate residuals of less than 100 ppm as measured using a high-performance liquid chromatography sodium carbonate assay. The method may further comprise adding a therapeutic agent to the aqueous solution of pure silk fibroin protein fragments. The method may further comprise adding a molecule selected from one of an antioxidant or an enzyme to the aqueous solution of pure silk fibroin protein fragments. The method may further comprise adding a vitamin to the aqueous solution of pure silk fibroin protein fragments. The vitamin may be vitamin C or a derivative thereof. The aqueous solution of pure silk fibroin protein fragments may be lyophilized. The method may further comprise adding an alpha hydroxy acid to the aqueous solution of pure silk fibroin protein fragments. The alpha hydroxy acid may be selected from the group consisting of glycolic acid, lactic acid, tartaric acid and citric acid. The method may further comprise adding hyaluronic acid or its salt form at a concentration of about 0.5% to about 10.0% to the aqueous solution of pure silk fibroin protein fragments. The method may further comprise adding at least one of zinc oxide or titanium dioxide. A film may be fabricated from the aqueous solution of pure silk fibroin protein fragments produced by this method. The film may comprise from about 1.0 wt. % to about 50.0 wt. % of vitamin C or a derivative thereof. The film may have a water content ranging from about 2.0 wt. % to about 20.0 wt. %. The film may comprise from about 30.0 wt. % to about 99.5 wt. % of pure silk fibroin protein fragments. A gel may be fabricated from the aqueous solution of pure silk fibroin protein fragments produced by this method. The gel may comprise from about 0.5 wt. % to about 20.0 wt. % of vitamin C or a derivative thereof. The gel may have a silk content of at least 2% and a vitamin content of at least 20%.

In some embodiments, a method for preparing an aqueous solution of silk fibroin protein fragments having an average weight average molecular weight selected from between about 17 kDa to about 39 kDa includes the steps of: adding a silk source to a boiling (100° C.) aqueous solution of sodium carbonate for a treatment time of between about 30 minutes to about 60 minutes so as to result in degumming; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 80° C. to about 140° C.; maintaining the solution of silk fibroin-lithium bromide in a dry oven having a temperature in the range between about 60° C. to about 100° C. for a period of at least 1 hour; removing the lithium bromide from the silk fibroin extract; and producing an aqueous solution of pure silk fibroin protein fragments, wherein the aqueous solution of pure silk fibroin protein fragments comprises lithium bromide residuals of between about 10 ppm and about 300 ppm, wherein the aqueous solution of silk protein fragments comprises sodium carbonate residuals of between about 10 ppm and about 100 ppm, wherein the aqueous solution of pure silk fibroin protein fragments comprises fragments having an average weight average molecular weight selected from between about 17 kDa to about 39 kDa, and a polydispersity of between 1 and about 5, or between about 1.5 and about 3.0. The method may further comprise drying the silk fibroin extract prior to the dissolving step. The aqueous solution of pure silk fibroin protein fragments may comprise lithium bromide residuals of less than 300 ppm as measured using a high-performance liquid chromatography lithium bromide assay. The aqueous solution of pure silk fibroin protein fragments may comprise sodium carbonate residuals of less than 100 ppm as measured using a high-performance liquid chromatography sodium carbonate assay. The method may further comprise adding a therapeutic agent to the aqueous solution of pure silk fibroin protein fragments. The method may further comprise adding a molecule selected from one of an antioxidant or an enzyme to the aqueous solution of pure silk fibroin protein fragments. The method may further comprise adding a vitamin to the aqueous solution of pure silk fibroin protein fragments. The vitamin may be vitamin C or a derivative thereof. The aqueous solution of pure silk fibroin protein fragments may be lyophilized. The method may further comprise adding an alpha hydroxy acid to the aqueous solution of pure silk fibroin protein fragments. The alpha hydroxy acid may be selected from the group consisting of glycolic acid, lactic acid, tartaric acid and citric acid. The method may further comprise adding hyaluronic acid or its salt form at a concentration of about 0.5% to about 10.0% to the aqueous solution of pure silk fibroin protein fragments. The method may further comprise adding at least one of zinc oxide or titanium dioxide. A film may be fabricated from the aqueous solution of pure silk fibroin protein fragments produced by this method. The film may comprise from about 1.0 wt. % to about 50.0 wt. % of vitamin C or a derivative thereof. The film may have a water content ranging from about 2.0 wt. % to about 20.0 wt. %. The film may comprise from about 30.0 wt. % to about 99.5 wt. % of pure silk fibroin protein fragments. A gel may be fabricated from the aqueous solution of pure silk fibroin protein fragments produced by this method. The gel may comprise from about 0.5 wt. % to about 20.0 wt. % of vitamin C or a derivative thereof. The gel may have a silk content of at least 2% and a vitamin content of at least 20%.

In an embodiment, solutions of silk fibroin protein fragments having a weight average molecular weight selected from between about 39 kDa to about 80 kDa are prepared according to the following steps: adding a silk source to a boiling (100° C.) aqueous solution of sodium carbonate for a treatment time of about 30 minutes so as to result in degumming; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 80° C. to about 140° C.; maintaining the solution of silk fibroin-lithium bromide in a dry oven having a temperature in the range between about 60° C. to about 100° C. for a period of at most 1 hour; removing the lithium bromide from the silk fibroin extract; and producing an aqueous solution of silk fibroin protein fragments, wherein the aqueous solution of silk fibroin protein fragments comprises lithium bromide residuals of between about 10 ppm and about 300 ppm, sodium carbonate residuals of between about 10 ppm and about 100 ppm, fragments having a weight average molecular weight selected from between about 39 kDa to about 80 kDa, and a polydispersity of between 1 and about 5, or between about 1.5 and about 3.0. The method may further comprise drying the silk fibroin extract prior to the dissolving step. The aqueous solution of silk fibroin protein fragments may comprise lithium bromide residuals of less than 300 ppm as measured using a high-performance liquid chromatography lithium bromide assay. The aqueous solution of silk fibroin protein fragments may comprise sodium carbonate residuals of less than 100 ppm as measured using a high-performance liquid chromatography sodium carbonate assay. In some embodiments, the method may further comprise adding an active agent (e.g., therapeutic agent) to the aqueous solution of pure silk fibroin protein fragments. The method may further comprise adding an active agent selected from one of an antioxidant or an enzyme to the aqueous solution of pure silk fibroin protein fragments. The method may further comprise adding a vitamin to the aqueous solution of pure silk fibroin protein fragments. The vitamin may be vitamin C or a derivative thereof. The aqueous solution of pure silk fibroin protein fragments may be lyophilized. The method may further comprise adding an alpha-hydroxy acid to the aqueous solution of pure silk fibroin protein fragments. The alpha hydroxy acid may be selected from the group consisting of glycolic acid, lactic acid, tartaric acid and citric acid. The method may further comprise adding hyaluronic acid or its salt form at a concentration of about 0.5% to about 10.0% to the aqueous solution of pure silk fibroin protein fragments. A film may be fabricated from the aqueous solution of pure silk fibroin protein fragments produced by this method. The film may comprise from about 1.0 wt. % to about 50.0 wt. % of vitamin C or a derivative thereof. The film may have a water content ranging from about 2.0 wt. % to about 20.0 wt. %. The film may comprise from about 30.0 wt. % to about 99.5 wt. % of pure silk fibroin protein fragments. A gel may be fabricated from the aqueous solution of pure silk fibroin protein fragments produced by this method. The gel may comprise from about 0.5 wt. % to about 20.0 wt. % of vitamin C or a derivative thereof. The gel may have a silk content of at least 2 wt. % and a vitamin content of at least 20 wt. %.

Molecular weight of the silk protein fragments may be controlled based upon the specific parameters utilized during the extraction step, including extraction time and temperature; specific parameters utilized during the dissolution step, including the LiBr temperature at the time of submersion of the silk in to the lithium bromide and time that the solution is maintained at specific temperatures; and specific parameters utilized during the filtration step. By controlling process parameters using the disclosed methods, it is possible to create silk fibroin protein fragment solutions with polydispersity equal to or lower than 2.5 at a variety of different molecular weight selected from between 5 kDa to 200 kDa, or between 10 kDa and 80 kDa. By altering process parameters to achieve silk solutions with different molecular weights, a range of fragment mixture end products, with desired polydispersity of equal to or less than 2.5 may be targeted based upon the desired performance requirements. For example, a higher molecular weight silk film containing an ophthalmic drug may have a controlled slow release rate compared to a lower molecular weight film making it ideal for a delivery vehicle in eye care products. Additionally, the silk fibroin protein fragment solutions with a polydispersity of greater than 2.5 can be achieved. Further, two solutions with different average molecular weights and polydispersity can be mixed to create combination solutions. Alternatively, a liquid silk gland (100% sericin free silk protein) that has been removed directly from a worm could be used in combination with any of the silk fibroin protein fragment solutions of the present disclosure. Molecular weight of the pure silk fibroin protein fragment composition was determined using High Pressure Liquid Chromatography (HPLC) with a Refractive Index Detector (RID). Polydispersity was calculated using Cirrus GPC Online GPC/SEC Software Version 3.3 (Agilent).

Differences in the processing parameters can result in regenerated silk fibroins that vary in molecular weight, and peptide chain size distribution (polydispersity, PD). This, in turn, influences the regenerated silk fibroin performance, including mechanical strength, water solubility etc.

Parameters were varied during the processing of raw silk cocoons into the silk solution. Varying these parameters affected the MW of the resulting silk solution. Parameters manipulated included (i) time and temperature of extraction, (ii) temperature of LiBr, (iii) temperature of dissolution oven, and (iv) dissolution time. Experiments were carried out to determine the effect of varying the extraction time. Tables A-G summarize the results. Below is a summary:
A sericin extraction time of 30 minutes resulted in larger molecular weight than a sericin extraction time of 60 minutes
Molecular weight decreases with time in the oven
140° C. LiBr and oven resulted in the low end of the confidence interval to be below a molecular weight of 9500 Da
30 min extraction at the 1 hour and 4 hour time points have undigested silk
30 min extraction at the 1 hour time point resulted in a significantly high molecular weight with the low end of the confidence interval being 35,000 Da
The range of molecular weight reached for the high end of the confidence interval was 18000 to 216000 Da (important for offering solutions with specified upper limit).

TABLE A
The effect of extraction time (30 min vs 60 min) on molecular weight of silk processed
under the conditions of 100° C. Extraction Temperature, 100° C. Lithium Bromide (LiBr) and
100° C. Oven Dissolution (Oven/Dissolution Time was varied).

| Boil Time | Oven Time | Average Mw | Std dev | Confidence Interval | | PD |
|---|---|---|---|---|---|---|
| 30 | 1 | 57247 | 12780 | 35093 | 93387 | 1.63 |
| 60 | 1 | 31520 | 1387 | 11633 | 85407 | 2.71 |
| 30 | 4 | 40973 | 2632 | 14268 | 117658 | 2.87 |
| 60 | 4 | 25082 | 1248 | 10520 | 59803 | 2.38 |
| 30 | 6 | 25604 | 1405 | 10252 | 63943 | 2.50 |
| 60 | 6 | 20980 | 1262 | 10073 | 43695 | 2.08 |

TABLE B
The effect of extraction time (30 min vs 60 min) on molecular weight of silk processed
under the conditions of 100° C. Extraction Temperature, boiling Lithium Bromide (LiBr) and
60° C. Oven Dissolution for 4 hr.

| Sample | Boil Time | Average Mw | Std dev | Confidence Interval | | PD |
|---|---|---|---|---|---|---|
| 30 min, 4 hr | 30 | 49656 | 4580 | 17306 | 142478 | 2.87 |
| 60 min, 4 hr | 60 | 30042 | 1536 | 11183 | 80705 | 2.69 |

TABLE C
The effect of extraction time (30 min vs 60 min) on molecular weight of silk processed
under the conditions of 100° C. Extraction Temperature, 60° C. Lithium Bromide (LiBr) and
60° C. Oven Dissolution (Oven/Dissolution Time was varied).

| | | Oven | Average | Std | | | |
|---|---|---|---|---|---|---|---|
| Sample | Boil Time | Time | Mw | dev | Confidence Interval | | PD |
| 30 min, 1 hr | 30 | 1 | 58436 | | 22201 | 153809 | 2.63 |
| 60 min, 1 hr | 60 | 1 | 31700 | | 11931 | 84224 | 2.66 |
| 30 min, 4 hr | 30 | 4 | 61956.5 | 13337 | 21463 | 178847 | 2.89 |
| 60 min, 4 hr | 60 | 4 | 25578.5 | 2446 | 9979 | 65564 | 2.56 |

TABLE D
The effect of extraction time (30 min vs 60 min) on molecular weight of silk processed
under the conditions of 100° C. Extraction Temperature, 80° C. Lithium Bromide (LiBr) and
80° C. Oven Dissolution for 6 hr.

| | | Average | Std | | | |
|---|---|---|---|---|---|---|
| Sample | Boil Time | Mw | dev | Confidence Interval | | PD |
| 30 min, 6 hr | 30 | 63510 | | 18693 | 215775 | 3.40 |
| 60 min, 6 hr | 60 | 25164 | 238 | 9637 | 65706 | 2.61 |

TABLE E
The effect of extraction time (30 min vs 60 min) on molecular weight of silk processed
under the conditions of 100° C. Extraction Temperature, 80° C. Lithium Bromide (LiBr) and
60° C. Oven Dissolution (Oven/Dissolution Time was varied).

| | | Oven | Average | | | | |
|---|---|---|---|---|---|---|---|
| Sample | Boil Time | Time | Mw | Std dev | Confidence Interval | | PD |
| 30 min, 4 hr | 30 | 4 | 59202 | 14028 | 19073 | 183760 | 3.10 |
| 60 min, 4 hr | 60 | 4 | 26312.5 | 637 | 10266 | 67442 | 2.56 |
| 30 min, 6 hr | 30 | 6 | 46824 | | 18076 | 121293 | 2.59 |
| 60 min, 6 hr | 60 | 6 | 26353 | | 10168 | 68302 | 2.59 |

TABLE F
The effect of extraction time (30 min vs 60 min) on molecular weight of silk processed
under the conditions of 100° C. Extraction Temperature, 140° C. Lithium Bromide (LiBr) and
140° C. Oven Dissolution (Oven/Dissolution Time was varied).

| | | Oven | Average | | | | |
|---|---|---|---|---|---|---|---|
| Sample | Boil Time | Time | Mw | Std dev | Confidence Interval | | PD |
| 30 min, 4 hr | 30 | 4 | 9024.5 | 1102 | 4493 | 18127 | 2.00865 |
| 60 min, 4 hr | 60 | 4 | 15548 | | 6954 | 34762 | 2.2358 |
| 30 min, 6 hr | 30 | 6 | 13021 | | 5987 | 28319 | 2.1749 |
| 60 min, 6 hr | 60 | 6 | 10888 | | 5364 | 22100 | 2.0298 |

Experiments were carried out to determine the effect of varying the extraction temperature. Table G summarizes the results. Below is a summary:
Sericin extraction at 90° C. resulted in higher MW than sericin extraction at 100° C. extraction
Both 90° C. and 100° C. show decreasing MW over time in the oven.

TABLE G
The effect of extraction temperature (90° C. vs. 100° C.) on molecular weight of silk
processed under the conditions of 60 min. Extraction Temperature, 100° C. Lithium Bromide
(LiBr) and 100° C. Oven Dissolution (Oven/Dissolution Time was varied).

| Sample | Boil Time | Oven Time | Average Mw | Std dev | Confidence Interval | | PD |
|---|---|---|---|---|---|---|---|
| 90° C., 4 hr | 60 | 4 | 37308 | 4204 | 13368 | 104119 | 2.79 |
| 100° C., 4 hr | 60 | 4 | 25082 | 1248 | 10520 | 59804 | 2.38 |
| 90° C., 6 hr | 60 | 6 | 34224 | 1135 | 12717 | 92100 | 2.69 |
| 100° C., 6 hr | 60 | 6 | 20980 | 1262 | 10073 | 43694 | 2.08 |

Experiments were carried out to determine the effect of varying the Lithium Bromide (LiBr) temperature when added to silk. Tables H-I summarize the results. Below is a summary:

TABLE H
The effect of Lithium Bromide (LiBr) temperature on molecular weight of silk
processed under the conditions of 60 min. Extraction Time., 100° C. Extraction
Temperature and 60° C. Oven Dissolution (Oven/Dissolution Time was varied).

| | LiBr | | | | | | |
|---|---|---|---|---|---|---|---|
| | Temp | Oven | Average | | | | |
| Sample | (° C.) | Time | Mw | Std dev | Confidence Interval | | PD |
| 60° C. LiBr, | 60 | 1 | 31700 | | 11931 | 84223 | 2.66 |
| 1 hr | | | | | | | |
| 100° C. LiBr, | 100 | 1 | 27907 | 200 | 10735 | 72552 | 2.60 |
| 1 hr | | | | | | | |
| RT LiBr, | RT | 4 | 29217 | 1082 | 10789 | 79119 | 2.71 |
| 4 hr | | | | | | | |
| 60° C. LiBr, | 60 | 4 | 25578 | 2445 | 9978 | 65564 | 2.56 |
| 4 hr | | | | | | | |
| 80° C. LiBr, | 80 | 4 | 26312 | 637 | 10265 | 67441 | 2.56 |
| 4 hr | | | | | | | |
| 100° C. LiBr, | 100 | 4 | 27681 | 1729 | 11279 | 67931 | 2.45 |
| 4 hr | | | | | | | |
| Boil LiBr, | Boil | 4 | 30042 | 1535 | 11183 | 80704 | 2.69 |
| 4 hr | | | | | | | |
| RT LiBr, | RT | 6 | 26543 | 1893 | 10783 | 65332 | 2.46 |
| 6 hr | | | | | | | |
| 80° C. LiBr, | 80 | 6 | 26353 | | 10167 | 68301 | 2.59 |
| 6 hr | | | | | | | |
| 100° C. LiBr, | 100 | 6 | 27150 | 916 | 11020 | 66889 | 2.46 |
| 6 hr | | | | | | | |

TABLE I
The effect of Lithium Bromide (LiBr) temperature on molecular weight of silk
processed under the conditions of 30 min. Extraction Time, 100° C.
Extraction Temperature and 60° C. Oven Dissolution (Oven/Dissolution Time was varied).

| | LiBr | Oven | Average | | | | |
|---|---|---|---|---|---|---|---|
| Sample | Temp (° C.) | Time | Mw | Std dev | Confidence Interval | | PD |
| 60° C. LiBr, | 60 | 4 | 61956 | 13336 | 21463 | 178847 | 2.89 |
| 4 hr | | | | | | | |
| 80° C. LiBr, | 80 | 4 | 59202 | 14027 | 19073 | 183760 | 3.10 |
| 4 hr | | | | | | | |
| 100° C. LiBr, | 100 | 4 | 47853 | | 19757 | 115899 | 2.42 |
| 4 hr | | | | | | | |
| 80° C. LiBr, | 80 | 6 | 46824 | | 18075 | 121292 | 2.59 |
| 6 hr | | | | | | | |
| 100° C. LiBr, | 100 | 6 | 55421 | 8991 | 19152 | 160366 | 2.89 |
| 6 hr | | | | | | | |

Experiments were carried out to determine the effect of v oven/dissolution temperature. Tables J-N summarize the results. Below is a summary:
Oven temperature has less of an effect on 60 min extracted silk than 30 min extracted silk. Without wishing to be bound by theory, it is believed that the 30 min silk is less degraded during extraction and therefore the oven temperature has more of an effect on the larger MW, less degraded portion of the silk.
For 60° C. vs. 140° C. oven the 30 min extracted silk showed a very significant effect of lower MW at higher oven temp, while 60 min extracted silk had an effect but much less
The 140° C. oven resulted in a low end in the confidence interval at 6000 Da.

TABLE J
The effect of oven/dissolution temperature on molecular weight of silk
processed under the conditions of 100° C. Extraction Temperature, 30 min. Extraction
Time, and 100° C. Lithium Bromide (LiBr) (Oven/Dissolution Time was varied).

| | Oven Temp | Oven | Average | | | | |
|---|---|---|---|---|---|---|---|
| Boil Time | (° C.) | Time | Mw | Std dev | Confidence Interval | | PD |
| 30 | 60 | 4 | 47853 | | 19758 | 115900 | 2.42 |
| 30 | 100 | 4 | 40973 | 2632 | 14268 | 117658 | 2.87 |
| 30 | 60 | 6 | 55421 | 8992 | 19153 | 160366 | 2.89 |
| 30 | 100 | 6 | 25604 | 1405 | 10252 | 63943 | 2.50 |

TABLE K
The effect of oven/dissolution temperature on molecular weight of silk
processed under the conditions of 100° C. Extraction Temperature, 60 min. Extraction
Time, and 100° C. Lithium Bromide (LiBr) (Oven/Dissolution Time was varied).

| Boil Time | | Oven | Average | | | | |
|---|---|---|---|---|---|---|---|
| (minutes) | Oven Temp | Time | Mw | Std dev | Confidence Interval | | PD |
| 60 | 60 | 1 | 27908 | 200 | 10735 | 72552 | 2.60 |
| 60 | 100 | 1 | 31520 | 1387 | 11633 | 85407 | 2.71 |
| 60 | 60 | 4 | 27681 | 1730 | 11279 | 72552 | 2.62 |
| 60 | 100 | 4 | 25082 | 1248 | 10520 | 59803 | 2.38 |
| 60 | 60 | 6 | 27150 | 916 | 11020 | 66889 | 2.46 |
| 60 | 100 | 6 | 20980 | 1262 | 10073 | 43695 | 2.08 |

TABLE L
The effect of oven/dissolution temperature on molecular weight of silk
processed under the conditions of 100° C. Extraction Temperature, 60 min. Extraction
Time, and 140° C. Lithium Bromide (LiBr) (Oven/Dissolution Time was varied).

| Boil Time | Oven | Oven | | | | | |
|---|---|---|---|---|---|---|---|
| (minutes) | Temp (° C.) | Time | Average | Std dev | Confidence Interval | | PD |
| 60 | 60 | 4 | 30042 | 1536 | 11183 | 80705 | 2.69 |
| 60 | 140 | 4 | 15548 | | 7255 | 33322 | 2.14 |

TABLE M
The effect of oven/dissolution temperature on molecular weight of silk
processed under the conditions of 100° C. Extraction Temperature, 30 min. Extraction
Time, and 140° C. Lithium Bromide (LiBr) (Oven/Dissolution Time was varied).

| Boil Time | Oven | Oven | Average | | | | |
|---|---|---|---|---|---|---|---|
| (minutes) | Temp (° C.) | Time | Mw | Std dev | Confidence Interval | | PD |
| 30 | 60 | 4 | 49656 | 4580 | 17306 | 142478 | 2.87 |
| 30 | 140 | 4 | 9025 | 1102 | 4493 | 18127 | 2.01 |
| 30 | 60 | 6 | 59383 | 11640 | 17641 | 199889 | 3.37 |
| 30 | 140 | 6 | 13021 | | 5987 | 28319 | 2.17 |

TABLE N
The effect of oven/dissolution temperature on molecular weight of silk
processed under the conditions of 100° C. Extraction Temperature, 60 min. Extraction
Time, and 80° C. Lithium Bromide (LiBr) (Oven/Dissolution Time was varied).

| Boil Time | Oven Temp | Oven | Average | | | | |
|---|---|---|---|---|---|---|---|
| (minutes) | (° C.) | Time | Mw | Std dev | Confidence Interval | | PD |
| 60 | 60 | 4 | 26313 | 637 | 10266 | 67442 | 2.56 |
| 60 | 80 | 4 | 30308 | 4293 | 12279 | 74806 | 2.47 |
| 60 | 60 | 6 | 26353 | | 10168 | 68302 | 2.59 |
| 60 | 80 | 6 | 25164 | 238 | 9637 | 65706 | 2.61 |

The raw silk cocoons from the silkworm Bombyx mori was cut into pieces. The pieces of raw silk cocoons were boiled in an aqueous solution of Na₂CO₃ (about 100° C.) for a period of time between about 30 minutes to about 60 minutes to remove sericin (degumming). The volume of the water used equals about 0.4× raw silk weight and the amount of Na₂CO₃ is about 0.848× the weight of the raw silk cocoon pieces. The resulting degummed silk cocoon pieces were rinsed with deionized water three times at about 60° C. (20 minutes per rinse). The volume of rinse water for each cycle was 0.2L× the weight of the raw silk cocoon pieces. The excess water from the degummed silk cocoon pieces was removed. After the DI water washing step, the wet degummed silk cocoon pieces were dried at room temperature. The degummed silk cocoon pieces were mixed with a LiBr solution, and the mixture was heated to about 100° C. The warmed mixture was placed in a dry oven and was heated at a temperature ranging from about 60° C. to about 140° C. for about 60 minutes to achieve complete dissolution of the native silk protein. The resulting solution was allowed to cool to room temperature and then was dialyzed to remove LiBr salts using a 3,500 Da MWCO membrane. Multiple exchanges were performed in Di water until Br⁻ ions were less than 1 ppm as determined in the hydrolyzed fibroin solution read on an Oakton Bromide (Br⁻) double junction ion-selective electrode.

The resulting silk fibroin aqueous solution has a concentration of about 8.0% w/v containing pure silk fibroin protein fragments having an average weight average molecular weight selected from between about 6 kDa to about 16 kDa, about 17 kDa to about 39 kDa, and about 39 kDa to about 80 kDa and a polydispersity of between about 1.5 and about 3.0. The 8.0% w/v was diluted with DI water to provide a 1.0% w/v, 2.0% w/v, 3.0% w/v, 4.0% w/v, 5.0% w/v by the coating solution.

A variety of % silk concentrations have been produced through the use of Tangential Flow Filtration (TFF). In all cases a 1% silk solution was used as the input feed. A range of 750-18,000 mL of 1% silk solution was used as the starting volume. Solution is diafiltered in the TFF to remove lithium bromide. Once below a specified level of residual LiBr, solution undergoes ultrafiltration to increase the concentration through removal of water. See examples below.

Six (6) silk solutions were utilized in standard silk structures with the following results:

Solution #1 is a silk concentration of 5.9 wt. %, average MW of 19.8 kDa and 2.2 PDI (made with a 60 min boil extraction, 100° C. LiBr dissolution for 1 hour).

Solution #2 is a silk concentration of 6.4 wt. % (made with a 30 min boil extraction, 60° C. LiBr dissolution for 4 hrs).

Solution #3 is a silk concentration of 6.17 wt. % (made with a 30 min boil extraction 100° C. LiBr dissolution for 1 hour).

Solution #4 is a silk concentration of 7.30 wt. %: A 7.30% silk solution was produced beginning with 30 minute extraction batches of 100 g silk cocoons per batch. Extracted silk fibers were then dissolved using 100° C. 9.3 M LiBr in a 100° C. oven for 1 hour. 100 g of silk fibers were dissolved per batch to create 20% silk in LiBr. Dissolved silk in LiBr was then diluted to 1% silk and filtered through a 5 μm filter to remove large debris. 15,500 mL of 1%, filtered silk solution was used as the starting volume/diafiltration volume for TFF. Once LiBr was removed, the solution was ultrafiltered to a volume around 1300 mL. 1262 mL of 7.30% silk was then collected. Water was added to the feed to help remove the remaining solution and 547 mL of 3.91% silk was then collected.

Solution #5 is a silk concentration of 6.44 wt. %: A 6.44 wt. % silk solution was produced beginning with 60 minute extraction batches of a mix of 25, 33, 50, 75 and 100 g silk cocoons per batch. Extracted silk fibers were then dissolved using 100° C. 9.3 M LiBr in a 100° C. oven for 1 hour. 35, 42, 50 and 71 g per batch of silk fibers were dissolved to create 20% silk in LiBr and combined. Dissolved silk in LiBr was then diluted to 1% silk and filtered through a 5 μm filter to remove large debris. 17,000 mL of 1%, filtered silk solution was used as the starting volume/diafiltration volume for TFF. Once LiBr was removed, the solution was ultrafiltered to a volume around 3000 mL. 1490 mL of 6.44% silk was then collected. Water was added to the feed to help remove the remaining solution and 1454 mL of 4.88% silk was then collected.

Solution #6 is a silk concentration of 2.70 wt. %: A 2.70% silk solution was produced beginning with 60-minute extraction batches of 25 g silk cocoons per batch. Extracted silk fibers were then dissolved using 100° C. 9.3 M LiBr in a 100° C. oven for 1 hour. 35.48 g of silk fibers were dissolved per batch to create 20% silk in LiBr. Dissolved silk in LiBr was then diluted to 1% silk and filtered through a 5 μm filter to remove large debris. 1000 mL of 1%, filtered silk solution was used as the starting volume/diafiltration volume for TFF. Once LiBr was removed, the solution was ultrafiltered to a volume around 300 mL. 312 mL of 2.7% silk was then collected.

The preparation of silk fibroin solutions with higher molecular weights is given in Table O.

TABLE O
Preparation and properties of silk fibroin solutions.

| | | | | | Average | |
|---|---|---|---|---|---|---|
| | | | | | weight | |
| | | | | | average | |
| | Extraction | Extraction | LiBr | | molecular | |
| Sample | Time | Temp | Temp | Oven/Sol'n | weight | Average |
| Name | (mins) | (° C.) | (° C.) | Temp | (kDa) | polydispersity |
| Group A | 60 | 100 | 100 | 100° C. | 34.7 | 2.94 |
| TFF | | | | oven | | |
| Group A | 60 | 100 | 100 | 100° C. | 44.7 | 3.17 |
| DIS | | | | oven | | |
| Group B | 60 | 100 | 100 | 100° C. | 41.6 | 3.07 |
| TFF | | | | sol'n | | |
| Group B DIS | 60 | 100 | 100 | 100° C. | 44.0 | 3.12 |
| | | | | sol'n | | |
| Group D | 30 | 90 | 60 | 60° C. sol'n | 129.7 | 2.56 |
| DIS | | | | | | |
| Group D FIL | 30 | 90 | 60 | 60° C. sol'n | 144.2 | 2.73 |
| Group E DIS | 15 | 100 | RT | 60° C. sol'n | 108.8 | 2.78 |
| Group E FIL | 15 | 100 | RT | 60° C. sol'n | 94.8 | 2.62 |

Silk aqueous coating composition for application to fabrics are given in Tables P and Q below.

TABLE P
Silk Solution Characteristics

| Molecular Weight: | 57 kDa | | | |
|---|---|---|---|---|
| Polydispersity: | 1.6 | | | |
| % Silk | 5.0% | 3.0% | 1.0% | 0.5% |

Process Parameters

| Extraction | | |
|---|---|---|
| Boil Time: | 30 | minutes |
| Boil Temperature: | 100° | C. |
| Rinse Temperature: | 60° | C. |
| Dissolution | | |
| LiBr Temperature: | 100 | |
| Oven Temperature: | 100° | C. |
| Oven Time: | 60 | minutes |

TABLE Q
Silk Solution Characteristics

| Molecular Weight: | 25 kDa | | | |
|---|---|---|---|---|
| Polydispersity: | 2.4 | | | |
| % Silk | 5.0% | 3.0% | 1.0% | 0.5% |

Process Parameters

| | | |
|---|---|---|
| Extraction | | |
| Boil Time: | 60 | minutes |
| Boil Temperature: | 100° | C. |
| Rinse Temperature: | 60° | C. |
| Dissolution | | |
| LiBr Temperature: | 100° | C. |
| Oven Temperature: | 100° | C. |
| Oven Time: | 60 | minutes |

Three (3) silk solutions were utilized in film making with the following results:

Solution #1 is a silk concentration of 5.9%, average MW of 19.8 kDa and 2.2 PD (made with a 60 min boil extraction, 100° C. LiBr dissolution for 1 hr).

Solution #2 is a silk concentration of 6.4% (made with a 30 min boil extraction, 60° C. LiBr dissolution for 4 hrs).

Solution #3 is a silk concentration of 6.17% (made with a 30 min boil extraction, 100° C. LiBr dissolution for 1 hour).

Films were made in accordance with Rockwood et al. (Nature Protocols; Vol. 6; No. 10; published on-line Sep. 22, 2011; doi:10.1038/nprot.2011.379). 4 mL of 1% or 2% (wt/vol) aqueous silk solution was added into 100 mm Petri dish (Volume of silk can be varied for thicker or thinner films and is not critical) and allowed to dry overnight uncovered. The bottom of a vacuum desiccator was filled with water. Dry films were placed in the desiccator and vacuum applied, allowing the films to water anneal for 4 hours prior to removal from the dish. Films cast from solution #1 did not result in a structurally continuous film; the film was cracked in several pieces. These pieces of film dissolved in water in spite of the water annealing treatment.

Silk solutions of various molecular weights and/or combinations of molecular weights can be optimized for gel applications. The following provides an example of this process but it not intended to be limiting in application or formulation. Three (3) silk solutions were utilized in gel making with the following results:

Solution #1 is a silk concentration of 5.9%, average MW of 19.8 kDa and 2.2 PD (made with a 60 min boil extraction, 100° C. LiBr dissolution for 1 hr).

Solution #2 is a silk concentration of 6.4% (made with a 30 min boil extraction, 60° C. LiBr dissolution for 4 hrs).

Solution #3 is a silk concentration of 6.17% (made with a 30 min boil extraction, 100° C. LiBr dissolution for 1 hour).

“Egel” is an electrogelation process as described in Rockwood of al. Briefly, 10 ml of aqueous silk solution is added to a 50 ml conical tube and a pair of platinum wire electrodes immersed into the silk solution. A 20 volt potential was applied to the platinum electrodes for 5 minutes, the power supply turned off and the gel collected. Solution #1 did not form an EGEL over the 5 minutes of applied electric current.

Solutions #2 and #3 were gelled in accordance with the published horseradish peroxidase (HRP) protocol. Behavior seemed typical of published solutions.

Materials and Methods: the following equipment and material are used in determination of Silk Molecular weight: Agilent 1100 with chemstation software ver. 10.01; Refractive Index Detector (RID); analytical balance; volumetric flasks (1000 mL, 10 mL and 5 mL); HPLC grade water; ACS grade sodium chloride; ACS grade sodium phosphate dibasic heptahydrate; phosphoric acid; dextran MW Standards-Nominal Molecular Weights of 5 kDa, 11.6 kDa, 23.8 kDa, 48.6 kDa, and 148 kDa; 50 mL PET or polypropylene disposable centrifuge tubes; graduated pipettes; amber glass HPLC vials with Teflon caps; Phenomenex PolySep GFC P-4000 column (size: 7.8 mm×300 mm).

Procedural Steps:

### A) Preparation of 1 L Mobile Phase (0.1 M Sodium Chloride Solution in 0.0125 M Sodium Phosphate Buffer)

Take a 250 mL clean and dry beaker, place it on the balance and tare the weight. Add about 3.3509 g of sodium phosphate dibasic heptahydrate to the beaker. Note down the exact weight of sodium phosphate dibasic weighed. Dissolve the weighed sodium phosphate by adding 100 mL of HPLC water into the beaker. Take care not to spill any of the content of the beaker. Transfer the solution carefully into a clean and dry 1000 mL volumetric flask. Rinse the beaker and transfer the rinse into the volumetric flask. Repeat the rinse 4-5 times. In a separate clean and dry 250 mL beaker weigh exactly about 5.8440 g of sodium chloride. Dissolve the weighed sodium chloride in 50 mL of water and transfer the solution to the sodium phosphate solution in the volumetric flask. Rinse the beaker and transfer the rinse into the volumetric flask. Adjust the pH of the solution to 7.0±0.2 with phosphoric acid. Make up the volume in volumetric flask with HPLC water to 1000 mL and shake it vigorously to homogeneously mix the solution. Filter the solution through 0.45 μm polyamide membrane filter. Transfer the solution to a clean and dry solvent bottle and label the bottle. The volume of the solution can be varied to the requirement by correspondingly varying the amount of sodium phosphate dibasic heptahydrate and sodium chloride.

### B) Preparation of Dextran Molecular Weight Standard Solutions

At least five different molecular weight standards are used for each batch of samples that are run so that the expected value of the sample to be tested is bracketed by the value of the standard used. Label six 20 mL scintillation glass vials respective to the molecular weight standards. Weigh accurately about 5 mg of each of dextran molecular weight standards and record the weights. Dissolve the dextran molecular weight standards in 5 mL of mobile phase to make a 1 mg/mL standard solution.

### C) Preparation of Sample Solutions

When preparing sample solutions, if there are limitations on how much sample is available, the preparations may be scaled as long as the ratios are maintained. Depending on sample type and silk protein content in sample weigh enough sample in a 50 mL disposable centrifuge tube on an analytical balance to make a 1 mg/mL sample solution for analysis. Dissolve the sample in equivalent volume of mobile phase make a 1 mg/mL solution. Tightly cap the tubes and mix the samples (in solution). Leave the sample solution for 30 minutes at room temperature. Gently mix the sample solution again for 1 minute and centrifuge at 4000 RPM for 10 minutes.

### D) HPLC Analysis of the Samples

Transfer 1.0 mL of all the standards and sample solutions into individual HPLC vials. Inject the molecular weight standards (one injection each) and each sample in duplicate. Analyze all the standards and sample solutions using the following HPLC conditions:

| Column | PolySep GFC P-4000 (7.8 × 300 mm) | |
|---|---|---|
| Column Temperature | 25° | C. |
| Detector | Refractive Index Detector (Temperature @ | |
| | 35° C.) | |
| Injection Volume | 25.0 | μL |
| Mobile Phase | 0.1M Sodium Chloride solution in 0.0125M | |
| | sodium phosphate buffer | |
| Flow Rate | 1.0 | mL/min |
| Run Time | 20.0 | min |

E) Data Analysis and Calculations—Calculation of Average Molecular Weight using Cirrus Software

Upload the chromatography data files of the standards and the analytical samples into Cirrus SEC data collection and molecular weight analysis software. Calculate the weight average molecular weight (Mw), number average molecular weight (Mn), peak average molecular weight (Mₚ), and polydispersity for each injection of the sample.

### Spider Silk Fragments

Spider silks are natural polymers that consist of three domains: a repetitive middle core domain that dominates the protein chain, and non-repetitive N-terminal and C-terminal domains. The large core domain is organized in a block copolymer-like arrangement, in which two basic sequences, crystalline [poly(A) or poly(GA)] and less crystalline (GGX or GPGXX (SEQ ID NO: 6)) polypeptides alternate. Dragline silk is the protein complex composed of major ampullate dragline silk protein 1 (MaSp1) and major ampullate dragline silk protein 2 (MaSp2). Both silks are approximately 3500 amino acid long. MaSp1 can be found in the fibre core and the periphery, whereas MaSp2 forms clusters in certain core areas. The large central domains of MaSp1 and MaSp2 are organized in block copolymer-like arrangements, in which two basic sequences, crystalline [poly(A) or poly(GA)] and less crystalline (GGX or GPGXX (SEQ ID NO: 6)) polypeptides alternate in core domain. Specific secondary structures have been assigned to poly(A)/(GA), GGX and GPGXX (SEQ ID NO: 6) motifs including β-sheet, α-helix and β-spiral respectively. The primary sequence, composition and secondary structural elements of the repetitive core domain are responsible for mechanical properties of spider silks; whereas, non-repetitive N- and C-terminal domains are essential for the storage of liquid silk dope in a lumen and fibre formation in a spinning duct.

The main difference between MaSp1 and MaSp2 is the presence of proline (P) residues accounting for 15% of the total amino acid content in MaSp2, whereas MaSp1 is proline-free. By calculating the number of proline residues in N. clavipes dragline silk, it is possible to estimate the presence of the two proteins in fibres; 81% MaSp1 and 19% MaSp2. Different spiders have different ratios of MaSp1 and MaSp2. For example, a dragline silk fibre from the orb weaver Argiope aurantia contains 41% MaSp1 and 59% MaSp2. Such changes in the ratios of major ampullate silks can dictate the performance of the silk fibre.

At least seven different types of silk proteins are known for one orb-weaver species of spider. Silks differ in primary sequence, physical properties and functions. For example, dragline silks used to build frames, radii and lifelines are known for outstanding mechanical properties including strength, toughness and elasticity. On an equal weight basis, spider silk has a higher toughness than steel and Kevlar. Flageliform silk found in capture spirals has extensibility of up to 500%. Minor ampullate silk, which is found in auxiliary spirals of the orb-web and in prey wrapping, possesses high toughness and strength almost similar to major ampullate silks, but does not supercontract in water.

Spider silks are known for their high tensile strength and toughness. The recombinant silk proteins also confer advantageous properties to cosmetic or dermatological compositions, in particular to be able to improve the hydrating or softening action, good film forming property and low surface density. Diverse and unique biomechanical properties together with biocompatibility and a slow rate of degradation make spider silks excellent candidates as biomaterials for tissue engineering, guided tissue repair and drug delivery, for cosmetic products (e.g. nail and hair strengthener, skin care products), and industrial materials (e.g. nanowires, nanofibers, surface coatings).

In an embodiment, a silk protein may include a polypeptide derived from natural spider silk proteins. The polypeptide is not limited particularly as long as it is derived from natural spider silk proteins, and examples of the polypeptide include natural spider silk proteins and recombinant spider silk proteins such as variants, analogs, derivatives or the like of the natural spider silk proteins. In terms of excellent tenacity, the polypeptide may be derived from major dragline silk proteins produced in major ampullate glands of spiders. Examples of the major dragline silk proteins include major ampullate spidroin MaSp1 and MaSp2 from Nephila clavipes, and ADF3 and ADF4 from Araneus diadematus, etc. Examples of the polypeptide derived from major dragline silk proteins include variants, analogs, derivatives or the like of the major dragline silk proteins. Further, the polypeptide may be derived from flagelliform silk proteins produced in flagelliform glands of spiders. Examples of the flagelliform silk proteins include flagelliform silk proteins derived from Nephila clavipes, etc.

Examples of the polypeptide derived from major dragline silk proteins include a polypeptide containing two or more units of an amino acid sequence represented by the formula 1:REP1-REP2 (1), preferably a polypeptide containing five or more units thereof, and more preferably a polypeptide containing ten or more units thereof. Alternatively, the polypeptide derived from major dragline silk proteins may be a polypeptide that contains units of the amino acid sequence represented by the formula 1: REP1-REP2 (1) and that has, at a C-terminal, an amino acid sequence represented by any of SEQ ID NOS: 52 to 54, which is also described in U.S. Pat. No. 9,051,453, which is incorporated by reference herein in its entirety, or an amino acid sequence having a homology of 90% or more with the amino acid sequence represented by any of SEQ ID NOS: 52 to 54, which is also described in U.S. Pat. No. 9,051,453, which is incorporated by reference herein in its entirety. In the polypeptide derived from major dragline silk proteins, units of the amino acid sequence represented by the formula 1: REP1-REP2 (1) may be the same or may be different from each other. In the case of producing a recombinant protein using a microbe such as Escherichia coli as a host, the molecular weight of the polypeptide derived from major dragline silk proteins is 500 kDa or less, or 300 kDa or less, or 200 kDa or less, in terms of productivity.

In the formula (1), the REP1 indicates polyalanine. In the REP1, the number of alanine residues arranged in succession is preferably 2 or more, more preferably 3 or more, further preferably 4 or more, and particularly preferably 5 or more. Further, in the REP1, the number of alanine residues arranged in succession is preferably 20 or less, more preferably 16 or less, further preferably 12 or less, and particularly preferably 10 or less. In the formula (1), the REP2 is an amino acid sequence composed of 10 to 200 amino acid residues. The total number of glycine, serine, glutamine and alanine residues contained in the amino acid sequence is 40% or more, preferably 60% or more, and more preferably 70% or more with respect to the total number of amino acid residues contained therein.

In the major dragline silk, the REP1 corresponds to a crystal region in a fiber where a crystal β sheet is formed, and the REP2 corresponds to an amorphous region in a fiber where most of the parts lack regular configurations and that has more flexibility. Further, the [REP1-REP2] corresponds to a repetitious region (repetitive sequence) composed of the crystal region and the amorphous region, which is a characteristic sequence of dragline silk proteins.

### Recombinant Silk Fragments

In some embodiments, the recombinant silk protein refers to recombinant spider silk polypeptides, recombinant insect silk polypeptides, or recombinant mussel silk polypeptides. In some embodiments, the recombinant silk protein fragment disclosed herein include recombinant spider silk polypeptides of Araneidae or Araneoids, or recombinant insect silk polypeptides of Bombyx mori. In some embodiments, the recombinant silk protein fragment disclosed herein include recombinant spider silk polypeptides of Araneidae or Araneoids. In some embodiments, the recombinant silk protein fragment disclosed herein include block copolymer having repetitive units derived from natural spider silk polypeptides of Araneidae or Araneoids. In some embodiments, the recombinant silk protein fragment disclosed herein include block copolymer having synthetic repetitive units derived from spider silk polypeptides of Araneidae or Araneoids and non-repetitive units derived from natural repetitive units of spider silk polypeptides of Araneidae or Araneoids.

Recent advances in genetic engineering have provided a route to produce various types of recombinant silk proteins. Recombinant DNA technology has been used to provide a more practical source of silk proteins. As used herein “recombinant silk protein” refers to synthetic proteins produced heterologously in prokaryotic or eukaryotic expression systems using genetic engineering methods.

Various methods for synthesizing recombinant silk peptides are known and have been described by Ausubel et al., Current Protocols in Molecular Biology § 8 (John Wiley & Sons 1987, (1990)), incorporated herein by reference. A gram-negative, rod-shaped bacterium E. coli is a well-established host for industrial scale production of proteins. Therefore, the majority of recombinant silks have been produced in E. coli. E. coli which is easy to manipulate, has a short generation time, is relatively low cost and can be scaled up for larger amounts protein production.

The recombinant silk proteins can be produced by transformed prokaryotic or eukaryotic systems containing the cDNA coding for a silk protein, for a fragment of this protein or for an analog of such a protein. The recombinant DNA approach enables the production of recombinant silks with programmed sequences, secondary structures, architectures and precise molecular weight. There are four main steps in the process: (i) design and assembly of synthetic silk-like genes into genetic ‘cassettes’, (ii) insertion of this segment into a DNA recombinant vector, (iii) transformation of this recombinant DNA molecule into a host cell and (iv) expression and purification of the selected clones.

The term “recombinant vectors”, as used herein, includes any vectors known to the skilled person including plasmid vectors, cosmid vectors, phage vectors such as lambda phage, viral vectors such as adenoviral or baculoviral vectors, or artificial chromosome vectors such as bacterial artificial chromosomes (BAC), yeast artificial chromosomes (YAC), or P1 artificial chromosomes (PAC). Said vectors include expression as well as cloning vectors. Expression vectors comprise plasmids as well as viral vectors and generally contain a desired coding sequence and appropriate DNA sequences necessary for the expression of the operably linked coding sequence in a particular host organism (e.g., bacteria, yeast, or plant) or in in vitro expression systems. Cloning vectors are generally used to engineer and amplify a certain desired DNA fragment and may lack functional sequences needed for expression of the desired DNA fragments.

The prokaryotic systems include Gram-negative bacteria or Gram-positive bacteria. The prokaryotic expression vectors can include an origin of replication which can be recognized by the host organism, a homologous or heterologous promoter which is functional in the said host, the DNA sequence coding for the spider silk protein, for a fragment of this protein or for an analogous protein. Nonlimiting examples of prokaryotic expression organisms are Escherichia coli, Bacillus subtilis, Bacillus megaterium, Corynebacterium glutamicum, Anabaena, Caulobacter, Gluconobacter, Rhodobacter, Pseudomonas, Para coccus, Bacillus (e.g. Bacillus subtilis) Brevibacterium, Corynebacterium, Rhizobium (Sinorhizobium), Flavobacterium, Klebsiella, Enterobacter, Lactobacillus, Lactococcus, Methylobacterium, Propionibacterium, Staphylococcus or Streptomyces cells.

The eukaryotic systems include yeasts and insect, mammalian or plant cells. In this case, the expression vectors can include a yeast plasmid origin of replication or an autonomous replication sequence, a promoter, a DNA sequence coding for a spider silk protein, for a fragment or for an analogous protein, a polyadenylation sequence, a transcription termination site and, lastly, a selection gene. Nonlimiting examples of eukaryotic expression organisms include yeasts, such as Saccharomyces cerevisiae, Pichia pastoris, basidiosporogenous, ascosporogenous, filamentous fungi, such as Aspergillus niger, Aspergillus oryzae, Aspergillus nidulans, Trichoderma reesei, Acremonium chrysogenum, Candida, Hansenula, Kluyveromyces, Saccharomyces (e.g. Saccharomyces cerevisiae), Schizosaccharomyces, Pichia (e.g. Pichia pastoris) or Yarrowia cells etc., mammalian cells, such as HeLa cells, COS cells, CHO cells etc., insect cells, such as Sf9 cells, MEL cells, etc., “insect host cells” such as Spodoptera frugiperda or Trichoplusia ni cells. SF9 cells, SF-21 cells or High-Five cells, wherein SF-9 and SF-21 are ovarian cells from Spodopterafrupperda, and High-Five cells are egg cells from Trichoplusia ni., “plant host cells”, such as tobacco, potato or pea cells.

A variety of heterologous host systems have been explored to produce different types of recombinant silks. Recombinant partial spidroins as well as engineered silks have been cloned and expressed in bacteria (Escherichia coli), yeast (Pichia pastoris), insects (silkworm larvae), plants (tobacco, soybean, potato, Arabidopsis), mammalian cell lines (BHT/hamster) and transgenic animals (mice, goats). Most of the silk proteins are produced with an N- or C-terminal His-tags to make purification simple and produce enough amounts of the protein.

In some embodiments, the host suitable for expressing the recombinant spider silk protein using heterogeneous system may include transgenic animals and plants. In some embodiments, the host suitable for expressing the recombinant spider silk protein using heterogeneous system comprises bacteria, yeasts, mammalian cell lines. In some embodiments, the host suitable for expressing the recombinant spider silk protein using heterogeneous system comprises E. coli. In some embodiments, the host suitable for expressing the recombinant spider silk protein using heterogeneous system comprises transgenic B. mori silkworm generated using genome editing technologies (e.g. CRISPR).

The recombinant silk protein in this disclosure comprises synthetic proteins which are based on repeat units of natural silk proteins. Besides the synthetic repetitive silk protein sequences, these can additionally comprise one or more natural nonrepetitive silk protein sequences.

In some embodiments, “recombinant silk protein” refers to recombinant silkworm silk protein or fragments thereof. The recombinant production of silk fibroin and silk sericin has been reported. A variety of hosts are used for the production including E. coli, Sacchromyces cerevisiae, Pseudomonas sp., Rhodopseudomonas sp., Bacillus sp., and Strepomyces. See EP 0230702, which is incorporate by reference herein by its entirety.

Provided herein also include design and biological-synthesis of silk fibroin protein-like multiblock polymer comprising GAGAGX (SEQ ID NO: 1) hexapeptide (X is A, Y, V or S) derived from the repetitive domain of B. mori silk heavy chain (H chain)

In some embodiments, this disclosure provides silk protein-like multiblock polymers derived from the repetitive domain of B. mori silk heavy chain (H chain) comprising the GAGAGS (SEQ ID NO: 2) hexapeptide repeating units. The GAGAGS (SEQ ID NO: 2) hexapeptide is the core unit of H-chain and plays an important role in the formation of crystalline domains. The silk protein-like multiblock polymers containing the GAGAGS (SEQ ID NO: 2) hexapeptide repeating units spontaneously aggregate into (3-sheet structures, similar to natural silk fibroin protein, where in the silk protein-like multiblock polymers having any weight average molecular weight described herein.

In some embodiments, this disclosure provides silk-peptide like multiblock copolymers composed of the GAGAGS (SEQ ID NO: 2) hexapeptide repetitive fragment derived from H chain of B. mori silk heavy chain and mammalian elastin VPGVG (SEQ ID NO: 3) motif produced by E. coli. In some embodiments, this disclosure provides fusion silk fibroin proteins composed of the GAGAGS (SEQ ID NO: 2) hexapeptide repetitive fragment derived from H chain of B. mori silk heavy chain and GVGVP (SEQ ID NO: 4) produced by E. coli, where in the silk protein-like multiblock polymers having any weight average molecular weight described herein.

In some embodiments, this disclosure provides B. mori silkworm recombinant proteins composed of the (GAGAGS)16 (SEQ ID NO: 55) repetitive fragment. In some embodiments, this disclosure provides recombinant proteins composed of the (GAGAGS)16 (SEQ ID NO: 55) repetitive fragment and the non-repetitive (GAGAGS)16—F—COOH (SEQ ID NO: 56), (GAGAGS)₁₆—F—F—COOH (SEQ ID NO: 57), (GAGAGS)16—F—F—F—COOH (SEQ ID NO: 58), (GAGAGS)₁₆—F—F—F—F—COOH (SEQ ID NO: 59), (GAGAGS)₁₆—F—F—F—F—F—F—F—F—COOH (SEQ ID NO: 60), (GAGAGS)₁₆ —F—F—F—F—F—F—F—F—F—F—F—F—COOH (SEQ ID NO: 61) produced by E. coli, where F has the following amino acid sequence SGFGPVANGGSGEASSESDFGSSGFGPVANASSGEASSESDFAG (SEQ ID NO: 5), and where in the silk protein-like multiblock polymers having any weight average molecular weight described herein.

In some embodiments, “recombinant silk protein” refers to recombinant spider silk protein or fragments thereof. The productions of recombinant spider silk proteins based on a partial cDNA clone have been reported. The recombinant spider silk proteins produced as such comprise a portion of the repetitive sequence derived from a dragline spider silk protein, Spidroin 1, from the spider Nephila clavipes. see Xu et al. (Proc. Natl. Acad. Sci. U.S.A., 87:7120-7124 (1990). cDNA clone encoding a portion of the repeating sequence of a second fibroin protein, Spidroin 2, from dragline silk of Nephila clavipes and the recombinant synthesis thereof is described in J. Biol. Chem., 1992, volume 267, pp. 19320-19324. The recombinant synthesis of spider silk proteins including protein fragments and variants of Nephila clavipes from transformed E. coli is described in U.S. Pat. Nos. 5,728,810 and 5,989,894. cDNA clones encoding minor ampullate spider silk proteins and the expression thereof is described in U.S. Pat. Nos. 5,733,771 and 5,756,677. cDNA clone encoding the flagelliform silk protein from an orb-web spinning spider is described in U.S. Pat. No. 5,994,099. U.S. Pat. No. 6,268,169 describes the recombinant synthesis of spider silk like proteins derived from the repeating peptide sequence found in the natural spider dragline of Nephila clavipes by E. coli, Bacillus subtilis, and Pichia pastoris recombinant expression systems. WO 03/020916 describes the cDNA clone encoding and recombinant production of spider silk proteins having repeative sequences derived from the major ampullate glands of Nephila madagascariensis, Nephila senegalensis, Tetragnatha kauaiensis, Tetragnatha versicolor, Argiope aurantia, Argiope trifasciata, Gasteracantha mammosa, and Latrodectus geometricus, the flagelliform glands of Argiope trifasciata, the ampullate glands of Dolomedes tenebrosus, two sets of silk glands from Plectreurys tristis, and the silk glands of the mygalomorph Euagrus chisoseus. Each of the above reference is incorporated herein by reference in its entirety.

In some embodiments, the recombinant spider silk protein is a hybrid protein of a spider silk protein and an insect silk protein, a spider silk protein and collagen, a spider silk protein and resilin, or a spider silk protein and keratin. The spider silk repetitive unit comprises or consists of an amino acid sequence of a region that comprises or consists of at least one peptide motif that repetitively occurs within a naturally occurring major ampullate gland polypeptide, such as a dragline spider silk polypeptide, a minor ampullate gland polypeptide, a flagelliform polypeptide, an aggregate spider silk polypeptide, an aciniform spider silk polypeptide or a pyriform spider silk polypeptide.

In some embodiments, the recombinant spider silk protein in this disclosure comprises synthetic spider silk proteins derived from repetitive units of natural spider silk proteins, consensus sequence, and optionally one or more natural non-repetitive spider silk protein sequences. The repeated units of natural spider silk polypeptide may include dragline spider silk polypeptides or flagelliform spider silk polypeptides of Araneidae or Araneoids.

As used herein, the spider silk “repetitive unit” comprises or consists of at least one peptide motif that repetitively occurs within a naturally occurring major ampullate gland polypeptide, such as a dragline spider silk polypeptide, a minor ampullate gland polypeptide, a flagelliform polypeptide, an aggregate spider silk polypeptide, an aciniform spider silk polypeptide or a pyriform spider silk polypeptide. A “repetitive unit” refers to a region which corresponds in amino acid sequence to a region that comprises or consists of at least one peptide motif (e.g. AAAAAA (SEQ ID NO: 20)) or GPGQQ (SEQ ID NO: 15)) that repetitively occurs within a naturally occurring silk polypeptide (e.g. MaSpI, ADF-3, ADF-4, or Flag) (i.e. identical amino acid sequence) or to an amino acid sequence substantially similar thereto (i.e. variational amino acid sequence). A “repetitive unit” having an amino acid sequence which is “substantially similar” to a corresponding amino acid sequence within a naturally occurring silk polypeptide (i.e. wild-type repetitive unit) is also similar with respect to its properties, e.g. a silk protein comprising the “substantially similar repetitive unit” is still insoluble and retains its insolubility. A “repetitive unit” having an amino acid sequence which is “identical” to the amino acid sequence of a naturally occurring silk polypeptide, for example, can be a portion of a silk polypeptide corresponding to one or more peptide motifs of MaSpI (SEQ ID NO: 48), MaSpII (SEQ ID NO: 49), ADF-3 (SEQ ID NO: 50) and/or ADF-4 (SEQ ID NO: 51). A “repetitive unit” having an amino acid sequence which is “substantially similar” to the amino acid sequence of a naturally occurring silk polypeptide, for example, can be a portion of a silk polypeptide corresponding to one or more peptide motifs of MaSpI (SEQ ID NO: 48), MaSpII (SEQ ID NO: 49), ADF-3 (SEQ ID NO: 50) and/or ADF-4 (SEQ ID NO: 51) but having one or more amino acid substitution at specific amino acid positions.

As used herein, the term “consensus peptide sequence” refers to an amino acid sequence which contains amino acids which frequently occur in a certain position (e.g. “G”) and wherein, other amino acids which are not further determined are replaced by the place holder “X”. In some embodiments, the consensus sequence is at least one of (i) GPGXX (SEQ ID NO: 6), wherein X is an amino acid selected from A, S, G, Y, P and Q; (ii) GGX, wherein X is an amino acid selected from Y, P, R, S, A, T, N and Q, preferably Y, P and Q; (iii) Aₓ, wherein x is an integer from 5 to 10.

The consensus peptide sequences GPGXX (SEQ ID NO: 6) and GGX, i.e. glycine rich motifs, provide flexibility to the silk polypeptide and thus, to the thread formed from the silk protein containing said motifs. In detail, the iterated GPGXX (SEQ ID NO: 6) motif forms turn spiral structures, which imparts elasticity to the silk polypeptide. Major ampullate and flagelliform silks both have a GPGXX (SEQ ID NO: 6) motif. The iterated GGX motif is associated with a helical structure having three amino acids per turn and is found in most spider silks. The GGX motif may provide additional elastic properties to the silk. The iterated polyalanine Ax (peptide) motif forms a crystalline β-sheet structure that provides strength to the silk polypeptide, as described for example in WO 03/057727.

In some embodiments, the recombinant spider silk protein in this disclosure comprises two identical repetitive units each comprising at least one, preferably one, amino acid sequence selected from the group consisting of: GGRPSDTYG (SEQ ID NO: 7) and GGRPSSSYG (SEQ ID NO: 8) derived from Resilin. Resilin is an elastomeric protein found in most arthropods that provides low stiffness and high strength.

As used herein, “non-repetitive units” refers to an amino acid sequence which is “substantially similar” to a corresponding non-repetitive (carboxy terminal) amino acid sequence within a naturally occurring dragline polypeptide (i.e. wild-type non-repetitive (carboxy terminal) unit), preferably within ADF-3 (SEQ ID NO:50), ADF-4 (SEQ ID NO: 51), NR3 (SEQ ID NO: 62), NR4 (SEQ ID NO: 63) of the spider Araneus diadematus, which is also described in U.S. Pat. No. 9,217,017, which is incorporated by reference herein in its entirety, C16 peptide (spider silk protein eADF4, molecular weight of 47.7 kDa, AMSilk) comprising the 16 repeats of the sequence GSSAAAAAAAASGPGGYGPENQGPSGPGGYGPGGP (SEQ ID NO: 9), an amino acid sequence adapted from the natural sequence of ADF4 from A. diadematus. Non-repetitive ADF-4 and variants thereof display efficient assembly behavior.

Among the synthetic spider silk proteins, the recombinant silk protein in this disclosure comprises in some embodiments the C16-protein having the polypeptide sequence SEQ ID NO: 64, which is also described in U.S. Pat. No. 8,288,512, which is incorporated by reference herein in its entirety. Besides the polypeptide sequence shown in SEQ ID NO: 64, particularly functional equivalents, functional derivatives and salts of this sequence are also included.

As used herein, “functional equivalents” refers to mutant which, in at least one sequence position of the abovementioned amino acid sequences, have an amino acid other than that specifically mentioned.

In some embodiments, the recombinant spider silk protein in this disclosure comprises, in an effective amount, at least one natural or recombinant silk protein including spider silk protein, corresponding to Spidroin major 1 described by Xu et al., PNAS, USA, 87, 7120, (1990), Spidroin major 2 described by Hinman and Lewis, J. Biol. Chem., 267, 19320, (1922), recombinant spider silk protein as described in U.S. Patent Application No. 2016/0222174 and U.S. Pat. Nos. 9,051,453, 9,617,315, 9,689,089, 8,173,772, 8,642,734, 8,367,803 8,097,583, 8,030,024, 7,754,851, 7,148,039, 7,060,260, or alternatively the minor Spidroins described in patent application WO 95/25165. Each of the above-cited references is incorporated herein by reference in its entirety. Additional recombinant spider silk proteins suitable for the recombinant RSPF of this disclosure include ADF3 and ADF4 from the “Major Ampullate” gland of Araneus diadematus.

Recombinant silk is also described in other patents and patent applications, incorporated by reference herein: US 2004590196, U.S. Pat. No. 7,754,851, US 2007654470, U.S. Pat. No. 7,951,908, US 2010785960, U.S. Pat. No. 8,034,897, US 20090263430, US 2008226854, US 20090123967, US 2005712095, US 2007991037, US 20090162896, US 200885266, U.S. Pat. No. 8,372,436, US 2007989907, US 2009267596, US 2010319542, US 2009265344, US 2012684607, US 2004583227, U.S. Pat. No. 8,030,024, US 2006643569, U.S. Pat. No. 7,868,146, US 2007991916, U.S. Pat. No. 8,097,583, US 2006643200, U.S. Pat. Nos. 8,729,238, 8,877,903, US 20190062557, US 20160280960, US 20110201783, US 2008991916, US 2011986662, US 2012697729, US 20150328363, U.S. Pat. No. 9,034,816, US 20130172478, U.S. Pat. No. 9,217,017, US 20170202995, U.S. Pat. No. 8,721,991, US 2008227498, U.S. Pat. Nos. 9,233,067, 8,288,512, US 2008161364, U.S. Pat. No. 7,148,039, US 1999247806, US 2001861597, US 2004887100, U.S. Pat. Nos. 9,481,719, 8,765,688, US 200880705, US 2010809102, U.S. Pat. No. 8,367,803, US 2010664902, U.S. Pat. No. 7,569,660, US 1999138833, US 2000591632, US 20120065126, US 20100278882, US 2008161352, US 20100015070, US 2009513709, US 20090194317, US 2004559286, US 200589551, US 2008187824, US 20050266242, US 20050227322, and US 20044418.

Recombinant silk is also described in other patents and patent applications, incorporated by reference herein: US 20190062557, US 20150284565, US 20130225476, US 20130172478, US 20130136779, US 20130109762, US 20120252294, US 20110230911, US 20110201783, US 20100298877, U.S. Pat Nos. 10,478,520, 10,253,213, 10,072,152, 9,233,067, 9,217,017, 9,034,816, 8,877,903, 8,729,238, 8,721,991, 8,097,583, 8,034,897, 8,030,024, 7,951,908, 7,868,146, and 7,754,851.

In some embodiments, the recombinant spider silk protein in this disclosure comprises or consists of 2 to 80 repetitive units, each independently selected from GPGXX (SEQ ID NO: 6), GGX and Aₓ as defined herein.

In some embodiments, the recombinant spider silk protein in this disclosure comprises or consists of repetitive units each independently selected from selected from the group consisting of GPGAS (SEQ ID NO: 10), GPGSG (SEQ ID NO: 11), GPGGY (SEQ ID NO: 12), GPGGP (SEQ ID NO: 13), GPGGA (SEQ ID NO: 14), GPGQQ (SEQ ID NO: 15), GPGGG (SEQ ID NO: 16), GPGQG (SEQ ID NO: 17), GPGGS (SEQ ID NO: 18), GGY, GGP, GGA, GGR, GGS, GGT, GGN, GGQ, AAAAA (SEQ ID NO: 19), AAAAAA (SEQ ID NO: 20), AAAAAAA (SEQ ID NO: 21), AAAAAAAA (SEQ ID NO: 22), AAAAAAAAA (SEQ ID NO: 23), AAAAAAAAAA (SEQ ID NO: 24), GGRPSDTYG (SEQ ID NO: 7) and GGRPSSSYG (SEQ ID NO: 8), (i) GPYGPGASAAAAAAGGYGPGSGQQ (SEQ ID NO: 25), (ii) GSSAAAAAAAASGPGGYGPENQGPSGPGGYGPGGP (SEQ ID NO: 9), (iii) GPGQQGPGQQGPGQQGPGQQ (SEQ ID NO: 26): (iv) GPGGAGGPYGPGGAGGPYGPGGAGGPY (SEQ ID NO: 27), (v) GGTTIIEDLDITIDGADGPITISEELTI (SEQ ID NO: 28), (vi) PGSSAAAAAAAASGPGQGQGQGQGQGGRPSDTYG (SEQ ID NO: 29), (vii) SAAAAAAAAGPGGGNGGRPSDTYGAPGGGNGGRPSSSYG (SEQ ID NO: 30), (viii) GGAGGAGGAGGSGGAGGS (SEQ ID NO: 31), (ix) GPGGAGPGGYGPGGSGPGGYGPGGSGPGGY (SEQ ID NO: 32), (x) GPYGPGASAAAAAAGGYGPGCGQQ (SEQ ID NO: 33), (xi) GPYGPGASAAAAAAGGYGPGKGQQ (SEQ ID NO: 34), (xii) GSSAAAAAAAASGPGGYGPENQGPCGPGGYGPGGP (SEQ ID NO: 35), (xiii) GSSAAAAAAAASGPGGYGPKNQGPSGPGGYGPGGP (SEQ ID NO: 36), (xiv) GSSAAAAAAAASGPGGYGPKNQGPCGPGGYGPGGP (SEQ ID NO: 37), or variants thereof as described in U.S. Pat. No. 8,877,903, for example, a synthetic spider peptide having sequential order of GPGAS (SEQ ID NO: 10), GGY, GPGSG (SEQ ID NO: 11) in the peptide chain, or sequential order of AAAAAAAA (SEQ ID NO: 22), GPGGY (SEQ ID NO: 12), GPGGP (SEQ ID NO: 13) in the peptide chain, sequential order of AAAAAAAA (SEQ ID NO: 22), GPGQG (SEQ ID NO: 17), GGR in the peptide chain.

In some embodiments, this disclosure provides silk protein-like multiblock peptides that imitate the repeating units of amino acids derived from natural spider silk proteins such as Spidroin major 1 domain, Spidroin major 2 domain or Spidroin minor 1 domain and the profile of variation between the repeating units without modifying their three-dimensional conformation, wherein these silk protein-like multiblock peptides comprise a repeating unit of amino acids corresponding to one of the sequences (I), (II), (III) and/or (IV) below.

[(XGG)_{w}(XGA)(GXG)ₓ(AGA)_{y}(G)_{z}AG]ₚ (SEQ ID NO: 38) Formula (I) in which: X corresponds to tyrosine or to glutamine, w is an integer equal to 2 or 3,× is an integer from 1 to 3, y is an integer from 5 to 7, z is an integer equal to 1 or 2, and p is an integer and having any weight average molecular weight described herein, and/or

[(GPG₂YGPGQ₂)ₐ(X′)₂S(A)_{b}]ₚ (SEQ ID NO: 39) Formula (II) in which: X′ corresponds to the amino acid sequence GPS or GPG, a is equal to 2 or 3, b is an integer from 7 to 10, and p is an integer and having any weight average molecular weight described herein, and/or

[(GR)(GA)₁(A)ₘ(GGX)ₙ(GA)₁(A)ₘ]₉ (SEQ ID NO: 40) Formula (III) and/or [(GGX″)ₙ(GA)ₘ(A)₁]ₚ (SEQ ID NO: 41) Formula (IV) in which: X″ corresponds to tyrosine, glutamine or alanine, 1 is an integer from 1 to 6, m is an integer from 0 to 4, n is an integer from 1 to 4, and p is an integer.

In some embodiments, the recombinant spider silk protein or an analog of a spider silk protein comprising an amino acid repeating unit of sequence (V):

[(Xaa Gly Gly)_{w}(Xaa Gly Ala)(Gly Xaa Gly)ₓ(Ala Gly Ala)_{y}(Gly)_{z}Ala Gly]ₚ Formula (V), wherein Xaa is tyrosine or glutamine, w is an integer equal to 2 or 3,x is an integer from 1 to 3, y is an integer from 5 to 7, z is an integer equal to 1 or 2, and p is an integer.

In some embodiments, the recombinant spider silk protein in this disclosure is selected from the group consisting of ADF-3 or variants thereof, ADF-4 or variants thereof, MaSpI or variants thereof, MaSpII or variants thereof as described in U.S. Pat. No. 9,217,017.

In some embodiments, this disclosure provides water soluble recombinant spider silk proteins produced in mammalian cells. The solubility of the spider silk proteins produced in mammalian cells was attributed to the presence of the COOH-terminus in these proteins, which makes them more hydrophilic. These COOH-terminal amino acids are absent in spider silk proteins expressed in microbial hosts.

In some embodiments, the recombinant spider silk protein in this disclosure comprises water soluble recombinant spider silk protein C16 modified with an amino or carboxyl terminal selected from the amino acid sequences consisting of: GCGGGGGG (SEQ ID NO: 42), GKGGGGGG (SEQ ID NO: 43), GCGGSGGGGSGGGG (SEQ ID NO: 44), GKGGGGGGSGGGG (SEQ ID NO: 45), and GCGGGGGGSGGGG (SEQ ID NO: 46). In some embodiments, the recombinant spider silk protein in this disclosure comprises C₁₆NR4, C₃₂NR4, C16, C32, NR4C₁₆NR4, NR4C₃₂NR4, NR3C₁₆NR3, or NR3C₃₂NR3 such that the molecular weight of the protein ranges as described herein.

In some embodiments, the recombinant spider silk protein in this disclosure comprises recombinant spider silk protein having a synthetic repetitive peptide segments and an amino acid sequence adapted from the natural sequence of ADF4 from A. diadematus as described in U.S. Pat. No. 8,877,903. In some embodiments, the RSPF in this disclosure comprises the recombinant spider silk proteins having repeating peptide units derived from natural spider silk proteins such as Spidroin major 1 domain, Spidroin major 2 domain or Spidroin minor 1 domain, wherein the repeating peptide sequence is GSSAAAAAAAASGPGQGQGQGQGQGGRPSDTYG (SEQ ID NO: 47) or SAAAAAAAAGPGGGNGGRPSDTYGAPGGGNGGRPSSSYG (SEQ ID NO: 30), as described in U.S. Pat. No. 8,367,803, which is incorporated by reference herein in its entirety.

In some embodiments, this disclosure provides recombinant spider proteins composed of the GPGGAGPGGYGPGGSGPGGYGPGGSGPGGY (SEQ ID NO: 32) repetitive fragment and having a molecular weight as described herein.

As used herein, the term “recombinant silk” refers to recombinant spider and/or silkworm silk protein or fragments thereof. In an embodiment, the spider silk protein is selected from the group consisting of swathing silk (Achniform gland silk), egg sac silk (Cylindriform gland silk), egg case silk (Tubuliform silk), non-sticky dragline silk (Ampullate gland silk), attaching thread silk (Pyriform gland silk), sticky silk core fibers (Flagelliform gland silk), and sticky silk outer fibers (Aggregate gland silk). For example, recombinant spider silk protein, as described herein, includes the proteins described in U.S. Patent Application No. 2016/0222174 and U.S. Pat. Nos. 9,051,453, 9,617,315, 9,689,089, 8,173,772, and 8,642,734.

Some organisms make multiple silk fibers with unique sequences, structural elements, and mechanical properties. For example, orb weaving spiders have six unique types of glands that produce different silk polypeptide sequences that are polymerized into fibers tailored to fit an environmental or lifecycle niche. The fibers are named for the gland they originate from and the polypeptides are labeled with the gland abbreviation (e.g. “Ma”) and “Sp” for spidroin (short for spider fibroin). In orb weavers, these types include Major Ampullate (MaSp, also called dragline), Minor Ampullate (MiSp), Flagelliform (Flag), Aciniform (AcSp), Tubuliform (TuSp), and Pyriform (PySp). This combination of polypeptide sequences across fiber types, domains, and variation amongst different genus and species of organisms leads to a vast array of potential properties that can be harnessed by commercial production of the recombinant fibers. To date, the vast majority of the work with recombinant silks has focused on the Major Ampullate Spidroins (MaSp).

Aciniform (AcSp) silks tend to have high toughness, a result of moderately high strength coupled with moderately high extensibility. AcSp silks are characterized by large block (“ensemble repeat”) sizes that often incorporate motifs of poly serine and GPX. Tubuliform (TuSp or Cylindrical) silks tend to have large diameters, with modest strength and high extensibility. TuSp silks are characterized by their poly serine and poly threonine content, and short tracts of poly alanine. Major Ampullate (MaSp) silks tend to have high strength and modest extensibility. MaSp silks can be one of two subtypes: MaSp1 and MaSp2. MaSp1 silks are generally less extensible than MaSp2 silks, and are characterized by poly alanine, GX, and GGX motifs. MaSp2 silks are characterized by poly alanine, GGX, and GPX motifs. Minor Ampullate (MiSp) silks tend to have modest strength and modest extensibility. MiSp silks are characterized by GGX, GA, and poly A motifs, and often contain spacer elements of approximately 100 amino acids. Flagelliform (Flag) silks tend to have very high extensibility and modest strength. Flag silks are usually characterized by GPG, GGX, and short spacer motifs.

Silk polypeptides are characteristically composed of a repeat domain (REP) flanked by non-repetitive regions (e.g., C-terminal and N-terminal domains). In an embodiment, both the C-terminal and N-terminal domains are between 75-350 amino acids in length. The repeat domain exhibits a hierarchical architecture. The repeat domain comprises a series of blocks (also called repeat units). The blocks are repeated, sometimes perfectly and sometimes imperfectly (making up a quasi-repeat domain), throughout the silk repeat domain. The length and composition of blocks varies among different silk types and across different species. Table 1 of U.S. Published Application No. 2016/0222174, the entirety of which is incorporated herein, lists examples of block sequences from selected species and silk types, with further examples presented in Rising, A. et al., Spider silk proteins: recent advances in recombinant production, structure-function relationships and biomedical applications, Cell Mol. Life Sci., 68:2, pg 169-184 (2011); and Gatesy, J. et al., Extreme diversity, conservation, and convergence of spider silk fibroin sequences, Science, 291:5513, pg. 2603-2605 (2001). In some cases, blocks may be arranged in a regular pattern, forming larger macro-repeats that appear multiple times (usually 2-8) in the repeat domain of the silk sequence. Repeated blocks inside a repeat domain or macro-repeat, and repeated macro-repeats within the repeat domain, may be separated by spacing elements.

The construction of certain spider silk block copolymer polypeptides from the blocks and/or macro-repeat domains, according to certain embodiments of the disclosure, is illustrated in U.S. Published Patent Application No. 2016/0222174.

The recombinant block copolymer polypeptides based on spider silk sequences produced by gene expression in a recombinant prokaryotic or eukaryotic system can be purified according to methods known in the art. In a preferred embodiment, a commercially available expression/secretion system can be used, whereby the recombinant polypeptide is expressed and thereafter secreted from the host cell, to be easily purified from the surrounding medium. If expression/secretion vectors are not used, an alternative approach involves purifying the recombinant block copolymer polypeptide from cell lysates (remains of cells following disruption of cellular integrity) derived from prokaryotic or eukaryotic cells in which a polypeptide was expressed. Methods for generation of such cell lysates are known to those of skill in the art. In some embodiments, recombinant block copolymer polypeptides are isolated from cell culture supernatant.

Recombinant block copolymer polypeptide may be purified by affinity separation, such as by immunological interaction with antibodies that bind specifically to the recombinant polypeptide or nickel columns for isolation of recombinant polypeptides tagged with 6-8 histidine residues at their N-terminus or C-terminus Alternative tags may comprise the FLAG epitope or the hemagglutinin epitope. Such methods are commonly used by skilled practitioners.

A solution of such polypeptides (i.e., recombinant silk protein) may then be prepared and used as described herein.

In another embodiment, recombinant silk protein may be prepared according to the methods described in U.S. Pat. No. 8,642,734, the entirety of which is incorporated herein, and used as described herein.

In an embodiment, a recombinant spider silk protein is provided. The spider silk protein typically consists of from 170 to 760 amino acid residues, such as from 170 to 600 amino acid residues, preferably from 280 to 600 amino acid residues, such as from 300 to 400 amino acid residues, more preferably from 340 to 380 amino acid residues. The small size is advantageous because longer spider silk proteins tend to form amorphous aggregates, which require use of harsh solvents for solubilization and polymerization. The recombinant spider silk protein may contain more than 760 residues, in particular in cases where the spider silk protein contains more than two fragments derived from the N-terminal part of a spider silk protein, The spider silk protein comprises an N-terminal fragment consisting of at least one fragment (NT) derived from the corresponding part of a spider silk protein, and a repetitive fragment (REP) derived from the corresponding internal fragment of a spider silk protein. Optionally, the spider silk protein comprises a C-terminal fragment (CT) derived from the corresponding fragment of a spider silk protein. The spider silk protein comprises typically a single fragment (NT) derived from the N-terminal part of a spider silk protein, but in preferred embodiments, the N-terminal fragment include at least two, such as two fragments (NT) derived from the N-terminal part of a spider silk protein. Thus, the spidroin can schematically be represented by the formula NTm-REP, and alternatively NTm-REP-CT, where m is an integer that is 1 or higher, such as 2 or higher, preferably in the ranges of 1-2, 1-4, 1-6, 2-4 or 2-6. Preferred spidroins can schematically be represented by the formulas NT₂-REP or NT-REP, and alternatively NT₂-REP-CT or NT-REP-CT. The protein fragments are covalently coupled, typically via a peptide bond. In one embodiment, the spider silk protein consists of the NT fragment(s) coupled to the REP fragment, which REP fragment is optionally coupled to the CT fragment.

In one embodiment, the first step of the method of producing polymers of an isolated spider silk protein involves expression of a polynucleic acid molecule which encodes the spider silk protein in a suitable host, such as Escherichia coli. The thus obtained protein is isolated using standard procedures. Optionally, lipopolysaccharides and other pyrogens are actively removed at this stage.

In the second step of the method of producing polymers of an isolated spider silk protein, a solution of the spider silk protein in a liquid medium is provided. By the terms “soluble” and “in solution” is meant that the protein is not visibly aggregated and does not precipitate from the solvent at 60,000×g. The liquid medium can be any suitable medium, such as an aqueous medium, preferably a physiological medium, typically a buffered aqueous medium, such as a 10-50 mM Tris-HCl buffer or phosphate buffer. The liquid medium has a pH of 6.4 or higher and/or an ion composition that prevents polymerization of the spider silk protein. That is, the liquid medium has either a pH of 6.4 or higher or an ion composition that prevents polymerization of the spider silk protein, or both.

Ion compositions that prevent polymerization of the spider silk protein can readily be prepared by the skilled person utilizing the methods disclosed herein. A preferred ion composition that prevents polymerization of the spider silk protein has an ionic strength of more than 300 mM. Specific examples of ion compositions that prevent polymerization of the spider silk protein include above 300 mM NaCl, 100 mM phosphate and combinations of these ions having desired preventive effect on the polymerization of the spider silk protein, e.g. a combination of 10 mM phosphate and 300 mM NaCl.

The presence of an NT fragment improves the stability of the solution and prevents polymer formation under these conditions. This can be advantageous when immediate polymerization may be undesirable, e.g. during protein purification, in preparation of large batches, or when other conditions need to be optimized. It is preferred that the pH of the liquid medium is adjusted to 6.7 or higher, such as 7.0 or higher, or even 8.0 or higher, such as up to 10.5, to achieve high solubility of the spider silk protein. It can also be advantageous that the pH of the liquid medium is adjusted to the range of 6.4-6.8, which provides sufficient solubility of the spider silk protein but facilitates subsequent pH adjustment to 6.3 or lower.

In the third step, the properties of the liquid medium are adjusted to a pH of 6.3 or lower and ion composition that allows polymerization. That is, if the liquid medium wherein the spider silk protein is dissolved has a pH of 6.4 or higher, the pH is decreased to 6.3 or lower. The skilled person is well aware of various ways of achieving this, typically involving addition of a strong or weak acid. If the liquid medium wherein the spider silk protein is dissolved has an ion composition that prevents polymerization, the ion composition is changed so as to allow polymerization. The skilled person is well aware of various ways of achieving this, e.g. dilution, dialysis or gel filtration. If required, this step involves both decreasing the pH of the liquid medium to 6.3 or lower and changing the ion composition so as to allow polymerization. It is preferred that the pH of the liquid medium is adjusted to 6.2 or lower, such as 6.0 or lower. In particular, it may be advantageous from a practical point of view to limit the pH drop from 6.4 or 6.4-6.8 in the preceding step to 6.3 or 6.0-6.3, e.g. 6.2 in this step. In a preferred embodiment, the pH of the liquid medium of this step is 3 or higher, such as 4.2 or higher. The resulting pH range, e.g. 4.2-6.3 promotes rapid polymerization,

In the fourth step, the spider silk protein is allowed to polymerize in the liquid medium having pH of 6.3 or lower and an ion composition that allows polymerization of the spider silk protein. Although the presence of the NT fragment improves solubility of the spider silk protein at a pH of 6.4 or higher and/or an ion composition that prevents polymerization of the spider silk protein, it accelerates polymer formation at a pH of 6.3 or lower when the ion composition allows polymerization of the spider silk protein. The resulting polymers are preferably solid and macroscopic, and they are formed in the liquid medium having a pH of 6.3 or lower and an ion composition that allows polymerization of the spider silk protein. In a preferred embodiment, the pH of the liquid medium of this step is 3 or higher, such as 4.2 or higher. The resulting pH range, e.g. 4.2-6.3 promotes rapid polymerization, Resulting polymer may be provided at the molecular weights described herein and prepared as a solution form that may be used as necessary for article coatings.

Ion compositions that allow polymerization of the spider silk protein can readily be prepared by the skilled person utilizing the methods disclosed herein. A preferred ion composition that allows polymerization of the spider silk protein has an ionic strength of less than 300 mM. Specific examples of ion compositions that allow polymerization of the spider silk protein include 150 mM NaCl, 10 mM phosphate, 20 mM phosphate and combinations of these ions lacking preventive effect on the polymerization of the spider silk protein, e.g. a combination of 10 mM phosphate or 20 mM phosphate and 150 mM NaCl. It is preferred that the ionic strength of this liquid medium is adjusted to the range of 1-250 mM.

Without desiring to be limited to any specific theory, it is envisaged that the NT fragments have oppositely charged poles, and that environmental changes in pH affects the charge balance on the surface of the protein followed by polymerization, whereas salt inhibits the same event.

At neutral pH, the energetic cost of burying the excess negative charge of the acidic pole may be expected to prevent polymerization. However, as the dimer approaches its isoelectric point at lower pH, attractive electrostatic forces will eventually become dominant, explaining the observed salt and pH-dependent polymerization behavior of NT and NT-containing minispidroins. It is proposed that, in some embodiments, pH-induced NT polymerization, and increased efficiency of fiber assembly of NT-minispidroins, are due to surface electrostatic potential changes, and that clustering of acidic residues at one pole of NT shifts its charge balance such that the polymerization transition occurs at pH values of 6.3 or lower.

In a fifth step, the resulting, preferably solid spider silk protein polymers are isolated from said liquid medium. Optionally, this step involves actively removing lipopolysaccharides and other pyrogens from the spidroin polymers.

Without desiring to be limited to any specific theory, it has been observed that formation of spidroin polymers progresses via formation of water-soluble spidroin dimers. The present disclosure thus also provides a method of producing dimers of an isolated spider silk protein, wherein the first two method steps are as described above. The spider silk proteins are present as dimers in a liquid medium at a pH of 6.4 or higher and/or an ion composition that prevents polymerization of said spider silk protein. The third step involves isolating the dimers obtained in the second step, and optionally removal of lipopolysaccharides and other pyrogens. In a preferred embodiment, the spider silk protein polymer of the disclosure consists of polymerized protein dimers. The present disclosure thus provides a novel use of a spider silk protein, preferably those disclosed herein, for producing dimers of the spider silk protein.

According to another aspect, the disclosure provides a polymer of a spider silk protein as disclosed herein. In an embodiment, the polymer of this protein is obtainable by any one of the methods therefor according to the disclosure. Thus, the disclosure provides various uses of recombinant spider silk protein, preferably those disclosed herein, for producing polymers of the spider silk protein as recombinant silk based coatings. According to one embodiment, the present disclosure provides a novel use of a dimer of a spider silk protein, preferably those disclosed herein, for producing polymers of the isolated spider silk protein as recombinant silk based coatings. In these uses, it is preferred that the polymers are produced in a liquid medium having a pH of 6.3 or lower and an ion composition that allows polymerization of said spider silk protein. In an embodiment, the pH of the liquid medium is 3 or higher, such as 4.2 or higher. The resulting pH range, e.g. 4.2-6.3 promotes rapid polymerization,

Using the method(s) of the present disclosure, it is possible to control the polymerization process, and this allows for optimization of parameters for obtaining silk polymers with desirable properties and shapes.

In an embodiment, the recombinant silk proteins described herein, include those described in U.S. Pat. No. 8,642,734, the entirety of which is incorporated by reference.

In another embodiment, the recombinant silk proteins described herein may be prepared according to the methods described in U.S. Pat. No. 9,051,453, the entirety of which is incorporated herein by reference.

An amino acid sequence represented by SEQ ID NO: 52, which is also described in U.S. Pat. No. 9,051,453,is identical to an amino acid sequence that is composed of 50 amino acid residues of an amino acid sequence of ADF3 at the C-terminal (NCBI Accession No.: AAC47010, GI: 1263287). An amino acid sequence represented by SEQ ID NO: 53, which is also described in U.S. Pat. No. 9,051,453, is identical to an amino acid sequence represented by SEQ ID NO: 52, which is also described in U.S. Pat. No. 9,051,453, from which 20 residues have been removed from the C-terminal. An amino acid sequence represented by SEQ ID NO: 54, which is also described in U.S. Pat. No. 9,051,453, is identical to an amino acid sequence represented by SEQ ID NO: 52 from which 29 residues have been removed from the C-terminal.

An example of the polypeptide that contains units of the amino acid sequence represented by the formula 1: REP1-REP2 (1) and that has, at a C-terminal, an amino acid sequence represented by any of SEQ ID NOS: 52 to 54 or an amino acid sequence having a homology of 90% or more with the amino acid sequence represented by any of SEQ ID NOS: 52 to 54, which are also described in U.S. Pat. No. 9,051,453, is a polypeptide having an amino acid sequence represented by SEQ ID NO: 65, which is also described in U.S. Pat. No. 9,051,453, which is incorporated by reference herein in its entirety. The polypeptide having the amino acid sequence represented by SEQ ID NO: 65, which is also described in U.S. Pat. No. 9,051,453, is obtained by the following mutation: in an amino acid sequence of ADF3 (NCBI Accession No.: AAC47010, GI: 1263287) to the N-terminal of which has been added an amino acid sequence (SEQ ID NO: 66, which is also described in U.S. Pat. No. 9,051,453) composed of a start codon, His 10 tags and an HRV3C Protease (Human rhinovirus 3C Protease) recognition site, 1^{st} to 13^{th} repetitive regions are about doubled and the translation ends at the 1154^{th} amino acid residue. In the polypeptide having the amino acid sequence represented by SEQ ID NO: 65, which is also described in U.S. Pat. No. 9,051,453, the C-terminal sequence is identical to the amino acid sequence represented by SEQ ID NO: 54.

Further, the polypeptide that contains units of the amino acid sequence represented by the formula 1: REP1-REP2 (1) and that has, at a C-terminal, an amino acid sequence represented by any of SEQ ID NOS: 52 to 54, which are also described in U.S. Pat. No. 9,051,453, or an amino acid sequence having a homology of 90% or more with the amino acid sequence represented by any of SEQ ID NOS: 52 to 54, which are also described in U.S. Patent No. 9,051,453, may be a protein that has an amino acid sequence represented by SEQ ID NO: 65, which is also described in U.S. Pat. No. 9,051,453, in which one or a plurality of amino acids have been substituted, deleted, inserted and/or added and that has a repetitious region composed of a crystal region and an amorphous region.

Further, an example of the polypeptide containing two or more units of the amino acid sequence represented by the formula 1: REP1-REP2 (1) is a recombinant protein derived from ADF4 having an amino acid sequence represented by SEQ ID NO: 67, which is also described in U.S. Pat. No. 9,051,453, which is incorporated by reference herein in its entirety. The amino acid sequence represented by SEQ ID NO: 67, which is also described in U.S. Patent No. 9,051,453, is an amino acid sequence obtained by adding the amino acid sequence (SEQ ID NO: 66, which is also described in U.S. Pat. No. 9,051,453) composed of a start codon, His 10 tags and an HRV3C Protease (Human rhinovirus 3C Protease) recognition site, to the N-terminal of a partial amino acid sequence of ADF4 obtained from the NCBI database (NCBI Accession No.: AAC47011, GI: 1263289). Further, the polypeptide containing two or more units of the amino acid sequence represented by the formula 1: REP1-REP2 (1) may be a polypeptide that has an amino acid sequence represented by SEQ ID NO: 67, which is also described in U.S. Pat. No. 9,051,453, in which one or a plurality of amino acids have been substituted, deleted, inserted and/or added and that has a repetitious region composed of a crystal region and an amorphous region. Further, an example of the polypeptide containing two or more units of the amino acid sequence represented by the formula 1: REP1-REP2 (1) is a recombinant protein derived from MaSp2 that has an amino acid sequence represented by SEQ ID NO: 68, which is also described in of U.S. Pat. No. 9,051,453, which is incorporated by reference here in its entirety. The amino acid sequence represented by SEQ ID NO: 68, which is also described in of U.S. Pat. No. 9,051,453, is an amino acid sequence obtained by adding the amino acid sequence (SEQ ID NO: 66, which is also described in of U.S. Pat. No. 9,051,453,) composed of a start codon, His 10 tags and an HRV3C Protease (Human rhinovirus 3C Protease) recognition site, to the N-terminal of a partial sequence of MaSp2 obtained from the NCBI web database (NCBI Accession No.: AAT75313, GI: 50363147). Furthermore, the polypeptide containing two or more units of the amino acid sequence represented by the formula 1: REP1-REP2 (1) may be a polypeptide that has an amino acid sequence represented by SEQ ID NO: 68, which is also described in of U.S. Pat. No. 9,051,453, in which one or a plurality of amino acids have been substituted, deleted, inserted and/or added and that has a repetitious region composed of a crystal region and an amorphous region.

Examples of the polypeptide derived from flagelliform silk proteins include a polypeptide containing 10 or more units of an amino acid sequence represented by the formula 2: REP3 (2), preferably a polypeptide containing 20 or more units thereof, and more preferably a polypeptide containing 30 or more units thereof. In the case of producing a recombinant protein using a microbe such as Escherichia coli as a host, the molecular weight of the polypeptide derived from flagelliform silk proteins is preferably 500 kDa or less, more preferably 300 kDa or less, and further preferably 200 kDa or less, in terms of productivity.

In the formula (2), the REP 3 indicates an amino acid sequence composed of Gly-Pro-Gly-Gly-X (SEQ ID NO: 69), where X indicates an amino acid selected from the group consisting of Ala, Ser, Tyr and Val.

A major characteristic of the spider silk is that the flagelliform silk does not have a crystal region, but has a repetitious region composed of an amorphous region. Since the major dragline silk and the like have a repetitious region composed of a crystal region and an amorphous region, they are expected to have both high stress and stretchability. Meanwhile, as to the flagelliform silk, although the stress is inferior to that of the major dragline silk, the stretchability is high. The reason for this is considered to be that most of the flagelliform silk is composed of amorphous regions.

An example of the polypeptide containing 10 or more units of the amino acid sequence represented by the formula 2: REP3 (2) is a recombinant protein derived from flagelliform silk proteins having an amino acid sequence represented by SEQ ID NO: 70, which is also described in U.S. Pat. No. 9,051,453, which is incorporated by reference herein in its entirety. The amino acid sequence represented by SEQ ID NO: 70, which is also described in U.S. Pat. No. 9,051,453, is an amino acid sequence obtained by combining a partial sequence of flagelliform silk protein of Nephila clavipes obtained from the NCBI database (NCBI Accession No.: AAF36090, GI: 7106224), specifically, an amino acid sequence thereof from the 1220^{th} residue to the 1659^{th} residue from the N-terminal that corresponds to repetitive sections and motifs (referred to as a PR1 sequence), with a partial sequence of flagelliform silk protein of Nephila clavipes obtained from the NCBI database (NCBI Accession No.: AAC38847, GI: 2833649), specifically, a C-terminal amino acid sequence thereof from the 816^{th} residue to the 907^{th} residue from the C-terminal, and thereafter adding the amino acid sequence (SEQ ID NO: 66, which is also described in U.S. Pat. No. 9,051,453,) composed of a start codon, His 10 tags and an HRV3C Protease recognition site, to the N-terminal of the combined sequence. Further, the polypeptide containing 10 or more units of the amino acid sequence represented by the formula 2: REP3 (2) may be a polypeptide that has an amino acid sequence represented by SEQ ID NO: 70, which is also described in U.S. Pat. No. 9,051,453, in which one or a plurality of amino acids have been substituted, deleted, inserted and/or added and that has a repetitious region composed of an amorphous region.

The polypeptide can be produced using a host that has been transformed by an expression vector containing a gene encoding a polypeptide. A method for producing a gene is not limited particularly, and it may be produced by amplifying a gene encoding a natural spider silk protein from a cell derived from spiders by a polymerase chain reaction (PCR), etc., and cloning it, or may be synthesized chemically. Also, a method for chemically synthesizing a gene is not limited particularly, and it can be synthesized as follows, for example: based on information of amino acid sequences of natural spider silk proteins obtained from the NCBI web database, etc., oligonucleotides that have been synthesized automatically with AKTA oligopilot plus 10/100 (GE Healthcare Japan Corporation) are linked by PCR, etc. At this time, in order to facilitate the purification and observation of protein, it is possible to synthesize a gene that encodes a protein having an amino acid sequence of the above-described amino acid sequence to the N-terminal of which has been added an amino acid sequence composed of a start codon and His 10 tags.

Examples of the expression vector include a plasmid, a phage, a virus, and the like that can express protein based on a DNA sequence. The plasmid-type expression vector is not limited particularly as long as it allows a target gene to be expressed in a host cell and it can amplify itself. For example, in the case of using Escherichia coli Rosetta (DE3) as a host, a pET22b(+) plasmid vector, a pCold plasmid vector, and the like can be used. Among these, in terms of productivity of protein, it is preferable to use the pET22b(+) plasmid vector. Examples of the host include animal cells, plant cells, microbes, etc.

The polypeptide used in the present disclosure is preferably a polypeptide derived from ADF3, which is one of two principal dragline silk proteins of Araneus diadematus. This polypeptide has advantages of basically having high strength-elongation and toughness and of being synthesized easily.

Accordingly, the recombinant silk protein (e.g., the recombinant spider silk-based protein) used in accordance with the embodiments, articles, and/or methods described herein, may include one or more recombinant silk proteins described above or recited in U.S. Pat. Nos. 8,173,772, 8,278,416, 8,618,255, 8,642,734, 8,691,581, 8,729,235, 9,115,204, 9,157,070, 9,309,299, 9,644,012, 9,708,376, 9,051,453, 9,617,315, 9,968,682, 9,689,089, 9,732,125, 9,856,308, 9,926,348, 10,065,997, 10,316,069, and 10,329,332; and U.S. Patent Publication Nos. 2009/0226969, 2011/0281273, 2012/0041177, 2013/0065278, 2013/0115698, 2013/0316376, 2014/0058066, 2014/0079674, 2014/0245923, 2015/0087046, 2015/0119554, 2015/0141618, 2015/0291673, 2015/0291674, 2015/0239587, 2015/0344542, 2015/0361144, 2015/0374833, 2015/0376247, 2016/0024464, 2017/0066804, 2017/0066805, 2015/0293076, 2016/0222174, 2017/0283474, 2017/0088675, 2019/0135880, 2015/0329587, 2019/0040109, 2019/0135881, 2019/0177363, 2019/0225646, 2019/0233481, 2019/0031842, 2018/0355120, 2019/0186050, 2019/0002644, 2020/0031887, 2018/0273590, 20191/094403, 2019/0031843, 2018/0251501, 2017/0066805, 2018/0127553, 2019/0329526, 2020/0031886, 2018/0080147, 2019/0352349, 2020/0043085, 2019/0144819, 2019/0228449, 2019/0340666, 2020/0000091, 2019/0194710, 2019/0151505, 2018/0265555, 2019/0352330, 2019/0248847, and 2019/0378191, the entirety of which are incorporated herein by reference.

Silk Fibroin-like Protein Fragments

The recombinant silk protein in this disclosure comprises synthetic proteins which are based on repeat units of natural silk proteins. Besides the synthetic repetitive silk protein sequences, these can additionally comprise one or more natural nonrepetitive silk protein sequences. As used herein, “silk fibroin-like protein fragments” refer to protein fragments having a molecular weight and polydispersity as defined herein, and a certain degree of homology to a protein selected from native silk protein, fibroin heavy chain, fibroin light chain, or any protein comprising one or more GAGAGS (SEQ ID NO: 2) hexa amino acid repeating units. In some embodiments, a degree of homology is selected from about 99%, about 98%, about 97%, about 96%, about 95%, about 94%, about 93%, about 92%, about 91%, about 90%, about 89%, about 88%, about 87%, about 86%, about 85%, about 84%, about 83%, about 82%, about 81%, about 80%, about 79%, about 78%, about 77%, about 76%, about 75%, or less than 75%.

As described herein, a protein such as native silk protein, fibroin heavy chain, fibroin light chain, or any protein comprising one or more GAGAGS (SEQ ID NO: 2) hexa amino acid repeating units includes between about 9% and about 45% glycine, or about 9% glycine, or about 10% glycine, about 43% glycine, about 44% glycine, about 45% glycine, or about 46% glycine. As described herein, a protein such as native silk protein, fibroin heavy chain, fibroin light chain, or any protein comprising one or more GAGAGS (SEQ ID NO: 2) hexa amino acid repeating units includes between about 13% and about 30% alanine, or about 13% alanine, or about 28% alanine, or about 29% alanine, or about 30% alanine, or about 31% alanine. As described herein, a protein such as native silk protein, fibroin heavy chain, fibroin light chain, or any protein comprising one or more GAGAGS (SEQ ID NO: 2) hexa amino acid repeating units includes between 9% and about 12% serine, or about 9% serine, or about 10% serine, or about 11% serine, or about 12% serine.

In some embodiments, a silk fibroin-like protein described herein includes about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, or about 55% glycine. In some embodiments, a silk fibroin-like protein described herein includes about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, or about 39% alanine. In some embodiments, a silk fibroin-like protein described herein includes about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, or about 22% serine. In some embodiments, a silk fibroin-like protein described herein may include independently any amino acid known to be included in natural fibroin. In some embodiments, a silk fibroin-like protein described herein may exclude independently any amino acid known to be included in natural fibroin. In some embodiments, on average 2 out of 6 amino acids, 3 out of 6 amino acids, or 4 out of 6 amino acids in a silk fibroin-like protein described herein is glycine. In some embodiments, on average 1 out of 6 amino acids, 2 out of 6 amino acids, or 3 out of 6 amino acids in a silk fibroin-like protein described herein is alanine. In some embodiments, on average none out of 6 amino acids, 1 out of 6 amino acids, or 2 out of 6 amino acids in a silk fibroin-like protein described herein is serine.

Sericin or Sericin Fragments

The main body of the raw silk is silk fibroin fiber, and the silk fibroin fiber is coated with an adhesive substance silk sericin. Sericin is a colloidal silk protein that covers the surface of the silk thread and is composed of bulky amino acids rich in chemical reactivity such as serine, threonine, and aspartic acid, in addition to glycine and alanine. In the various processes of producing silk from raw silk, sericin is important in controlling the solubility of silk and producing high quality silk. Moreover, it plays an extremely important role as an adhesion functional protein. When silk fiber is used as a clothing material, most of the silk sericin covering the silk thread is removed and discarded, so sericin is a valuable unused resource.

In some embodiments, the silk protein fragments described herein include sericin or sericin fragments. Methods of preparing sericin or sericin fragments and their applications in various fields are known and are described herein , and are also described, for example, in U.S. Pat. Nos. 7,115,388, 7,157,273, and 9,187,538, all of which are incorporated by reference herein in their entireties.

In some embodiments, sericin removed from the raw silk cocoons, such as in a degumming step, can be collected and used in the methods described herein. Sericin can also be reconstituted from a powder, and used within the compositions and methods of the disclosure.

### Other Properties of SPF

Compositions of the present disclosure are “biocompatible” or otherwise exhibit “biocompatibility” meaning that the compositions are compatible with living tissue or a living system by not being toxic, injurious, or physiologically reactive and not causing immunological rejection or an inflammatory response. Such biocompatibility can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely. For example, in some embodiments, the coatings described herein are biocompatible coatings.

In some embodiments, compositions described herein, which may be biocompatible compositions (e.g., biocompatible coatings that include silk), may be evaluated and comply with International Standard ISO 10993-1, titled the “Biological evaluation of medical devices—Part 1: Evaluation and testing within a risk management process.” In some embodiments, compositions described herein, which may be biocompatible compositions, may be evaluated under ISO 106993-1 for one or more of cytotoxicity, sensitization, hemocompatibility, pyrogenicity, implantation, genotoxicity, carcinogenicity, reproductive and developmental toxicity, and degradation.

Compositions of the present disclosure are “hypoallergenic” meaning that they are relatively unlikely to cause an allergic reaction. Such hypoallergenicity can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely.

In an embodiment, the stability of a composition of the present disclosure is about 1 day. In an embodiment, the stability of a composition of the present disclosure is about 2 days. In an embodiment, the stability of a composition of the present disclosure is about 3 days. In an embodiment, the stability of a composition of the present disclosure is about 4 days. In an embodiment, the stability of a composition of the present disclosure is about 5 days. In an embodiment, the stability of a composition of the present disclosure is about 6 days. In an embodiment, the stability of a composition of the present disclosure is about 7 days. In an embodiment, the stability of a composition of the present disclosure is about 8 days. In an embodiment, the stability of a composition of the present disclosure is about 9 days. In an embodiment, the stability of a composition of the present disclosure is about 10 days.

In an embodiment, the stability of a composition of the present disclosure is about 11 days, about 12 days, about 13 days, about 14 days, about 15 days, about 16 days, about 17 days, about 18 days, about 19 days, about 20 days, about 21 days, about 22 days, about 23 days, about 24 days, about 25 days, about 26 days, about 27 days, about 28 days, about 29 days, or about 30 days.

In an embodiment, the stability of a composition of the present disclosure is 10 days to 6 months. In an embodiment, the stability of a composition of the present disclosure is 6 months to 12 months. In an embodiment, the stability of a composition of the present disclosure is 12 months to 18 months. In an embodiment, the stability of a composition of the present disclosure is 18 months to 24 months. In an embodiment, the stability of a composition of the present disclosure is 24 months to 30 months. In an embodiment, the stability of a composition of the present disclosure is 30 months to 36 months. In an embodiment, the stability of a composition of the present disclosure is 36 months to 48 months. In an embodiment, the stability of a composition of the present disclosure is 48 months to 60 months.

In an embodiment, a SPF composition of the present disclosure is not soluble in an aqueous solution due to the crystallinity of the protein. In an embodiment, a SPF composition of the present disclosure is soluble in an aqueous solution. In an embodiment, the SPF of a composition of the present disclosure include a crystalline portion of about two-thirds and an amorphous region of about one-third. In an embodiment, the SPF of a composition of the present disclosure include a crystalline portion of about one-half and an amorphous region of about one-half. In an embodiment, the SPF of a composition of the present disclosure include a 99% crystalline portion and a 1% amorphous region. In an embodiment, the SPF of a composition of the present disclosure include a 95% crystalline portion and a 5% amorphous region. In an embodiment, the SPF of a composition of the present disclosure include a 90% crystalline portion and a 10% amorphous region. In an embodiment, the SPF of a composition of the present disclosure include a 85% crystalline portion and a 15% amorphous region. In an embodiment, the SPF of a composition of the present disclosure include a 80% crystalline portion and a 20% amorphous region. In an embodiment, the SPF of a composition of the present disclosure include a 75% crystalline portion and a 25% amorphous region. In an embodiment, the SPF of a composition of the present disclosure include a 70% crystalline portion and a 30% amorphous region. In an embodiment, the SPF of a composition of the present disclosure include a 65% crystalline portion and a 35% amorphous region. In an embodiment, the SPF of a composition of the present disclosure include a 60% crystalline portion and a 40% amorphous region. In an embodiment, the SPF of a composition of the present disclosure include a 50% crystalline portion and a 50% amorphous region. In an embodiment, the SPF of a composition of the present disclosure include a 40% crystalline portion and a 60% amorphous region. In an embodiment, the SPF of a composition of the present disclosure include a 35% crystalline portion and a 65% amorphous region. In an embodiment, the SPF of a composition of the present disclosure include a 30% crystalline portion and a 70% amorphous region. In an embodiment, the SPF of a composition of the present disclosure include a 25% crystalline portion and a 75% amorphous region. In an embodiment, the SPF of a composition of the present disclosure include a 20% crystalline portion and a 80% amorphous region. In an embodiment, the SPF of a composition of the present disclosure include a 15% crystalline portion and a 85% amorphous region. In an embodiment, the SPF of a composition of the present disclosure include a 10% crystalline portion and a 90% amorphous region. In an embodiment, the SPF of a composition of the present disclosure include a 5% crystalline portion and a 90% amorphous region. In an embodiment, the SPF of a composition of the present disclosure include a 1% crystalline portion and a 99% amorphous region.

As used herein, the term “substantially free of inorganic residuals” means that the composition exhibits residuals of 0.1% (w/w) or less. In an embodiment, substantially free of inorganic residuals refers to a composition that exhibits residuals of 0.05% (w/w) or less. In an embodiment, substantially free of inorganic residuals refers to a composition that exhibits residuals of 0.01% (w/w) or less. In an embodiment, the amount of inorganic residuals is between 0 ppm (“non-detectable” or “ND”) and 1000 ppm. In an embodiment, the amount of inorganic residuals is ND to about 500 ppm. In an embodiment, the amount of inorganic residuals is ND to about 400 ppm. In an embodiment, the amount of inorganic residuals is ND to about 300 ppm. In an embodiment, the amount of inorganic residuals is ND to about 200 ppm. In an embodiment, the amount of inorganic residuals is ND to about 100 ppm. In an embodiment, the amount of inorganic residuals is between 10 ppm and 1000 ppm.

As used herein, the term “substantially free of organic residuals” means that the composition exhibits residuals of 0.1% (w/w) or less, in an embodiment, substantially free of organic residuals refers to a composition that exhibits residuals of 0.05% (w/w) or less. In an embodiment, substantially free of organic residuals refers to a composition that exhibits residuals of 0.01% (w/w) or less. In an embodiment, the amount of organic residuals is between 0 ppm (“non-detectable” or “ND”) and 1000 ppm. In an embodiment, the amount of organic residuals is ND to about 500 ppm. In an embodiment, the amount of organic residuals is ND to about 400 ppm. In an embodiment, the amount of organic residuals is ND to about 300 ppm. In an embodiment, the amount of organic residuals is ND to about 200 ppm. In an embodiment, the amount of organic residuals is ND to about 100 ppm. In an embodiment, the amount of organic residuals is between 10 ppm and 1000 ppm.

Compositions of the present disclosure exhibit “biocompatibility” meaning that the compositions are compatible with living tissue or a living system by not being toxic, injurious, or physiologically reactive and not causing immunological rejection. Such biocompatibility can be evidenced by participants topically applying compositions of the present disclosure on their skin for an extended period of time. In an embodiment, the extended period of time is about 3 days. In an embodiment, the extended period of time is about 7 days, in an embodiment, the extended period of time is about 14 days, in an embodiment, the extended period of time is about 21 days. In an embodiment, the extended period of time is about 30 days. In an embodiment, the extended period of time is selected from the group consisting of about I month, about 2 months, about 3 months, about 4 months, about 5 months, about 6 months, about 7 months, about 8 months, about 9 months, about 10 months, about 11 months, about 12 months, and indefinitely.

Compositions of the present disclosure are “hypoallergenic” meaning that they are relatively unlikely to cause an allergic reaction. Such hypoallergenicity can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely.

Following are non-limiting examples of suitable ranges for various parameters in and for preparation of the silk solutions of the present disclosure. The silk solutions of the present disclosure may include one or more, but not necessarily all, of these parameters and may be prepared using various combinations of ranges of such parameters.

In an embodiment, the percent SPF in the solution is less than 30.0 wt. %. In an embodiment, the percent SPF in the solution is less than 25.0 wt. %. In an embodiment, the percent SPF in the solution is less than 20.0 wt. %. In an embodiment, the percent SPF in the solution is less than 19.0 wt. %. In an embodiment, the percent SPF in the solution is less than 18.0 wt. %. In an embodiment, the percent SPF in the solution is less than 17.0 wt. %. In an embodiment, the percent SPF in the solution is less than 16.0 wt. %. In an embodiment, the percent SPF in the solution is less than 15.0 wt. %. In an embodiment, the percent SPF in the solution is less than 14.0 wt. %. In an embodiment, the percent SPF in the solution is less than 13.0 wt. %. In an embodiment, the percent SPF in the solution is less than 12.0 wt. %. In an embodiment, the percent SPF in the solution is less than 11.0 wt. %. In an embodiment, the percent SPF in the solution is less than 10.0 wt. %. In an embodiment, the percent SPF in the solution is less than 9.0 wt. %. In an embodiment, the percent SPF in the solution is less than 8.0 wt. %. In an embodiment, the percent SPF in the solution is less than 7.0 wt. %. In an embodiment, the percent SPF in the solution is less than 6.0 wt. %. In an embodiment, the percent SPF in the solution is less than 5.0 wt. %. In an embodiment, the percent SPF in the solution is less than 4.0 wt. %. In an embodiment, the percent SPF in the solution is less than 3.0 wt. %. In an embodiment, the percent SPF in the solution is less than 2.0 wt. %. In an embodiment, the percent SPF in the solution is less than 1.0 wt. %. In an embodiment, the percent SPF in the solution is less than 0.9 wt. %. In an embodiment, the percent SPF in the solution is less than 0.8 wt. %. In an embodiment, the percent SPF in the solution is less than 0.7 wt. %. In an embodiment, the percent SPF in the solution is less than 0.6 wt. %. In an embodiment, the percent SPF in the solution is less than 0.5 wt. %. In an embodiment, the percent SPF in the solution is less than 0.4 wt. %. In an embodiment, the percent SPF in the solution is less than 0.3 wt. %. In an embodiment, the percent SPF in the solution is less than 0.2 wt. %. In an embodiment, the percent SPF in the solution is less than 0.1 wt. %.

In an embodiment, the percent SPF in the solution is greater than 0.1 wt. %. In an embodiment, the percent SPF in the solution is greater than 0.2 wt. %. In an embodiment, the percent SPF in the solution is greater than 0.3 wt. %. In an embodiment, the percent SPF in the solution is greater than 0.4 wt. %. In an embodiment, the percent SPF in the solution is greater than 0.5 wt. %. In an embodiment, the percent SPF in the solution is greater than 0.6 wt. %. In an embodiment, the percent SPF in the solution is greater than 0.7 wt. %. In an embodiment, the percent SPF in the solution is greater than 0.8 wt. %. In an embodiment, the percent SPF in the solution is greater than 0.9 wt. %. In an embodiment, the percent SPF in the solution is greater than 1.0 wt. %. In an embodiment, the percent SPF in the solution is greater than 2.0 wt. %. In an embodiment, the percent SPF in the solution is greater than 3.0 wt. %. In an embodiment, the percent SPF in the solution is greater than 4.0 wt. %. In an embodiment, the percent SPF in the solution is greater than 5.0 wt. %. In an embodiment, the percent SPF in the solution is greater than 6.0 wt. %. In an embodiment, the percent SPF in the solution is greater than 7.0 wt. %. In an embodiment, the percent SPF in the solution is greater than 8.0 wt. %. In an embodiment, the percent SPF in the solution is greater than 9.0 wt. %. In an embodiment, the percent SPF in the solution is greater than 10.0 wt. %. In an embodiment, the percent SPF in the solution is greater than 11.0 wt. %. In an embodiment, the percent SPF in the solution is greater than 12.0 wt. %. In an embodiment, the percent SPF in the solution is greater than 13.0 wt. %. In an embodiment, the percent SPF in the solution is greater than 14.0 wt. %. In an embodiment, the percent SPF in the solution is greater than 15.0 wt. %. In an embodiment, the percent SPF in the solution is greater than 16.0 wt. %. In an embodiment, the percent SPF in the solution is greater than 17.0 wt. %. In an embodiment, the percent SPF in the solution is greater than 18.0 wt. %. In an embodiment, the percent SPF in the solution is greater than 19.0 wt. %. In an embodiment, the percent SPF in the solution is greater than 20.0 wt. %. In an embodiment, the percent SPF in the solution is greater than 25.0 wt. %.

In an embodiment, the percent SPF in the solution ranges from about 0.1 wt. % to about 30.0 wt. %. In an embodiment, the percent SPF in the solution ranges from about 0.1 wt. % to about 25.0 wt. %. In an embodiment, the percent SPF in the solution ranges from about 0.1 wt. % to about 20.0 wt. %. In an embodiment, the percent SPF in the solution ranges from about 0.1 wt. % to about 15.0 wt. %. In an embodiment, the percent SPF in the solution ranges from about 0.1 wt. % to about 10.0 wt. %. In an embodiment, the percent SPF in the solution ranges from about 0.1 wt. % to about 9.0 wt. %. In an embodiment, the percent SPF in the solution ranges from about 0.1 wt. % to about 8.0 wt. %. In an embodiment, the percent SPF in the solution ranges from about 0.1 wt. % to about 7.0 wt. %. In an embodiment, the percent SPF in the solution ranges from about 0.1 wt. % to about 6.5 wt. %. In an embodiment, the percent SPF in the solution ranges from about 0.1 wt. % to about 6.0 wt. %. In an embodiment, the percent SPF in the solution ranges from about 0.1 wt. % to about 5.5 wt. %. In an embodiment, the percent SPF in the solution ranges from about 0.1 wt. % to about 5.0 wt. %. In an embodiment, the percent SPF in the solution ranges from about 0.1 wt. % to about 4.5 wt. %. In an embodiment, the percent SPF in the solution ranges from about 0.1 wt. % to about 4.0 wt. %. In an embodiment, the percent SPF in the solution ranges from about 0.1 wt. % to about 3.5 wt. %. In an embodiment, the percent SPF in the solution ranges from about 0.1 wt. % to about 3.0 wt. %. In an embodiment, the percent SPF in the solution ranges from about 0.1 wt. % to about 2.5 wt. %. In an embodiment, the percent SPF in the solution ranges from about 0.1 wt. % to about 2.0 wt. %. In an embodiment, the percent SPF in the solution ranges from about 0.1 wt. % to about 2.4 wt. %. In an embodiment, the percent SPF in the solution ranges from about 0.5 wt. % to about 5.0 wt. %. In an embodiment, the percent SPF in the solution ranges from about 0.5 wt. % to about 4.5 wt. %. In an embodiment, the percent SPF in the solution ranges from about 0.5 wt. % to about 4.0 wt. %. In an embodiment, the percent SPF in the solution ranges from about 0.5 wt. % to about 3.5 wt. %. In an embodiment, the percent SPF in the solution ranges from about 0.5 wt. % to about 3.0 wt. %. In an embodiment, the percent SPF in the solution ranges from about 0.5 wt. % to about 2.5 wt. %. In an embodiment, the percent SPF in the solution ranges from about 1.0 wt. % to about 4.0 wt. %. In an embodiment, the percent SPF in the solution ranges from about 1.0 wt. % to about 3.5 wt. %. In an embodiment, the percent SPF in the solution ranges from about 1.0 wt. % to about 3.0 wt. %. In an embodiment, the percent SPF in the solution ranges from about 1.0 wt. % to about 2.5 wt. %. In an embodiment, the percent SPF in the solution ranges from about 1.0 wt. % to about 2.4 wt. %. In an embodiment, the percent SPF in the solution ranges from about 1.0 wt. % to about 2.0 wt. %.

In an embodiment, the percent SPF in the solution ranges from about 20.0 wt. % to about 30.0 wt. %. In an embodiment, the percent SPF in the solution ranges from about 0.1 wt. % to about 10.0 wt. %. In an embodiment, the percent SPF in the solution ranges from about 1.0 wt. % to about 10.0 wt. %. In an embodiment, the percent SPF in the solution ranges from about 2 wt. % to about 10.0 wt. %. In an embodiment, the percent SPF in the solution ranges from about 0.1 wt. % to about 6.0 wt. %. In an embodiment, the percent SPF in the solution ranges from about 6.0 wt. % to about 10.0 wt. %. In an embodiment, the percent SPF in the solution ranges from about 6.0 wt. % to about 8.0 wt. %. In an embodiment, the percent SPF in the solution ranges from about 6.0 wt. % to about 9.0 wt. %. In an embodiment, the percent SPF in the solution ranges from about 10.0 wt. % to about 20.0 wt. %. In an embodiment, the percent SPF in the solution ranges from about 11.0 wt. % to about 19.0 wt. %. In an embodiment, the percent SPF in the solution ranges from about 12.0 wt. % to about 18.0 wt. %. In an embodiment, the percent SPF in the solution ranges from about 13.0 wt. % to about 17.0 wt. %. In an embodiment, the percent SPF in the solution ranges from about 14.0 wt. % to about 16.0 wt. %. In an embodiment, the percent SPF in the solution is about 1.0 wt. %. In an embodiment, the percent SPF in the solution is about 1.5 wt. %. In an embodiment, the percent SPF in the solution is about 2.0 wt.%. In an embodiment, the percent SPF in the solution is about 2.4 wt. %. In an embodiment, the percent SPF in the solution is 3.0 wt. %. In an embodiment, the percent SPF in the solution is 3.5 wt. %. In an embodiment, the percent SPF in the solution is about 4.0 wt. %. In an embodiment, the percent SPF in the solution is about 4.5 wt. %. In an embodiment, the percent SPF in the solution is about 5.0 wt. %. In an embodiment, the percent SPF in the solution is about 5.5 wt. %. In an embodiment the percent SPF in the solution is about 6.0 wt. %. In an embodiment, the percent SPF in the solution is about 6.5 wt. %. In an embodiment, the percent SPF in the solution is about 7.0 wt. %. In an embodiment, the percent SPF in the solution is about 7.5 wt. %. In an embodiment, the percent SPF in the solution is about 8.0 wt. %. In an embodiment, the percent SPF in the solution is about 8.5 wt. %. In an embodiment, the percent SPF in the solution is about 9.0 wt. %. In an embodiment, the percent SPF in the solution is about 9.5 wt. %. In an embodiment, the percent SPF in the solution is about 10.0 wt. %.

In an embodiment, the percent sericin in the solution is non-detectable to 25.0 wt. %. In an embodiment, the percent sericin in the solution is non-detectable to 5.0 wt. %. In an embodiment, the percent sericin in the solution is 1.0 wt. %. In an embodiment, the percent sericin in the solution is 2.0 wt. %. In an embodiment, the percent sericin in the solution is 3.0 wt. %. In an embodiment, the percent sericin in the solution is 4.0 wt. %. In an embodiment, the percent sericin in the solution is 5.0 wt. %. In an embodiment, the percent sericin in the solution is 10.0 wt. %. In an embodiment, the percent sericin in the solution is 25.0 wt. %.

In some embodiments, the silk fibroin protein fragments of the present disclosure are shelf stable (they will not slowly or spontaneously gel when stored in an aqueous solution and there is no aggregation of fragments and therefore no increase in molecular weight over time), from 10 days to 3 years depending on storage conditions, percent SPF, and number of shipments and shipment conditions. Additionally, pH may be altered to extend shelf life and/or support shipping conditions by preventing premature folding and aggregation of the silk. In an embodiment, the stability of the LiBr-silk fragment solution is 0 to 1 year. In an embodiment, the stability of the LiBr-silk fragment solution is 0 to 2 years. In an embodiment, the stability of the LiBr-silk fragment solution is 0 to 3 years. In an embodiment, the stability of the LiBr-silk fragment solution is 0 to 4 years. In an embodiment, the stability of the LiBr-silk fragment solution is 0 to 5 years. In an embodiment, the stability of the LiBr-silk fragment solution is 1 to 2 years. In an embodiment, the stability of the LiBr-silk fragment solution is 1 to 3 years. In an embodiment, the stability of the LiBr-silk fragment solution is 1 to 4 years. In an embodiment, the stability of the LiBr-silk fragment solution is 1 to 5 years. In an embodiment, the stability of the LiBr-silk fragment solution is 2 to 3 years. In an embodiment, the stability of the LiBr-silk fragment solution is 2 to 4 years. In an embodiment, the stability of the LiBr-silk fragment solution is 2 to 5 years. In an embodiment, the stability of the LiBr-silk fragment solution is 3 to 4 years. In an embodiment, the stability of the LiBr-silk fragment solution is 3 to 5 years. In an embodiment, the stability of the LiBr-silk fragment solution is 4 to 5 years.

In an embodiment, the stability of a composition of the present disclosure is 10 days to 6 months. In an embodiment, the stability of a composition of the present disclosure is 6 months to 12 months. In an embodiment, the stability of a composition of the present disclosure is 12 months to 18 months. In an embodiment, the stability of a composition of the present disclosure is 18 months to 24 months. In an embodiment, the stability of a composition of the present disclosure is 24 months to 30 months. In an embodiment, the stability of a composition of the present disclosure is 30 months to 36 months. In an embodiment, the stability of a composition of the present disclosure is 36 months to 48 months. In an embodiment, the stability of a composition of the present disclosure is 48 months to 60 months.

In an embodiment, a composition of the present disclosure having SPF has non-detectable levels of LiBr residuals. In an embodiment, the amount of the LiBr residuals in a composition of the present disclosure is between 10 ppm and 1000 ppm. In an embodiment, the amount of the LiBr residuals in a composition of the present disclosure is between 10 ppm and 300 ppm. In an embodiment, the amount of the LiBr residuals in a composition of the present disclosure is less than 25 ppm. In an embodiment, the amount of the Li Br residuals in a composition of the present disclosure is less than 50 ppm. In an embodiment, the amount of the LiBr residuals in a composition of the present disclosure is less than 75 ppm. In an embodiment, the amount of the LiBr residuals in a composition of the present disclosure is less than 100 ppm. In an embodiment, the amount of the LiBr residuals in a composition of the present disclosure is less than 200 ppm. In an embodiment, the amount of the LiBr residuals in a composition of the present disclosure is less than 300 ppm. In an embodiment, the amount of the LiBr residuals in a composition of the present disclosure is less than 400 ppm. In an embodiment, the amount of the LiBr residuals in a composition of the present disclosure is less than 500 ppm. In an embodiment, the amount of the LiBr residuals in a composition of the present disclosure is less than 600 ppm. In an embodiment, the amount of the LiBr residuals in a composition of the present disclosure is less than 700 ppm. In an embodiment, the amount of the LiBr residuals in a composition of the present disclosure is less than 800 ppm. In an embodiment, the amount of the LiBr residuals in a composition of the present disclosure is less than 900 ppm. In an embodiment, the amount of the LiBr residuals in a composition of the present disclosure is less than 1000 ppm. In an embodiment, the amount of the LiBr residuals in a composition of the present disclosure is non-detectable to 500 ppm. In an embodiment, the amount of the LiBr residuals in a composition of the present disclosure is non-detectable to 450 ppm. In an embodiment, the amount of the LiBr residue in a composition of the present disclosure is non-detectable to 400 ppm. In an embodiment, the amount of the LiBr residuals in a composition of the present disclosure is non-detectable to 350 ppm. In an embodiment, the amount of the LiBr residuals in a composition of the present disclosure is non-detectable to 300 ppm. In an embodiment, the amount of the LiBr residuals in a composition of the present disclosure is non-detectable to 250 ppm. In an embodiment, the amount of the LiBr residuals in a composition of the present disclosure is non-detectable to 200 ppm. In an embodiment, the amount of the LiBr residuals in a composition of the present disclosure is non-detectable to 150 ppm. In an embodiment, the amount of the LiBr residuals in a composition of the present disclosure is non-detectable to 100 ppm. In an embodiment, the amount of the LiBr residuals in a composition of the present disclosure is 100 ppm to 200 ppm. In an embodiment, the amount of the LiBr residuals in a composition of the present disclosure is 200 ppm to 300 ppm. In an embodiment, the amount of the LiBr residuals in a composition of the present disclosure is 300 ppm to 400 ppm. In an embodiment, the amount of the LiBr residuals in a composition of the present disclosure is 400 ppm to 500 ppm.

In an embodiment, a composition of the present disclosure having SPF, has non-detectable levels of Na₂CO₃ residuals. In an embodiment, the amount of the Na₂CO₃ residuals in a composition of the present disclosure is less than 100 ppm. In an embodiment, the amount of the Na₂CO₃ residuals in a composition of the present disclosure is less than 200 ppm. In an embodiment, the amount of the Na₂CO₃ residuals in a composition of the present disclosure is less than 300 ppm. In an embodiment, the amount of the Na₂CO₃ residuals in a composition of the present disclosure is less than 400 ppm. In an embodiment, the amount of the Na₂CO₃ residuals in a composition of the present disclosure is less than 500 ppm. In an embodiment, the amount of the Na₂CO₃ residuals in a composition of the present disclosure is less than 600 ppm. In an embodiment, the amount of the Na₂CO₃ residuals in a composition of the present disclosure is less than 700 ppm. In an embodiment, the amount of the Na₂CO₃ residuals in a composition of the present disclosure is less than 800 ppm. In an embodiment, the amount of the Na₂CO₃ residuals in a composition of the present disclosure is less than 900 ppm. In an embodiment, the amount of the Na₂CO₃ residuals in a composition of the present disclosure is less than 1000 ppm. In an embodiment, the amount of the Na₂CO₃ residuals in a composition of the present disclosure is non-detectable to 500 ppm. In an embodiment, the amount of the Na₂CO₃ residuals in a composition of the present disclosure is non-detectable to 450 ppm. In an embodiment, the amount of the Na₂CO₃ residuals in a composition of the present disclosure is non-detectable to 400 ppm. In an embodiment, the amount of the Na₂CO₃ residuals in a composition of the present disclosure is non-detectable to 350 ppm. In an embodiment, the amount of the Na₂CO₃ residuals in a composition of the present disclosure is non-detectable to 300 ppm. In an embodiment, the amount of the Na₂CO₃ residuals in a composition of the present disclosure is non-detectable to 250 ppm. In an embodiment, the amount of the Na₂CO₃ residuals in a composition of the present disclosure is non-detectable to 200 ppm. In an embodiment, the amount of the Na₂CO₃ residuals in a composition of the present disclosure is non-detectable to 150 ppm. In an embodiment, the amount of the Na₂CO₃ residuals in a composition of the present disclosure is non-detectable to 100 ppm. In an embodiment, the amount of the Na₂CO₃ residuals in a composition of the present disclosure is 100 ppm to 200 ppm. In an embodiment, the amount of the Na₂CO₃ residuals in a composition of the present disclosure is 200 ppm to 300 ppm. In an embodiment, the amount of the Na₂CO₃ residuals in a composition of the present disclosure is 300 ppm to 400 ppm. In an embodiment, the amount of the Na₂CO₃ residuals in a composition of the present disclosure is 400 ppm to 500 ppm.

A unique feature of the SPF compositions of the present disclosure are shelf stability (they will not slowly or spontaneously gel when stored in an aqueous solution and there is no aggregation of fragments and therefore no increase in molecular weight over time), from 10 days to 3 years depending on storage conditions, percent silk, and number of shipments and shipment conditions. Additionally pH may be altered to extend shelf-life and/or support shipping conditions by preventing premature folding and aggregation of the silk. In an embodiment, a SPF solution composition of the present disclosure has a shelf stability for up to 2 weeks at room temperature (RT). In an embodiment, a SPF solution composition of the present disclosure has a shelf stability for up to 4 weeks at RT. In an embodiment, a SPF solution composition of the present disclosure has a shelf stability for up to 6 weeks at RT. In an embodiment, a SPF solution composition of the present disclosure has a shelf stability for up to 8 weeks at RT. In an embodiment, a SPF solution composition of the present disclosure has a shelf stability for up to 10 weeks at RT. In an embodiment, a SPF solution composition of the present disclosure has a shelf stability for up to 12 weeks at RT. In an embodiment, a SPF solution composition of the present disclosure has a shelf stability ranging from about 4 weeks to about 52 weeks at RT.

Table R below shows shelf stability test results for embodiments of SPF compositions of the present disclosure.

TABLE R
Shelf Stability of SPF Compositions of the Present Disclosure

| % Silk | Temperature | Time to Gelation | |
|---|---|---|---|
| 2 | RT | 4 | weeks |
| 2 | 4° C. | >9 | weeks |
| 4 | RT | 4 | weeks |
| 4 | 4° C. | >9 | weeks |
| 6 | RT | 2 | weeks |
| 6 | 4° C. | >9 | weeks |

In some embodiments, the water solubility of the silk film derived from silk fibroin protein fragments as described herein can be modified by solvent annealing (water annealing or methanol annealing), chemical crosslinking, enzyme crosslinking and heat treatment.

In some embodiments, the process of annealing may involve inducing beta-sheet formation in the silk fibroin protein fragment solutions used as a coating material. Techniques of annealing (e.g., increase crystallinity) or otherwise promoting “molecular packing” of silk fibroin-protein based fragments have been described. In some embodiments, the amorphous silk film is annealed to introduce beta-sheet in the presence of a solvent selected from the group of water or organic solvent. In some embodiments, the amorphous silk film is annealed to introduce beta-sheet in the presence of water (water annealing process). In some embodiments, the amorphous silk fibroin protein fragment film is annealed to introduce beta-sheet in the presence of methanol. In some embodiments, annealing (e.g., the beta sheet formation) is induced by addition of an organic solvent. Suitable organic solvents include, but are not limited to methanol, ethanol, acetone, isopropanol, or combination thereof.

In some embodiments, annealing is carried out by so-called “water-annealing” or “water vapor annealing” in which water vapor is used as an intermediate plasticizing agent or catalyst to promote the packing of beta-sheets. In some embodiments, the process of water annealing may be performed under vacuum. Suitable such methods have been described in Jin H-J et al. (2005), Water-stable Silk Films with Reduced Beta-Sheet Content, Advanced Functional Materials, 15: 1241-1247; Xiao H. et al. (2011), Regulation of Silk Material Structure by Temperature-Controlled Water Vapor Annealing, Biomacromolecules, 12(5): 1686-1696.

The important feature of the water annealing process is to drive the formation of crystalline beta-sheet in the silk fibroin protein fragment peptide chain to allow the silk fibroin self-assembling into a continuous film. In some embodiments, the crystallinity of the silk fibroin protein fragment film is controlled by controlling the temperature of water vapor and duration of the annealing. In some embodiments, the annealing is performed at a temperature ranging from about 65° C. to about 110° C. In some embodiments, the temperature of the water is maintained at about 80° C. In some embodiments, annealing is performed at a temperature selected from the group of about 65° C., about 70° C., about 75° C., about 80° C., about 85° C., about 90° C., about 95° C., about 100° C., about 105° C., and about 110° C.

In some embodiments, the annealing process lasts a period of time selected from the group of about 1 minute to about 40 minutes, about 1 minute to about 50 minutes, about 1 minute to about 60 minutes, about 1 minute to about 70 minutes, about 1 minute to about 80 minutes, about 1 minute to about 90 minutes, about 1 minute to about 100 minutes, about 1 minute to about 110 minutes, about 1 minute to about 120 minutes, about 1 minute to about 130 minutes, about 5 minutes to about 40 minutes, about 5 minutes to about 50 minutes, about 5 minutes to about 60 minutes, about 5 minutes to about 70 minutes, about 5 minutes to about 80 minutes, about 5 minutes to about 90 minutes, about 5 minutes to about 100 minutes, about 5 minutes to about 110 minutes, about 5 minutes to about 120 minutes, about 5 minutes to about 130 minutes, about 10 minutes to about 40 minutes, about 10 minutes to about 50 minutes, about 10 minutes to about 60 minutes, about 10 minutes to about 70 minutes, about 10 minutes to about 80 minutes, about 10 minutes to about 90 minutes, about 10 minutes to about 100 minutes, about 10 minutes to about 110 minutes, about 10 minutes to about 120 minutes, about 10 minutes to about 130 minutes, about 15 minutes to about 40 minutes, about 15 minutes to about 50 minutes, about 15 minutes to about 60 minutes, about 15 minutes to about 70 minutes, about 15 minutes to about 80 minutes, about 15 minutes to about 90 minutes, about 15 minutes to about 100 minutes, about 15 minutes to about 110 minutes, about 15 minutes to about 120 minutes, about 15 minutes to about 130 minutes, about 20 minutes to about 40 minutes, about 20 minutes to about 50 minutes, about 20 minutes to about 60 minutes, about 20 minutes to about 70 minutes, about 20 minutes to about 80 minutes, about 20 minutes to about 90 minutes, about 20 minutes to about 100 minutes, about 20 minutes to about 110 minutes, about 20 minutes to about 120 minutes, about 20 minutes to about 130 minutes, about 25 minutes to about 40 minutes, about 25 minutes to about 50 minutes, about 25 minutes to about 60 minutes, about 25 minutes to about 70 minutes, about 25 minutes to about 80 minutes, about 25 minutes to about 90 minutes, about 25 minutes to about 100 minutes, about 25 minutes to about 110 minutes, about 25 minutes to about 120 minutes, about 25 minutes to about 130 minutes, about 30 minutes to about 40 minutes, about 30 minutes to about 50 minutes, about 30 minutes to about 60 minutes, about 30 minutes to about 70 minutes, about 30 minutes to about 80 minutes, about 30 minutes to about 90 minutes, about 30 minutes to about 100 minutes, about 30 minutes to about 110 minutes, about 30 minutes to about 120 minutes, about 30 minutes to about 130 minutes, about 35 minutes to about 40 minutes, about 35 minutes to about 50 minutes, about 35 minutes to about 60 minutes, about 35 minutes to about 70 minutes, about 35 minutes to about 80 minutes, about 35 minutes to about 90 minutes, about 35 minutes to about 100 minutes, about 35 minutes to about 110 minutes, about 35 minutes to about 120 minutes, about 35 minutes to about 130 minutes, about 40 minutes to about 50 minutes, about 40 minutes to about 60 minutes, about 40 minutes to about 70 minutes, about 40 minutes to about 80 minutes, about 40 minutes to about 90 minutes, about 40 minutes to about 100 minutes, about 40 minutes to about 110 minutes, about 40 minutes to about 120 minutes, about 40 minutes to about 130 minutes, about 45 minutes to about 50 minutes, about 45 minutes to about 60 minutes, about 45 minutes to about 70 minutes, about 45 minutes to about 80 minutes, about 45 minutes to about 90 minutes, about 45 minutes to about 100 minutes, about 45 minutes to about 110 minutes, about 45 minutes to about 120 minutes, and about 45 minutes to about 130 minutes. In some embodiments, the annealing process lasts a period of time ranging from about 1 minute to about 60 minutes. In some embodiments, the annealing process lasts a period of time ranging from about 45 minutes to about 60 minutes. The longer water annealing post-processing corresponded an increased crystallinity of silk fibroin protein fragments.

In some embodiments, the annealed silk fibroin protein fragment film is immersing the wet silk fibroin protein fragment film in 100% methanol for 60 minutes at room temperature. The methanol annealing changed the composition of silk fibroin protein fragment film from predominantly amorphous random coil to crystalline antiparallel beta-sheet structure.

In some embodiments, the SPF as described herein can be used to prepare SPF microparticles by precipitation with methanol. Alternative flash drying, fluid-bed drying, spray drying or vacuum drying can be applied to remove water from the silk solution. The SPF powder can then be stored and handled without refrigeration or other special handling procedures. In some embodiments, the SPF powders comprise low molecular weight silk fibroin protein fragments. In some embodiments, the SPF powders comprise mid-molecular weight silk fibroin protein fragments. In some embodiments, the SPF powders comprise a mixture of low molecular weight silk fibroin protein fragments and mid-molecular weight silk fibroin protein fragment. Silk Fibroin Protein Fragment based Food Additive

Raw silk from Bombyx mori is composed of two primary proteins: silk fibroin (approximately 75%) and sericin (approximately 25%). Silk fibroin is a fibrous protein with a semi-crystalline structure that provides stiffness and strength. As used herein, the term “silk fibroin” means the fibers of the cocoon of Bombyx mori having a weight average molecular weight of about 370,000 Da.

Conversion of these insoluble silk fibroin fibrils into water-soluble silk fibroin protein fragments requires the addition of a concentrated neutral salt (e.g., 8-10 M lithium bromide), which interferes with inter- and intramolecular ionic and hydrogen bonding that would otherwise render the fibroin protein insoluble in water. Methods of making silk fibroin fragments, and/or compositions thereof, are known and are described for example in U.S. Patent Application Publication Nos. 20200188269, 20200188268, 20190336431, 20190380944, 20190070089, 20190070088, 20160022563, 20160022562, 20160022561, 20160022560, 20160022559, 20160193130, 20150094269, 20150093340, 20190211498, 20190309467, 20190003113, 20160281294, and 20160222579, and U.S. Pat. Nos. 9,187,538, 9,511,012, 9,517,191, 9,522,107, 9,522,108, 9,545,369, 10,166,177, 10,610,478, 10,588,843, 10,287,728, and 10,301,768, all of which are incorporated by reference herein in their entireties.

In an embodiment, silk protein fragment (SPF) mixture solutions are obtained by dissolving raw unscoured, partially scoured, or scoured silkworm fibers with a neutral lithium bromide salt. The raw silkworm silks are processed under selected temperature and other conditions in order to remove any sericin and achieve the desired weight average molecular weight (Mw) and polydispersity (PD) of the fragment mixture. Select process parameters may be altered to achieve distinct final silk protein fragment characteristics depending upon the intended use. The resulting final fragment solution is silk fibroin protein fragments and water with parts per million (ppm) to non-detectable levels of process contaminants, levels acceptable in the pharmaceutical, medical and consumer cosmetic markets. The concentration, size and polydispersity of silk fibroin protein fragments in the solution may further be altered depending upon the desired use and performance requirements.

In some embodiments, silk solutions used to fabricate various compositions of the present disclosure contain the heavy chain of fibroin, but are essentially free of other proteins. In some embodiments, silk solutions used to fabricate various compositions of the present disclosure contain both the heavy and light chains of fibroin, but are essentially free of other proteins.

In some embodiments, silk solutions used to fabricate various compositions comprises chains of silk fibroin fragments crosslinked via disulfide bond. In some embodiments, the silk solution comprising the chains of silk fibroin fragments linked via at least one disulfide bond. In some embodiments, the silk solution comprising the chains of silk fibroin fragments linked via one, two, three or more disulfide bonds.

In an embodiment, silk protein fragment solutions useful for applications as additive in food or beverage products are prepared according to the following steps: forming pieces of silk cocoons from the Bombyx mori silkworm; extracting the pieces at about 100° C. in a Na₂CO₃ water solution for about 60 minutes, wherein a volume of the water equals about 0.4× raw silk weight and the amount of Na₂CO₃ is about 0.848× the weight of the pieces to form a silk fibroin extract; triple rinsing the silk fibroin extract at about 60° C. for about 20 minutes per rinse in a volume of rinse water, wherein the rinse water for each cycle equals about 0.2L× the weight of the pieces; removing excess water from the silk fibroin extract; drying the silk fibroin extract; dissolving the dry silk fibroin extract in a LiBr solution, wherein the LiBr solution is first heated to about 100° C. to create a silk and LiBr solution and maintained; placing the silk and LiBr solution in a dry oven at about 100° C. for about 60 minutes to achieve complete dissolution and further fragmentation of the native silk protein structure into mixture with desired molecular weight and polydispersity; filtering the solution to remove any remaining debris from the silkworm; diluting the solution with water to result in a 1.0 wt. % silk solution; and removing solvent from the solution using Tangential Flow Filtration (TFF). In an embodiment, a 10 kDa membrane is utilized to purify the silk solution and create the final desired silk-to-water ratio. TFF can then be used to further concentrate the silk solution to a concentration of 2.0 wt. % silk in water.

Without wishing to be bound by any particular theory, varying extraction (i.e., time and temperature), LiBr (i.e., temperature of LiBr solution when added to silk fibroin extract or vice versa) and dissolution (i.e., time and temperature) parameters results in solvent and silk solutions with different viscosities, homogeneities, and colors. Also without wishing to be bound by any particular theory, increasing the temperature for extraction, lengthening the extraction time, using a higher temperature LiBr solution at emersion and over time when dissolving the silk and increasing the time at temperature (e.g., in an oven as shown here, or an alternative heat source) all resulted in less viscous and more homogeneous solvent and silk solutions.

In an embodiment, solutions of silk fibroin-based protein fragments having a weight average ranging from about 6 kDa to about 17 kDa are prepared according to following steps: degumming a silk source by adding the silk source to a boiling (100° C.) aqueous solution of sodium carbonate for a treatment time of between about 30 minutes to about 60 minutes; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 60° C. to about 140° C.; maintaining the solution of silk fibroin-lithium bromide in an oven having a temperature of about 140° C. for a period of at least 1 hour; removing the lithium bromide from the silk fibroin extract; and producing an aqueous solution of silk protein fragments, the aqueous solution comprising: fragments having a weight average molecular weight ranging from about 6 kDa to about 17 kDa, and wherein the aqueous solution of silk fibroin-based protein fragments comprises a polydispersity of between about 1.5 and about 3.0. The method may further comprise drying the silk fibroin extract prior to the dissolving step. The aqueous solution of silk fibroin-based protein fragments may comprise lithium bromide residuals of less than 300 ppm as measured using a high-performance liquid chromatography lithium bromide assay. The aqueous solution of silk fibroin-based protein fragments may comprise sodium carbonate residuals of less than 100 ppm as measured using a high-performance liquid chromatography sodium carbonate assay. The aqueous solution of silk fibroin-based protein fragments may be lyophilized. In some embodiments, the silk fibroin protein fragment solution may be further processed into various forms including gel, powder, and nanofiber.

In an embodiment, solutions of silk fibroin-based protein fragments having a weight average molecular weight ranging from about 17 kDa to about 39 kDa are prepared according to the following steps: adding a silk source to a boiling (100° C.) aqueous solution of sodium carbonate for a treatment time of between about 30 minutes to about 60 minutes so as to result in degumming; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 80° C. to about 140° C.; maintaining the solution of silk fibroin-lithium bromide in a dry oven having a temperature in the range between about 60° C. to about 100° C. for a period of at least 1 hour; removing the lithium bromide from the silk fibroin extract; and producing an aqueous solution of silk fibroin-based protein fragments, wherein the aqueous solution of silk fibroin-based protein fragments comprises lithium bromide residuals of between about 10 ppm and about 300 ppm, wherein the aqueous solution of silk protein fragments comprises sodium carbonate residuals of between about 10 ppm and about 100 ppm, wherein the aqueous solution of silk fibroin-based protein fragments comprises fragments having a weight average molecular weight ranging from about 17 kDa to about 39 kDa, and wherein the aqueous solution of silk fibroin-based protein fragments comprises a polydispersity of between about 1.5 and about 3.0. The method may further comprise drying the silk fibroin extract prior to the dissolving step. The aqueous solution of silk fibroin-based protein fragments may comprise lithium bromide residuals of less than 300 ppm as measured using a high- performance liquid chromatography lithium bromide assay. The aqueous solution of silk fibroin-based protein fragments may comprise sodium carbonate residuals of less than 100 ppm as measured using a high-performance liquid chromatography sodium carbonate assay.

In an embodiment, solutions of silk fibroin-based protein fragments having a weight average molecular weight ranging from about 39 kDa to about 80 kDa are prepared according to the following steps: adding a silk source to a boiling (100° C.) aqueous solution of sodium carbonate for a treatment time of about 30 minutes so as to result in degumming; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 80° C. to about 140° C.; maintaining the solution of silk fibroin-lithium bromide in a dry oven having a temperature in the range between about 60° C. to about 100° C. for a period of at least 1 hour; removing the lithium bromide from the silk fibroin extract; and producing an aqueous solution of silk fibroin-based protein fragments, wherein the aqueous solution of silk fibroin-based protein fragments comprises lithium bromide residuals of between about 10 ppm and about 300 ppm, sodium carbonate residuals of between about 10 ppm and about 100 ppm, fragments having a weight average molecular weight ranging from about 39 kDa to about 80 kDa, and wherein the aqueous solution of silk fibroin-based protein fragments comprises a polydispersity of between about 1.5 and about 3.0. The method may further comprise drying the silk fibroin extract prior to the dissolving step. The aqueous solution of silk fibroin-based protein fragments may comprise lithium bromide residuals of less than 300 ppm as measured using a high-performance liquid chromatography lithium bromide assay. The aqueous solution of silk fibroin-based protein fragments may comprise sodium carbonate residuals of less than 100 ppm as measured using a high-performance liquid chromatography sodium carbonate assay.

In an embodiment, the silk fibroin-based protein fragments in the solution are substantially devoid of sericin, have a weight average molecular weight ranging from about 6 kDa to about 17 kDa, and have a polydispersity ranging from about 1.5 and about 3.0. In an embodiment, the silk fibroin-based protein fragments in the solution are substantially devoid of sericin, have a weight average molecular weight ranging from about 17 kDa to about 39 kDa, and have a polydispersity ranging from about 1.5 and about 3.0. In an embodiment, the silk fibroin-based protein fragments in the solution are substantially devoid of sericin, have a weight average molecular weight ranging from about 39 kDa to about 80 kDa, and have a polydispersity ranging from about 1.5 and about 3.0.

As used herein, the terms “substantially sericin free” or “substantially devoid of sericin” refer to silk fibers in which a majority of the sericin protein has been removed. In an embodiment, silk fibroin that is substantially devoid of sericin refers to silk fibroin having from about 0.01 wt. % to about 10.0 wt. % sericin. In an embodiment, silk fibroin that is substantially devoid of sericin refers to silk fibroin having about 0.01 wt. % to about 9.0 wt. % sericin. In an embodiment, silk fibroin that is substantially devoid of sericin refers to silk fibroin having from about 0.01 wt. % to about 8.0 wt. % sericin. In an embodiment, silk fibroin that is substantially devoid of sericin refers to silk fibroin having from about 0.01 wt. % to about 7.0 wt. % sericin. In an embodiment, silk fibroin that is substantially devoid of sericin refers to silk fibroin having from about 0.01 wt. % to about 6.0 wt. % sericin. In an embodiment, silk fibroin that is substantially devoid of sericin refers to silk fibroin having from about 0.01 wt. % to about 5.0 wt. % sericin. In an embodiment, silk fibroin that is substantially devoid of sericin refers to silk fibroin having from about 0 wt. % to about 4.0 wt. % sericin. In an embodiment, silk fibroin that is substantially devoid of sericin refers to silk fibroin having from about 0.05 wt. % to about 4.0 wt. % sericin. In an embodiment, silk fibroin that is substantially devoid of sericin refers to silk fibroin having from about 0.1 wt. % to about 4.0 wt. % sericin. In an embodiment, silk fibroin that is substantially devoid of sericin refers to silk fibroin having from about 0.5 wt. % to about 4.0 wt. % sericin. In an embodiment, silk fibroin that is substantially devoid of sericin refers to silk fibroin having from about 1.0 wt. % to about 4.0 wt. % sericin. In an embodiment, silk fibroin that is substantially devoid of sericin refers to silk fibroin having from about 1.5 wt. % to about 4.0 wt. % sericin. In an embodiment, silk fibroin that is substantially devoid of sericin refers to silk fibroin having from about 2.0 wt. % to about 4.0 wt. % sericin. In an embodiment, silk fibroin that is substantially devoid of sericin refers to silk fibroin having from about 2.5 wt. % to about 4.0 wt. % sericin. In an embodiment, silk fibroin that is substantially devoid of sericin refers to silk fibroin having a sericin content from about 0.01 wt. % to about 0.1 wt. %. In an embodiment, silk fibroin that is substantially devoid of sericin refers to silk fibroin having a sericin content below about 0.1 wt. %. In an embodiment, silk fibroin that is substantially devoid of sericin refers to silk fibroin having a sericin content below about 0.05 wt. %. In an embodiment, when a silk source is added to a boiling (100° C.) aqueous solution of sodium carbonate for a treatment time of between about 30 minutes to about 60 minutes, a degumming loss of about 26.0 wt. % to about 31.0 wt. % is obtained.

Following are non-limiting examples of suitable ranges for various parameters in and for preparation of the silk solutions of the present disclosure. The silk solutions of the present disclosure may include one or more, but not necessarily all, of these parameters and may be prepared using various combinations of ranges of such parameters.

In an embodiment, the percent silk in the solution is less than 30.0 wt. %. In an embodiment, the percent silk in the solution is less than 25.0 wt. %. In an embodiment, the percent silk in the solution is less than 20.0 wt. %. In an embodiment, the percent silk in the solution is less than 19.0 wt. %. In an embodiment, the percent silk in the solution is less than 18.0 wt. %. In an embodiment, the percent silk in the solution is less than 17.0 wt. %. In an embodiment, the percent silk in the solution is less than 16.0 wt. %. In an embodiment, the percent silk in the solution is less than 15.0 wt. %. In an embodiment, the percent silk in the solution is less than 14.0 wt. %. In an embodiment, the percent silk in the solution is less than 13.0 wt. %. In an embodiment, the percent silk in the solution is less than 12.0 wt. %. In an embodiment, the percent silk in the solution is less than 11.0 wt. %. In an embodiment, the percent silk in the solution is less than 10.0 wt. %. In an embodiment, the percent silk in the solution is less than 9.0 wt. %. In an embodiment, the percent silk in the solution is less than 8.0 wt. %. In an embodiment, the percent silk in the solution is less than 7.0 wt. %. In an embodiment, the percent silk in the solution is less than 6.0 wt. %. In an embodiment, the percent silk in the solution is less than 5.0 wt. %. In an embodiment, the percent silk in the solution is less than 4.0 wt. %. In an embodiment, the percent silk in the solution is less than 3.0 wt. %. In an embodiment, the percent silk in the solution is less than 2.0 wt. %. In an embodiment, the percent silk in the solution is less than 1.0 wt. %. In an embodiment, the percent silk in the solution is less than 0.9 wt. %. In an embodiment, the percent silk in the solution is less than 0.8 wt. %. In an embodiment, the percent silk in the solution is less than 0.7 wt. %. In an embodiment, the percent silk in the solution is less than 0.6 wt. %. In an embodiment, the percent silk in the solution is less than 0.5 wt. %. In an embodiment, the percent silk in the solution is less than 0.4 wt. %. In an embodiment, the percent silk in the solution is less than 0.3 wt. %. In an embodiment, the percent silk in the solution is less than 0.2 wt. %. In an embodiment, the percent silk in the solution is less than 0.1 wt. %.

In an embodiment, the percent silk in the solution is greater than 0.1 wt. %. In an embodiment, the percent silk in the solution is greater than 0.2 wt. %. In an embodiment, the percent silk in the solution is greater than 0.3 wt. %. In an embodiment, the percent silk in the solution is greater than 0.4 wt. %. In an embodiment, the percent silk in the solution is greater than 0.5 wt. %. In an embodiment, the percent silk in the solution is greater than 0.6 wt. %. In an embodiment, the percent silk in the solution is greater than 0.7 wt. %. In an embodiment, the percent silk in the solution is greater than 0.8 wt. %. In an embodiment, the percent silk in the solution is greater than 0.9 wt. %. In an embodiment, the percent silk in the solution is greater than 1.0 wt. %. In an embodiment, the percent silk in the solution is greater than 2.0 wt. %. In an embodiment, the percent silk in the solution is greater than 3.0 wt. %. In an embodiment, the percent silk in the solution is greater than 4.0 wt. %. In an embodiment, the percent silk in the solution is greater than 5.0 wt. %. In an embodiment, the percent silk in the solution is greater than 6.0 wt. %. In an embodiment, the percent silk in the solution is greater than 7.0 wt. %. In an embodiment, the percent silk in the solution is greater than 8.0 wt. %. In an embodiment, the percent silk in the solution is greater than 9.0 wt. %. In an embodiment, the percent silk in the solution is greater than 10.0 wt. %. In an embodiment, the percent silk in the solution is greater than 11.0 wt. %. In an embodiment, the percent silk in the solution is greater than 12.0 wt. %. In an embodiment, the percent silk in the solution is greater than 13.0 wt. %. In an embodiment, the percent silk in the solution is greater than 14.0 wt. %. In an embodiment, the percent silk in the solution is greater than 15.0 wt. %. In an embodiment, the percent silk in the solution is greater than 16.0 wt. %. In an embodiment, the percent silk in the solution is greater than 17.0 wt. %. In an embodiment, the percent silk in the solution is greater than 18.0 wt. %. In an embodiment, the percent silk in the solution is greater than 19.0 wt. %. In an embodiment, the percent silk in the solution is greater than 20.0 wt. %. In an embodiment, the percent silk in the solution is greater than 25.0 wt. %.

In an embodiment, the percent silk in the solution ranges from about 0.1 wt. % to about 30.0 wt. %. In an embodiment, the percent silk in the solution ranges from about 0.1 wt. % to about 25.0 wt. %. In an embodiment, the percent silk in the solution ranges from about 0.1 wt. % to about 20.0 wt. %. In an embodiment, the percent silk in the solution ranges from about 0.1 wt. % to about 15.0 wt. %. In an embodiment, the percent silk in the solution ranges from about 0.1 wt. % to about 10.0 wt. %. In an embodiment, the percent silk in the solution ranges from about 0.1 wt. % to about 9.0 wt. %. In an embodiment, the percent silk in the solution ranges from about 0.1 wt. % to about 8.0 wt. %. In an embodiment, the percent silk in the solution ranges from about 0.1 wt. % to about 7.0 wt. %. In an embodiment, the percent silk in the solution ranges from about 0.1 wt. % to about 6.5 wt. %. In an embodiment, the percent silk in the solution ranges from about 0.1 wt. % to about 6.0 wt. %. In an embodiment, the percent silk in the solution ranges from about 0.1 wt. % to about 5.5 wt. %. In an embodiment, the percent silk in the solution ranges from about 0.1 wt. % to about 5.0 wt. %. In an embodiment, the percent silk in the solution ranges from about 0.1 wt. % to about 4.5 wt. %. In an embodiment, the percent silk in the solution ranges from about 0.1 wt. % to about 4.0 wt. %. In an embodiment, the percent silk in the solution ranges from about 0.1 wt. % to about 3.5 wt. %. In an embodiment, the percent silk in the solution ranges from about 0.1 wt. % to about 3.0 wt. %. In an embodiment, the percent silk in the solution ranges from about 0.1 wt. % to about 2.5 wt. %. In an embodiment, the percent silk in the solution ranges from about 0.1 wt. % to about 2.0 wt. %. In an embodiment, the percent silk in the solution ranges from about 0.1 wt. % to about 2.4 wt. %. In an embodiment, the percent silk in the solution ranges from about 0.5 wt. % to about 5.0 wt. %. In an embodiment, the percent silk in the solution ranges from about 0.5 wt. % to about 4.5 wt. %. In an embodiment, the percent silk in the solution ranges from about 0.5 wt. % to about 4.0 wt. %. In an embodiment, the percent silk in the solution ranges from about 0.5 wt. % to about 3.5 wt. %. In an embodiment, the percent silk in the solution ranges from about 0.5 wt. % to about 3.0 wt. %. In an embodiment, the percent silk in the solution ranges from about 0.5 wt. % to about 2.5 wt. %. In an embodiment, the percent silk in the solution ranges from about 1.0 wt. % to about 4.0 wt. %. In an embodiment, the percent silk in the solution ranges from about 1.0 wt. % to about 3.5 wt. %. In an embodiment, the percent silk in the solution ranges from about 1.0 wt. % to about 3.0 wt. %. In an embodiment, the percent silk in the solution ranges from about 1.0 wt. % to about 2.5 wt. %. In an embodiment, the percent silk in the solution ranges from about 1.0 wt. % to about 2.4 wt. %. In an embodiment, the percent silk in the solution ranges from about 1.0 wt. % to about 2.0 wt. %.

In an embodiment, the percent silk in the solution ranges from about 20.0 wt. % to about 30.0 wt. %. In an embodiment, the percent silk in the solution ranges from about 0.1 wt. % to about 10.0 wt. %. In an embodiment, the percent silk in the solution ranges from about 1.0 wt. % to about 10.0 wt. %. In an embodiment, the percent silk in the solution ranges from about 2 wt. % to about 10.0 wt. %. In an embodiment, the percent silk in the solution ranges from about 0.1 wt. % to about 6.0 wt. %. In an embodiment, the percent silk in the solution ranges from about 6.0 wt. % to about 10.0 wt. %. In an embodiment, the percent silk in the solution ranges from about 6.0 wt. % to about 8.0 wt. %. In an embodiment, the percent silk in the solution ranges from about 6.0 wt. % to about 9.0 wt. %. In an embodiment, the percent silk in the solution ranges from about 10.0 wt. % to about 20.0 wt. %. In an embodiment, the percent silk in the solution ranges from about 11.0 wt. % to about 19.0 wt. %. In an embodiment, the percent silk in the solution ranges from about 12.0 wt. % to about 18.0 wt. %. In an embodiment, the percent silk in the solution ranges from about 13.0 wt. % to about 17.0 wt. %. In an embodiment, the percent silk in the solution ranges from about 14.0 wt. % to about 16.0 wt. %. In an embodiment, the percent silk in the solution is about 1.0 wt. %. In an embodiment, the percent silk in the solution is about 1.5 wt. %. In an embodiment, the percent silk in the solution is about 2.0 wt.%. In an embodiment, the percent silk in the solution is about 2.4 wt. %. In an embodiment, the percent silk in the solution is 3.0 wt. %. In an embodiment, the percent silk in the solution is 3.5 wt. %. In an embodiment, the percent silk in the solution is about 4.0 wt. %. In an embodiment, the percent silk in the solution is about 4.5 wt. %. In an embodiment, the percent silk in the solution is about 5.0 wt. %. In an embodiment, the percent silk in the solution is about 5.5 wt. %. In an embodiment the percent silk in the solution is about 6.0 wt. %. In an embodiment, the percent silk in the solution is about 6.5 wt. %. In an embodiment, the percent silk in the solution is about 7.0 wt. %. In an embodiment, the percent silk in the solution is about 7.5 wt. %. In an embodiment, the percent silk in the solution is about 8.0 wt. %. In an embodiment, the percent silk in the solution is about 8.5 wt. %. In an embodiment, the percent silk in the solution is about 9.0 wt. %. In an embodiment, the percent silk in the solution is about 9.5 wt. %. In an embodiment, the percent silk in the solution is about 10.0 wt. %.

In an embodiment, the percent sericin in the solution is non-detectable to 30.0 wt. %. In an embodiment, the percent sericin in the solution is non-detectable to 5.0 wt. %. In an embodiment, the percent sericin in the solution is 1.0 wt. %. In an embodiment, the percent sericin in the solution is 2.0 wt. %. In an embodiment, the percent sericin in the solution is 3.0 wt. %. In an embodiment, the percent sericin in the solution is 4.0 wt. %. In an embodiment, the percent sericin in the solution is 5.0 wt. %. In an embodiment, the percent sericin in the solution is 10.0 wt. %. In an embodiment, the percent sericin in the solution is 30.0 wt. %.

In some embodiments, the silk fibroin protein fragments of the present disclosure are shelf stable (they will not slowly or spontaneously gel when stored in an aqueous solution and there is no aggregation of fragments and therefore no increase in molecular weight over time), from 10 days to 3 years depending on storage conditions, percent silk, and number of shipments and shipment conditions. Additionally, pH may be altered to extend shelf life and/or support shipping conditions by preventing premature folding and aggregation of the silk. In an embodiment, the stability of the LiBr-silk fragment solution is 0 to 1 year. In an embodiment, the stability of the LiBr-silk fragment solution is 0 to 2 years. In an embodiment, the stability of the LiBr-silk fragment solution is 0 to 3 years. In an embodiment, the stability of the LiBr-silk fragment solution is 0 to 4 years. In an embodiment, the stability of the LiBr-silk fragment solution is 0 to 5 years. In an embodiment, the stability of the LiBr-silk fragment solution is 1 to 2 years. In an embodiment, the stability of the LiBr-silk fragment solution is 1 to 3 years. In an embodiment, the stability of the LiBr-silk fragment solution is 1 to 4 years. In an embodiment, the stability of the LiBr-silk fragment solution is 1 to 5 years. In an embodiment, the stability of the LiBr-silk fragment solution is 2 to 3 years. In an embodiment, the stability of the LiBr-silk fragment solution is 2 to 4 years. In an embodiment, the stability of the LiBr-silk fragment solution is 2 to 5 years. In an embodiment, the stability of the LiBr-silk fragment solution is 3 to 4 years. In an embodiment, the stability of the LiBr-silk fragment solution is 3 to 5 years. In an embodiment, the stability of the LiBr-silk fragment solution is 4 to 5 years.

In an embodiment, the stability of a composition of the present disclosure is 10 days to 6 months. In an embodiment, the stability of a composition of the present disclosure is 6 months to 12 months. In an embodiment, the stability of a composition of the present disclosure is 12 months to 18 months. In an embodiment, the stability of a composition of the present disclosure is 18 months to 24 months. In an embodiment, the stability of a composition of the present disclosure is 24 months to 30 months. In an embodiment, the stability of a composition of the present disclosure is 30 months to 36 months. In an embodiment, the stability of a composition of the present disclosure is 36 months to 48 months. In an embodiment, the stability of a composition of the present disclosure is 48 months to 60 months.

In an embodiment, a composition of the present disclosure includes silk fibroin-based protein fragments having a weight average molecular weight ranging from 6 kDa to 17 kDa. In an embodiment, a composition of the present disclosure includes silk fibroin-based protein fragments having a weight average molecular weight ranging from 17 kDa to 39 kDa. In an embodiment, a composition of the present disclosure includes silk fibroin-based protein fragments having a weight average molecular weight ranging from 39 kDa to 80 kDa. In an embodiment, a composition of the present disclosure includes silk fibroin-based protein fragments having a weight average molecular weight ranging from 40 kDa to 65 kDa. In an embodiment, a composition of the present disclosure includes silk fibroin-based protein fragments having a weight average molecular weight ranging from 1 kDa to 5 kDa. In an embodiment, a composition of the present disclosure includes silk fibroin-based protein fragments having a weight average molecular weight ranging from 5 kDa to 10 kDa. In an embodiment, a composition of the present disclosure includes silk fibroin-based protein fragments having a weight average molecular weight ranging from 10 kDa to 15 kDa. In an embodiment, a composition of the present disclosure includes silk fibroin-based protein fragments having a weight average molecular weight ranging from 15 kDa to 20 kDa. In an embodiment, a composition of the present disclosure includes silk fibroin-based protein fragments having a weight average molecular weight ranging from 20 kDa to 25 kDa. In an embodiment, a composition of the present disclosure includes silk fibroin-based protein fragments having a weight average molecular weight ranging from 25 kDa to 30 kDa. In an embodiment, a composition of the present disclosure includes silk fibroin-based protein fragments having a weight average molecular weight ranging from 30 kDa to 35 kDa. In an embodiment, a composition of the present disclosure includes silk fibroin-based protein fragments having a weight average molecular weight ranging from 35 kDa to 40 kDa. In an embodiment, a composition of the present disclosure includes silk fibroin-based protein fragments having a weight average molecular weight ranging from 40 kDa to 45 kDa. In an embodiment, a composition of the present disclosure includes silk fibroin-based protein fragments having a weight average molecular weight ranging from 45 kDa to 50 kDa. In an embodiment, a composition of the present disclosure includes silk fibroin-based protein fragments having a weight average molecular weight ranging from 50 kDa to 55 kDa. In an embodiment, a composition of the present disclosure includes silk fibroin-based protein fragments having a weight average molecular weight ranging from 55 kDa to 60 kDa. In an embodiment, a composition of the present disclosure includes silk fibroin-based protein fragments having a weight average molecular weight ranging from 60 kDa to 65 kDa. In an embodiment, a composition of the present disclosure includes silk fibroin-based protein fragments having a weight average molecular weight ranging from 65 kDa to 70 kDa. In an embodiment, a composition of the present disclosure includes silk fibroin-based protein fragments having a weight average molecular weight ranging from 70 kDa to 75 kDa. In an embodiment, a composition of the present disclosure includes silk fibroin-based protein fragments having a weight average molecular weight ranging from 75 kDa to 80 kDa. In an embodiment, a composition of the present disclosure includes silk fibroin-based protein fragments having a weight average molecular weight ranging from 80 kDa to 85 kDa. In an embodiment, a composition of the present disclosure includes silk fibroin-based protein fragments having a weight average molecular weight ranging from 85 kDa to 90 kDa. In an embodiment, a composition of the present disclosure includes silk fibroin-based protein fragments having a weight average molecular weight ranging from 90 kDa to 95 kDa. In an embodiment, a composition of the present disclosure includes silk fibroin-based protein fragments having a weight average molecular weight ranging from 95 kDa to 100 kDa. In an embodiment, a composition of the present disclosure includes silk fibroin-based protein fragments having a weight average molecular weight ranging from 100 kDa to 105 kDa. In an embodiment, a composition of the present disclosure includes silk fibroin-based protein fragments having a weight average molecular weight ranging from 105 kDa to 110 kDa. In an embodiment, a composition of the present disclosure includes silk fibroin-based protein fragments having a weight average molecular weight ranging from 110 kDa to 115 kDa. In an embodiment, a composition of the present disclosure includes silk fibroin-based protein fragments having a weight average molecular weight ranging from 115 kDa to 120 kDa. In an embodiment, a composition of the present disclosure includes silk fibroin-based protein fragments having a weight average molecular weight ranging from 120 kDa to 125 kDa. In an embodiment, a composition of the present disclosure includes silk fibroin-based protein fragments having a weight average molecular weight ranging from 125 kDa to 130 kDa. In an embodiment, a composition of the present disclosure includes silk fibroin-based protein fragments having a weight average molecular weight ranging from 130 kDa to 135 kDa. In an embodiment, a composition of the present disclosure includes silk fibroin-based protein fragments having a weight average molecular weight ranging from 135 kDa to 140 kDa. In an embodiment, a composition of the present disclosure includes silk fibroin-based protein fragments having a weight average molecular weight ranging from 140 kDa to 145 kDa. In an embodiment, a composition of the present disclosure includes silk fibroin-based protein fragments having a weight average molecular weight ranging from 145 kDa to 150 kDa. In an embodiment, a composition of the present disclosure includes silk fibroin-based protein fragments having a weight average molecular weight ranging from 150 kDa to 155 kDa. In an embodiment, a composition of the present disclosure includes silk fibroin-based protein fragments having a weight average molecular weight ranging from 155 kDa to 160 kDa. In an embodiment, a composition of the present disclosure includes silk fibroin-based protein fragments having a weight average molecular weight ranging from 160 kDa to 165 kDa. In an embodiment, a composition of the present disclosure includes silk fibroin-based protein fragments having a weight average molecular weight ranging from 165 kDa to 170 kDa. In an embodiment, a composition of the present disclosure includes silk fibroin-based protein fragments having a weight average molecular weight ranging from 170 kDa to 175 kDa. In an embodiment, a composition of the present disclosure includes silk fibroin-based protein fragments having a weight average molecular weight ranging from 175 kDa to 180 kDa. In an embodiment, a composition of the present disclosure includes silk fibroin-based protein fragments having a weight average molecular weight ranging from 180 kDa to 185 kDa. In an embodiment, a composition of the present disclosure includes silk fibroin-based protein fragments having a weight average molecular weight ranging from 185 kDa to 190 kDa. In an embodiment, a composition of the present disclosure includes silk fibroin-based protein fragments having a weight average molecular weight ranging from 190 kDa to 195 kDa. In an embodiment, a composition of the present disclosure includes silk fibroin-based protein fragments having a weight average molecular weight ranging from 195 kDa to 200 kDa. In an embodiment, a composition of the present disclosure includes silk fibroin-based protein fragments having a weight average molecular weight ranging from 200 kDa to 205 kDa. In an embodiment, a composition of the present disclosure includes silk fibroin-based protein fragments having a weight average molecular weight ranging from 205 kDa to 210 kDa. In an embodiment, a composition of the present disclosure includes silk fibroin-based protein fragments having a weight average molecular weight ranging from 210 kDa to 215 kDa. In an embodiment, a composition of the present disclosure includes silk fibroin-based protein fragments having a weight average molecular weight ranging from 215 kDa to 220 kDa. In an embodiment, a composition of the present disclosure includes silk fibroin-based protein fragments having a weight average molecular weight ranging from 220 kDa to 225 kDa. In an embodiment, a composition of the present disclosure includes silk fibroin-based protein fragments having a weight average molecular weight ranging from 225 kDa to 230 kDa. In an embodiment, a composition of the present disclosure includes silk fibroin-based protein fragments having a weight average molecular weight ranging from 230 kDa to 235 kDa. In an embodiment, a composition of the present disclosure includes silk fibroin-based protein fragments having a weight average molecular weight ranging from 235 kDa to 240 kDa. In an embodiment, a composition of the present disclosure includes silk fibroin-based protein fragments having a weight average molecular weight ranging from 240 kDa to 245 kDa. In an embodiment, a composition of the present disclosure includes silk fibroin-based protein fragments having a weight average molecular weight ranging from 245 kDa to 250 kDa. In an embodiment, a composition of the present disclosure includes silk fibroin-based protein fragments having a weight average molecular weight ranging from 250 kDa to 255 kDa. In an embodiment, a composition of the present disclosure includes silk fibroin-based protein fragments having a weight average molecular weight ranging from 255 kDa to 260 kDa. In an embodiment, a composition of the present disclosure includes silk fibroin-based protein fragments having a weight average molecular weight ranging from 260 kDa to 265 kDa. In an embodiment, a composition of the present disclosure includes silk fibroin-based protein fragments having a weight average molecular weight ranging from 265 kDa to 270 kDa. In an embodiment, a composition of the present disclosure includes silk fibroin-based protein fragments having a weight average molecular weight ranging from 270 kDa to 275 kDa. In an embodiment, a composition of the present disclosure includes silk fibroin-based protein fragments having a weight average molecular weight ranging from 275 kDa to 280 kDa. In an embodiment, a composition of the present disclosure includes silk fibroin-based protein fragments having a weight average molecular weight ranging from 280 kDa to 285 kDa. In an embodiment, a composition of the present disclosure includes silk fibroin-based protein fragments having a weight average molecular weight ranging from 285 kDa to 290 kDa. In an embodiment, a composition of the present disclosure includes silk fibroin-based protein fragments having a weight average molecular weight ranging from 290 kDa to 295 kDa. In an embodiment, a composition of the present disclosure includes silk fibroin-based protein fragments having a weight average molecular weight ranging from 295 kDa to 300 kDa. In an embodiment, a composition of the present disclosure includes silk fibroin-based protein fragments having a weight average molecular weight ranging from 300 kDa to 305 kDa. In an embodiment, a composition of the present disclosure includes silk fibroin-based protein fragments having a weight average molecular weight ranging from 305 kDa to 310 kDa. In an embodiment, a composition of the present disclosure includes silk fibroin-based protein fragments having a weight average molecular weight ranging from 310 kDa to 315 kDa. In an embodiment, a composition of the present disclosure includes silk fibroin-based protein fragments having a weight average molecular weight ranging from 315 kDa to 320 kDa. In an embodiment, a composition of the present disclosure includes silk fibroin-based protein fragments having a weight average molecular weight ranging from 320 kDa to 325 kDa. In an embodiment, a composition of the present disclosure includes silk fibroin-based protein fragments having a weight average molecular weight ranging from 325 kDa to 330 kDa. In an embodiment, a composition of the present disclosure includes silk fibroin-based protein fragments having a weight average molecular weight ranging from 330 kDa to 335 kDa. In an embodiment, a composition of the present disclosure includes silk fibroin-based protein fragments having a weight average molecular weight ranging from 350 kDa to 340 kDa. In an embodiment, a composition of the present disclosure includes silk fibroin-based protein fragments having a weight average molecular weight ranging from 340 kDa to 345 kDa. In an embodiment, a composition of the present disclosure includes silk fibroin-based protein fragments having a weight average molecular weight ranging from 345 kDa to 350 kDa.

In an embodiment, the silk fibroin-based protein fragments in this disclosure has a polydispersity ranging from about 1.0 to about 5.0. In an embodiment, a composition of the silk fibroin-based protein fragments has a polydispersity ranging from about 1.5 to about 3.0. In an embodiment, a composition of the silk fibroin-based protein fragments has a polydispersity ranging from about 1.0 to about 1.5. In an embodiment, a composition of the silk fibroin- based protein fragments has a polydispersity ranging from about 1.5 to about 2.0. In an embodiment, a composition of the silk fibroin-based protein fragments has a polydispersity ranging from about 2.0 to about 2.5. In an embodiment, a composition of the silk fibroin-based protein fragments, has a polydispersity ranging from about is 2.0 to about 3.0. In an embodiment, a composition of the silk fibroin-based protein fragments has a polydispersity ranging from about is 2.5 to about 3.0.

The silk solution can be dried to a SPF powder. This can be accomplished by placing the silk solution in a lyophilizer at an appropriate temperature (e.g., room temperature), at a pressure of less than about 100 millitorr (mtorr) until the water and other volatiles have been evaporated (about 1.0 wt. % to about 10 wt. % moisture content), and a fine SPF powder remains. Alternative flash drying, fluid-bed drying, spray drying or vacuum drying can be applied to remove water from the silk solution. In some embodiments, the silk solution is dried using a rototherm evaporator for creating a dry protein powder containing less than 10.0 wt. % moisture content.

The SPF powder can then be stored and handled without refrigeration or other special handling procedures. Reconstitution of SPF powder in solvent can be accomplished by adding the SPF powder to water, an aqueous medium, or an organic solvent, with agitation sufficient to resuspend the protein particles and form a solution or suspension. The weight ratio of SPF powder to solvent will depend upon the desired concentration of the final reconstituted product. For use as a coating or barrier, it is preferred to have an aqueous SPF solution or SPF suspension having a weight ratio of SPF to water at about 1:10 to about 1:4.

In some embodiments, the solubility of silk fibroin-based protein fragments in organic solutions ranges from about 50.0% to about 100%. In some embodiments, the solubility of silk fibroin-based protein fragments in organic solutions ranges from about 60.0% to about 100%. In some embodiments, the solubility of silk fibroin-based protein fragments in organic solutions ranges from about 70.0% to about 100%. In some embodiments, the solubility of silk fibroin-based protein fragments in organic solutions ranges from about 80.0% to about 100%. In some embodiments, the solubility of silk fibroin-based protein fragments of the present disclosure in organic solutions ranges from about 90.0% to about 100%. In some embodiments, the silk fibroin-based fragments of the present disclosure are non-soluble in organic solutions.

In some embodiments, the silk solution can be casted on a substrate to form a silk fibroin film after drying.

In some embodiments, the silk solution can be induced to form silk gel. The gelation of an aqueous silk solutions may be induced by sonication, vortex, heating, solvent treatment (e.g. methanol, ethanol), electrogelation, ultrasonication, chemicals (e.g. vitamin C), or the like.

In some embodiments, In some embodiments, the silk fibroin protein fragments as described above may find application as additive or ingredient (thereafter SPF additive or SPF ingredient) in the food and pharmaceutical industries, including as edible coatings or barriers in foods or for drugs, e.g., for tablets, such as aspirin. For these purposes, the coating should impart neither significant flavor nor color, so that it does not substantially alter the flavor or appearance of the food or the drug product. In some embodiments, silk fibroin protein fragments are useful as additive or ingredient for applications in food or beverage products.

In some embodiments, SPF additive or SPF ingredient useful for applications in food or beverage products may be silk powders resulted from drying of the silk solution as described above.

In some embodiments, SPF additive or SPF ingredient useful for applications in food or beverage products may be silk film resulted from casting /coating the silk solution as described above onto a substrate, wherein the substrate may be perishable food items, or solid support.

In some embodiments, the silk fibroin protein fragments as described above may find application as amino acid source compounds in food or beverage products. Silk peptide is a hydrolysis or enzymatic degradation product from natural silk fibroin protein and has 2 to 50 amino acid residues. The structure of silk peptide is similar to human tissue. The silk peptides are serine rich polypeptides. Thus, the silk peptides incorporated in the silk food or beverage products having high affinity to human tissue after the ingestion.

In some embodiments, the silk fibroin protein fragments as described above may find application as nutrients in food or beverage products may include silk amino acids resulted from the hydrolysis of silk of Bombyx mori. In some embodiments, the silk fibroin amino acids are sourced from commercially available hydrolyzed silk (CAS Number: 96690-41-4). The amino acids derived from the silk fibroin protein of Bombyx mori consists mainly of Gly (43%), Ala (30%), and Ser (12%).

In some embodiments, the silk fibroin protein fragments as described above may find application as preservative for preserve freshness of perishable goods. The preservative may be applied as a coating or as an additive embedded within the perishable goods. The silk fibroin protein fragment additive may be used as a functional ingredient for foodstuffs to impart functional properties (antimicrobial or biocidal activity) to the foodstuffs. In some embodiments, the silk fibroin protein fragment additive may be applied as nutrient to enrich the foodstuffs. In some embodiments, the silk fibroin protein fragment additive are applied to prepare food or beverage products.

### Silk Foodstuff

Edible films and coatings based on water-soluble proteins are typically water-soluble themselves and exhibit excellent oxygen, lipid and flavor barrier properties; however, they are poor moisture barriers. Additionally, proteins act as a cohesive, structural matrix in multicomponent systems to provide films and coatings having good mechanical properties.

This disclosure exploit the potential of the hydrophobic silk fibroin protein as coating material for formation of edible coatings. The water solubility of the film or coating derived from silk fibroin protein fragments as described herein can be modified by solvent annealing (water annealing or methanol annealing), chemical crosslinking, enzyme crosslinking and heat treatment.

### 1. SPF-Coated/SPF-Added Perishable Products

Retarding the spoilage of perishable foods, and significantly extending the useful life of perishable food items such as fruits and vegetable would be of major interest for the fruits and vegetable markets.

Presently, controlling the humidity and temperature for storage of items such as fruits and vegetables is employed to extend useful life by retarding spoilage and reducing their tendencies for drying out. However, providing this means for retarding spoilage and extending useful life for fruits and vegetables adds considerably to the market prices because of the costs of the facilities and equipment required for storing these items in a controlled environment. After removing the stored fruits and vegetables to the market place for displaying and selling, there is a need to further retard spoilage and extending useful life of these items.

Edible coatings are technologies used in foods as barrier layer for preventing the perishable food items from reacting with atmospheric oxygen or carbon dioxide. Edible coatings can also reduce gas permeability in foods. Oxygen uptake by a food often results in deleterious reactions that affect its flavor, nutritional quality and acceptability. In addition, Edible coatings may be used to minimize the migration or loss of other additives, such as colors, flavors, preservatives, antioxidants, etc. Edible coatings also can be used to impart structural integrity to the surface of a food, making it less susceptible to mechanical damage.

Moisture loss or uptake in a food can have dramatic effects on the texture, stability or yield of the food product. Moisture uptake can reduce or eliminate crispness, can speed enzymatic or chemical deterioration of flavors or nutrients, and can impair the food's structural integrity. A slight change in either direction of moisture levels or water activity could be very detrimental for the food quality. The edible coating should be permeable to water that precludes their drying out due to dehydration.

In addition to the traditional function of edible coating to reduce water loss, the recent developments of formulated edible coatings with a wide range of permeability characteristics extended the potential for fresh produce applications.

Commercially exploited protein-based edible coatings include collagen, gelatin, corn zein, wheat glutens, casein and whey. However, none of these protein based coating materials provides the all desired functional characteristics as edible coatings. Both collagen and gelatin form highly hydrophilic, water soluble films and therefore do not function as effective moisture barrier. Zein protein is hydrophobic and film formed thereof is brittle that requires the addition of plasticizer to modulate film flexibility. To be useful as edible coating material for perishable goods, usually plasticizer is added to wheat gluten, casein, and whey proteins.

Non-edible silk fibroin film has been reported, e.g. ultrathin films in WO2007/016524, thick films, conformal coatings in WO2005/000483 and WO2005/123114.

Japanese Patent Laid-Open Publication No. 1-118,545 describes various uses of silk films such as artificial skins, wigs, and sweat clothes. These types of silk film have excellent vapor permeability, improved transparency and mechanical strength, and desirable affinity to the human body.

In addition, water insoluble silk films prepared from fibroin and sericin mixture was described in Japanese Patent Laid-Open Publication No. 2-233,128. This type of silk film exhibits excellent oxygen permeability, improved transparency and mechanical strength, desirable biocompatibility and high stability to the human body, and is accordingly useful as contact lenses, artificial skins, blood bags and the like.

Films containing silk fibroin protein have only received limited attention as edible coatings. This disclosure provides an edible coating comprising silk fibroin protein fragments (SPF coatings) as described above.

In one embodiment, this disclosure provides silk fibroin film coated products comprising a foodstuff and an edible coating layer formed of silk fibroin protein fragments (SPF coating) as described above. In some embodiments, at least part of the foodstuff is in contact with a SPF coating layer. As compared with the commercially exploited protein edible coatings described above, the SPF coatings provide exceptional functional attributes of the edible coatings: (1) useful to form barrier coatings on the perishable goods for freshness preservation, (2) carrier for active agents, (3) organoleptic property enhancement to perishable goods such as flavor, texture etc., and (4) silky and smooth sensory property.

In some embodiments, the foodstuff is selected from the group consisting of powdery food, dry solid food, oily food, perishable good, vegetable, fruit, meat, egg, and seafood. In some embodiments, the SPF coating layer is used to preserve fresh produce. In some embodiments, perishable products such as fruits are coated one or more layers of the SPF coatings. In some embodiments, the perishable good is selected from vegetable, fruit, meat, egg, and seafood. In some embodiments, the perishable good is selected from the group consisting of vegetable and fruit. In some embodiments, the perishable good is vegetable. In some embodiments, the vegetable is carrot. In some embodiments, the perishable good is fruit. In some embodiments, the fruit is selected from the group consisting of strawberry, orange, apple, pear, plum, banana, and grapefruit. In some embodiments, the fruit is any berry known in the art. In some embodiments, the fruit is any drupe known in the art. In some embodiments, the fruit is any pome known in the art. In some embodiments, the fruit is any citrus known in the art. In some embodiments, the fruit is any melon known in the art. In some embodiments, the fruit is any tropical or tropical-like fruit known in the art. In some embodiments, the perishable good is any vegetable known in the art. In some embodiments, the perishable good is any seed known in the art.

In some embodiments, the perishable good is meat. In some embodiments, the meat is poultry, pork, beef, veal, lamb, bison, ostrich, rabbit, game, fish, eel, shellfish, or seafood. In some embodiments, the poultry is selected from the group consisting of poultry chicken, turkey, duck, goose, and pigeon.

In some embodiments, the perishable good comprises the entire intact natural foodstuff, a selected tissue of the natural foodstuff or a selected part of a tissue of the natural foodstuff (cut fruit). In some embodiments, the perishable good comprises of intact tissue or tissue part. In some embodiments, the perishable good comprises of multiple parts of a tissue part or multiple parts of different tissue parts. In some embodiments, the perishable good comprises different tissues of a single natural foodstuff. In some embodiments, the perishable good comprises different tissues of different natural foodstuffs. In some embodiments, the perishable good comprises synthetic edible substances. In some embodiments, the perishable good is comprised entirely of synthetic edible substances.

In some embodiments, the SPF coating layer on the foodstuff is readily soluble in hot water. In some embodiments, the SPF coating layer on the foodstuff is water insoluble. In some embodiments, the SPF coating layer has excellent edibility and oxygen barrier properties. Typically, SPF-based coatings described herein are odorless, flavorless, or both. In some embodiments, SPF-based coatings described herein can be made sufficiently water-soluble and therefore are easily washable. However, in some embodiments, coatings on perishable foodstuffs do not require removal before consumption.

In some embodiments, the SPF coating layer on the perishable goods have at least one of the following characteristics including containing no toxic, allergic and non-digestible components, providing structural integrity and prevent mechanical damage during transportation, handling, and display, having good adhesion to surface of perishable goods to be protected providing uniform coverage, control water migration both in and out of protected perishable goods to maintain desired moisture content, preventing loss or uptake of components that stabilize aroma, flavor, nutritional and organoleptic characteristics necessary for consumer acceptance while not inversely altering the taste or appearance, providing biochemical and microbial surface stability while protecting against contamination, pest infestation, microbe proliferation, and other types of decay, maintaining or enhancing aesthetics and sensory attributes of the products, serving as carrier for desirable additives such as flavor, fragrance, coloring, nutrients and vitamins, incorporating antioxidant and antimicrobial agents etc.

In some embodiments, the silk fibroin protein fragment based coating layer is useful for preserving freshness of the perishable good. In some embodiments, the SPF coating comprising silk fibroin protein fragments having a weight average molecular weight ranging from about 1 kDa to about 390 kDa. The silk fibroin protein fragments described herein are ideally suited for film-forming and coating applications due to their ability to self-assemble in solution. The self-assembly property of silk proteins is due to the formation of anti-parallel beta-pleated sheets via hydrogen bonding and electrostatic interactions.

In some embodiments, at least 10%, 15%, 20%, 25%, 30%, 35%, 40%, 45%, 50%, 55%, 60%, 65%, 70%, 75%, 80%, 85%, 90%, 95%, or 100% of the surface of the perishable good is covered with the SPF coating layer.

In some embodiments, the SPF coating layer comprising silk fibroin protein fragments having (i) an average weight average molecular weight selected from the group consisting of between about 1 kDa and about 5 kDa, between about 5 kDa and about 10 kDa, between about 6 kDa and about 17 kDa, between about 10 kDa and about 15 kDa, between about 15 kDa and about 20 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa; and (ii) a polydispersity selected from the group consisting of between 1 and about 5, between about 1.5 and about 3.0, between about 1.5 and about 2.0, between about 2.0 and about 2.5, between about 2.5 and about 3.0, and between 1 and about 1.5.

In some embodiments, the silk fibroin protein fragments in the SPF coating layer have the polydispersity between 1 and about 1.5. In some embodiments, the silk fibroin protein fragments in the SPF coating layer have the polydispersity between 1.5 and about 3.0. In some embodiments, the silk fibroin protein fragments in the SPF coating layer have the polydispersity between 1.5 and about 2.0. In some embodiments, the silk fibroin protein fragments in the SPF coating layer have the polydispersity between about 2.0 and about 2.5. In some embodiments, the silk fibroin protein fragments in the SPF coating layer have the polydispersity between about 2.5 and about 3.0.

In some embodiments, the silk fibroin protein fragments in the SPF coating layer have a weight average molecular weight selected from the group consisting of between about 6 kDa and about 17 kDa, between about 17 kDa and about 39 kDa, and between about 39 kDa and about 80 kDa, and a polydispersity selected from the group consisting of between 1 and about 5, between about 1.5 and about 3.0, and between 1 and about 1.5.

In some embodiments, the silk fibroin protein fragments in the SPF coating layer have a weight average molecular weight between about 6 kDa and about 17 kDa and a polydispersity between about 1.5 and about 3.0. In some embodiments, the silk fibroin protein fragments in the SPF coating layer have a weight average molecular weight between about 17 kDa and about 39 kDa and a polydispersity between about 1.5 and about 3.0. In some embodiments, the silk fibroin protein fragments in the SPF coating layer have a weight average molecular weight between about 39 kDa and about 80 kDa and a polydispersity between about 1.5 and about 3.0.

In some embodiments, the silk fibroin fragments are present in the coated perishable good at a weight amount ranging from about 0.001 wt. % to about 10.0 wt. % by the total weight of the dry silk-coated perishable good. In some embodiments, the silk fibroin fragments are present in the coated perishable good at a weight amount ranging from about 0.001 wt. % to about 5.0 wt. % by the total weight of the dry silk-coated perishable good. In some embodiments, the silk fibroin fragments are present in the coated perishable good at a weight amount ranging from about 0.001 wt. % to about 1.0 wt. % by the total weight of the dry silk-coated perishable good. In some embodiments, the silk fibroin fragments are present in the coated perishable good at a weight amount ranging from about 10 wt. % by the total weight of the dry silk-coated perishable good.

In some embodiments, SPF coating layer further contains one or more additional edible coating material selected from the group consisting of sugars, polyhydric alcohols, proteins, lipids, waxes, gelling agent, and polysaccharides.

In some embodiments, the SPF coating layer further comprises a polysaccharide selected from the group consisting of maltodextrin, methylcellulose, carboxymethyl cellulose, alginic acid, alginate, agar, pectin, carrageenan, κ-carrageenan, i-carrageenan, λ-carrageenan, gellan, starch, starch hydrolysates and cellulose derivatives, pullulan, arabinogalactan pullulan, chitosan, and combinations thereof. In some embodiments, the polysaccharide is selected from the group consisting of carrageenan, alginic acid, alginate, and agar.

In some embodiments, the SPF coating layer further comprises a gelling agent selected from the group consisting of gum, xanthan gum, guar gum, taro seed gum, locust bean gum, and combinations thereof.

In some embodiments, the SPF coating layer further comprises a lipid selected from the group consisting of fatty acids, fatty alcohols, waxes, triglycerides, monoglycerides, acetylated monoglyceride, and combinations thereof. In some embodiments, the lipid is selected from the group consisting of beeswax, palmitic acid, stearyl alcohol and combinations thereof. In some embodiments, the SPF coating layer further comprises a wax selected from natural wax (e.g., shellac, carnauba wax), and synthetic wax.

In some embodiments, the lipid is an oil such as an animal or vegetable oil as exemplified above. In some embodiments, the lipid is unsaturated fatty acids, mono- and diacyl glycerols triacyl glycerols, phospholipids, glycolipids, phosphatidyl derivatives, glycerolglycolipids, sphingolipids, lipoproteins, diol lipids, waxes, cutin, or any combination thereof. In some embodiments, the oil can be any ingestible oil such as any vegetable oil or any animal oil. For example, vegetable oil comprises olive oil, palm oil, soybean oil, canola oil (rapeseed oil), avocado oil, coconut oil, pumpkin seed oil, corn oil, sunflower oil, safflower oil, peanut oil, grape seed oil, sesame oil, argan oil or rice bran oil. In some embodiments, animal oil comprises butter, ghee or lard.

In some embodiments, the amount of lipid may be incorporated into the SPF coating layer ranges from about 0.1 wt. % to about 28 wt. %. In some embodiments, the amount of lipid may be incorporated into the SPF coating layer is selected from the group consisting 0.01%, 0.05%, 0.1%, 0.2%, 0.3%, 0.4%, 0.5%, 0.6%, 0.7%, 0.8%, 0.9%, 1.0%, 1.1%, 1.2%, 1.3 , 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9%, 10%, 15%, 20%, 25%, and 30% w/w by the total weight of the SPF coating layer.

In some embodiments, the SPF coating layer further comprises an additional protein selected form the group consisting of collagen, gelatin, casein, sodium caseinate, whey, milk protein, serum albumin, ovalbumin, wheat gluten and zein, soybean protein, and combinations thereof.

In some embodiments, the additional coating material and the silk fibroin protein fragments forming a composite in the SPF coating layer, wherein the additional coating material is selected from the group consisting of gelatin, collagen, casein, carrageenan, alginic acid, alginate, and agar.

In some embodiments, the additional coating material is covalently conjugated to the silk fibroin protein fragments. In some embodiments, the edible coating material comprises a conjugate of silk fibroin protein fragments with an additional protein selected from the group consisting of gelatin, collagen, and casein. In some embodiments, the edible coating material comprises a conjugate of silk fibroin protein fragments with a polysaccharide selected from the group consisting of carrageenan, alginic acid, alginate, and agar.

In some embodiments, the SPF coating layer comprises at least 65.0 wt. % of silk fibroin protein fragments as primary coating material. In some embodiments, the SPF coating layer comprises at least 75.0 wt. % of silk fibroin protein fragments as primary coating material. In some embodiments, the SPF coating layer comprises at least 85.0 wt. % of silk fibroin protein fragments as primary coating material. In some embodiments, the SPF coating layer comprises at least 95.0 wt. % of silk fibroin protein fragments as primary coating material. In some embodiments, the SPF coating layer comprises at least 99.0 wt. % of silk fibroin protein fragments as primary coating material. In some embodiments, the SPF coating layer comprises 100 wt. % of silk fibroin protein fragments as primary coating material.

In some embodiments, the additional coating material in the SPF coating layer has a weight percent ranging from about 1.0 wt. % to 25.0 wt. % by the total weight of the SPF coating layer. In some embodiments, the additional coating material in the SPF coating layer has a weight percent selected from the group consisting of about 1.0 wt. %, 2.0 wt. %, 3.0 wt. %, 4.0 wt. %, 5.0 wt. %, 6.0 wt. %, 7.0 wt. %, 8.0 wt. %, 9.0 wt. %, 10.0 wt. %, 12.0 wt. %, 13.0 wt. %, 14.0 wt. %, 15.0 wt. %, 16.0 wt. %, 17.0 wt. %, 18.0 wt. %, 19.0 wt. %, 20.0 wt. %, 21.0 wt. %, 22.0 wt. %, 23.0 wt. %, 24.0 wt. %, and 25.0 wt. % by the total weight of the SPF coating layer.

In some embodiments, the SPF coating layer comprise the additional coating material in a weight ratio of silk fibroin protein fragments to the additional coating material ranging from 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, and 1:1.

In some embodiments, the silk coating composition comprises at least two different populations of silk fibroin protein fragments characterized by different weight average molecular weight range and polydispersity range; wherein the film strength or other film properties are improved by the combination of two or more populations of the silk fibroin protein fragments. In some embodiments, the silk coating composition comprises a mixture of low molecular weight silk fibroin protein fragments and mid-molecular weight silk fibroin protein fragment. In some embodiments, the silk coating composition comprises a mixture of low molecular weight silk fibroin protein fragments and high molecular weight silk fibroin protein fragment. In some embodiments, the silk coating composition comprises a mixture of mid-molecular weight silk fibroin protein fragment and molecular weight silk fibroin protein fragments.

In some embodiments, the silk coating composition comprises low molecular weight silk fibroin protein fragments having a weight average molecular weight ranging from about 5 kDa to about 20 kDa. In some embodiments, the silk coating composition comprises low molecular weight silk fibroin protein fragments having a weight average molecular weight selected from the group consisting of from about 5 kDa to 10 kDa, about 10 kDa to about 20 kDa, and about 20 kDa to about 25 kDa. In some embodiments, the silk coating composition comprises low molecular weight silk fibroin protein fragments having a weight average molecular weight ranging from about 10 kDa to about 20 kDa.

In some embodiments, the silk coating composition comprises medium molecular weight silk fibroin protein fragments having an average weight average molecular weight selected from the group consisting of from about 25 kDa to about 30 kDa, about 30 kDa to about 35 kDa, from about 35 kDa to about 40 kDa, from about 17 kDa to about 39 kDa, from about 45 kDa to about 50 kDa, from about 50 kDa to about 55 kDa, from about 55 kDa to about 60 kDa, from about 60 kDa to about 65 kDa, from about 40 kDa to about 65 kDa, from 65 kDa to about 70 kDa, from about 70 kDa to about 75 kDa, from about 75 kDa to about 80 kDa, from about 39 kDa to about 80 kDa, from about 80 kDa to about 85 kDa, from about 85 kDa to about 90 kDa, from about 90 kDa to about 95 kDa, from about 95 kDa to about 100 kDa, from about 100 kDa to about 105 kDa, from about 105 kDa to about 110 kDa, from about 60 kDa to about 100 kDa, and from about 80 kDa to about 144 kDa. In some embodiments, the silk coating composition comprises medium molecular weight silk fibroin protein fragments having a weight average molecular weight ranging from about 17 kDa to about 39 kDa. In some embodiments, the silk coating composition comprises medium molecular weight silk fibroin protein fragments having a weight average molecular weight ranging from about 40 kDa to about 65 kDa. In some embodiments, the silk coating composition comprises medium molecular weight silk fibroin protein fragments having a weight average molecular weight ranging from about 39 kDa to about 80 kDa. In some embodiments, the silk coating composition comprises medium molecular weight silk fibroin protein fragments having a weight average molecular weight ranging from about 80 kDa to about 144 kDa.

In some embodiments, the silk coating composition comprises low molecular weight silk fibroin fragments (low-MW silk) having a weight average molecular weight (Mw) 6 kDa and about 17 kDa and a polydispersity between about 1.5 and about 3.0. In some embodiments, the silk coating composition comprises medium molecular weight silk fibroin fragments (Med-MW silk) having a weight average molecular weight ranging from about 17 kDa and about 39 kDa and a polydispersity between about 1.5 and about 3.0. In some embodiments, the silk coating composition comprises high molecular weight silk fibroin fragments (high-MW silk) having a weight average molecular weight ranging from about 39 kDa to about 80 kDa and a polydispersity between about 1.5 and about 3.0.

In some embodiments, the two different populations of silk fibroin protein fragments present in the silk coating composition ata weight ratio of 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19 and 1:20.

In an exemplary embodiment, the edible SPF coating layer is physically modified or chemically modified. In some examples, being chemically modified comprises being chemically adapted, chemically altered, chemically changed, chemically improved, chemically revised, chemically adjusted, chemically customized, chemically tailored, chemically adapted, chemically adjusted, chemically changed, chemically varied, chemically transformed, chemically revised or chemically refashioned. In some examples, chemical modification is accomplished by any of the following procedures, or any combination of the following procedures: annealing, oxidation, oxidation, esterification, crosslinking, extrusion, pregelatinization or hydrolysis. In some embodiments, the modification of the edible material and/or foodstuff takes place while the SPF coating layer is intact.

In some embodiments, the SPF coating layer is subject to enzymatic or chemical crosslinking to increase the rigidity, the barrier properties, heat resistance and film forming properties. In some embodiments, the aqueous SPF coating solutions are denatured with heat, or modified with chemicals and/or enzymes to induce thiol-disulfide interchange and thiol oxidation reactions, thereby forming new intermolecular and intramolecular disulfide crosslinkages. The formation of covalent intermolecular crosslinkages in protein-based SPF edible films and coatings results in SPF films having improved barrier and mechanical properties that are insoluble in water.

Some chemical crosslinking agent can react with an amino group, an amide group, a hydroxyl group, a thiol group of the protein peptide chain. In some embodiments, the chemical crosslinking agent is selected from the group consisting of ketose containing 3-5 carbon atoms, mercaptoethanol, cysteine, dithiothreitol, sulfites, carbodiimide, (1-ethyl-3-(3-dimethylaminopropyl)carbodiimide hydrochloride) (EDC), bis-n-hydroxy-succinimide (NETS), epichlorohydrin-modified polyamine, epichlorohydrin-modified polyamide, and epichlorohydrin-modified polyamidoamine. In some embodiments, the chemical crosslinking agent is (1-ethyl-3-(3-dimethylaminopropyl)carbodiimide hydrochloride) (EDC), or NHS/EDC. In some embodiments, the chemical crosslinking agent is ketose containing 3-5 carbon atoms selected form the group consisting of dihydroxyacetone, erythrulose, ribulose and xylulose. In some embodiments, the chemical crosslinking agent is selected from the group consisting of mercaptoethanol, cysteine, dithiothreitol, and sulfites.

In some embodiments, the chemical crosslinking reaction is performed at a pH of at least 8.5, 9.0, 9.5, 10.0, 10.5, 11.0, 11.5, 12.0, 12.5, 13.0, 13.5 or 14.0. In some embodiments, the chemical crosslinking reaction is performed at a temperature of 25° C.

In some embodiments, the properties (e.g., tensile strength, gas permeability, oil permeability, elasticity, water solubility etc.) of the SPF coating layer can be enhanced by crosslinking the SPF in the coating solution by the addition of an enzyme which catalyzes intra- and/or intermolecular crosslinking of the protein is selected from the group consisting of transglutaminase; protein disulfide isomerase; sulfhydryl oxidase; lipoxygenase and peroxidase; and protein disulfide reductase (NAD(P)H and glutathione. Transglutaminase and protein disulfide isomerase cause inter- and intramolecular crosslinking of the protein through glutamine and cysteine, respectively. Transglutaminase catalyzes an acyl transfer reaction, in which the amide group of the amino acid glutamine is the acyl donor. The result of these reactions is a solution of a denatured SPF protein having a mixture of intermolecular and intramolecular disulfide crosslinks.

In some embodiments, the properties of SPF coating layer can be enhanced by heat treatment to the silk coating solution to produce denatured SPF. In some embodiments, the aqueous silk solution is heated to a temperature above the denaturation temperature of the particular protein for a period of time sufficient to initiate disulfide crosslinkage reactions. These thiol-disulfide interchange and thiol oxidation reactions can be either intramolecular or intermolecular. The precise temperature and length of time for a given protein can be determined empirically, but will typically involve temperatures of from about 70° C. to 95° C. In some embodiments, the heat treatment is performed at a temperature ranging from about 75° C. to about 85° C., and a duration up to 3 hours. In some embodiments, the heat treatment duration is from about 15 to 45 minutes.

Following reduction of disulfide bonds and thiol-disulfide interchange, any remaining free thiol groups can be oxidized either by exposure to atmospheric oxygen or by reaction with oxidizing agents.

In some embodiments, the silk coating solution comprises chains of silk fibroin fragments crosslinked via disulfide bond. In some embodiments, the silk solution comprises the chains of silk fibroin fragments linked via at least one disulfide bond. In some embodiments, the silk solution comprises the chains of silk fibroin fragments linked via one, two, three or more disulfide bonds.

In some embodiments, the concentration of the chemical crosslinking agent in the silk coating solution ranges from about 0.5% w/v to about 20.0 wt. % w/v by the total weight of the silk coating solution. In some embodiments, the concentration of the chemical crosslinking agent in the silk coating solution ranges from about 0.5% w/v to about 15.0 wt. % w/v by the total weight of the silk coating solution. In some embodiments, the concentration of the chemical crosslinking agent in the silk coating solution ranges from about 0.5% w/v to about 10.0 wt. % w/v by the total weight of the silk coating solution. In some embodiments, the concentration of the chemical crosslinking agent in the silk coating solution ranges from about 0.5% w/v to about 5.0 wt. % w/v by the total weight of the silk coating solution. In some embodiments, the concentration of the chemical crosslinking agent in the silk coating solution is selected from the group consisting of about 0.5 wt. % w/v, about 0.6 wt. % w/v, about 0.7 wt. % w/v, about 0.8 wt. % w/v, about 0.9 wt. % w/v, about 1.0 wt. % w/v, about 1.5 wt. % w/v, about 2.0 wt. % w/v, about 2.5 wt. % w/v, about 3.0 wt. % w/v, about 3.5 wt. % w/v, about 4.0 wt. % w/v, about 4.5 wt. % w/v, about 5.0 wt. % w/v, about 5.5 wt. % w/v, about 6.0 wt. % w/v, about 6.5 wt. % w/v, about 7.0 wt. % w/v, about 7.5 wt. % w/v, about 8.0 wt. % w/v, about 8.5 wt. % w/v, about 9.0 wt. % w/v, about 10.0 wt. % w/v, about 11.0 wt. % w/v, about 11.0 wt. % w/v, about 12.0 wt. % w/v, about 13.0 wt. % w/v, about 14.0 wt. % w/v, about 15.0 wt. % w/v, about 16.0 wt. % w/v, about 17.0 wt. % w/v, about 18.0 wt. % w/v, about wt. % w/v, and about 20.0 wt. % w/v.

### Optional Additive

In some embodiments, one or more optional additives are used to enhance certain properties of the SPF coating layer. In some embodiments, the SPF coating layer further comprises an optional additive selected from the group consisting of polyhydric alcohol, antioxidant, preservative, antimicrobial agent, anti-browning agent, flavor masking agent, flavoring agent, spice, fragrance, coloring agent, anti-caking agent, nutrient, vitamin, surfactant, emulsifier, and combinations thereof.

In some embodiments, waxes (e.g., beeswax, carnauba wax, or paraffin wax), oils and/or surfactants e.g., acetylated glycerides, or diacetyl tartaric acid esters of mono- and di-glycerides (DATEM esters)) are incorporated into the SPF coating layer to improve the water resistance. In some embodiments, glycerol, or polyethylene glycols are added to the SPF coating layer to plasticize the SPF coating. Additives that are soluble in water can be incorporated in the coating formulation by direct dissolution in the aqueous medium. Additives that are insoluble in water may be dispersed by surfactants and added as an emulsion or latex, or incorporated in the silk fibroin protein fragment powder during the drying process.

In some embodiments, the antioxidant is selected from the group consisting of citric acid, ascorbic acid, sodium ascorbate, and combinations thereof, wherein the antioxidant preserves the color of the perishable goods and delay browning.

In some embodiments, the vitamin is selected from the group consisting of Vitamin A, Vitamin B1, Vitamin B6, Vitamin C, Vitamin D, Vitamin E, and Vitamin K.

In some embodiments, the emulsifier is selected from the group consisting of egg yolk, lecithin, mustard, soy lecithin, diacetyl tartaric (acid) ester of monoglyceride, sodium stearoyl lactylate, and combinations thereof.

In some embodiments, the nutrient is protein, peptide, amino acid or any combinations thereof. In some embodiments, the protein is from a vegetable source, animal source, bacteria source, yeast source, synthetic source or any combination thereof. In some embodiments, the amino acid is selected from the group consisting of histidine, isoleucine, leucine, lysine, methionine, phenylalanine, threonine, tryptophan, valine, alanine, arginine, asparagines, aspartic acid, cysteine, glutamic acid, glutamine, glycine, ornithine, proline, selenocysteine, serine, taurine, tyrosine, gamma amino-butyric acid, hydroxyproline, selenomethionine, lanthionine, 2-aminoisobutyric acid, dehydro-alanine, ornithine, citrulline, beta-alanine, and combinations thereof. In some embodiments, the nutrient is an amino acid derived from silk fibroin protein hydrolysate. In some embodiments, the nutrient is an amino acid selected from the group consisting of glycine, serine and alanine.

In some embodiments, the aroma is an agent imparting an odor, fragrance or smell with the basic known fragrance characteristics or any combination thereof. For example, basic fragrance characteristics comprise sweet, pungent, acrid, fragrant, warm, dry, sour, or any combination thereof. Examples for food aroma agents comprise carbonyl compounds, pyranones, furanones, thiols, thioethers, di- and trisulfides, thiophenes, thiazoles, pyrroles, pyridines, pyrazines, phenols, alcohols, hydrocarbons, esters, lactones, terpenes, volatile sulfur compounds, or any combination thereof. In some embodiments, the flavor is derived from natural fruit juice, natural fruit juice concentrate, or any combination thereof.

In some embodiments, the coloring agent is any natural or artificial food coloring agent. In some embodiments, the food coloring agent is selected from the group consisting of Annatto (E160b), Betanin (E162), Butterfly pea (Clitoria ternatea), Caramel coloring (E150), Chlorophyllin (E140), Elderberry juice, Lycopene (E160d), Cochineal (E120), Pandan (Pandanus amaryllifolius), Paprika (E160c), Turmeric (curcuminoids, E100), Saffron (carotenoids, E160a), beet color, berry color, red cabbage color, Berry color derives from strawberry, blueberry, currant, raspberry, mulberry, grape, gooseberry, wolfberry (goji-berry), Artificial food coloring is FD&C Blue No. 1 Brilliant Blue FCF, E133 (blue shade), FD&C Blue No. 2 Indigotine, E132 (indigo shade), FD&C Green No. 3 Fast Green FCF, E143 (turquoise shade), FD&C Red No. 3 Erythrosine, E127 (pink shade, commonly used in glace cherries), FD&C Red No. 40 Allura Red AC, E129 (red shade), FD&C Yellow No. 5 Tartrazine, E102 (yellow shade), FD&C Yellow No. 6 Sunset Yellow FCF, E110 (orange shade), any other governmentally authorized food coloring, and combinations thereof.

In some embodiments, the anti-caking agent is selected from the group consisting of E341 tricalcium phosphate, E460(ii) powdered cellulose, E470b magnesium stearate, E500 sodium bicarbonate, E535 sodium ferrocyanide, E536 potassium ferrocyanide, E538 calcium ferrocyanide, E542 bone phosphate, E550 sodium silicate, E551 silicon dioxide, E552 calcium silicate, E553a magnesium trisilicate, E553b talcum powder, E554 sodium aluminosilicate, E555 potassium aluminium silicate, E556 calcium aluminosilicate, E558 bentonite, E559 aluminium silicate, E570 stearic acid, E900 polydimethylsiloxane, and combinations thereof.

In some embodiments, the antimicrobial agent is selected from the group consisting of vanillin, malic acid, an anti-microbial essential oil, benzoic acid, PHB esters, sorbic acid, propionic acid, acetic acid, sodium sulfite, sodium metabisulfite, diethyl pyrocarbonate, ethylene oxide, propylene oxide, nitrite, nitrate, diphenyl, o-phenylphenol, thiabendazole, and combinations thereof; wherein the antimicrobial agent functions as an inhibitor of the growing microorganisms, molds and yeasts during the storage of the perishable goods. In some embodiments, the antimicrobial agent is selected from the group consisting of vanillin and malic acid. In some embodiments, the antimicrobial agent is vanillin. In some embodiments, the antimicrobial agent is malic acid.

In some embodiments, the antimicrobial agent is antimicrobial essential oil. In some embodiments, the antimicrobial essential oil is selected from the group consisting of cinnamon oil, clove oil, eucalyptus oil, garlic, oregano oil, lavender oil, leleshwa oil, lemon oil, lemon myrtle oil, mint oil, neem oil, nigella sativa (black cumin) oil, onion oil, peppermint oil, sandalwood oil, ironwort, tea tree oil, thyme oil, and combinations thereof.

In some embodiments, the antioxidant (anti-oxydant) agent is vitamin E, vitamin E complex, tocopherols, 2,6-di-tert-butyl-p-cresol (BHT), tert-butyl-4-hydroxyanisole (BHA), propylgallate, octylgallate, dodecylgallate, ethoxyquin, ascorbyl palmitate, ascorbic acid (Vitamin C), alpha caroten, astaxantin, beta carotene (vitamin A), canthaxantin, luthein, lycophene, zeaxanthin, curcumin, flavonolignans, xanthones, eugenol, chicoric acid, chlorogenic acid, cinnamic acid, ellagic acid, elagitannins, gallic acid, gallotannins, rosmarinic acid, salicylic acid, flavonoid, and combinations thereof. In some embodiments, a flavonoid is selected from the group consisting of flavone, flavonol, flavanols, flavanone, isoflavone phytoestrogen, stilbenoid, anthocyanin, pterostilbene, and combinations thereof. In some embodiments, flavone is selected from the group consisting of apigenin, luteolin, tangeritin, and combinations thereof. In some embodiments, flavonol is selected from the group consisting of isorhamnetin, kaempferol, myricetin, proanthocyanidins (or condensed tannins), quercetin, rutin, and combination thereof. In some embodiments, flavanon is selected from the group consisting of eriodictyol, hesperetin (metabolizes to hesperidin), naringenin (metabolized from naringin), and combinations thereof. In some embodiments, flavanol comprises flavanol polymers. In some embodiments, flanvanol is selected from the group consisting of catechin, gallocatechin, gallocatechin gallate ester, epicatechin, epigallocatechin, epigallocatechin gallate ester, theaflavin, theaflavin gallate ester, thearubigin, and combinations thereof. In some embodiments, isoflavone phytoestrogens is selected from the group consisting of daidzein, genistein, glycitein, and combinations thereof. In some embodiments, stilbenoids is selected from the group consisting of resveratrolm, pterostilbene (methoxylated analogue of resveratrol), and combinations thereof. In some embodiments, anthocyanins is selected from the group consisting of cyanidin, delphinidin, malvidin, pelargonidin, peonidin, petunidin, and combinations thereof.

In some embodiments, the polyhydric alcohol is selected from the group consisting of ethylene glycol, glycerol, mannitol, maltitol, xylitol, sorbitol, glucose, fructose, galactose, xylose, sucrose, saccharose, maltose, lactose, and combinations thereof, wherein the polyhydric alcohol may function as plasticizer to keep the coating layer from becoming brittle.

In some embodiments, the disclosure provides a food composition comprising an SPF of the present disclosure. In some aspects, the SPF may be a dried powder. In some further aspects, the SPF may be in liquid form. In some aspects, the solution may comprise the SPF powder mixed with a solvent. In some aspects, the solvent may be a liquid. In some further aspects, the solvent may be an acid with a pH under 6.0. In some embodiments, the solvent may be an alcohol or water. In some embodiments, the solvent may be acetic acid.

In some embodiments, the SPF powder may be in a mixture containing an additive. In some embodiments, the liquid solvent may contain an additive. In some embodiments, both the SPF powder mixture and the liquid solvent may contain additives. In some embodiments, the silk fibroin may be emulsified with the additive prior to being mixed into the solution. For example, liquid SPF may be mixed or dry-blended with the additive prior to being mixed into the solution. In some embodiments, the additive may be at least one of a sugar, a plasticizer, or a crosslinking agent. For example, the sugar additive may be a sugar-ol, a poly-ol, or a hygroscopic polymer (e.g., polyethylene glycol). In other examples, if the sugar additive is a crosslinking agent, the crosslinking agent may be photoreactive. The crosslinking agent may be, for example, one or more of horseradish peroxidase, lysyl oxidase, disuccinimidyl suberate, disuccinimidyl glutarate, N-hydroxysuccinimide ester, or an aryl azide. In some embodiments, the additive may include one or more of a bacteria, a metal, an enzyme, or a biologic. For example, the metal may include one or more of an alkali metal, an alkaline earth metal, or a transition metal. In other examples, the biologic may be an insulin glargine, infliximad, rituximab, etanercept, adalimumab, monoclonal antibodies, trastuzumab, or other biologics. In some embodiments, the additive may be an oligonucleotide, such as an RNA. The RNA may be tRNA, mRNA, rRNA, snRNA, srpRNA, gRNA, TERC, SL RNA, crRNA, miRNA, siRNA, or eRNA. Alternatively, in other examples, the additive may be an enzyme (i.e., an RNase or a DNase), a fatty acid, a sugar (e.g., an alcohol sugar), or a mineral. For example, the enzyme may include erepsin maltase, lactase, sucrase, disaccharidases, lingual lipase, lysozymes, salivary amylase, pepsin, gastric lipase, other lipases, hydrochloric acids, intrinsic factors, mucins, gastrins, trypsinogen, ductal cells, carboxypeptidase, elastases, and the like.

In some embodiments, the additive may be at least one of a coloring agent, a chelator, a ligand, an antimicrobial, a filler, a scent, or a flavor. For example, the coloring agent may be allura red, Ponceau 3R, amaranth, erythrosine, indigotine, Light Green SF, Naphthol yellow, Orange 1, quinoline yellow, tartrazine, an E1 suit (e.g., E100, E161b, etc.), an anthocyanin, a betacyanin, a carotenoid, or a phenolic. In other examples, the chelator may be ethylenediaminetetraacetic acid (EDTA), transferrin, or desferrixoxamine. In some embodiments, the microbial may be acetic acid, benzoic acid, natamycin, nisin, nitrate, nitrite, propionic acid, sorbic acid, sulfite, or sulfur dioxide. In other examples, the filler is cellulose. In other alternative embodiments, the additive is one or more of a vitamin, a nutrient, an antioxidant, and a protein. In some embodiments, the protein is a peptide, an amino acid, (e.g., a post-translated amino acid), or a synthetic amino acid. In some embodiments, the nutrient is a mineral, protein, carbohydrate, fat, Q10, glutathione, lithium, probiotic, glycine, DHA, flavonoid, or others. Non-limiting examples of an antioxidant include vitamins C and E, selenium, carotenoids, thiols, catalase, superoxide dismutase, uric acid, and ubiquinol. In some embodiments, the additive one or more of a green tea extract, a rosemary extract, a phenolic antioxidant, catechin, acerola, tocopherol, chamomile extract, malphigia emarginata, camellia sinensis, epicatechin, epigallocatechin, gallochatechin, epigallocatechin gallates, vitamin A, vitamin E, and/or vitamin C. In some embodiments, the additive is mixed with an accelerant or an excipient. For example, the additive may be mixed with polyethylene glycol or xylitol. In some embodiments, the additive is emulsified with the accelerant or excipient and mixed into a silk fibroin solution. In some embodiments, the solution is deposited onto the food composition via spray-coating. In some embodiments, the solution is deposited onto the food composition via dip-coating. In some embodiments, the silk fibroin may not be annealed after or before deposition. In some embodiments, the food composition includes multiple layers of SPF. For example; the food could be sprayed with SPF solution, dried, and then sprayed once more. This can happen any number of times to add thickness and additional layers. In some further aspects, the food composition may comprise of multiple layers, with each layer serving a function. For example, the food may be coated with SPF. Then, the SPF-coated food may be itself coated by another coating that is hydrophobic or water-tight such that water may not permeate the outer layer and reach the inner SPF layer. In some further aspects, a tablet-coating may be utilized, where the SPF is coated while in an industrially-relevant drum. Tablet coating may additionally be utilized, as well as film-coating. See, for example, U.S. Patent Application Publication No. 20200178576, which is incorporated by reference herein in its entirety.

In some embodiments, the optional additive is present in the SPF coating layer at an amount ranging from about 0.01 wt. % to 6.0 wt. % by the total weight of the coated foodstuff. In some embodiments, the optional additive is present in the SPF coating layer at an amount ranging from about 0.1 wt. % to about 2.0 wt. % by the total weight of the coated foodstuff. In some embodiments, the optional additive is present in the SPF coating layer at an amount ranging from about 0.1 wt. % to about 1.0 wt. % by the total weight of the coated foodstuff. In some embodiments, the optional additive is present in the SPF coating layer at an amount selected from the group consisting of about 0.01 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2.0 wt. %, about 2.1 wt. %, about 2.2 wt. %, about 2.3 wt. %, about 2.4 wt. %, about 2.5 wt. %, about 2.6 wt. %, about 2.7 wt. %, about 2.8 wt. %, about 2.9 wt. %, about 3.0 wt. %, about 3.1 wt. %, about 3.2 wt. %, about 3.3 wt. %, about 3.4 wt. %, about 3.5 wt. %, about 3.6 wt. %, about 3.7 wt. %, about 3.8 wt. %, about 3.9 wt. %, about 4.0 wt. %, about 4.1 wt. %, about 4.2 wt. %, about 4.3 wt. %, about 4.4 wt. %, about 4.5 wt. %, about 4.6 wt. %, about 4.7 wt. %, about 4.8 wt. %, about 4.9 wt. %, about 5.0 wt. %, about 5.1 wt. %, about 5.2 wt. %, about 5.3 wt. %, about 5.4 wt. %, about 5.5 wt. %, about 5.6 wt. %, about 5.7 wt. %, about 5.8 wt. %, about 5.9 wt. %, and about 6.0 wt. % by the total weight of the coated foodstuff

In some embodiments, the SPF coating has a weight percent selected from the group consisting of about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.5 wt. %, about 2.0 wt. %, about 2.5 wt. %, about 3.0 wt. %, about 3.5 wt. %, about 4.0 wt. %, about 4.5 wt. %, about 5.0 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 10.0 wt. %, about 11.0 wt. %, about 11.0 wt. %, about 12.0 wt. %, about 13.0 wt. %, about 14.0 wt. %, about 15.0 wt. %, about 16.0 wt. %, about 17.0 wt. %, about 18.0 wt. %, about 19.0 wt. %, about 20.0 wt. %, about 21.0 wt. %, about 22.0 wt. %, about 23.0 wt. %, about 24.0 wt. %, about 25.0 wt. %, about 26.0 wt. %, about 27.0 wt. %, about 28.0 wt. %, about 29.0 wt. %, about 30.0 wt. %, about 31.0 wt. %, about 32.0 wt. %, about 33.0 wt. %, about 34.0 wt. %, about 35.0 wt. %, about 36.0 wt. %, about 37.0 wt. %, about 38.0 wt. %, about 39.0 wt. %, about 40.0 wt. %, about 41.0 wt. %, about 42.0 wt. %, about 43.0 wt. %, about 44.0 wt. %, about 45.0 wt. %, about 46.0 wt. %, about 47.0 wt. %, about 48.0 wt. %, about 49.0 wt. %, and about 50.0 wt. % and by the total weight of the coated perishable good.

In some embodiments, the SPF coating layer has a thickness ranging from 0.1 nm to 500 μm. In some embodiments, the SPF coating layer has a thickness less than 300 μm. In some embodiments, the SPF coating layer has a thickness ranging from 1 nm to 300 μm. In some embodiments, the SPF coating layer has a thickness ranging from 1 nm to 1000 nm. In some embodiments, the SPF coating layer has a thickness ranging from 1 μm to 300 μm. In some embodiments, the SPF coating layer has a thickness ranging from 1 μm to 100 μm. In some embodiments, the SPF coating layer has a thickness ranging from 1 μm to 50 μm. In some embodiments, the SPF coating layer has a thickness ranging from 1 μm to 10 μm. In some embodiments, the SPF coating layer has a thickness ranging from 0.1 μm to 10 μm. In some embodiments, the SPF coating layer has a thickness ranging from 10 μm to 100 μm. In some embodiments, the SPF coating layer has a thickness ranging from 100 μm to 300 μm. In some embodiments, the SPF coating layer has a thickness ranging from 50 μm to 300 μm. In some embodiments, the SPF coating layer has a thickness selected from 0.0001 μm, 0.002 μm, 0.003 μm, 0.004 μm, 0.005 μm, 0.006 μm, 0.007 μm, 0.008 μm, 0.009 μm, 0.01 μm, 0.02 μm, 0.03 μm, 0.04 μm, 0.05 μm, 0.1 μm, 0.2 μm, 0.3 μm, 0.4 μm, 0.5 μm, 0.6 μm, 0.7 μm, 0.8 μm, 0.9 μm, 1.0 μm, 1.5 μm, 2.0 μm, 2.5 μm, 3.0 μm, 3.5 μm, 4.0 μm, 4.5 μm, 5.0 μm, 5.5 μm, 6.0 μm, 6.5 μm, 7.0 μm, 7.5 μm, 8.0 μm, 8.5 μm, 9 μm, 10 μm, 20 μm, 30 μm, 40 μm, 50 μm, 75 μm, 100 μm, 110 μm, 125 μm, 150 μm, 175 μm, 200 μm, 225 μm, 250 μm, 275 μm, 300 μm and 500 μm.

In some embodiments, at least a portion of a perishable good may be coated or covered with one or more layers of SPF coating. A layer of SPF coatings may be of any suitable thickness, for example, between about 0.1 μm and about 1 mm. In some embodiments, a layer of SPF coating layer has a thickness selected from the group consisting of about 0.5 μm, about 1 μm, about 5 μm, about 10 μm, about 15 μm, about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, and about 1000 μm.

In some embodiments, SPF-based coatings of the present disclosure form conformal covering or sheath on at least a portion of the surface of a perishable product. In some embodiments, such coatings may completely ensheathe one or all surfaces of a perishable product.The water content of the SPF coating layer affects the blocking resistance, flexibility and other properties of the SPF coating layer, it should be adjusted to obtain desired film properties. If the water content is relatively high, the SPF coating layer shows improvement in flexibility and resistance to extension, but suffers a reduction in blocking resistance. On the other hand, if the water content is relatively low, the SPF coating layer shows an improvement in blocking resistance, but suffers a reduction in flexibility. In some embodiments, the SPF coating layer has a water content not greater than 25.0 wt. % by the total weight of the SPF coating layer. In some embodiments, the SPF coating layer has a water content not greater than 20.0 wt. % by the total weight of the SPF coating layer.

In some embodiments, the SPF coating layer may further comprises a separate edible sub-coating layer, a colored layer, a gas barrier layer and/or a plurality of sub-film layers formed from film forming materials described above.

In some embodiments, the SPF coating layer exhibits low water permeability and suitable for forming an effective moisture barrier to prevent the loss of moisture from perishable products.

In some embodiments, the SPF coating layer has a water diffusivity of less than 10^{-≢}cm²/s, e.g., less than 10⁻⁷ cm²/s, less than 10⁻⁸ cm²/s, less than 10⁻⁹ cm²/s, or less. In some embodiments, such coatings have a water diffusivity ranging between about 10−6 cm²/s and about 10⁻⁹ cm²/s, e.g., between about 10⁻⁶ cm²/s and about 10⁻⁷ cm²/s, between about 10⁻⁶ cm²/s and about 10⁻⁸ cm²/s, between about 10⁻⁸ cm²/s and about 10⁻⁸ cm²/s, between about 10⁻⁷ cm²/s and about 10⁻⁹ cm²/s, and between about 10⁻⁸ cm²/s and about 10⁻⁹ cm²/s.

In some embodiments, the SPF coating layer exhibits low gas permeability. In some embodiments, coatings described herein have an oxygen permeability coefficient (Dk_{O2}) of less than 10⁻¹⁰ [(ml_{O2}.cm)/(cm.s.mmHg)]. In some embodiments, such coatings have an oxygen permeability coefficient (Dk_{O2}) ranging between about 10⁻¹⁰ and about 10⁻¹³ [(ml_{O2}.cm)/(cm.s.mmHg)], e.g., between about 10⁻¹⁰ and about 10⁻¹² [(ml_{O2}.cm)/(cm.s.mmHg)], between about 10⁻¹⁰ and about 10⁻¹¹ [(ml_{O2}.cm)/(cm.s.mmHg)], between about 10⁻¹¹ and about 10⁻¹³ [(ml_{O2}.cm)/(cm.s.mmHg)], between about 10⁻¹¹ and about 10⁻¹² [(ml_{O2}.cm)/(cm.s.mmHg)]. In some embodiments, an oxygen permeability coefficient (Dk_{O2}) of described coatings is about 10⁻¹³ [(ml_{O2}.cm)/(cm.s.mmHg)], about 10⁻¹² [(ml_{O2}.cm)/(cm.s.mmHg)], or about 10⁻¹¹ [(ml_{O2}.cm)/(cm.s.mmHg)], about 10⁻¹⁰ [(ml_{O2}.cm)/(cm s mmHg)].

In some embodiments of the disclosure, the SPF coating layer is useful for the enhanced or improved ability to preserve perishable goods that are susceptible to dehydration, susceptible to discoloration, susceptible to oxidation, susceptible to photodegradation, susceptible to enzymatic degradation, susceptible to decay caused by microbe, ethylene-sensitive, emit ethylene, susceptible to mechanical bruising, or any combination thereof.

### Method of Coating Perishable Goods

In some embodiments, this disclosure provides a method to retard spoilage of perishable goods and extending the useful storage lives thereof, wherein the method comprising:

(a) providing a pure silk coating solution containing the silk fibroin protein fragments as described above,

(b) providing a perishable good selected from the group consisting of fresh fruit and vegetable,

(c) coating the perishable good with the silk coating solution to form a wet coated perishable good, and

(d) air drying the coated wet coated perishable good to form a coated perishable good with a dry silk coating layer, wherein the dry silk coating layer acting as an barrier layer for retarding the perishable good from reacting with atmospheric oxygen or carbon dioxide gas, wherein the coating layer retarding the loss of moisture from perishable good.

In a broad sense, such method involves adding a coating to at least part of a perishable item desired to be stored or preserved. Typically, at least a portion of the perishable item is in direct contact with at least a portion of a coating comprising a SPF as described in more detail above.

A perishable item is said to be preserved, at least in part, when it retains one or more properties or the original status/features, as measured by any suitable parameters, such as water content, color, weight, shape, texture, structural integrity, taste, flavor, smell, and so on.

The silk coating solution is an aqueous solution of silk fibroin protein fragments prepared according to the methods described in the Example 1 and 5a below. The silk fibroin protein fragments in the aqueous solution has a concentration ranges from about 0.1-20 wt. % by the total weight of the aqueous solution of silk fibroin protein fragments. The silk fibroin protein fragments in the aqueous solution has a concentration selected from the group consisting of about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 1.5 wt. %, about 2.0 wt. %, about 3.0 wt. %, about 4.0 wt. %, about 5.0 wt. %, about 6.0 wt. %, about 7.0 wt. %, about 8.0 wt. %, about 9.0 wt. %, about 10.0 wt. %, about 11.0 wt. %, about 12.0 wt. %, about 13.0 wt. %, about 14.0 wt. %, about 15.0 wt. %, about 16.0 wt. %, about 17.0 wt. %, about 18.0 wt. %, about 19.0 wt. %, and about 20.0 wt. % by the total weight of the aqueous solution of silk fibroin protein fragments.

In some embodiments, the SPF-based coating layer may be dried, and optionally annealed, crossed-linked, or both.

In some embodiments, the water solubility of pure silk fibroin-based protein fragments of the present disclosure is 50 to 100%. In some embodiments, the water solubility of pure silk fibroin-based protein fragments of the present disclosure is 60 to 100%. In some embodiments, the water solubility of pure silk fibroin-based protein fragments of the present disclosure is 70 to 100%. In some embodiments, the water solubility of pure silk fibroin-based protein fragments of the present disclosure is 80 to 100%. In some embodiments, the water solubility is 90 to 100%. In some embodiments, the silk fibroin-based fragments of the present disclosure are non-soluble in aqueous solutions.

In some embodiments, the solubility of pure silk fibroin-based protein fragments of the present disclosure in organic solutions is 50 to 100%. In some embodiments, the solubility of pure silk fibroin-based protein fragments of the present disclosure in organic solutions is 60 to 100%. In some embodiments, the solubility of pure silk fibroin-based protein fragments of the present disclosure in organic solutions is 70 to 100%. In some embodiments, the solubility of pure silk fibroin-based protein fragments of the present disclosure in organic solutions is 80 to 100%. In some embodiments, the solubility of pure silk fibroin-based protein fragments of the present disclosure in organic solutions is 90 to 100%. In some embodiments, the silk fibroin-based fragments of the present disclosure are non-soluble in organic solutions.

In some embodiments, the extraction temperature during a method of preparing a composition of the present disclosure is greater than 84° C. In some embodiments, the extraction temperature during a method of preparing a composition of the present disclosure is less than 100° C. In some embodiments, the extraction temperature during a method of preparing a composition of the present disclosure is 84° C. to 100° C. In some embodiments, the extraction temperature during a method of preparing a composition of the present disclosure is 84° C. to 94° C. In an embodiment, the extraction temperature during a method of preparing a composition of the present disclosure is 94° C. to 100° C.

There is disclosed an edible material and/or foodstuff that is at least surface treated with an aqueous solution of pure silk fibroin-based protein fragments of the present disclosure to result in a silk coating on the foodstuff. In some embodiments, the silk coating of the present disclosure is available in a spray can and can be sprayed on any foodstuff by a consumer. In some embodiments, a foodstuff comprising a silk coating of the present disclosure is sold to a consumer.

In some embodiments, the silk coating solution contains no plasticizer.

In some embodiments, the silk coating solution is applied to the surface of perishable goods by dipping, brushing, smearing, immersing or spraying. The silk coating solution is applied to the perishable goods and dried under moderate heat to evaporate the water, and cause the silk fibroin protein fragment self-assemble into a continuous film.

Any suitable techniques may be used to perform the step of coating (e.g., step of depositing a coating material onto a perishable item). For example, the coating process may be carried out by any suitable means, including but are not limited to, dip-coating, spray-coating, brushing on, and so on. Such step may be carried out once or repeated multiple times, e.g., 2 times, 3 times, 4 times, 5 times, 6 times, 7 times, 8 times, 9 times, 10 times, 11 times, 12 times, 13 times, 14 times, 15 times, 16 times, 17 times, 18 times, 19 times, 20 times, 21 times, 22 times, 23 times, 24 times, 25 times 26 times, 27 times, 28 times, 29 times, 30 times, or more.

In some embodiments, a method further comprises a step of removing excess coating from the coated foodstuff. In some examples, the removal of excess coating is by shaking, vibrating, jarring, jolting, pulsating, juddering, shivering, shuddering, quaking, quivering, trembling, rocking, bumping, wobbling, rattling, quivering or agitating the coated foodstuff (e.g., silk food or beverage product).

In some embodiments, the coating may applied by dripping the perishable good in the silk coating solution for a period of time of at least 1 minute, 5 minutes, 10 minutes, 20 minutes, 30 minutes, 40 minutes, 50 minutes, 60 minutes, 70 minutes, 80 minutes or more to allow the perishable good to absorb an appropriate amount of silk fibroin protein fragment coating material necessary to form the coating layer with desired thickness.

In some embodiments, the coating process further comprise a step of annealing the wet coated perishable good for strengthening, toughening, galvanizing or forging the SPF coating layer formed thereof.

In some embodiments, the SPF coating layer comprising amorphous SPF film. In some embodiments, the SPF coating layer comprising crystalline SPF film. In some embodiments, the process of annealing may involve inducing beta-sheet formation in the SPF used as a coating material. Techniques of annealing (e.g., increase crystallinity) or otherwise promoting “molecular packing” of SPFs have been described. In some embodiments, the amorphous SPF film is annealed to introduce beta-sheet in the presence of a solvent selected from the group consisting of water or organic solvent. In some embodiments, the amorphous SPF coating layer is annealed to introduce beta-sheet in the presence of water (water annealing process). In some embodiments, the amorphous SPF coating layer is annealed to introduce beta-sheet in the presence of methanol. In some embodiments, annealing (e.g., the beta sheet formation) is induced by addition of an organic solvent. Suitable organic solvents include, but are not limited to methanol, ethanol, acetone, isopropanol, or combination thereof.

In some embodiments, annealing is carried out by so-called “water-annealing” or “water vapor annealing” in which water vapor is used as an intermediate plasticizing agent or catalyst to promote the packing of beta-sheets. In some embodiments, the process of water annealing may be performed under vacuum. Suitable such methods have been described in Jin H-J et al. (2005), Water-stable Silk Films with Reduced Beta-Sheet Content, Advanced Functional Materials, 15: 1241-1247; Xiao H. et al. (2011), Regulation of Silk Material Structure by Temperature-Controlled Water Vapor Annealing, Biomacromolecules, 12(5): 1686-1696.

The important feature of the water annealing process is to drive the formation of crystalline beta-sheet in the SPF peptide chain to allow the SPF self-assembling into a continuous film. In some embodiments, the crystallinity of the SPF coating layer was controlled by controlling the temperature of water vapor and duration of the annealing. In some embodiments, the annealing is performed at a temperature ranging from about 65° C. to about 110° C. In some embodiments, the temperature of the water is maintained at about 80° C. In some embodiments, annealing is performed at a temperature selected from the group consisting of about 65° C., about 70° C., about 75° C., about 80° C., about 85° C., about 90° C., about 95° C., about 100° C., about 105° C., and about 110° C.

In some embodiments, the annealing process lasts a period of time selected from the group consisting of about 1 minute to about 40 minutes, about 1 minute to about 50 minutes, about 1 minute to about 60 minutes, about 1 minute to about 70 minutes, about 1 minute to about 80 minutes, about 1 minute to about 90 minutes, about 1 minute to about 100 minutes, about 1 minute to about 110 minutes, about 1 minute to about 120 minutes, about 1 minute to about 130 minutes, about 5 minutes to about 40 minutes, about 5 minutes to about 50 minutes, about 5 minutes to about 60 minutes, about 5 minutes to about 70 minutes, about 5 minutes to about 80 minutes, about 5 minutes to about 90 minutes, about 5 minutes to about 100 minutes, about 5 minutes to about 110 minutes, about 5 minutes to about 120 minutes, about 5 minutes to about 130 minutes, about 10 minutes to about 40 minutes, about 10 minutes to about 50 minutes, about 10 minutes to about 60 minutes, about 10 minutes to about 70 minutes, about 10 minutes to about 80 minutes, about 10 minutes to about 90 minutes, about 10 minutes to about 100 minutes, about 10 minutes to about 110 minutes, about 10 minutes to about 120 minutes, about 10 minutes to about 130 minutes, about 15 minutes to about 40 minutes, about 15 minutes to about 50 minutes, about 15 minutes to about 60 minutes, about 15 minutes to about 70 minutes, about 15 minutes to about 80 minutes, about 15 minutes to about 90 minutes, about 15 minutes to about 100 minutes, about 15 minutes to about 110 minutes, about 15 minutes to about 120 minutes, about 15 minutes to about 130 minutes, about 20 minutes to about 40 minutes, about 20 minutes to about 50 minutes, about 20 minutes to about 60 minutes, about 20 minutes to about 70 minutes, about 20 minutes to about 80 minutes, about 20 minutes to about 90 minutes, about 20 minutes to about 100 minutes, about 20 minutes to about 110 minutes, about 20 minutes to about 120 minutes, about 20 minutes to about 130 minutes, about 25 minutes to about 40 minutes, about 25 minutes to about 50 minutes, about 25 minutes to about 60 minutes, about 25 minutes to about 70 minutes, about 25 minutes to about 80 minutes, about 25 minutes to about 90 minutes, about 25 minutes to about 100 minutes, about 25 minutes to about 110 minutes, about 25 minutes to about 120 minutes, about 25 minutes to about 130 minutes, about 30 minutes to about 40 minutes, about 30 minutes to about 50 minutes, about 30 minutes to about 60 minutes, about 30 minutes to about 70 minutes, about 30 minutes to about 80 minutes, about 30 minutes to about 90 minutes, about 30 minutes to about 100 minutes, about 30 minutes to about 110 minutes, about 30 minutes to about 120 minutes, about 30 minutes to about 130 minutes, about 35 minutes to about 40 minutes, about 35 minutes to about 50 minutes, about 35 minutes to about 60 minutes, about 35 minutes to about 70 minutes, about 35 minutes to about 80 minutes, about 35 minutes to about 90 minutes, about 35 minutes to about 100 minutes, about 35 minutes to about 110 minutes, about 35 minutes to about 120 minutes, about 35 minutes to about 130 minutes, about 40 minutes to about 50 minutes, about 40 minutes to about 60 minutes, about 40 minutes to about 70 minutes, about 40 minutes to about 80 minutes, about 40 minutes to about 90 minutes, about 40 minutes to about 100 minutes, about 40 minutes to about 110 minutes, about 40 minutes to about 120 minutes, about 40 minutes to about 130 minutes, about 45 minutes to about 50 minutes, about 45 minutes to about 60 minutes, about 45 minutes to about 70 minutes, about 45 minutes to about 80 minutes, about 45 minutes to about 90 minutes, about 45 minutes to about 100 minutes, about 45 minutes to about 110 minutes, about 45 minutes to about 120 minutes, and about 45 minutes to about 130 minutes. In some embodiments, the annealing process lasts a period of time ranging from about 1 minute to about 60 minutes. In some embodiments, the annealing process lasts a period of time ranging from about 45 minutes to about 60 minutes. The longer water annealing post-processing corresponded an increased crystallinity of silk fibroin protein fragments.

In some embodiments, the annealed SPF coating layer is immersing the wet SPF coated perishable goods in 100% methanol for 60 minutes at room temperature. The methanol annealing changed the composition of SPF coating layer from predominantly amorphous random coil to crystalline antiparallel beta-sheet structure.

In some embodiments, the silk coating layer comprising silk fibroin protein fragments having (i) an average weight average molecular weight selected from the group consisting of between about 1 kDa and about 5 kDa, between about 5 kDa and about 10 kDa, between about 6 kDa and about 17 kDa, between about 10 kDa and about 15 kDa, between about 15 kDa and about 20 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa; and (ii) a polydispersity between 1 and about 5.

In some embodiments, the polydispersity is between 1 and about 1.5. In some embodiments, the polydispersity is between about 1.5 and about 3.0. In some embodiments, the polydispersity is between is between about 1.5 and about 2.0. In some embodiments, the polydispersity is between is between about 2.0 and about 2.5. In some embodiments, the polydispersity is between is between about 2.5 and about 3.0.

In some embodiments, the silk fibroin fragments are present in the coated perishable good at a weight amount ranging from about 0.001 wt. % to about 10.0 wt. % by the total weight of the dry silk coated perishable good. In some embodiments, the silk fibroin fragments are present in the coated perishable good at a weight amount ranging from about 0.001 wt. % to about 5.0 wt. % by the total weight of the dry silk coated perishable good. In some embodiments, the silk fibroin fragments are present in the coated perishable good at a weight amount ranging from about 0.001 wt. % to about 1.0 wt. % by the total weight of the dry silk coated perishable good. In some embodiments, the silk fibroin fragments are present in the coated perishable good at a weight amount ranging from about 10 wt. % by the total weight of the dry silk coated perishable good.

In some embodiments, the SPF coating layer is transparent. In some embodiments, the SPF coating layer is translucent. Transparency is a desirable feature for keeping the natural color or appearance of the perishable product. In some embodiments, SPF coatings may have an effect of added sheen (e.g., glossy appearance) to the product being coated.

In some embodiments, the SPF coating layer has a water diffusivity of less than 10⁻⁶ cm²/s, e.g., less than 10⁻⁷ cm²/s, less than 10⁻⁻⁸ cm²/s, less than 10⁻⁹ cm²/s, or less. In some embodiments, such coatings have a water diffusivity ranging between about 10′ cm²/s and about 10⁻⁹ cm²/s, e.g., between about 10 ⁻⁶ cm²/s and about 10⁻⁷ cm²/s, between about 10⁻⁶ cm²/s and about 10⁻⁸ cm²/s, between about 10⁻⁷ cm²/s and about 10⁻⁸ cm²/s, between about 10⁻⁷ cm²/s and about 10⁻⁹ cm²/s, and between about 10⁻⁸ cm²/s and about 10′ cm²/s.

In some embodiments, the SPF coating layer exhibits low gas permeability. In some embodiments, coatings described herein have an oxygen permeability coefficient (Dk_{O2}) of less than 10⁻¹⁰ [(ml_{O2}cm)/(cm.s.mmHg)]. In some embodiments, such coatings have an oxygen permeability coefficient (Dk_{O2}) ranging between about 10⁻¹⁰ and about 10⁻¹³ [(ml_{O2} cm)/(cm.s.mmHg)], e.g., between about 10⁻¹⁰ and about 10⁻¹² [(ml_{O2} cm)/(cm.s.mmHg)], between about 10⁻¹⁰ and about 10⁻¹¹ [(ml_{O2} cm)/(cm.s.mmHg)], between about 10⁻¹¹ and about 10⁻¹³ [(ml_{O2}cm)/(cm.s.mmHg)], between about 10⁻¹¹ and about 10⁻¹² [(ml_{O2} cm)/(cm.s.mmHg)]. In some embodiments, an oxygen permeability coefficient (Dk_{O2}) of described coatings is about 10⁻¹³ [(ml_{O2} cm)/(cm.s.mmHg)], about 10⁻¹² [(ml_{O2}cm)/(cmsmmHg)], or about 10⁻¹¹ [(ml_{O2} cm)/(cm.s.mmHg)], about 10⁻¹⁰ [(ml_{O2} cm)/(cm.s.mmHg)].

In some embodiments, the SPF coating layer of the disclosure are useful for the enhanced or improved ability to preserve perishable items that are susceptible to dehydration, susceptible to discoloration, susceptible to oxidation, susceptible to photodegradation, susceptible to enzymatic degradation, susceptible to decay caused by microbe, ethylene-sensitive, emit ethylene, susceptible to mechanical bruising, or any combination thereof

The coated perishable good (e.g., strawberries) maintained the original intense red color of the product, as well as a firm texture and a good flavor and odor of the product during storage. On the contrary, the uncoated strawberries showed a rather dull red color and dark tones throughout the storage, a notable loss of the texture thereof being also evident. Furthermore, there could also be appreciated an accumulation of odors proper to fermentation processes in the uncoated product at the end of storage.

In some embodiments, the techniques for SPF coated perishable good gave important advantages including as carrier for incorporating several active ingredients into the edible SPF film matrix and consumed with the perishable goods thereby enhancing safety, nutritional and sensory attributes.

Thus, the disclosure provides methods for enhanced preservation of perishable items that are susceptible to decay or fermentation caused by fungus (e.g., mold), bacteria, or combination thereof. Generally, freshness of perishable products is better preserved when such products are coated multiple times with the SPF-based coating described herein, and when the protein crystalline formation is induced in the coating material, resulting in prolonged preservation observed by structural integrity and appearance of external and internal tissues of the products following standard storage. Correspondingly, increasing coating steps and increasing protein crystallinity resulted in the down-regulation of microbial growth, visible by reduced fungal and mold decay.

In some embodiments, suitable storage conditions involve storing a perishable item at a temperature ranging between about 2° C. and about 50° C. In some embodiments, suitable storage conditions involve storing a perishable item at a temperature ranging between about 2° ° C. and about 35° C. In some embodiments, suitable storage conditions involve storing a perishable item at a temperature selected form the group consisting of about 2° C., about 3° C., about 4° C., about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., about 30° C., about 31° C., about 32° C., about 33° C., about 34° C., and about 35° C.

In some embodiments, suitable storage conditions involve storing a perishable item at a temperature ranging between about −16° C. and about 2° C. In some embodiments, suitable storage conditions involve storing a perishable item at a temperature selected form the group consisting of about −16° C., about −15° C., about −14° C., about −13° C., about −12° C., about −11° C., about −10° C., about −9° C., about −8° C., about −7° C., about −6° C., about −5° C., about −4° C., about −3° C., about −2° C., about −1° C., about 0° C., about 1° C., and about 2° C.

In any of such embodiments, suitable storage conditions involve storing a perishable item under certain humidity levels, e.g., less than 5%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, and about 100%.

In any of such embodiments, suitable storage conditions involve storing a perishable item for a duration of time, ranging between about 1 hour and about 3 years. More typically, storage duration ranges between about 1 day and about 1 year, e.g., about 1 day, 2 days, 3 days, 4 days, 5 days, 6 days, 7 days, 8 days, 9 days, 10 days, 11 days, 12 days, 13 days, 2 weeks, 3 weeks, 4 weeks, 5 weeks, 6 weeks, 7 weeks, 8 weeks, 9 weeks, 10 weeks, 11 weeks, 12 weeks, 4 months, 5 months, 6 months, 7 months, 8 months, 9 months, 10 months, 11 month, 12 months, or longer.

Coatings prepared and used in accordance with the present application may significantly extend the shelf life of perishable products coated or packaged therewith. “Shelf life” is generally defined as the duration of time that a commodity may be stored without becoming unfit for use or consumption. Thus, shelf-life is the recommended maximum time, for which products can be stored, during which the defined quality of a specified proportion of the goods remains acceptable under expected (or specified) conditions of distribution, storage and display.

In some regions, an advisory best before, mandatory use by, or freshness date is required on packaged perishable foods. Coatings described herein may include such information.

Generally, “expiry dates” are used as guidelines based on normal and expected handling and exposure to temperature. Use prior to the expiration date does not guarantee the safety of a perishable product, and such a product is not necessarily dangerous or ineffective after the expiration date.

For foodstuffs, shelf life is typically different from expiration date in that the former refers to food quality, while the latter refers to food safety. A perishable product that has passed its shelf life might still be safe, but quality is no longer guaranteed.

In some embodiments, use of a coating described herein prolongs the shelf life of a perishable product coated therewith, as compared to the same or similar product without the described coating, when both products are processed and stored otherwise under identical or substantially similar conditions. With the use of the described coating, in some embodiments, the shelf-life of a perishable product is extended by at least 5%, at least 10%, at least 15%, at least 20%, at least 25%, at least 30%, at least 35%, at least 40%, at least 45%, at least 50%, at least 55%, at least 60%, at least 70%, at least 75%, at least 80%, at least 85%, at least 90%, at least 95%, or greater, relative to the shelf-life of an equivalent product under the otherwise same processing and storage conditions, with the exception of the coating.

In some embodiments, an average shelf-life of a perishable item coated with a coating described in the present application is increased by between about 1.1 and about 10 fold, as compared to the corresponding counterpart (e.g., reference), i.e., an item without the inventive coating, e.g., about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.5, about 5.0, about 5.5, about 6.0, about 6.5, about 7.0, about 7.5, about 8.0, about 8.5, about 9.0, about 9.5, and about 10 fold.

In some embodiments, an average shelf-life of a perishable product coated with a coating described herein, as compared to a reference product without such coating, is extended by at least 1 day, at least 2 days, at least 3 days, at least 4 days, at least 5 days, at least 6 days, at least 7 days, at least 8 days, at least 9 days, at least 10 days, at least 11 days, at least 12 days, at least 13 days, at least 14 days, at least 15 days, at least 16 days, at least 17 days, at least 18 days, at least 19 days, at least 20 days, at least 21 days, at least 22 days, at least 23 days, at least 24 days, at least 25 days, at least 26 days, at least 27 days, at least 28 days, at least 29 days, at least 30 days, at least 5 weeks, at least 6 weeks, at least 7 weeks, at least 8 weeks, at least 9 weeks, at least 10 weeks, at least 11 weeks, at least 12 weeks, at least 4 months, at least 5 months, at least 6 months, at least 7 months, at least 8 months, at least 9 months, at least 10 months, at least 11 months, at least 1 year, at least 18 months, at least 2 years, at least 30 months, at least 3 years, at least 4 years, at least 5 years, or longer.

In some embodiments, coatings described in the present disclosure can reduce the need for, or even eliminate, the conventional cold chain requirement typically employed for a particular perishable product. For example, in some embodiments, perishable products that are typically shipped and/or stored at certain ranges of preferred or recommended temperatures may retain one or more parameters of product quality outside such temperature ranges, when coated with a coating described according to the present disclosure. In some embodiments, products coated with such a coating may withstand a greater degree of deviations and/or fluctuations in temperature, moisture, mechanical stress, light exposure, or any combination thereof, as determined by any one of parameters described herein or other suitable methods known in the art.

### Measurements of Preservation

There are a number of parameters to measure relative efficacy of food preservation. Any suitable means may be employed to measure or assay for the degree of freshness or preservation of, or assess the quality of, perishable products before and after or over the course of storage. These include, without limitation, changes in weight, which may reflect water loss, changes in shape or overall structural integrity, changes in texture such as firmness, changes in colors including overall shading or local spotting, changes in chemical species (e.g., contents of sugar, starch, etc.), changes in acidity, changes in smell, taste, etc. Relative gas exchange rates (e.g., oxygen permeability) may also be measured. In addition, emission of specific compounds such as ethylene may be measured. See also U.S. Patent Application Publication 20170156356 and 20190343137, all of which are incorporated by reference herein in their entireties Climacteric Fruits and Non-Climacteric Fruits

Fruits that ripen through ethylene production and increased cell respiration are called climacteric. Examples of climacteric fruits include, without limitation, apples, bananas, and tomatoes. By contrast, berries and grapes are non-climacteric fruits. The climacteric event is said to be associated with changes in fruit color and with the production of sugar in the extracellular space.

In some embodiments, SPF coating layers of the disclosure are effective in preserving both climacteric and non-climacteric types of produce. In some embodiments, SPF coating layers described herein may be used to retard the rate of ripening process of fruits. In some embodiments, SPF coating layers described herein may be used to maintain the firmness of fruits. In some embodiments, SPF coating layers described herein may be used to slow microbe growth. In some embodiments, certain fruits, such as non-climacteric fruits (e.g., berries), coated with a SPF coating layer described herein, may show very limited presence of “black spots” which are typically indicative of the presence of mold on the surface of the fruits.

In some embodiments, protein polymorphism may be used to tailor the properties of the coating, affecting the interplay between the protein (such as silk fibroin) and water evaporation and the microbial-driven food decay.

2. Foodstuffs Modified with Silk Fibroin Protein Based Additives and/or Ingredients

Many snack food items produced by the food industry are provided with a coating. Such coatings are used to maintain a desired moisture content in the coated food article, and to provide additional qualities to the food article that will enhance consumer appeal, such as flavor and mouth feel. Such coatings typically comprise fats, sugars, and other flavor enhancers.

In recent years, there has been increasing concern about high levels of consumption of both fat and sugar, and a corresponding concern about lower levels of protein consumption. The food industry has provided a variety of products intended to address those concerns. One such food product that has gained in popularity in recent years is a snack bar made with enhanced nutrients, and especially a higher protein content. In standard confectionery items, protein comes from four main sources—milk, egg whites, soy products, and grains. The concentrated protein in such bars is hygroscopic, and can absorb moisture from the other ingredients in the bar, making the bar hard and less appealing to the consumer. Increased protein can make it difficult to maintain a desired moisture level in the bar. Some energy bar products are provided with a coating to help maintain the moisture level of the bar. Such coatings typically include sugar, fat, cocoa powder, nonfat dry milk, salt, and lecithin. In some products, the sugar may be replaced with one or more sugar alcohols, such as maltitol or lactitol and other artificial sweeteners such as sucralose, saccharin and aspartame.

It would be desirable to provide a coating composition with a higher protein content for such products to provide an additional health benefit to consumers.

In an embodiment, this disclosure provides food or beverage composition comprises the silk fibroin protein fragments as described above as an additive (SPF additive) and one or more food or beverage ingredients.

In an embodiment, this disclosure provides food or beverage composition comprises effective amount of the silk fibroin protein fragments as described above as an ingredient (SPF ingredient) and one or more food or beverage ingredients.

In some embodiments, the food ingredient is selected from the group consisting of simple sugar, disaccharide, carbohydrate, fat, oil, vitamin, mineral, water, protein, amino acid, and combinations thereof. In some embodiments, the beverage ingredient is selected from the group consisting of water, coloring agent, vitamin, mineral, protein, amino acid, and combinations thereof.

In some embodiments, a water-soluble silk coating may be used as an adhesive or binder for binding particles to a foodstuff. In some embodiments, a coated silk food or beverage product comprises a foodstuff having a surface in contact with an edible SPF coating.

In some embodiments, the coating has a thickness selected from the group consisting of about 5 nm, about 10 nm, about 15 nm, about 20 nm, about 25 nm, about 50 nm, about 100 nm, about 200 nm, about 500 nm, about 1 μm, about 5 μm, about 10 μm, and about 20 μm. In some embodiments, the coating has a thickness range selected from the group consisting of about 5 nm to about 100 nm, about 100 nm to about 200 nm, about 200 nm to about 500 nm, about 1 μm to about 2 μm, about 2 μm to about 5 μm, about 5 μm to about 10 μm, and about 10 μm to about 20 μm.

In some embodiments, a silk food or beverage product comprises a foodstuff mixed with silk fibroin protein fragments.

In some embodiments, this disclosure provides a food product fortified with effective amount of the silk fibroin protein fragments described above, wherein the food product includes energy bar, dairy products, cereals, breads, pasta, and processed foods, wherein the SPF containing food product exhibits improved nutritional value, health benefits, and/or therapeutic advantages to human or animal that consumes the food or beverage. In some embodiments, this disclosure provides a beverage product fortified with effective amount of the silk fibroin protein fragments described above, wherein the beverage product includes yogurt, beers, milk, and fruit juice.

In some embodiments, this disclosure provides food or beverage composition comprises effective amount of the silk fibroin protein fragments as described above as fat replacer and one or more food or beverage ingredients. As used herein, the term “fat replacer” refers to any substance the intended use of which results in providing expected texture and a creamy “mouth-feel” in reduced-fat foods. In some embodiments, the silk fibroin protein fragments may be incorporated in the food or beverage composition to replace in part or in whole of a food ingredient selected from the group consisting of cellulose gel, carrageenan, modified food starch, microparticulated egg white protein, guar gum, xanthan gum, and whey protein concentrate. In some embodiments, the foodstuff containing silk fibroin protein fragments as fat replacer may be selected from the group consisting of baked goods, dressings, frozen desserts, confections, cake and dessert mixes, and dairy products.

In some embodiments, this disclosure provides food or beverage composition comprises effective amount of the silk fibroin protein fragments as described above as food emulsifier and one or more food or beverage ingredients. As used herein, the term “food emulsifier” refers to any substance the intended use of which allowing smooth mixing of ingredients, prevent separation, keep emulsified products stable, reduce stickiness, control crystallization, keep ingredients dispersed, and to help products dissolve more easily. In some embodiments, the silk fibroin protein fragments may be incorporated in the food or beverage composition to replace in part or in whole of a food ingredient selected from the group consisting of soy lecithin, mono- and diglycerides, and egg yolks. In some embodiments, the foodstuff containing silk fibroin protein fragments as emulsifier may be selected from the group consisting of salad dressings, peanut butter, chocolate, margarine, and frozen desserts.

In some embodiments, the silk fibroin fragment based food emulsifier may be combined with a sugar surfactant to form a food emulsifier blend. In some embodiments, the silk fibroin protein fragments as described above is blended with a sugar surfactant selected from the group consisting of sucrose fatty acid ester, sorbitan or sorbitol fatty acid ester, alkyl glucoside, alkyl polyglucoside, and combinations thereof, wherein the sugar surfactant reduces surface tension and promotes better uniformity of the SPF coating layer.

In some embodiments, the sugar surfactant is sucrose fatty acid ester. In some embodiments, the sugar surfactant is alkyl polyglucoside. In some embodiments, the sugar surfactant has a HLB value greater than 8. In some embodiments, the sugar surfactant has a HLB value greater than 9.

In some embodiments, the sucrose fatty acid ester comprises sucrose fatty acid monoesters. In some embodiments, the sugar surfactant may comprise a blend of sucrose esters. In some embodiments, the different sucrose fatty acid esters in the blend can vary in the length and/or saturation of the carbon chain of the fatty acid portion of the ester, or in the degree of esterification (e.g., whether the ester is a monoester, diester, triester, or polyester). Typically, the sucrose fatty acid ester surfactant comprises proportionally more monoesters than other types of esters (e.g., diesters, triesters, and polyesters).

In some embodiments, the sucrose fatty acid ester surfactants comprises a fatty acid chain having 12 to 18 carbon atoms (e.g., 12, 13, 14, 15, 16, 17, or 18 carbon atoms), such as stearic acid, lauric acid, oleic acid, and palmitic acid. In some embodiments, the sucrose fatty acid ester surfactant has a HLB value ranging from 2 to 18. Typically, the lower the degree of esterification (e.g., average degree), the higher the HLB value of the sucrose fatty acid ester or mixture thereof. Exemplary HLB value for various sucrose esters include sucrose distearate (HLB=3), sucrose distearate/monostearate (HLB=12), sucrose dipalmitate (HLB=7.4); sucrose monostearate (HLB=15), sucrose monopalmitate (HLB>10), and sucrose monolaurate (HLB=15). In some embodiments, the sucrose ester has a HLB value ranging from about 14 to about 18. In some embodiments, the sucrose ester has a HLB value selected from the group consisting of about 14, about 15, about 16, about 17, about 18, about 19, and about 20. In some embodiments, the sucrose esters have an HLB value ranging from about 15 to about 18 (e.g., at or about 15, 16, 17, or 18).

In some embodiments, the sucrose ester is selected from the group consisting of sucrose cocoate, sucrose dilaurate, sucrose distearate, sucrose hexaerucate, sucrose laurate, sucrose myristate, sucrose oleate, sucrose palmitate, sucrose caprylate, sucrose decanoate, sucrose tridecanoate, sucrose undecanoate, sucrose pentadeconoate, sucrose heptadecanoate, sucrose pelargonate, sucrose pentaerucate, sucrose polybehenate, sucrose polycottonseedate, sucrose polylaurate, sucrose polylinoleate, sucrose polyoleate, sucrose polypalmate, sucrose polysoyate, sucrose polystearate, sucrose ricinoleate, sucrose stearate, sucrose tetraisostearate, sucrose tribehenate, sucrose tristearat, and combinations thereof. In some embodiments, the sucrose ester is selected from the group consisting of sucrose monostearate, sucrose monooleate, sucrose monopalmitate, sucrose monolaurate, and combinations thereof.

In some embodiments, the glucoside emulsifier is selected from the group consisting of alkyl polyglucoside having an alkyl group with 8 to 22 carbon atoms and a degree of glucoside unit condensation ranging from 1 to 7, alkyl polyglucoside having an alkyl group with 8 to 11 carbon atoms and a degree of glucoside unit condensation ranging from 1.0 to 1.4, alkyl polyglucoside having an alkyl group with 12 to 20 carbon atoms and a degree of glucoside unit condensation ranging from 1 to 7, alkyl polyglucoside having an alkyl group with 12 to 14 carbon atoms and a degree of glucoside unit condensation ranging from 1.5 to 4.0, methyl glycoside ester, ethyl glycoside esters, cetearyl glucoside, caprylyl/capryl glucoside, and combinations thereof. In some embodiments, the glucoside emulsifier is selected from the group consisting of cetearyl glucoside, caprylyl/capryl glucoside (APG C8-C10, e.g., a 63% aqueous solution of alkyl polyglucosides with 8-10 carbon alkyl chains and the average degree of polymerization DP=1.5), and combinations thereof. In some embodiments, the glucoside emulsifier is selected from the group consisting of octyl polyglucoside, 2-ethylhexyl polyglucoside, decyl polyglucoside, lauryl polyglucoside, myristyl polyglucoside, palmityl polyglucoside, isostearyl polyglucoside, stearyl polyglucoside, oleyl polyglucoside, behenyl polyglucoside, and combinations thereof. In some embodiments, the glucoside emulsifier is caprylyl/capryl glucoside.

In some embodiments, the food emulsifier blend comprises a water-soluble glucoside containing an alkyl polyglucoside compound having alkyl chains with 6 to 14 carbons and degree of glucoside unit condensation ranging from 1.0 to 5.0. In some embodiments, the food emulsifier blend comprises an oil soluble glucoside containing an alkyl polyglucoside compounds with alkyl chains having 16 to 22 carbon atoms. In general, increasing the degree of polymerization of the alkyl polyglucoside increases solubility in a polar medium, while lengthening of the alkyl chain increases solubility in a non-polar medium.

In some embodiments, the silk fibroin protein fragments are incorporated into food or beverage products as protein supplement, wherein the SPF containing food or beverage composition have enhanced protein content to provide greater nutritional benefit to the consumer. In some embodiments, the silk fibroin fragments to be incorporated in the food or beverage composition is in the form of a powder, an aqueous solution, or a gel. In some embodiments, the silk fibroin fragments to be incorporated in the food or beverage composition is an aqueous solution. In some embodiments, the silk fibroin fragments to be incorporated in the food or beverage composition is in the form of powder.

In some embodiments, the food or beverage product may further comprise one or more additional proteins selected from the group consisting of whey protein concentrate, whey protein isolate, whey protein hydrolysate, soy isolate, soy concentrate, milk casein, calcium caseinate, calcium sodium caseinate, milk protein isolates, pea flour, pea protein isolates, beta-lacto globulin, and alpha-lactalbumin. In some embodiments, the additional protein may be used is selected from the group consisting of whey protein hydrolysates and pea protein isolates. In some embodiments, the additional protein may be incorporated into the silk fibroin coating composition. In some embodiments, the additional protein may be incorporated into the food product as additive.

In some embodiments, the food product is a snack food item such as an energy bar, and the coating can serve as a moisture barrier to prevent hydration of the protein component of the bar, thereby preserving the energy level of the bar.

The silk fibroin protein-rich coating can add to the protein content of the overall bar, or the silk fibroin protein-rich coating can allow the producer to reduce the protein content of the uncoated bar to make the bar more palatable and still provide the same level of overall protein to the consumer. Depending on the amount of silk fibroin protein fragments in the coating, the amount of silk fibroin protein fragments added to the bar can be in the range of about 5-40%.

In some embodiments, the silk fibroin protein fragments may be used as food preservatives. The mulberry leaves that the silkworms feed upon are super rich in antioxidants. The mulberries have been reported to contain up to 79% more antioxidants than those of super-fruits such as blueberries, blackberries and cranberries. Silk fibroin protein naturally contains antibacterial and antifungal properties. Silkworm silk has very strong affinity to the human body, good biocompatibility, high antioxidant and antibacterial activities. The silkworm silk functions to enhance the vitality of skin cells, promote metabolism through effective supplement of amino acid nutrients. Silk is naturally hypoallergenic.

In some embodiments, the silk fibroin protein fragments may be used as nutrient for foodstuff as amino acid source. The silk fibroin protein contains 18 amino acids and consists mainly of Gly (43%), Ala (30%), and Ser (12%). (http://www.mulberrytreesilk.com/blog/benefits-of-silk; Dixit, Silk in personal care products & cosmetics, HPIC India, 2016, pp. 47-55).

Alanine is a nonessential amino acid found in many food protein sources as well as in the body. It is degraded in the liver to produce important bio molecules such as pyruvate and glutamate. Its carbon skeleton also can be used as an energy source.

Glycine is a non-essential amino acid used therapeutically as a nutrient. Glycine is also a fast neurotransmitter inhibitor, important in the generating of hormones responsible for a strong immune system, triggering the release of oxygen to energy for cell-making process. Glycine also functions on the detoxification of harmful aromatic substances. Alanine is a non-essential amino acid that degrades in the liver to produce important biomolecules such as pyruvate and glutamate.

Histidine is an essential amino acid. Histidine plays a very important role in the growth and repair of tissues in the body. One major role of histidine in the body is in preserving the integrity of the myelin sheaths that protect and insulate the nerve cells. At the same time, this amino acid is also required for the bio-synthesis red and white blood cells. Additional functions of histidine include, protecting the body from damage caused by radiation. Histidine also aids the body in the detoxification process regarding the presence of heavy metals.

Leucine works with the amino acids isoleucine and valine to repair muscles, regulate blood sugar, and provide the body with energy. It also increases production of growth hormones, and helps burn visceral fat. Leucine and histidine have a high nutritional value, to prevent aging, body metabolism and promote regeneration.

Lysine is an essential amino acid. It plays a major role in calcium absorption, as well as in helping building muscle protein. Besides, Lysine aids in recovering from surgery or traumas and helps your body produce hormones, enzymes, and antibodies. This amino acid was also proved to depress the central nervous system while having anti-seizure properties

Methionine is an essential amino acid that helps the body process and eliminate fat. It contains sulfur, a substance that is required for the production of the body's most abundant natural antioxidant, glutathione. The body also needs plenty of methionine to produce two other sulfur-containing amino acids, cysteine and taurine, which help the body eliminate toxins, build strong, healthy tissues, and promote cardiovascular health.

Serine is a non-essential amino acid known for assisting in production of immunoglobulin's and antibodies for a healthy immune system. Serine is also known for helping the absorption of creatine that helps build and maintain the muscles. Serine prevents aging, decreased white blood cells and preventing hair growth. Glycine and valine have anti-radiation, preventing effect decreased white blood cells.

Threonine is an essential amino acid that promotes normal growth by helping to maintain the proper protein balance in the body. Threonine also supports cardiovascular, liver, central nervous, and immune system function. Threonine is needed to create glycine and serine, two amino acids that are necessary for the production of collagen, elastin, and muscle tissue. Threonine helps keep connective tissues and muscles throughout the body strong and elastic, including the heart, where it is found in significant amounts. It also helps build strong bones and tooth enamel, and may speed wound healing or recovery from injury.

In some embodiments, the silk fibroin protein fragments may be used as food emulsifier due to amphiphilic property of the silk fibroin protein. Silk fibroin is an amphiphilic polymer with large hydrophobic domains occupying the backbone component of the peptide chain. The hydrophobic regions are interrupted by small hydrophilic spacers, and the N- and C-termini of the peptide chains are highly hydrophilic. The hydrophobic domains of the fibroin protein H-chain contain a repetitive hexa-peptide sequence of Gly-Ala-Gly-Ala-Gly-Ser and repeats of Gly-Ala/Ser/Tyr dipeptides, which can form stable anti-parallel-sheet crystallites. The amino acid sequence of the silk fibroin L-chain is non-repetitive. Therefore, the L-chain is more hydrophilic and relatively elastic. The hydrophilic blocks (Tyr, Ser) and the hydrophobic (Gly, Ala) blocks in silk fibroin molecules are arranged alternatively such that allows self-assembling of silk fibroin molecules. Silk fibroin has a hydrophobic tail like section formed by the Gly-Ala repeats followed by a polar amino acid such as serine such that it behaves as the surfactant head group. Studies in this disclosure on surface active property of silk fibroin fragments and emulsion behavior supported that silk fibroin peptide has the propensity to adsorb at the water-air interface. Once silk fibroin is adsorbed at the air—water interface, interfacial gel-like structures are formed. The adsorption process and the structure formed at the air-water interface are important when assessing the suitability for applications dependent on surface activity.

In some embodiments, the silk fibroin protein fragment composition may be used in the preparation of a confection such as a toffee-style confection, or a chocolate-candy type confection, but with a higher protein content than traditional confections. Those skilled in the art will recognize from the foregoing disclosure how parameters such as mixing speed, temperature, and proportions of ingredients can be adjusted to create a higher protein confectionery product with a consistency and palatability having appeal to consumers.

In some embodiments, the SPF additive or SPF ingredient is in the food or beverage product at an effective amount ranging from about 0.01 wt. % to about 92.0 wt. % by the total weight of the food or beverage product. In some embodiments, the effective amount of SPF additive or SPF ingredient in the food or beverage product ranging from about 0.1 wt. % to about 30.0 wt. % by the total weight of the food or beverage product. In some embodiments, the effective amount of SPF additive or SPF ingredient in the food or beverage product ranging from about 0.5 wt. % to about 20.0 wt. % by the total weight of the food or beverage product. In some embodiments, the effective amount of SPF additive or SPF ingredient in the food or beverage product ranging from about 1.0 wt. % to about 10.0 wt. % by the total weight of the food or beverage product.

In some embodiments, the SPF functional additive or SPF ingredients may form a coating layer on the surface of the solid foodstuffs.

In some embodiments, the wet SPF coated foodstuffs are placed inside the oven for a period ranging between 1-4 hours at temperature ranging between 40° C. to 60° C. for drying. In some embodiments, quickly raising the temperature of the wet SPF coating layer to above 75° C. has the effect of driving off the water, driving the formation of crystalline beta-sheet in the SPF peptide chain and causing the SPF self-assemble into a continuous, transparent film. Heat is applied to the surface of wet coated foodstuffs, via a radiant source, such as an infrared light emitting lamp having a surface temperature of about 75° C. or higher.

In some embodiments, the foodstuff with SPF coating layer are subject to water annealing process is to drive the formation of crystalline beta-sheet in the SPF peptide chain and the SPF self-assembling into a continuous film. In some embodiments, the crystallinity of the SPF coating layer was controlled by controlling the temperature of water vapor and duration of the annealing. In some embodiments, the annealing is performed at a temperature ranging from about 65° C. to about 300° C. In some embodiments, the SPF coated foodstuffs are subjected to water vapor treatment under vacuum for an hour and the temperature of the water is maintained at about 80° C. In some embodiments, the water annealing is performed at a temperature selected from the group consisting of about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., about 140° C., about 145° C., about 150° C., about 155° C., about 160° C., about 165° C., about 170° C., about 175° C., about 180° C., about 185° C., about 190° C., about 195° C., about 200° C., about 205° C., about 210° C., about 215° C., about 220° C., about 225° C., about 230° C., about 235° C., about 240° C., about 245° C., about 250° C., about 255° C., about 260° C., about 265° C., about 270° C., about 275° C., about 280° C., about 285° C., about 290° C., about 295° C., and about 300° C., and the duration of the annealing is selected form the group consisting of about 5 seconds, about 10 seconds, about 20 seconds, about 30 seconds, about 40 seconds, about 50 seconds, about 60 seconds, about 10 minutes, about 20 minutes, about 30 minutes, about 40 minutes, about 50 minutes, and about 1 hour.

In some embodiments, an average shelf-life of a foodstuff coated with the SPF coating described herein, as compared to a reference product without such coating, is extended by at least 1 day, at least 2 days, at least 3 days, at least 4 days, at least 5 days, at least 6 days, at least 7 days, at least 8 days, at least 9 days, at least 10 days, at least 11 days, at least 12 days, at least 13 days, at least 14 days, at least 15 days, at least 16 days, at least 17 days, at least 18 days, at least 19 days, at least 20 days, at least 21 days, at least 22 days, at least 23 days, at least 24 days, at least 25 days, at least 26 days, at least 27 days, at least 28 days, at least 29 days, at least 30 days, at least 5 weeks, at least 6 weeks, at least 7 weeks, at least 8 weeks, at least 9 weeks, at least 10 weeks, at least 11 weeks, at least 12 weeks, at least 4 months, at least 5 months, at least 6 months, at least 7 months, at least 8 months, at least 9 months, at least 10 months, at least 11 months, at least 1 year, at least 18 months, at least 2 years, at least 30 months, at least 3 years, at least 4 years, at least 5 years, or longer.

In some embodiments, the SPF functional additive or SPF ingredients may be incorporated into liquid foodstuffs as dissolved solute or as colloidal dispersion. In some embodiments, the silk fibroin protein fragments described above are casted into standalone edible films. The SPF standalone films may be used as packaging materials for a variety of solid, fatty or oily food products. For example, SPF films provided herein may at least in part replace any conventional packaging materials that are used to wrap, cover, or bottle perishable items, including, without limitation, dairy products, wines and spirits, other bottled beverages, and the like.

In some embodiments, the silk foodstuff may further comprises an optional additive such as nutrients, antioxidants, therapeutically active agents, and enzymes to impart aesthetic properties, to improve nutritional value, or to improve organoleptic properties or sensory properties. In some embodiments, the silk foodstuff may further comprises an optional additive selected from the group consisting of ceramics, ceramic particles, metals, metal particles, polymer particles, inorganic particles, organic particles, selenium, ubiquinone derivatives, thiol-based antioxidants, saccharide-containing antioxidants, polyphenols, botanical extracts, caffeic acid, apigenin, pycnogenol, resveratrol, folic acid, vitamin B12, vitamin B6, vitamin B3, vitamin E, vitamin C and derivatives thereof, vitamin D, vitamin A, astaxathin, Lutein, lycopene, essential fatty acids (omegas 3 and 6), iron, zinc, magnesium, flavonoids (soy, Curcumin, Silymarin, Pycnongeol), growth factors, aloe, hyaluronic acid, extracellular matrix proteins, cells, nucleic acids, biomarkers, biological reagents, zinc oxide, benzyol peroxide, retnoids, titanium, allergens in a known dose (for sensitization treatment), essential oils including, but not limited to, lemongrass or rosemary oil, fragrances, and combinations thereof. Allergens include but are not limited to milk, eggs, peanuts, tree nuts, fish, shellfish, soy and wheat.

In some embodiments, the optional additive is present in the food or beverage products at an amount ranging from about 0.01 wt. % to 10.0 wt. % by the total weight of the food or beverage products. In some embodiments, the optional additive is present in the food or beverage products at an amount ranging from about 0.1 wt. % to about 2.0 wt. % by the total weight of the food or beverage products. In some embodiments, the optional additive is present in the food or beverage products at an amount ranging from about 0.1 wt. % to about 1.0 wt. % by the total weight of the food or beverage products. In some embodiments, the optional additive is present in the food or beverage products at an amount selected from the group consisting of about 0.01 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2.0 wt. %, about 2.1 wt. %, about 2.2 wt. %, about 2.3 wt. %, about 2.4 wt. %, about 2.5 wt. %, about 2.6 wt. %, about 2.7 wt. %, about 2.8 wt. %, about 2.9 wt. %, about 3.0 wt. %, about 3.1 wt. %, about 3.2 wt. %, about 3.3 wt. %, about 3.4 wt. %, about 3.5 wt. %, about 3.6 wt. %, about 3.7 wt. %, about 3.8 wt. %, about 3.9 wt. %, about 4.0 wt. %, about 4.1 wt. %, about 4.2 wt. %, about 4.3 wt. %, about 4.4 wt. %, about 4.5 wt. %, about 4.6 wt. %, about 4.7 wt. %, about 4.8 wt. %, about 4.9 wt. %, about 5.0 wt. %, about 5.1 wt. %, about 5.2 wt. %, about 5.3 wt. %, about 5.4 wt. %, about 5.5 wt. %, about 5.6 wt. %, about 5.7 wt. %, about 5.8 wt. %, about 5.9 wt. %, about 6.0 wt. %, about 6.1 wt. %, about 6.2 wt. %, about 6.3 wt. %, about 6.4 wt. %, about 6.5 wt. %, about 6.6 wt. %, about 6.7 wt. %, about 6.8 wt. %, about 6.9 wt. %, about 7.0 wt. %, about 7.1 wt. %, about 7.2 wt. %, about 7.3 wt. %, about 7.4 wt. %, about 7.5 wt. %, about 7.6 wt. %, about 7.7 wt. %, about 7.8 wt. %, about 7.9 wt. %, about 8.0 wt. %, about 8.1 wt. %, about 8.2 wt. %, about 8.3 wt. %, about 8.4 wt. %, about 8.5 wt. %, about 8.6 wt. %, about 8.7 wt. %, about 8.8 wt. %, about 8.9 wt. %, about 9.0 wt. %, about 9.1 wt. %, about 9.2 wt. %, about 9.3 wt. %, about 9.4 wt. %, about 9.5 wt. %, about 9.6 wt. %, about 9.7 wt. %, about 9.8 wt. %, about 9.9 wt. %, about 10.0 wt. % by the total weight of the food or beverage products.

The following clauses describe certain embodiments.

Clause 1. A silk food or beverage product comprising a foodstuff and silk fibroin fragments, the silk fibroin fragments having an average weight average molecular weight selected from between about 1 kDa and about 5 kDa, between about 5 kDa and about 10 kDa, between about 6 kDa and about 17 kDa, between about 10 kDa and about 15 kDa, between about 15 kDa and about 20 kDa, between about 14 kDa and about 30 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 54 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa, and a polydispersity between 1 and about 5.

Clause 2. The silk food or beverage product of clause 1, wherein the polydispersity is between 1 and about 1.5.

Clause 3. The silk food or beverage product of clause 1, wherein the polydispersity is between about 1.5 and about 3.0.

Clause 4. The silk food or beverage product of clause 1, wherein the polydispersity is between about 1.5 and about 2.0.

Clause 5. The silk food or beverage product of clause 1, wherein the polydispersity is between about 2.0 and about 2.5.

Clause 6. The silk food or beverage product of clause 1, wherein the polydispersity is between about 2.5 and about 3.0.

Clause 7. The silk food or beverage product of any one of clauses 1 to 6, wherein the silk fibroin fragments are present in the silk food or beverage product at about 0.001 wt. % to about 10.0 wt. % relative to the total weight of the silk food or beverage product. In some embodiments, the silk fibroin fragments are present in the silk food or beverage product at about 0.0001 wt. % to about 0.001 wt. % relative to the total weight of the silk food or beverage product. In some embodiments, the silk fibroin fragments are present in the silk food or beverage product at about 0.001 wt. % to about 0.01 wt. % relative to the total weight of the silk food or beverage product. In some embodiments, the silk fibroin fragments are present in the silk food or beverage product at about 0.01 wt. % to about 0.1 wt. % relative to the total weight of the silk food or beverage product. In some embodiments, the silk fibroin fragments are present in the silk food or beverage product at about 0.1 wt. % to about 1 wt. % relative to the total weight of the silk food or beverage product. In some embodiments, the silk fibroin fragments are present in the silk food or beverage product at about 0.1% relative to the total weight of the silk food or beverage product. In some embodiments, the silk fibroin fragments are present in the silk food or beverage product at about 0.2% relative to the total weight of the silk food or beverage product. In some embodiments, the silk fibroin fragments are present in the silk food or beverage product at about 0.3% relative to the total weight of the silk food or beverage product. In some embodiments, the silk fibroin fragments are present in the silk food or beverage product at about 0.4% relative to the total weight of the silk food or beverage product. In some embodiments, the silk fibroin fragments are present in the silk food or beverage product at about 0.5% relative to the total weight of the silk food or beverage product. In some embodiments, the silk fibroin fragments are present in the silk food or beverage product at about 0.6% relative to the total weight of the silk food or beverage product. In some embodiments, the silk fibroin fragments are present in the silk food or beverage product at about 0.7% relative to the total weight of the silk food or beverage product. In some embodiments, the silk fibroin fragments are present in the silk food or beverage product at about 0.8% relative to the total weight of the silk food or beverage product. In some embodiments, the silk fibroin fragments are present in the silk food or beverage product at about 0.9% relative to the total weight of the silk food or beverage product. In some embodiments, the silk fibroin fragments are present in the silk food or beverage product at about 1% relative to the total weight of the silk food or beverage product. In some embodiments, the silk fibroin fragments are present in the silk food or beverage product at about 2% relative to the total weight of the silk food or beverage product. In some embodiments, the silk fibroin fragments are present in the silk food or beverage product at about 3% relative to the total weight of the silk food or beverage product. In some embodiments, the silk fibroin fragments are present in the silk food or beverage product at about 4% relative to the total weight of the silk food or beverage product. In some embodiments, the silk fibroin fragments are present in the silk food or beverage product at about 5% relative to the total weight of the silk food or beverage product. In some embodiments, the silk fibroin fragments are present in the silk food or beverage product at about 6% relative to the total weight of the silk food or beverage product. In some embodiments, the silk fibroin fragments are present in the silk food or beverage product at about 7% relative to the total weight of the silk food or beverage product. In some embodiments, the silk fibroin fragments are present in the silk food or beverage product at about 8% relative to the total weight of the silk food or beverage product. In some embodiments, the silk fibroin fragments are present in the silk food or beverage product at about 9% relative to the total weight of the silk food or beverage product. In some embodiments, the silk fibroin fragments are present in the silk food or beverage product at about 10% relative to the total weight of the silk food or beverage product. In some embodiments, the silk fibroin fragments are present in the silk food or beverage product at about 11% relative to the total weight of the silk food or beverage product. In some embodiments, the silk fibroin fragments are present in the silk food or beverage product at about 12% relative to the total weight of the silk food or beverage product. In some embodiments, the silk fibroin fragments are present in the silk food or beverage product at about 13% relative to the total weight of the silk food or beverage product. In some embodiments, the silk fibroin fragments are present in the silk food or beverage product at about 14% relative to the total weight of the silk food or beverage product. In some embodiments, the silk fibroin fragments are present in the silk food or beverage product at about 15% relative to the total weight of the silk food or beverage product.

Clause 8. The silk food or beverage product of any one of clauses 1 to 6, wherein the silk fibroin fragments are present in the silk food or beverage product at about 0.001 wt. % to about 5.0 wt. % relative to the total weight of the silk food or beverage product.

Clause 9. The silk food or beverage product of any one of clauses 1 to 6, wherein the silk fibroin fragments are present in the silk food or beverage product at about 0.001 wt. % to about 1.0 wt. % relative to the total weight of the silk food or beverage product.

Clause 10. The silk food or beverage product of any one of clauses 1 to 9, further comprising about 0.001% wt. % to about 10 wt. % sericin relative to the total weight of the silk fibroin fragments.

Clause 11. The silk food or beverage product of any one of clauses 1 to 9, further comprising about 0.001% wt. % to about 10 wt. % sericin relative to the total weight of the silk food or beverage product.

Clause 12. The silk food or beverage product of any one of clauses to 11, wherein the silk fibroin fragments do not spontaneously or gradually gelate and do not visibly change in color or turbidity when in an aqueous solution for at least 10 days prior to formulation into the silk food or beverage product.

Clause 13. The silk food or beverage product of any one of clauses 1 to 11, wherein the silk fibroin fragments have a shelf stability of at least 1 week, at least 2 weeks, at least 3 weeks, at least 4 weeks, at least 6 week, at least 8 weeks, at least 10 weeks, at least 12 weeks, at least 16 weeks, at least 20 weeks, at least 24 weeks, at least 36 weeks, or at least 52 weeks.

Clause 14. The silk food or beverage product of any one of clauses 1 to 11, wherein the silk fibroin fragments have a shelf stability of at least 1 week, at least 2 weeks, at least 3 weeks, at least 4 weeks, at least 6 week, at least 8 weeks, at least 10 weeks, at least 12 weeks, at least 16 weeks, at least 20 weeks, at least 24 weeks, at least 36 weeks, or at least 52 weeks when in an aqueous solution prior to formulation into the silk food or beverage product.

Clause 15. The silk food or beverage product of any one of clauses 1 to 14, wherein the foodstuff has a shelf stability of at least 1 hour, at least 3 hours, at least 6 hours, at least 12 hours, at least 24 hours, at least 3 days, at least 1 week, at least 2 weeks, at least 3 weeks, at least 4 weeks, at least 8 weeks, at least 12 weeks, at least 24 weeks, or at least 52 weeks.

Clause 16. The silk food or beverage product of any one of clauses 1 to 14, wherein the silk food or beverage product has a shelf stability of at least 1 hour, at least 3 hours, at least 6 hours, at least 12 hours, at least 24 hours, at least 3 days, at least 1 week, at least 2 weeks, at least 3 weeks, at least 4 weeks, at least 8 weeks, at least 12 weeks, at least 24 weeks, or at least 52 weeks.

Clause 17(a). The silk food or beverage product of any one of clauses 1 to 14, wherein the silk food or beverage product has a shelf stability longer than the shelf stability of the corresponding foodstuff not formulated into the silk food or beverage product. In some embodiments, the silk food or beverage product has a shelf stability longer than the shelf stability of the corresponding foodstuff not formulated into the silk food or beverage product by about 1 hour, about 2 hours, about 3 hours, about 4 hours, about 5 hours, about 6 hours, between about 6 hours to about 12 hours, about 12 hours, between about 12 hours to about 24 hours, about 1 day, about 2 days, about 3 days, about 4 days, about 5 days, about 6 days, about 7 days, about 8 days, about 9 days, about 10 days, about 11 days, about 12 days, about 13 days, about 14 days, about 3 weeks, about 1 months, about 2 months, about 3 months, about 4 months, about 5 months, about 6 months, about 7 months, about 8 months, about 9 months, about 10 months, about 11 months, or about 12 months.

Clause 17(b). The silk food or beverage product of any one of the clauses described herein, wherein the silk food or beverage product has a superior shelf stability than the shelf stability of the corresponding foodstuff not formulated into the silk food or beverage product, wherein the superior shelf stability correlates with a smaller loss of weight during any period of time described herein. In some embodiments, the loss of weight in the silk food or beverage product is smaller than the loss of weight in the corresponding foodstuff not formulated into the silk food or beverage product by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%. In some embodiments, the period of time is about 1 hour, about 2 hours, about 3 hours, about 4 hours, about 5 hours, about 6 hours, between about 6 hours to about 12 hours, about 12 hours, between about 12 hours to about 24 hours, about 1 day, about 2 days, about 3 days, about 4 days, about 5 days, about 6 days, about 7 days, about 8 days, about 9 days, about 10 days, about 11 days, about 12 days, about 13 days, about 14 days, about 3 weeks, about 1 months, about 2 months, about 3 months, about 4 months, about 5 months, about 6 months, about 7 months, about 8 months, about 9 months, about 10 months, about 11 months, or about 12 months.

Clause 17(c). The silk food or beverage product of any one of the clauses described herein, wherein the silk food or beverage product has a superior shelf stability than the shelf stability of the corresponding foodstuff not formulated into the silk food or beverage product, wherein the superior shelf stability correlates with a smaller loss of water during any period of time described herein. In some embodiments, the loss of water in the silk food or beverage product is smaller than the loss of water in the corresponding foodstuff not formulated into the silk food or beverage product by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%. In some embodiments, the period of time is about 1 hour, about 2 hours, about 3 hours, about 4 hours, about 5 hours, about 6 hours, between about 6 hours to about 12 hours, about 12 hours, between about 12 hours to about 24 hours, about 1 day, about 2 days, about 3 days, about 4 days, about 5 days, about 6 days, about 7 days, about 8 days, about 9 days, about 10 days, about 11 days, about 12 days, about 13 days, about 14 days, about 3 weeks, about 1 months, about 2 months, about 3 months, about 4 months, about 5 months, about 6 months, about 7 months, about 8 months, about 9 months, about 10 months, about 11 months, or about 12 months.

Clause 17(d). The silk food or beverage product of any one of the clauses described herein, wherein the silk food or beverage product has a superior shelf stability than the shelf stability of the corresponding foodstuff not formulated into the silk food or beverage product, wherein the superior shelf stability correlates with a smaller change in shape during any period of time described herein. In some embodiments, the change in shape in the silk food or beverage product is smaller than the change in shape in the corresponding foodstuff not formulated into the silk food or beverage product by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%. In some embodiments, the period of time is about 1 hour, about 2 hours, about 3 hours, about 4 hours, about 5 hours, about 6 hours, between about 6 hours to about 12 hours, about 12 hours, between about 12 hours to about 24 hours, about 1 day, about 2 days, about 3 days, about 4 days, about 5 days, about 6 days, about 7 days, about 8 days, about 9 days, about 10 days, about 11 days, about 12 days, about 13 days, about 14 days, about 3 weeks, about 1 months, about 2 months, about 3 months, about 4 months, about 5 months, about 6 months, about 7 months, about 8 months, about 9 months, about 10 months, about 11 months, or about 12 months.

Clause 17(e). The silk food or beverage product of any one of the clauses described herein, wherein the silk food or beverage product has a superior shelf stability than the shelf stability of the corresponding foodstuff not formulated into the silk food or beverage product, wherein the superior shelf stability correlates with a smaller change in overall structural integrity during any period of time described herein. In some embodiments, the change in overall structural integrity in the silk food or beverage product is smaller than the change in overall structural integrity in the corresponding foodstuff not formulated into the silk food or beverage product by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%. In some embodiments, the period of time is about 1 hour, about 2 hours, about 3 hours, about 4 hours, about 5 hours, about 6 hours, between about 6 hours to about 12 hours, about 12 hours, between about 12 hours to about 24 hours, about 1 day, about 2 days, about 3 days, about 4 days, about 5 days, about 6 days, about 7 days, about 8 days, about 9 days, about 10 days, about 11 days, about 12 days, about 13 days, about 14 days, about 3 weeks, about 1 months, about 2 months, about 3 months, about 4 months, about 5 months, about 6 months, about 7 months, about 8 months, about 9 months, about 10 months, about 11 months, or about 12 months.

Clause 17(f). The silk food or beverage product of any one of the clauses described herein, wherein the silk food or beverage product has a superior shelf stability than the shelf stability of the corresponding foodstuff not formulated into the silk food or beverage product, wherein the superior shelf stability correlates with a smaller change in texture (e.g., firmness) during any period of time described herein. In some embodiments, the change in texture (e.g., firmness) in the silk food or beverage product is smaller than the change in texture (e.g., firmness) in the corresponding foodstuff not formulated into the silk food or beverage product by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%. In some embodiments, the period of time is about 1 hour, about 2 hours, about 3 hours, about 4 hours, about 5 hours, about 6 hours, between about 6 hours to about 12 hours, about 12 hours, between about 12 hours to about 24 hours, about 1 day, about 2 days, about 3 days, about 4 days, about 5 days, about 6 days, about 7 days, about 8 days, about 9 days, about 10 days, about 11 days, about 12 days, about 13 days, about 14 days, about 3 weeks, about 1 months, about 2 months, about 3 months, about 4 months, about 5 months, about 6 months, about 7 months, about 8 months, about 9 months, about 10 months, about 11 months, or about 12 months.

Clause 17(g). The silk food or beverage product of any one of the clauses described herein, wherein the silk food or beverage product has a superior shelf stability than the shelf stability of the corresponding foodstuff not formulated into the silk food or beverage product, wherein the superior shelf stability correlates with a smaller change in color(s) (e.g., overall shading and/or local spotting) during any period of time described herein. In some embodiments, the change in color(s) (e.g., overall shading and/or local spotting) in the silk food or beverage product is smaller than the change in color(s) (e.g., overall shading and/or local spotting) in the corresponding foodstuff not formulated into the silk food or beverage product by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%. In some embodiments, the period of time is about 1 hour, about 2 hours, about 3 hours, about 4 hours, about 5 hours, about 6 hours, between about 6 hours to about 12 hours, about 12 hours, between about 12 hours to about 24 hours, about 1 day, about 2 days, about 3 days, about 4 days, about 5 days, about 6 days, about 7 days, about 8 days, about 9 days, about 10 days, about 11 days, about 12 days, about 13 days, about 14 days, about 3 weeks, about 1 months, about 2 months, about 3 months, about 4 months, about 5 months, about 6 months, about 7 months, about 8 months, about 9 months, about 10 months, about 11 months, or about 12 months.

Clause 17(h). The silk food or beverage product of any one of the clauses described herein, wherein the silk food or beverage product has a superior shelf stability than the shelf stability of the corresponding foodstuff not formulated into the silk food or beverage product, wherein the superior shelf stability correlates with a smaller change in chemical species (e.g., contents of sugar and/or starch) during any period of time described herein. In some embodiments, the change in chemical species (e.g., contents of sugar and/or starch) in the silk food or beverage product is smaller than the change in chemical species (e.g., contents of sugar and/or starch) in the corresponding foodstuff not formulated into the silk food or beverage product by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%. In some embodiments, the period of time is about 1 hour, about 2 hours, about 3 hours, about 4 hours, about 5 hours, about 6 hours, between about 6 hours to about 12 hours, about 12 hours, between about 12 hours to about 24 hours, about 1 day, about 2 days, about 3 days, about 4 days, about 5 days, about 6 days, about 7 days, about 8 days, about 9 days, about 10 days, about 11 days, about 12 days, about 13 days, about 14 days, about 3 weeks, about 1 months, about 2 months, about 3 months, about 4 months, about 5 months, about 6 months, about 7 months, about 8 months, about 9 months, about 10 months, about 11 months, or about 12 months.

Clause 17(i). The silk food or beverage product of any one of the clauses described herein, wherein the silk food or beverage product has a superior shelf stability than the shelf stability of the corresponding foodstuff not formulated into the silk food or beverage product, wherein the superior shelf stability correlates with a smaller change in acidity during any period of time described herein. In some embodiments, the change in acidity in the silk food or beverage product is smaller than the change in acidity in the corresponding foodstuff not formulated into the silk food or beverage product by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%. In some embodiments, the period of time is about 1 hour, about 2 hours, about 3 hours, about 4 hours, about 5 hours, about 6 hours, between about 6 hours to about 12 hours, about 12 hours, between about 12 hours to about 24 hours, about 1 day, about 2 days, about 3 days, about 4 days, about 5 days, about 6 days, about 7 days, about 8 days, about 9 days, about 10 days, about 11 days, about 12 days, about 13 days, about 14 days, about 3 weeks, about 1 months, about 2 months, about 3 months, about 4 months, about 5 months, about 6 months, about 7 months, about 8 months, about 9 months, about 10 months, about 11 months, or about 12 months.

Clause 17(j). The silk food or beverage product of any one of the clauses described herein, wherein the silk food or beverage product has a superior shelf stability than the shelf stability of the corresponding foodstuff not formulated into the silk food or beverage product, wherein the superior shelf stability correlates with a smaller change in native smell and/or taste during any period of time described herein. In some embodiments, the change in native smell and/or taste in the silk food or beverage product is smaller than the change in native smell and/or taste in the corresponding foodstuff not formulated into the silk food or beverage product by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%. In some embodiments, the period of time is about 1 hour, about 2 hours, about 3 hours, about 4 hours, about 5 hours, about 6 hours, between about 6 hours to about 12 hours, about 12 hours, between about 12 hours to about 24 hours, about 1 day, about 2 days, about 3 days, about 4 days, about 5 days, about 6 days, about 7 days, about 8 days, about 9 days, about 10 days, about 11 days, about 12 days, about 13 days, about 14 days, about 3 weeks, about 1 months, about 2 months, about 3 months, about 4 months, about 5 months, about 6 months, about 7 months, about 8 months, about 9 months, about 10 months, about 11 months, or about 12 months.

Clause 18. The silk food or beverage product of any one of clauses 13 to 17(a-j), wherein shelf stability is measured at room temperature.

Clause 19. The silk food or beverage product of any one of clauses 13 to 17(a-j), wherein shelf stability is measured at about −18° C., about −17° C., about −16° C., about −15° C., about −14° C., about −13° C., about −12° C., about −11° C., about −10° C., about −9° C., about −8° C., about −7° C., about −6° C., about −5° C., about −4° C., about −3° C., about −2° C., about −1° C., about 0° C., about 1° C., about 2° C., about 3° C., about 4° C., about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., about 20° C., about 21° C., about 22° C., about 23° C., about 24° C., or about 25° C.

Clause 20. The silk food or beverage product of any one of clauses 1 to 19, wherein the silk food or beverage product is a beverage.

Clause 21. The silk food or beverage product of clause 20, wherein the beverage is selected from a ready-to-drink beverage, a milk or milk analog beverage, a weight management beverage, a protein shake, and a meal replacement drink.

Clause 22. The silk food or beverage product of clause 20, wherein the beverage is cold-pressed juice.

Clause 23. The silk food or beverage product of any one of clauses 1 to 19, wherein the foodstuff is selected from skim milk, whole milk, cream, dried milk powder, non-fat dry milk powder, caseinate, soy protein concentrate, soy protein isolate, whey protein concentrate, whey protein isolate, chocolate, cocoa powder, coffee, and combinations thereof.

Clause 24. The silk food or beverage product of any one of clauses 1 to 19, wherein the silk food or beverage product further comprises an ingredient selected from a sweetening agent, an emulsifying agent, a thickening agent, a stabilizer, a lipid material, a preservative, an antioxidant, a flavoring agent, a coloring agent, a vitamin, a mineral, and combinations thereof.

Clause 25. The silk food or beverage product of any one of clauses 1 to 19, wherein the silk food or beverage product is selected from a food bar, a nutritional supplement, a cereal-based product, a meat or meat analog product, a deli-meat, and a dairy or dairy analog product.

Clause 26. The silk food or beverage product of any one of clauses 1 to 19, wherein the silk food or beverage product is at least in part selected from the group consisting of lettuce, chicken, milk, beer, fish, berries, corn, avocado, banana, tomato, peach, potato, bean, kale, broccoli, mushroom, asparagus, hummus, grain, egg, cooked vegetable, raw vegetable, parsley, and yogurt.

Clause 27. The silk food or beverage product of any one of clauses 1 to 26, wherein the silk fibroin fragments are substantially mixed with the foodstuff.

Clause 28. The silk food or beverage product of any one of clauses 1 to 26, wherein the silk fibroin fragments form, at least in part, a coating on a surface of the foodstuff.

Clause 29. The silk food or beverage product of clause 28, wherein the coating is transparent.

Clause 30. The silk food or beverage product of clause 28, wherein the coating is edible.

Clause 31. The silk food or beverage product of clause 28, wherein the coating is water-soluble.

Clause 32. The silk food or beverage product of clause 28, wherein the coating further comprises an additive.

Clause 33. The silk food or beverage product of clause 32, wherein the additive is selected from anti-microbe agents, antibacterial agents and antifungal agents, enzyme inhibitors, ethylene-capturing/binding molecules, ethylene-binding domains of ethylene receptors, ethylene-absorbing substances, aluminosilicates, zeolites, silk fibroin-based aerogels, oxidizing agents, potassium permanganate, ethylene receptor antagonists, porphyrins, hormones, hormone receptor agonists and antagonists thereof, nutraceutical agents, dietary supplements, vitamins, antioxidants, fatty acids, flavorings and other compounds added to improve taste, sugars, perfumes or fragrances, colorings, dyes, and any combination thereof.

Clause 34. The silk food or beverage product of clause 28, wherein the coating does not contain an added plasticizing agent.

Clause 35. A method for preserving a foodstuff, the method comprising contacting the foodstuff with a silk fibroin protein fragment (SPF) coating composition comprising silk fibroin fragments having an average weight average molecular weight selected from between about 1 kDa and about 5 kDa, between about 5 kDa and about 10 kDa, between about 6 kDa and about 17 kDa, between about 10 kDa and about 15 kDa, between about 15 kDa and about 20 kDa, between about 14 kDa and about 30 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 54 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa, and a polydispersity between 1 and about 5, wherein a silk fibroin protein fragment coating layer is formed on at least a portion of the foodstuff.

Clause 36. The method of clause 35, wherein the foodstuff is preserved as compared to a foodstuff without the coating.

Clause 37. The method of clause 35, wherein the contacting comprises di-coating, spray-coating, powder-coating, wrapping, sealing, covering, layering, or any combination thereof.

Clause 38. The method of clause 35, wherein the contacting is repeated at least 2 times.

Clause 39. The method of clause 35, further comprising a step of annealing, crosslinking, or a combination thereof.

### EXAMPLES

### Example 1

### Aqueous Silk Solution

### Example 1a

### Preparation of Aqueous Silk Solution

Silk solutions of various molecular weights and/or combinations of molecular weights can be optimized for specific applications. The following provides an example of this process but it not intended to be limiting in application or formulation.

Methods of making silk fibroin or silk fibroin fragments and their applications in various fields, including coating, are known and are described for example in U.S. Patent Application Publication Nos. 20200188269, 20200188268, 20190336431, 20190380944, 20190070089, 20190070088, 20160022563, 20160022562, 20160022561, 20160022560, 20160022559, 20160193130, 20150094269, 20150093340, 20190211498, 20190309467, 20190003113, 20160281294, and 20160222579, and U.S. Pat. Nos. 9,187,538, 9,511,012, 9,517,191, 9,522,107, 9,522,108, 9,545,369, 10,166,177, 10,610,478, 10,588,843, 10,287,728, and all of which are incorporated herein in their entireties.

The raw silk cocoons from the silkworm Bombyx mori was cut into pieces. The pieces silk cocoons were processed in an aqueous solution of Na₂CO₃ at about 100° C. for about 60 minutes to remove sericin (degumming). The volume of the water used equals about 0.4× raw silk weight and the amount of Na₂CO₃ is about 0.848× the weight of the raw silk cocoon pieces. The resulting degummed silk cocoon pieces were rinsed with deionized water three times at about 60° C. (20 minutes per rinse). The volume of rinse water for each cycle was 0.2 L× the weight of the raw silk cocoon pieces. The excess water from the degummed silk cocoon pieces was removed. After the DI water washing step, the wet degummed silk cocoon pieces were dried at room temperature. The degummed silk cocoon pieces were mixed with a LiBr solution, and the mixture was heated to about 100° C. The warmed mixture was placed in a dry oven and was heated at about 100° C. for about 60 minutes to achieve complete dissolution of the native silk protein. The resulting silk fibroin solution was filtered and dialyzed using Tangential Flow Filtration (TFF) and a 10 kDa membrane against deionized water for 72 hours. The resulting silk fibroin aqueous solution has a concentration of about 8.5 wt. %. Then, 8.5% silk solution was diluted with water to result in a 1.0% w/v silk solution. TFF can then be used to further concentrate the pure silk solution to a concentration of 20.0% w/w silk to water.

Each process step from raw cocoons to dialysis is scalable to increase efficiency in manufacturing. Whole cocoons are currently purchased as the raw material, but pre-cleaned cocoons or non-heat treated cocoons, where worm removal leaves minimal debris, have also been used. Cutting and cleaning the cocoons is a manual process, however for scalability this process could be made less labor intensive by, for example, using an automated machine in combination with compressed air to remove the worm and any particulates, or using a cutting mill to cut the cocoons into smaller pieces.

The degumming step, currently performed in small batches, could be completed in a larger vessel, for example an industrial washing machine where temperatures at or in between 60° C. to 100° C. can be maintained. The rinsing step could also be completed in the industrial washing machine, eliminating the manual rinse cycles.

Dissolution of the silk in LiBr solution could occur in a vessel other than a convection oven, for example a stirred tank reactor.

Dialyzing the silk through a series of water changes is a manual and time intensive process, which could be accelerated by changing certain parameters, for example diluting the silk solution prior to dialysis. The dialysis process could be scaled for manufacturing by using semi-automated equipment, for example a tangential flow filtration system.

### Example 1b

### Size Exclusion Chromatography Analysis (SEC)

Agilent Infinity Bio-inert Quaternary High Pressure Liquid Chromatography (HPLC) System was used to determine molecular weight distribution of silk fibroin-based protein fragments in the silk solutions prepared in Example 1a. The Agilent HPLC system consisted of a quaternary pump, an automatic injector, a refractive index detector (RID), and a module of heater column. The injection volume of silk solution is 10 μL. The HPLC column used for silk fibroin peptide separation is AdvanceBio SEC® or Agilent Bio-SEC-5®. The mobile phased used was 150 mM phosphate buffer, pH=7, at a flow rate of 0.1-0.4 mL/min for 4.6 mm id column and 0.1-1.25 mL/min for 7.8 mm id column. The column temperature was maintained at 30° C. The standard curve was built using pullulan polysaccharide standards of known and narrow molecular weight values at 10 kDa, 22.4 kDa, 47.2 kDa, 112 kDa, 212 kDa, 404 kDa, 788 kDa. These standards and the samples of silk fibroin protein fragments were injected at a concentration of 0.1% w/v in water. The results of molecular weight distribution and polydispersity was analyzed using Cirrus GPC Online GPC/SEC Software Version 3.3 (Agilent).

### Example 2

### Methods of Preparing Foodstuffs with Silk Coatings

2a. Preparation of Silk Fibroin Protein Fragment Coating Solution

The raw silk cocoons from the silkworm Bombyx mori was cut into pieces. The pieces of raw silk cocoons were boiled in an aqueous solution of Na₂CO₃ (about 100° C.) for a period of time between about 30 minutes to about 60 minutes to remove sericin (degumming). The volume of the water used equals about 0.4× raw silk weight and the amount of Na₂CO₃ is about 0.848× the weight of the raw silk cocoon pieces. The resulting degummed silk cocoon pieces were rinsed with deionized water three times at about 60° C. (20 minutes per rinse). The volume of rinse water for each cycle was 0.2 L× the weight of the raw silk cocoon pieces. The excess water from the degummed silk cocoon pieces was removed. After the DI water washing step, the wet degummed silk cocoon pieces were dried at room temperature. The degummed silk cocoon pieces were mixed with a LiBr solution, and the mixture was heated to about 100° C. The warmed mixture was placed in a dry oven and was heated at a temperature ranging from about 60° C. to about 140° C. for about 60 minutes to achieve complete dissolution of the native silk protein. The resulting solution was allowed to cool to room temperature and then was dialyzed to remove LiBr salts using a 3,500 Da MWCO membrane. Multiple exchanges were performed in Di water until Br⁻ ions were less than 1 ppm as determined in the hydrolyzed fibroin solution read on an Oakton Bromide (Br⁻) double junction ion-selective electrode.

Three (3) silk solutions were utilized in standard silk structures in accordance with standard methods in the literature with the following results:

Solution #1 is a silk concentration of 5.9%, average MW of 19.8 kDa and 2.2 PDI (made with a 60 min boil extraction, 100° C. LiBr dissolution for 1 hr).

Solution #2 is a silk concentration of 6.4% (made with a 30 min boil extraction, 60° C. LiBr dissolution for 4 hrs).

Solution #3 is a silk concentration of 6.17% (made with a 30 min boil extraction 100° C. LiBr dissolution for 1 hour).

The resulting aqueous solution of pure silk fibroin-based protein fragments may comprise lithium bromide residuals of less than 300 ppm as measured using a high-performance liquid chromatography lithium bromide assay. The aqueous solution of pure silk fibroin-based protein fragments may comprise sodium carbonate residuals of less than 100 ppm as measured using a high-performance liquid chromatography sodium carbonate assay.

The composition of the silk fibroin coating solution may be modified by one or more optional additives to give various functional coating solutions with improved film forming property or as carrier for delivery of active agents such as vitamins. The process above may further comprise a step of adding a molecule selected from one of an antioxidant or an enzyme to the aqueous solution of pure silk fibroin-based protein fragments. The method may further comprise a step of adding a vitamin to the aqueous solution of pure silk fibroin-based protein fragments. The vitamin may be vitamin C or a derivative thereof. The method may further comprise a step of adding an alpha hydroxy acid to the aqueous solution of pure silk fibroin-based protein fragments. The alpha hydroxy acid may be selected from the group consisting of glycolic acid, lactic acid, tartaric acid and citric acid. The method may further comprise a step of adding hyaluronic acid or its salt form at a concentration of about 0.5% to about 10.0% to the aqueous solution of pure silk fibroin-based protein fragments.

2b. Dip Coating Fresh Fruits

A 1.0% w/v silk solution containing low molecular weight SPF, a 1.0% w/v silk solution containing Mid-molecular weight SPF, and a 1.0% w/v silk solution containing Mid-molecular weight SPF in Example 1 were used as coating solution for coating fresh strawberry via dip-coating method (dip-coater device). Each two of the six fresh strawberries were fully immersed in each of the three silk solutions. One set of three strawberries were dipped in distilled water as control sample. The coating process places a thin coating layer over the surface of strawberry. Three control samples of Example 2b were air dried at 25° C. for 16 hours.

The six resulting SPF coated strawberries were stored at 25° C. over a period of 12 days. The loss of mass and physical appearance were examined every two days (3 day interval in case of weekend).

Double-coated and triple-coated strawberries were prepared by repeating the above coating procedure.

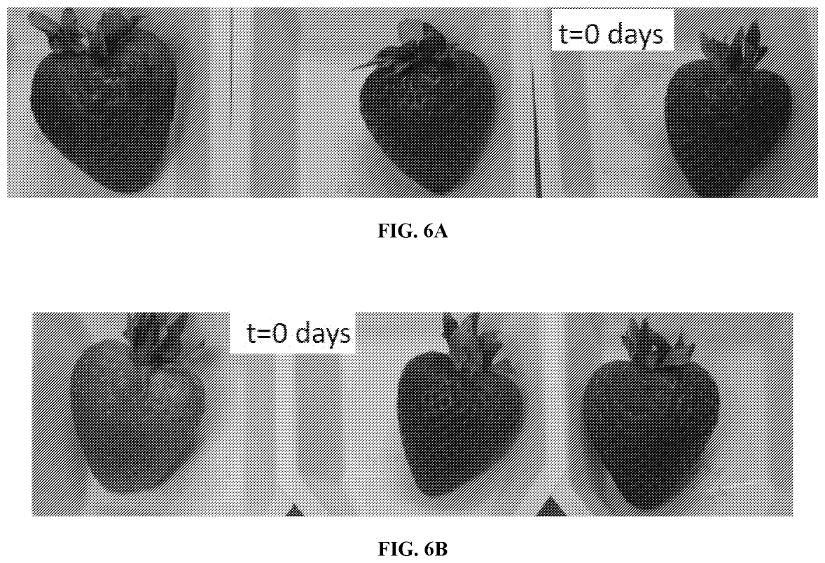

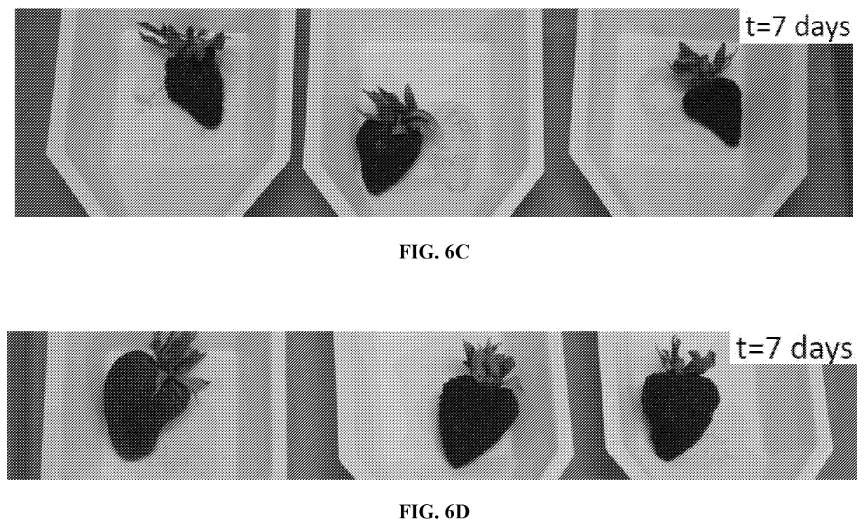

The mass, color and shape of the strawberries were monitored every 12 hours. Observations at every 12 hours showed that the strawberry without the SPF-based coating showed significant signs of spoilage after 24 hours, whereas the strawberries with the SPF-based coating showed no signs of spoilage until after 120 hours or a longer period of time. The results are summarized in FIG. 4 and FIGS. 6A-6D. FIG. 4 illustrates the weight loss effects under ambient storage conditions by silk fibroin protein fragment based coating on the perishable goods (e.g., strawberry) over a period of 7 day as compared with strawberry without coating (control). FIGS. 6A-6D illustrate the effects food decay under ambient storage conditions by silk fibroin protein fragment based coating on the perishable goods (e.g., strawberry) over a period of 7 days as compared with strawberry without coating (control) at 0 day and 7th day; FIG. 6A: control at t=0 days; FIG. 6B: high dip coated at t=0 days; FIG. 6C: control at t=7 days; FIG. 6D: high dip coated at t=7 days.

2c. Spray Coating Fresh Fruit

A 1.0% w/v silk solution containing low molecular weight SPF, a 1.0% w/v silk solution containing Mid-molecular weight SPF, and a 1.0% w/v silk solution containing Mid-molecular weight SPF in Example 1 were used as coating solution for coating fresh strawberry. Alternatively, the SPF coatings on the strawberry were formed by spraying the three aqueous solution of pure silk fibroin-based protein fragments having low, Mid, and high molecular weight onto a surface of the strawberries. The wet SPF-coated strawberries were placed in an incubator at 25° C. for 120 hours, along with an uncoated strawberry dipped in DI water. The mass, color and shape of the strawberries were monitored every 12 hours. Observations at every 12 hours showed that the strawberry without the SPF-based coating showed significant signs of spoilage after 24 hours, whereas the strawberries with the SPF-based coating showed no signs of spoilage until after 120 hours or a longer period of time. Signs of spoilage can include growth of bacteria and fungi on the surface of the fruit and loss of natural, fresh color of the fruits.

2d. Process of Water Annealing

Three of the SPF coated strawberries immersed in three different silk solutions as obtained in example 2b were then water annealed to introduce beta sheet formation. The SPF coated strawberry was subjected to water vapor treatment under vacuum for an hour. The temperature of the water was maintained at 80° C. Annealing resulted in changes to the conformation of SPF coating layer from predominantly amorphous random coil to crystalline antiparallel beta sheet structures. The annealed SPF coating layer on the strawberry did not readily solubilize in water.

Three of the SPF coated strawberries immersed in three different silk solutions as obtained in example 2b were exposed to water vapors under static vacuum (namely water annealing) for 16 hours at room temperature to induce crystallization.

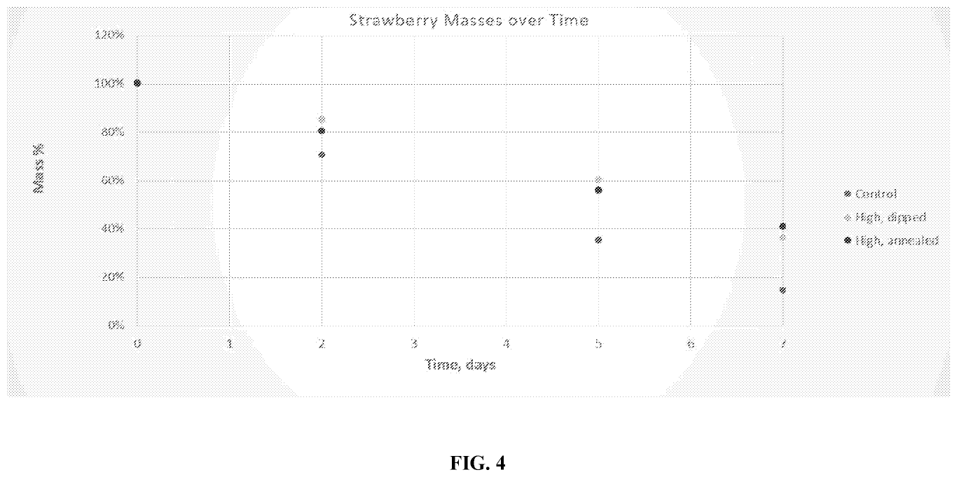

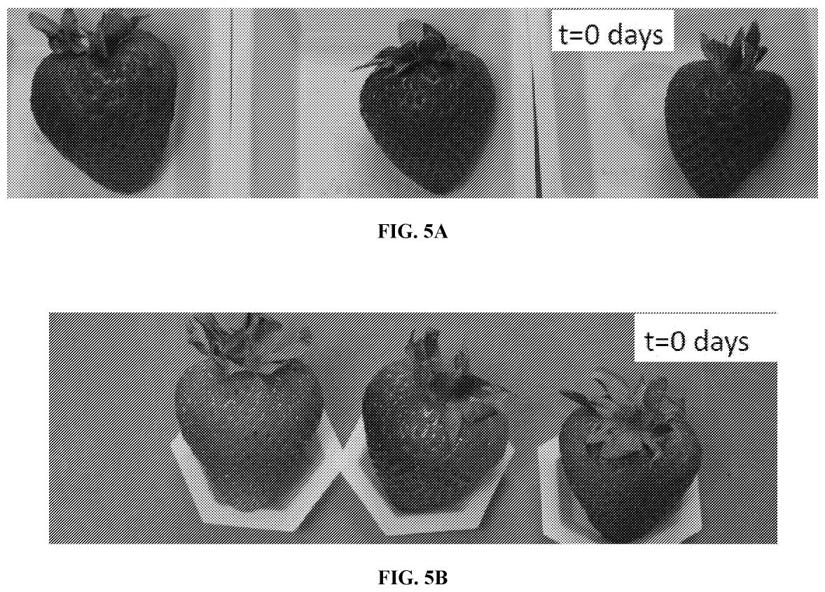

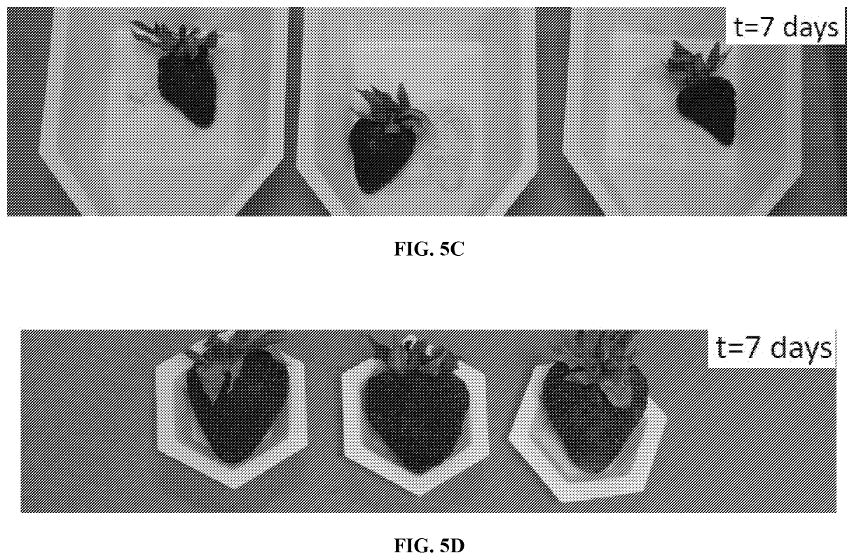

The results are summarized in FIG. 4 and FIGS. 5A-5D. FIG. 4 illustrates the weight loss effects under ambient storage conditions by silk fibroin protein fragment based coating on the perishable goods (e.g., strawberry) over a period of 7 day as compared with strawberry without coating (control). FIGS. 5A-5D illustrate the effects food decay under ambient storage conditions by silk fibroin protein fragment based coating on the perishable goods (e.g., strawberry) over a period of 7 days as compared with strawberry without coating (control) at 0 day and 7th day; FIG. 5A: control at t=0 days; FIG. 5B: high annealed at t=0 days; FIG. 5C: control at t=7 days; FIG. 5D: high annealed at t=7 days.

2e. Measurements of Preservation

There are a number of parameters to measure relative efficacy of food preservation. Any suitable means may be employed to measure or assay for the degree of freshness or preservation of, or assess the quality of, perishable products before and after or over the course of storage. These include, without limitation, changes in weight, which may reflect water loss, changes in shape or overall structural integrity, changes in texture such as firmness, changes in colors including overall shading or local spotting, changes in chemical species (e.g., contents of sugar, starch, etc.), changes in acidity, changes in smell, taste, etc. Relative gas exchange rates (e.g., oxygen permeability) may also be measured. In addition, emission of specific compounds such as ethylene may be measured.

### Example 3

### Methods of Preparing Foodstuffs with Silk Additives

A method for preparing an aqueous solution of pure silk fibroin-based protein fragments having an average weight average molecular weight ranging from about 17 kDa to about 38 kDa includes the steps of: adding a silk source to a boiling (100° C.) aqueous solution of sodium carbonate for a treatment time of between about 30 minutes to about 60 minutes so as to result in degumming; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 80° C. to about 140° C.; maintaining the solution of silk fibroin-lithium bromide in a dry oven having a temperature in the range between about 60° C. to about 100° C. for a period of at least 1 hour; removing the lithium bromide from the silk fibroin extract; and producing an aqueous solution of pure silk fibroin-based protein fragments, wherein the aqueous solution of pure silk fibroin-based protein fragments comprises lithium bromide residuals of between about 10 ppm and about 300 ppm, wherein the aqueous solution of silk fibroin protein fragments comprises sodium carbonate residuals of between about 10 ppm and about 100 ppm, wherein the aqueous solution of pure silk fibroin-based protein fragments comprises fragments having an average weight average molecular weight ranging from about 17 kDa to about 38 kDa, and wherein the aqueous solution of pure silk fibroin-based protein fragments comprises a polydispersity of between about 1.5 and about 3.0. The method may further comprise drying the silk fibroin extract prior to the dissolving step. The aqueous solution of pure silk fibroin-based protein fragments may comprise lithium bromide residuals of less than 300 ppm as measured using a high-performance liquid chromatography lithium bromide assay. The aqueous solution of pure silk fibroin-based protein fragments may comprise sodium carbonate residuals of less than 100 ppm as measured using a high-performance liquid chromatography sodium carbonate assay. The method may further comprise adding a therapeutic agent to the aqueous solution of pure silk fibroin-based protein fragments. The method may further comprise adding a molecule selected from one of an antioxidant or an enzyme to the aqueous solution of pure silk fibroin-based protein fragments. The method may further comprise adding a vitamin to the aqueous solution of pure silk fibroin-based protein fragments. The vitamin may be vitamin C or a derivative thereof. The method may further comprise adding an alpha hydroxy acid to the aqueous solution of pure silk fibroin-based protein fragments. The alpha hydroxy acid may be selected from the group consisting of glycolic acid, lactic acid, tartaric acid and citric acid. The method may further comprise adding hyaluronic acid or its salt form at a concentration of about 0.5% to about 10.0% to the aqueous solution of pure silk fibroin-based protein fragments. The method may further comprise adding at least one of zinc oxide or titanium dioxide. The method further comprises mixing the aqueous solution of pure silk fibroin-based protein fragments with a foodstuff (e.g., a guacamole). The SPF-containing guacamole is placed in a refrigerator at 4° C. for 96 hours, along with guacamole not containing the aqueous solution of pure silk fibroin-based protein fragments. Observations every 2 hours show that the guacamole that does not contain the pure silk fibroin-based protein fragments shows significant signs of spoilage after 8 hours while the guacamole containing the pure silk fibroin-based protein fragments shows no signs of spoilage until after 96 hours or a longer period of time. Signs of spoilage can include growth of bacteria and fungi on the surface of the fruit and loss of natural, fresh color of the fruits.

### Example 4

### Studying the Effects of Silk Coatings on Cheese

In the past, silk coatings have been shown to slow the decomposition of strawberries. Silk coatings slowed mass loss as well as visual decomposition. This is a continuation of previous study but with cheese instead of strawberries. This example uses cheddar cheese coating with low and mid skid silk, but it is equally applicable to a wide variety of other cheese types. The objective of this study is to determine if silk coatings applied to cheese could slow visual decomposition and mold growth.

Materials: RO/DI water, Low Skid 19236, Mid Skid 19291, Cabot Vermont Seriously Sharp Cheddar Cheese.

Equipment: Spectrophotometer (Konica Minolta Spectrophotometer CM-700d), Tru-Vue 2 datacolor light box, Canon E05 Rebel T6 Camera, Stainless Steel Water Annealing Chamber, 4° C. Lab fridge, 25° C. Incubator.

Methods: Two 6% solutions of silk were prepared: Low 19236 and Mid 19291 in a 100 mL beaker. A beaker of 100 mL of RODI was prepared. Six cheese squares samples were dipped in the Low Skid 19236 solution, for 10 seconds each. After 10 seconds, these samples were placed in the water annealing chamber. This process was repeated with the Mid Skid 19236 as well as the beaker of RODI, resulting in 18 samples in the water annealing chamber. A vial of RODI was placed in the chamber, and the chamber was held in static vacuumed for 24 hours, allowing the silk coatings to water anneal. In addition, six cheese slices were left at room temperature overnight without a water dip or being in the water annealing chamber, as controls. After samples were left for 24 hours, they were split into groups of 3 and placed in plastic zip-lock bags at different temperatures. 3 low samples, 3 mid samples, 3 water dipped controls, and 3 normal controls were bagged and placed in the 4° C. fridge. 3 low samples, 3 mid samples, 3 water dipped controls, and 3 normal controls were bagged and placed in the 25° C. fridge. Photos were taken every week of one sample from each set. Masses were taken of every sample for the first two weeks.

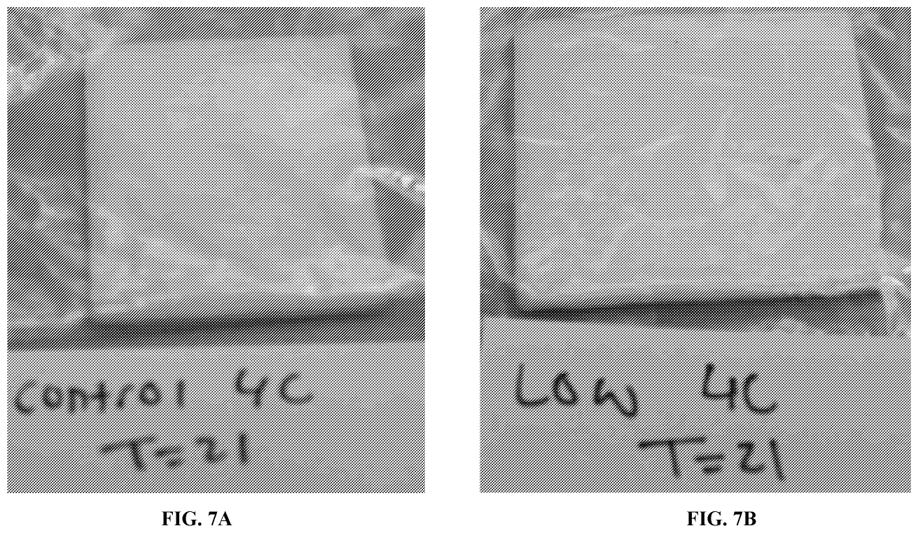

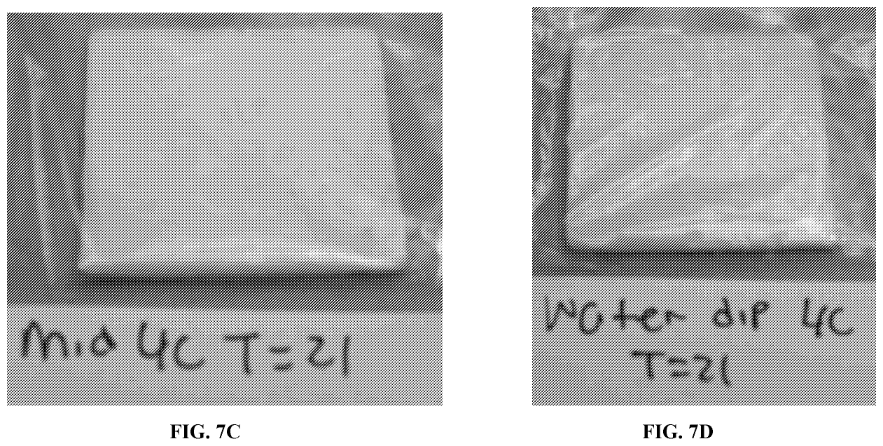

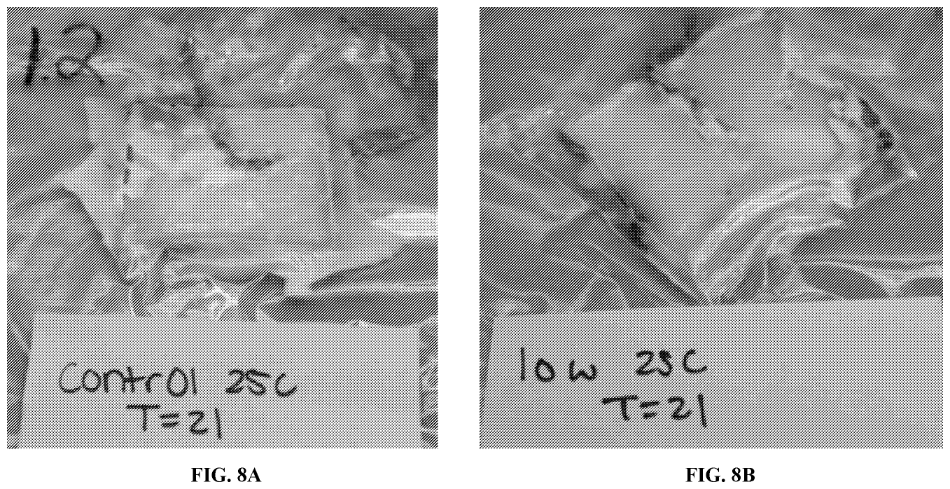

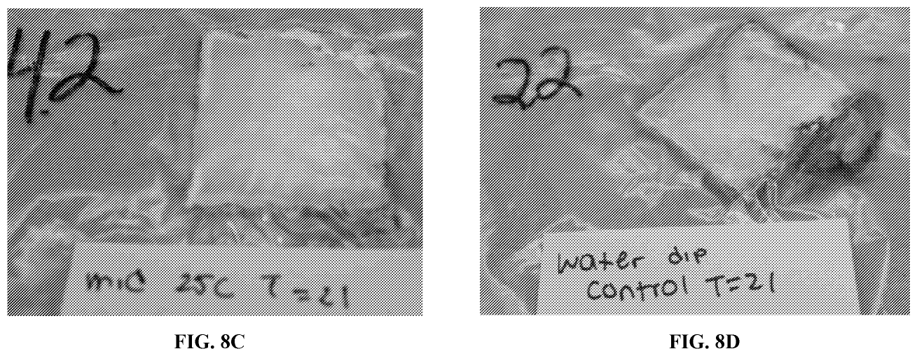

Results and discussion: FIGS. 7A-7D and FIGS. 8A-8D illustrate photographs of all samples after 21 days at the respective temperatures. For the samples at 4° C., there is no noticeable difference between any of the samples. For the samples at 25° C., there is a visual difference between the samples. The two controls showed significant mold growth. However, the mid MW silk coated cheese has less growth than the controls and the low MW silk coated cheese. While not wishing to be bound by any particular theory, this result suggests and clear protection from degradation of cheese when coated with Activated Silk (in particular with Mid MW activated silk). There was no major change in the total mass of the cheese during the first two weeks of the study.

1. A silk food or beverage product comprising a foodstuff and silk fibroin fragments, the silk fibroin fragments having an average weight average molecular weight selected from between about 1 kDa and about 5 kDa, between about 5 kDa and about 10 kDa, between about 6 kDa and about 17 kDa, between about 10 kDa and about 15 kDa, between about 15 kDa and about 20 kDa, between about 14 kDa and about 30 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 54 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa, and a polydispersity between 1 and about 5.

2. The silk food or beverage product of claim 1, wherein the polydispersity is between 1 and about 1.5, between about 1.5 and about 3.0, between about 1.5 and about 2.0, between about 2.0 and about 2.5, or between about 2.5 and about 3.0.

3-6. (canceled)

7. The silk food or beverage product of claim 1, wherein the silk fibroin fragments are present in the silk food or beverage product at about 0.001 wt. % to about 10.0 wt. % relative to the total weight of the silk food or beverage product.

8. The silk food or beverage product of claim 1, wherein the silk fibroin fragments are present in the silk food or beverage product at about 0.001 wt. % to about 5.0 wt. % relative to the total weight of the silk food or beverage product.

9. The silk food or beverage product of claim 1, wherein the silk fibroin fragments are present in the silk food or beverage product at about 0.001 wt. % to about 1.0 wt. % relative to the total weight of the silk food or beverage product.

10. The silk food or beverage product of claim 1, further comprising about 0.001% wt. % to about 10 wt. % sericin relative to the total weight of the silk fibroin fragments.

11. The silk food or beverage product of claim 1, further comprising about 0.001% wt. % to about 10 wt. % sericin relative to the total weight of the silk food or beverage product.

12. The silk food or beverage product of claim 1, wherein the silk fibroin fragments do not spontaneously or gradually gelate and do not visibly change in color or turbidity when in an aqueous solution for at least 10 days prior to formulation into the silk food or beverage product.

13. The silk food or beverage product of claim 1, wherein the silk fibroin fragments have a shelf stability of at least 1 week, at least 2 weeks, at least 3 weeks, at least 4 weeks, at least 6 week, at least 8 weeks, at least 10 weeks, at least 12 weeks, at least 16 weeks, at least 20 weeks, at least 24 weeks, at least 36 weeks, or at least 52 weeks.

14. The silk food or beverage product of claim 1, wherein the silk fibroin fragments have a shelf stability of at least 1 week, at least 2 weeks, at least 3 weeks, at least 4 weeks, at least 6 week, at least 8 weeks, at least 10 weeks, at least 12 weeks, at least 16 weeks, at least 20 weeks, at least 24 weeks, at least 36 weeks, or at least 52 weeks when in an aqueous solution prior to formulation into the silk food or beverage product.

15. The silk food or beverage product of claim 1, wherein the foodstuff has a shelf stability of at least 1 hour, at least 3 hours, at least 6 hours, at least 12 hours, at least 24 hours, at least 3 days, at least 1 week, at least 2 weeks, at least 3 weeks, at least 4 weeks, at least 8 weeks, at least 12 weeks, at least 24 weeks, or at least 52 weeks.

16. The silk food or beverage product of claim 1, wherein the silk food or beverage product has a shelf stability of at least 1 hour, at least 3 hours, at least 6 hours, at least 12 hours, at least 24 hours, at least 3 days, at least 1 week, at least 2 weeks, at least 3 weeks, at least 4 weeks, at least 8 weeks, at least 12 weeks, at least 24 weeks, or at least 52 weeks.

17. The silk food or beverage product of claim 1, wherein the silk food or beverage product has a shelf stability longer than the shelf stability of the corresponding foodstuff not formulated into the silk food or beverage product.

18. The silk food or beverage product of claim 13, wherein shelf stability is measured at room temperature.

19. The silk food or beverage product of claim 13, wherein shelf stability is measured at about −18° C., about −17° C., about −16° C., about −15° C., about −14° C., about −13° C., about −12° C., about −11° C., about −10° C., about −9° C., about −8° C., about −7° C., about −6° C., about −5° C., about −4° C., about −3° C., about −2° C., about −1° C., about 0° C., about 1° C., about 2° C., about 3° C., about 4° C., about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., about 20° C., about 21° C., about 22° C., about 23° C., about 24° C., or about 25° C.

20. The silk food or beverage product of claim 1, wherein the silk food or beverage product is a beverage.

21. The silk food or beverage product of claim 20, wherein the beverage is selected from a ready-to-drink beverage, a milk or milk analog beverage, a weight management beverage, a protein shake, and a meal replacement drink.

22. The silk food or beverage product of claim 20, wherein the beverage is cold-pressed juice.

23. The silk food or beverage product of claim 1, wherein the foodstuff is selected from skim milk, whole milk, cream, dried milk powder, non-fat dry milk powder, caseinate, soy protein concentrate, soy protein isolate, whey protein concentrate, whey protein isolate, chocolate, cocoa powder, coffee, and combinations thereof.

24. The silk food or beverage product of claim 1, wherein the silk food or beverage product further comprises an ingredient selected from a sweetening agent, an emulsifying agent, a thickening agent, a stabilizer, a lipid material, a preservative, an antioxidant, a flavoring agent, a coloring agent, a vitamin, a mineral, and combinations thereof.

25. The silk food or beverage product of claim 1, wherein the silk food or beverage product is selected from a food bar, a nutritional supplement, a cereal-based product, a meat or meat analog product, a deli-meat, and a dairy or dairy analog product.

26. The silk food or beverage product of claim 1, wherein the silk food or beverage product is at least in part selected from the group consisting of lettuce, chicken, milk, beer, fish, berries, corn, avocado, banana, tomato, peach, potato, bean, kale, broccoli, mushroom, asparagus, hummus, grain, egg, cooked vegetable, raw vegetable, parsley, and yogurt.

27. The silk food or beverage product of claim 1, wherein the silk fibroin fragments are substantially mixed with the foodstuff.

28. The silk food or beverage product of claim 1, wherein the silk fibroin fragments form, at least in part, a coating on a surface of the foodstuff.

29. The silk food or beverage product of claim 28, wherein the coating is transparent.

30. The silk food or beverage product of claim 28, wherein the coating is edible.

31. The silk food or beverage product of claim 28, wherein the coating is water-soluble.

32. The silk food or beverage product of claim 28, wherein the coating further comprises an additive.

33. The silk food or beverage product of claim 32, wherein the additive is selected from anti-microbe agents, antibacterial agents and antifungal agents, enzyme inhibitors, ethylene-capturing/binding molecules, ethylene-binding domains of ethylene receptors, ethylene-absorbing substances, aluminosilicates, zeolites, silk fibroin-based aerogels, oxidizing agents, potassium permanganate, ethylene receptor antagonists, porphyrins, hormones, hormone receptor agonists and antagonists thereof, nutraceutical agents, dietary supplements, vitamins, antioxidants, fatty acids, flavorings and other compounds added to improve taste, sugars, perfumes or fragrances, colorings, dyes, and any combination thereof.

34. The silk food or beverage product of claim 28, wherein the coating does not contain an added plasticizing agent.

35-39. (canceled)


SEQUENCE LISTING (70 sequences)

SEQ ID NO: 1 - protein, 6 aa, Artificial Sequence
  Synthetic protein-like multiblock polymer hexapeptide
  MISC_FEATURE (6)..(6): X can be alanine, tyrosine, valine, or serine
GAGAGX

SEQ ID NO: 2 - protein, 6 aa, Artificial Sequence
  Synthetic protein-like multiblock polymer hexapeptide
GAGAGS

SEQ ID NO: 3 - protein, 5 aa, Artificial Sequence
  Synthetic mammalian elastin
VPGVG

SEQ ID NO: 4 - protein, 5 aa, Artificial Sequence
  Synthetic mammalian elastin
GVGVP

SEQ ID NO: 5 - protein, 44 aa, Artificial Sequence
  Synthetic protein.
SGFGPVANGGSGEASSESDFGSSGFGPVANASSGEASSESDFAG

SEQ ID NO: 6 - protein, 5 aa, Artificial Sequence
  Synthetic consensus peptide
  MISC_FEATURE (4)..(5): X can be alanine, serine, glycine, tyrosine, proline, or glutamine
GPGXX

SEQ ID NO: 7 - protein, 9 aa, Artificial Sequence
  Synthetic pro-resilin elastomeric protein
GGRPSDTYG

SEQ ID NO: 8 - protein, 9 aa, Artificial Sequence
  Synthetic pro-resilin elastomeric protein
GGRPSSSYG

SEQ ID NO: 9 - protein, 35 aa, Artificial Sequence
  Derived from Araneus diadematus
GSSAAAAAAAASGPGGYGPENQGPSGPGGYGPGGP

SEQ ID NO: 10 - protein, 5 aa, Artificial Sequence
  Synthetic recombinant silk protein repetitive unit
GPGAS

SEQ ID NO: 11 - protein, 5 aa, Artificial Sequence
  Synthetic recombinant silk protein repetitive unit
GPGSG

SEQ ID NO: 12 - protein, 5 aa, Artificial Sequence
  Synthetic recombinant silk protein repetitive unit
GPGGY

SEQ ID NO: 13 - protein, 5 aa, Artificial Sequence
  Synthetic recombinant silk protein repetitive unit
GPGGP

SEQ ID NO: 14 - protein, 5 aa, Artificial Sequence
  Synthetic recombinant silk protein repetitive unit
GPGGA

SEQ ID NO: 15 - protein, 5 aa, Artificial Sequence
  Synthetic recombinant silk protein repetitive unit
GPGQQ

SEQ ID NO: 16 - protein, 5 aa, Artificial Sequence
  Synthetic recombinant silk protein repetitive unit
GPGGG

SEQ ID NO: 17 - protein, 5 aa, Artificial Sequence
  Synthetic recombinant silk protein repetitive unit
GPGQG

SEQ ID NO: 18 - protein, 5 aa, Artificial Sequence
  Synthetic recombinant silk protein repetitive unit
GPGGS

SEQ ID NO: 19 - protein, 5 aa, Artificial Sequence
  Synthetic recombinant silk protein repetitive unit
AAAAA

SEQ ID NO: 20 - protein, 6 aa, Artificial Sequence
  Synthetic recombinant silk protein repetitive unit
AAAAAA

SEQ ID NO: 21 - protein, 7 aa, Artificial Sequence
  Synthetic recombinant silk protein repetitive unit
AAAAAAA

SEQ ID NO: 22 - protein, 8 aa, Artificial Sequence
  Synthetic recombinant silk protein repetitive unit
AAAAAAAA

SEQ ID NO: 23 - protein, 9 aa, Artificial Sequence
  Synthetic recombinant silk protein repetitive unit
AAAAAAAAA

SEQ ID NO: 24 - protein, 10 aa, Artificial Sequence
  Synthetic recombinant silk protein repetitive unit
AAAAAAAAAA

SEQ ID NO: 25 - protein, 24 aa, Artificial Sequence
  Synthetic recombinant silk protein repetitive unit
GPYGPGASAAAAAAGGYGPGSGQQ

SEQ ID NO: 26 - protein, 20 aa, Artificial Sequence
  Synthetic recombinant silk protein repetitive unit
GPGQQGPGQQGPGQQGPGQQ

SEQ ID NO: 27 - protein, 27 aa, Artificial Sequence
  Synthetic recombinant silk protein repetitive unit
GPGGAGGPYGPGGAGGPYGPGGAGGPY

SEQ ID NO: 28 - protein, 28 aa, Artificial Sequence
  Synthetic recombinant silk protein repetitive unit
GGTTIIEDLDITIDGADGPITISEELTI

SEQ ID NO: 29 - protein, 34 aa, Artificial Sequence
  Synthetic recombinant silk protein repetitive unit
PGSSAAAAAAAASGPGQGQGQGQGQGGRPSDTYG

SEQ ID NO: 30 - protein, 39 aa, Artificial Sequence
  Synthetic recombinant silk protein repetitive unit
SAAAAAAAAGPGGGNGGRPSDTYGAPGGGNGGRPSSSYG

SEQ ID NO: 31 - protein, 18 aa, Artificial Sequence
  Synthetic recombinant silk protein repetitive unit
GGAGGAGGAGGSGGAGGS

SEQ ID NO: 32 - protein, 30 aa, Artificial Sequence
  Synthetic recombinant silk protein repetitive unit
GPGGAGPGGYGPGGSGPGGYGPGGSGPGGY

SEQ ID NO: 33 - protein, 24 aa, Artificial Sequence
  Synthetic recombinant silk protein repetitive unit
GPYGPGASAAAAAAGGYGPGCGQQ

SEQ ID NO: 34 - protein, 24 aa, Artificial Sequence
  Synthetic recombinant silk protein repetitive unit
GPYGPGASAAAAAAGGYGPGKGQQ

SEQ ID NO: 35 - protein, 35 aa, Artificial Sequence
  Synthetic recombinant silk protein repetitive unit
GSSAAAAAAAASGPGGYGPENQGPCGPGGYGPGGP

SEQ ID NO: 36 - protein, 35 aa, Artificial Sequence
  Synthetic recombinant silk protein repetitive unit
GSSAAAAAAAASGPGGYGPKNQGPSGPGGYGPGGP

SEQ ID NO: 37 - protein, 35 aa, Artificial Sequence
  Synthetic recombinant silk protein repetitive unit
GSSAAAAAAAASGPGGYGPKNQGPCGPGGYGPGGP

SEQ ID NO: 38 - protein, 46 aa, Artificial Sequence
  Synthetic silk protein-like multiblock peptide
  MISC_FEATURE (1)..(20): X can be tyrosine or glutamine
  MISC_FEATURE (7)..(9): XGG may be present or absent
  MISC_FEATURE (16)..(21): each group of GXG may be present or absent
  MISC_FEATURE (37)..(42): each group of AGA may be present or absent
  MISC_FEATURE (44)..(44): G may be present or absent
XGGXGGXGGXGAGXGGXGGXGAGAAGAAGAAGAAGAAGAAGAGGAG

SEQ ID NO: 39 - protein, 43 aa, Artificial Sequence
  Synthetic silk protein-like multiblock peptide
  MISC_FEATURE (21)..(30): GPGGYGPGQQ may be present or absent
  MISC_FEATURE (31)..(32): X can be amino acid sequence GPS or GPG
  MISC_FEATURE (41)..(43): each A may be present or absent
GPGGYGPGQQGPGGYGPGQQGPGGYGPGQQXXSAAAAAAAAAA

SEQ ID NO: 40 - protein, 46 aa, Artificial Sequence
  Synthetic silk protein-like multiblock peptide
  MISC_FEATURE (5)..(14): each sequence of GA may be present or absent
  MISC_FEATURE (15)..(18): each A may be present or absent
  MISC_FEATURE (21)..(30): X can be tyrosine, glutamine, or alanine
  MISC_FEATURE (21)..(30): each sequence of GGX may be present or absent
  MISC_FEATURE (33)..(42): each sequence of GA may be present or absent
  MISC_FEATURE (43)..(46): each A may be present or absent
GRGAGAGAGAGAGAAAAAGGXGGXGGXGGXGAGAGAGAGAGAAAAA

SEQ ID NO: 41 - protein, 26 aa, Artificial Sequence
  Synthetic silk protein-like multiblock peptide
  MISC_FEATURE (3)..(12): X can be tyrosine, glutamine, or alanine
  MISC_FEATURE (4)..(12): each sequence of GGX may be present or absent
  MISC_FEATURE (13)..(20): each sequence of GA may be present or absent
  MISC_FEATURE (22)..(26): each A may be present or absent
GGXGGXGGXGGXGAGAGAGAAAAAAA

SEQ ID NO: 42 - protein, 8 aa, Artificial Sequence
  Chemically synthesized
GCGGGGGG

SEQ ID NO: 43 - protein, 8 aa, Artificial Sequence
  Synthetic modified amino acid sequence
GKGGGGGG

SEQ ID NO: 44 - protein, 14 aa, Artificial Sequence
  Synthetic modified amino acid sequence
GCGGSGGGGSGGGG

SEQ ID NO: 45 - protein, 13 aa, Artificial Sequence
  Chemically synthesized
GKGGGGGGSGGGG

SEQ ID NO: 46 - protein, 13 aa, Artificial Sequence
  Synthetic modified amino acid sequence
GCGGGGGGSGGGG

SEQ ID NO: 47 - protein, 33 aa, Artificial Sequence
  Synthetic modified amino acid sequence
GSSAAAAAAAASGPGQGQGQGQGQGGRPSDTYG

SEQ ID NO: 48 - protein, 747 aa, Araneus diadematus
QGAGAAAAAAGGAGQGGYGGLGGQGAGQGGYGGLGGQGAGQGAGAAAAAAAGGAGQGGYGGLGSQGAGRGGQGAGAAAAAAGGAGQGGYGGLGSQGAGRGGLGGQGAGAAAAAAAGGAGQGGYGGLGNQGAGRGGQGAAAAAAGGAGQGGYGGLGSQGAGRGGLGGQGAGAAAAAAGGAGQGGYGGLGGQGAGQGGYGGLGSQGAGRGGLGGQGAGAAAAAAAGGAGQGGLGGQGAGQGAGASAAAAGGAGQGGYGGLGSQGAGRGGEGAGAAAAAAGGAGQGGYGGLGGQGAGQGGYGGLGSQGAGRGGLGGQGAGAAAAGGAGQGGLGGQGAGQGAGAAAAAAGGAGQGGYGGLGSQGAGRGGLGGQGAGAVAAAAAGGAGQGGYGGLGSQGAGRGGQGAGAAAAAAGGAGQRGYGGLGNQGAGRGGLGGQGAGAAAAAAAGGAGQGGYGGLGNQGAGRGGQGAAAAAGGAGQGGYGGLGSQGAGRGGQGAGAAAAAAVGAGQEGIRGQGAGQGGYGGLGSQGSGRGGLGGQGAGAAAAAAGGAGQGGLGGQGAGQGAGAAAAAAGGVRQGGYGGLGSQGAGRGGQGAGAAAAAAGGAGQGGYGGLGGQGVGRGGLGGQGAGAAAAGGAGQGGYGGVGSGASAASAAASRLSSPQASSRVSSAVSNLVASGPTNSAALSSTISNVVSQIGASNPGLSGCDVLIQALLEVVSALIQILGSSSIGQVNYGSAGQATQIVGQSVYQAL

SEQ ID NO: 49 - protein, 627 aa, Araneus diadematus
PGGYGPGQQGPGGYGPGQQGPSGPGSAAAAAAAAAAGPGGYGPGQQGPGGYGPGQQGPGRYGPGQQGPSGPGSAAAAAAGSGQQGPGGYGPRQQGPGGYGQGQQGPSGPGSAAAASAAASAESGQQGPGGYGPGQQGPGGYGPGQQGPGGYGPGQQGPSGPGSAAAAAAAASGPGQQGPGGYGPGQQGPGGYGPGQQGPSGPGSAAAAAAAASGPGQQGPGGYGPGQQGPGGYGPGQQGLSGPGSAAAAAAAGPGQQGPGGYGPGQQGPSGPGSAAAAAAAAAGPGGYGPGQQGPGGYGPGQQGPSGAGSAAAAAAAGPGQQGLGGYGPGQQGPGGYGPGQQGPGGYGPGSASAAAAAAGPGQQGPGGYGPGQQGPSGPGSASAAAAAAAAGPGGYGPGQQGPGGYAPGQQGPSGPGSASAAAAAAAAGPGGYGPGQQGPGGYAPGQQGPSGPGSAAAAAAAAAGPGGYGPAQQGPSGPGIAASAASAGPGGYGPAQQGPAGYGPGSAVAASAGAGSAGYGPGSQASAAASRLASPDSGARVASAVSNLVSSGPTSSAALSSVISNAVSQIGASNPGLSGCDVLIQALLEIVSACVTILSSSSIGQVNYGAASQFAQVVGQSVLSAF

SEQ ID NO: 50 - protein, 636 aa, Araneus diadematus
ARAGSGQQGPGQQGPGQQGPGQQGPYGPGASAAAAAAGGYGPGSGQQGPSQQGPGQQGPGGQGPYGPGASAAAAAAGGYGPGSGQQGPGGQGPYGPGSSAAAAAAGGNGPGSGQQGAGQQGPGQQGPGASAAAAAAGGYGPGSGQQGPGQQGPGGQGPYGPGASAAAAAAGGYGPGSGQGPGQQGPGGQGPYGPGASAAAAAAGGYGPGSGQQGPGQQGPGQQGPGGQGPYGPGASAAAAAAGGYGPGYGQQGPGQQGPGGQGPYGPGASAASAASGGYGPGSGQQGPGQQGPGGQGPYGPGASAAAAAAGGYGPGSGQQGPGQQGPGQQGPGQQGPGGQGPYGPGASAAAAAAGGYGPGSGQQGPGQQGPGQQGPGQQGPGQQGPGQQGPGQQGPGQQGPGQQGPGGQGAYGPGASAAAGAAGGYGPGSGQQGPGQQGPGQQGPGQQGPGQQGPGQQGPGQQGPGQQGPYGPGASAAAAAAGGYGPGSGQQGPGQQGPGQQGPGGQGPYGPGAASAAVSVGGYGPQSSSVPVASAVASRLSSPAASSRVSSAVSSLVSSGPTKHAALSNTISSVVSQVSASNPGLSGCDVLVQALLEVVSALVSILGSSSIGQINYGASAQYTQMVGQSVAQALA

SEQ ID NO: 51 - protein, 410 aa, Araneus diadematus
AGSSAAAAAAASGSGGYGPENQGPSGPVAYGPGGPVSSAAAAAAAGSGPGGYGPENQGPSGPGGYGPGGSGSSAAAAAAAASGPGGYGPGSQGPSGPGGSGGYGPGSQGASGPGGPGASAAAAAAAAAASGPGGYGPGSQGPSGPGAYGPGGPGSSAAAAAAAASGPGGYGPGSQGPSGPGVYGPGGPGSSAAAAAAAGSGPGGYGPENQGPSGPGGYGPGGSGSSAAAAAAAASGPGGYGPGSQGPSGPGGSGGYGPGSQGGSGPGASAAAAAAAASGPGGYGPGSQGPSGPGYQGPSGPGAYGPSPSASASVAASVYLRLQPRLEVSSAVSSLVSSGPTNGAAVSGALNSLVSQISASNPGLSGCDALVQALLELVSALVAILSSASIGQVNVSSVSQSTQMISQALS

SEQ ID NO: 52 - protein, 50 aa, Araneus diadematus
SGCDVLVQALLEVVSALVSILGSSSIGQINYGASAQYTQMVGQSVAQALA

SEQ ID NO: 53 - protein, 30 aa, Araneus diadematus
SGCDVLVQALLEVVSALVSILGSSSIGQIN

SEQ ID NO: 54 - protein, 21 aa, Araneus diadematus
SGCDVLVQALLEVVSALVSIL

SEQ ID NO: 55 - protein, 96 aa, Artificial Sequence
  Synthetic recombinant silk protein repetitive fragment
GAGAGSGAGAGSGAGAGSGAGAGSGAGAGSGAGAGSGAGAGSGAGAGSGAGAGSGAGAGSGAGAGSGAGAGSGAGAGSGAGAGSGAGAGSGAGAGS

SEQ ID NO: 56 - protein, 140 aa, Artificial Sequence
  Synthetic recombinant silk protein repetitive fragment
GAGAGSGAGAGSGAGAGSGAGAGSGAGAGSGAGAGSGAGAGSGAGAGSGAGAGSGAGAGSGAGAGSGAGAGSGAGAGSGAGAGSGAGAGSGAGAGSSGFGPVANGGSGEASSESDFGSSGFGPVANASSGEASSESDFAG

SEQ ID NO: 57 - protein, 184 aa, Artificial Sequence
  Synthetic recombinant silk protein repetitive fragment
GAGAGSGAGAGSGAGAGSGAGAGSGAGAGSGAGAGSGAGAGSGAGAGSGAGAGSGAGAGSGAGAGSGAGAGSGAGAGSGAGAGSGAGAGSGAGAGSSGFGPVANGGSGEASSESDFGSSGFGPVANASSGEASSESDFAGSGFGPVANGGSGEASSESDFGSSGFGPVANASSGEASSESDFAG

SEQ ID NO: 58 - protein, 228 aa, Artificial Sequence
  Synthetic recombinant silk protein repetitive fragment
GAGAGSGAGAGSGAGAGSGAGAGSGAGAGSGAGAGSGAGAGSGAGAGSGAGAGSGAGAGSGAGAGSGAGAGSGAGAGSGAGAGSGAGAGSGAGAGSSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAG

SEQ ID NO: 59 - protein, 272 aa, Artificial Sequence
  Synthetic recombinant silk protein repetitive fragment
GAGAGSGAGAGSGAGAGSGAGAGSGAGAGSGAGAGSGAGAGSGAGAGSGAGAGSGAGAGSGAGAGSGAGAGSGAGAGSGAGAGSGAGAGSGAGAGSSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAG

SEQ ID NO: 60 - protein, 448 aa, Artificial Sequence
  Synthetic recombinant silk protein repetitive fragment
GAGAGSGAGAGSGAGAGSGAGAGSGAGAGSGAGAGSGAGAGSGAGAGSGAGAGSGAGAGSGAGAGSGAGAGSGAGAGSGAGAGSGAGAGSGAGAGSSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAG

SEQ ID NO: 61 - protein, 624 aa, Artificial Sequence
  Synthetic recombinant silk protein repetitive fragment
GAGAGSGAGAGSGAGAGSGAGAGSGAGAGSGAGAGSGAGAGSGAGAGSGAGAGSGAGAGSGAGAGSGAGAGSGAGAGSGAGAGSGAGAGSGAGAGSSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAGSGFGPVANGGSGEASSESDFGSSGFGPVANASSGEASSESDFAG

SEQ ID NO: 62 - protein, 124 aa, Artificial Sequence
  Based on ADF-3
GAASAAVSVGGYGPQSSSAPVASAAASRLSSPAASSRVSSAVSSLVSSGPTNQAALSNTISSVVSQVSASNPGLSGCDVLVQALLEVVSALVSILGSSSIGQINYGASAQYTQMVGQSVAQALA

SEQ ID NO: 63 - protein, 109 aa, Artificial Sequence
  Based on ADF-3
GAYGPSPSASASVAASRLSSPAASSRVSSAVSSLVSSGPTNGAAVSGALNSLVSQISASNPGLSGCDALVQALLELVSALVAILSSASIGQVNVSSVSQSTQMISQALS

SEQ ID NO: 64 - protein, 576 aa, Artificial Sequence
  Synthetic spider silk C16 protein
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPG

SEQ ID NO: 65 - protein, 1154 aa, Artificial Sequence
  Recombinant spider silk protein ADF3Kai-Large- NRSH1
MHHHHHHHHHHSSGSSLEVLFQGPARAGSGQQGPGQQGPGQQGPGQQGPYGPGASAAAAAAGGYGPGSGQQGPSQQGPGQQGPGGQGPYGPGASAAAAAAGGYGPGSGQQGPGGQGPYGPGSSAAAAAAGGNGPGSGQQGAGQQGPGQQGPGASAAAAAAGGYGPGSGQQGPGQQGPGGQGPYGPGASAAAAAAGGYGPGSGQGPGQQGPGGQGPYGPGASAAAAAAGGYGPGSGQQGPGQQGPGQQGPGGQGPYGPGASAAAAAAGGYGPGYGQQGPGQQGPGGQGPYGPGASAASAASGGYGPGSGQQGPGQQGPGGQGPYGPGASAAAAAAGGYGPGSGQQGPGQQGPGQQGPGQQGPGGQGPYGPGASAAAAAAGGYGPGSGQQGPGQQGPGQQGPGQQGPGQQGPGQQGPGQQGPGQQGPGQQGPGGQGAYGPGASAAAGAAGGYGPGSGQQGPGQQGPGQQGPGQQGPGQQGPGQQGPGQQGPGQQGPYGPGASAAAAAAGGYGPGSGQQGPGQQGPGQQGPGGQGPYGPGAASAAVSVSRARAGSGQQGPGQQGPGQQGPGQQGPYGPGASAAAAAAGGYGPGSGQQGPSQQGPGQQGPGGQGPYGPGASAAAAAAGGYGPGSGQQGPGGQGPYGPGSSAAAAAAGGNGPGSGQQGAGQQGPGQQGPGASAAAAAAGGYGPGSGQQGPGQQGPGGQGPYGPGASAAAAAAGGYGPGSGQGPGQQGPGGQGPYGPGASAAAAAAGGYGPGSGQQGPGQQGPGQQGPGGQGPYGPGASAAAAAAGGYGPGYGQQGPGQQGPGGQGPYGPGASAASAASGGYGPGSGQQGPGQQGPGGQGPYGPGASAAAAAAGGYGPGSGQQGPGQQGPGQQGPGQQGPGGQGPYGPGASAAAAAAGGYGPGSGQQGPGQQGPGQQGPGQQGPGQQGPGQQGPGQQGPGQQGPGQQGPGGQGAYGPGASAAAGAAGGYGPGSGQQGPGQQGPGQQGPGQQGPGQQGPGQQGPGQQGPGQQGPYGPGASAAAAAAGGYGPGSGQQGPGQQGPGQQGPGGQGPYGPGAASAAVSVGGYGPQSSSVPVASAVASRLSSPAASSRVSSAVSSLVSSGPTKHAALSNTISSVVSQVSASNPGLSGCDVLVQALLEVVSALVSIL

SEQ ID NO: 66 - protein, 24 aa, Artificial Sequence
  His tag and start codon
MHHHHHHHHHHSSGSSLEVLFQGP

SEQ ID NO: 67 - protein, 434 aa, Artificial Sequence
  Recombinant spider silk protein ADF4Kai
MHHHHHHHHHHSSGSSLEVLFQGPAGSSAAAAAAASGSGGYGPENQGPSGPVAYGPGGPVSSAAAAAAAGSGPGGYGPENQGPSGPGGYGPGGSGSSAAAAAAAASGPGGYGPGSQGPSGPGGSGGYGPGSQGASGPGGPGASAAAAAAAAAASGPGGYGPGSQGPSGPGAYGPGGPGSSAAAAAAAASGPGGYGPGSQGPSGPGVYGPGGPGSSAAAAAAAGSGPGGYGPENQGPSGPGGYGPGGSGSSAAAAAAAASGPGGYGPGSQGPSGPGGSGGYGPGSQGGSGPGASAAAAAAAASGPGGYGPGSQGPSGPGYQGPSGPGAYGPSPSASASVAASVYLRLQPRLEVSSAVSSLVSSGPTNGAAVSGALNSLVSQISASNPGLSGCDALVQALLELVSALVAILSSASIGQVNVSSVSQSTQMISQALS

SEQ ID NO: 68 - protein, 355 aa, Artificial Sequence
  Recombinant spider silk protein MaSp2_N
MHHHHHHSSGSSLEVLFQGPARAGPGGYRPGQQGPSGPGSAAAAAAAAAGPGGYGPGQQGPGGYGPGQQGPSGAGSAAAAAAAGPGQQGLGGYGPGQQGPGGYGPGQQGPGGYGPGSASAAAAAAGPGQQGPGGYGPGQQGPSGPGSASAAAAAAGPGGYGPGQQGPGGYAPGQQGPSGPGSAAAAAAAARAGPGGYGPAQQGPSGPGIAASAASAGPGGYGPAQQGPAGYGPGSAVAASAGAGSAGYGPGSQASAAASRLASPDSGARVASAVSNLVSSGPTSSAALSSVISNAVSQIGASNPGLSGCDVLIQALLEIVSACVTILSSSSIGQVNYGAASQFAQVVGQSVLSAF

SEQ ID NO: 69 - protein, 5 aa, Artificial Sequence
  Synthetic recombinant silk protein repeating fragment
  MISC_FEATURE (5)..(5): X can be alanine, serine, tyrosine, or valine
GPGGX

SEQ ID NO: 70 - protein, 559 aa, Artificial Sequence
  Recombinant spider silk protein Flag_92_short2
MHHHHHHHHHHSSGSSLEVLFQGPGAGGSGPGGAGPGGVGPGGSGPGGVGPGGSGPGGVGPGGSGPGGVGPGGAGGPYGPGGSGPGGAGGAGGPGGAYGPGGSYGPGGSGGPGGAGGPYGPGGEGPGGAGGPYGPGGAGGPYGPGGAGGPYGPGGEGGPYGPGGSYGPGGAGGPYGPGGPYGPGGEGPGGAGGPYGPGGVGPGGGGPGGYGPGGAGPGGYGPGGSGPGGYGPGGSGPGGYGPGGSGPGGYGPGGSGPGGYGPGGSGPGGSGPGGYGPGGSGPGGSGPGGYGPGGSGPGGYGPGGSGPGGSGPGGYGPGGSGPGGSGPGGYGPGGSGPGGFGPGGFGPGGSGPGGYGPGGSGPGGAGPGGVGPGGFGPGGAGPGGAGPGGAGPGGAGPGGAGPGGAGPGGAGPGGAGPGGAGGAGGAGGAGGSGGAGGSGGTTIIEDLDITIDGADGPITISEELTISAYYPSSRVPDMVNGIMSAMQGSGFNYQMFGNMLSQYSSGSGTCNPNNVNVLMDALLAALHCLSNHGSSSFAPSPTPAAMSAYSNSVGRMFAY